(19) United States
(12) Patent Application Publication
(10) Pub. No.: US 2010/0087330 A1
(43) Pub. Date: Apr. 8, 2010

(54) BREAST CANCER GENE ARRAY

(76) Inventors: Brian Leyland-Jones, Montreal (CA); Mark Abramovitz, Dollard-des-Ormeaux (CA); Benjamin Gabriel Barwick, Atlanta, GA (US)

Correspondence Address: BENOIT & COTE, s.e.n.c., 1001, DE MAISONNEUVE BOULEVARD WEST, SUITE 210, MONTREAL, QC, H3A 3C8, CA

(21) Appl. No.: 12/524,306

(22) PCT Filed: Jan. 25, 2008
(86) PCT No.: PCT/CA08/00166

§ 371 Date: Nov. 17, 2009

Related U.S. Application Data
(60) Provisional application No. 60/886,772, filed on Jan. 26, 2007.

(51) Int. Cl. C40B 30/04; C40B 40/08

(52) U.S. Cl. 506/9; 506/17

(57) ABSTRACT

The present invention relates to a method for prognosing or classifying cancer subtypes in a subject with breast cancer. Methods and biomarkers are disclosed that are useful for prognosing or classifying ESR1, PGR and ERBB2 breast cancer subtypes.

### FIELD OF THE INVENTION

The present invention relates to a method for prognosing or classifying breast cancer subtypes in a subject with breast cancer. More specifically, the invention relates to set of biomarkers useful for prognosing or classifying breast cancer subtypes in a subject with breast cancer.

### BACKGROUND OF THE INVENTION

Tumor-associated antigens (TAAs) can help diagnose various tumors and sometimes determine the response to therapy or recurrence. An ideal tumor marker would be released only from tumor tissue, be specific for a given tumor type, be detectable at low levels of tumor cell burden, have a direct relationship to the tumor cell burden, and be present in all subjects with the tumor. However, although most tumors release detectable antigenic macromolecules into the circulation, no tumor marker has all the requisite characteristics to provide enough specificity or sensitivity to be used in early diagnosis or mass cancer screening programs.

Carcinoembryonic antigen (CEA) is a protein-polysaccharide complex present in colon carcinomas and in normal fetal intestine, pancreas, and Blood levels are elevated in subjects with colon carcinoma, but the specificity is relatively low because positive results also occur in heavy cigarette smokers and in subjects with cirrhosis, ulcerative colitis, and other cancers (eg, breast, pancreas, bladder, ovary, cervix). Monitoring CEA levels may be useful for detecting cancer recurrence after tumor excision if the subject initially had an elevated CEA.

CA 15-3 is elevated in 54 to 80% of subjects with metastatic breast cancer. It may also be elevated in other benign (eg, chronic hepatitis, cirrhosis, TB, sarcoidosis, SLE) and malignant (eg, lung, ovarian, endometrial, GI, and bladder carcinomas) conditions. This marker is primarily used to monitor the response to therapy.

Chromogranin A is used as a marker for carcinoid and other neuroendocrine tumors. Abnormal levels are seen in ⅓ of subjects with localized disease and in ⅔ of those with metastatic cancer. Levels can be elevated in other cancers, such as lung and prostate.

TA-90 is a highly immunogenic subunit of a urinary tumor-associated antigen that is present in 70% of melanomas, soft-tissue sarcomas, and carcinomas of the breast, colon, and lung. Some studies have shown that TA-90 levels can accurately predict survival and the presence of subclinical disease after surgery for melanoma.

Proteomic analyses of early stages cancers represent a new diagnostic tool for early detection of the disease. This technique evaluates the presence of various biomarkers in readily accessible body fluids such as serum, urine or saliva that are particular of specific changes in gene expression only occurring in cancer cells. Protein-based assays, such as the ELISA system, are used to evaluate the presence of biomarkers, therefore allowing detection and monitoring of cancer. The search for always more reliable cancer-related biomarkers is oriented towards proteins that are overexpressed, as a consequence of the disease process, and subsequently shed into body fluid. Novel proteomics methods and technologies are being used to discover new biomarkers for early-stage disease. Those methods comprise, besides the ELISA system, other antibody arrays, protein-based microarray technologies and multiplexed on-chip technologies. Despite their utility, there are several inherent disadvantages to these methods, such as the fact that they are often limited by the requirements for highly specific, high-affinity antibodies, two-site approaches and/or sensitive detection and signal amplification systems. Moreover, the development of proteomic pattern diagnostics is intricate since the specificity between physiologic biomarkers and the various types of cancer is hard to establish.

Accordingly, novel methods of prognosis or classifying breast cancer subtypes are highly desirable.

### SUMMARY OF THE INVENTION

In accordance with the present invention there is provided a method for prognosing or classifying a subject or a tumor from a subject for breast cancer subtypes.

The inventors have identified the 512 genes listed in Table 1 that are particularly useful for classifying breast cancer tumor subtypes. Also listed are probes that can be used in accordance with one embodiment of the present invention.

TABLE 1

512 Breast cancer gene array

| | | | |
|---|---|---|---|
| Gene | | | SEQ ID |
| Symbol | Accession | Probe Sequence | NO: |

| | | | |
|---|---|---|---|
| ABCB1 | NM_000927.3 | TCGCTATTCAAATTGGCTTGACAAGTTGTATATGGTGGTGGGAACT | 1 |
| ABCB1 | NM_000927.3 | TCCTCTCATGATGCTGGTGTTTGGAGAAATGACAGATATCTTTGCAA | 2 |
| ABCB1 | NM_000927.3 | ATTGGTGCTGGGGTGCTGGTTGCTGCTTACATTCAGGTTTCATT | 3 |
| ABCC1 | NM_019900.1 | GCCTTGTTTTTACCTCTGGGCCTGTTTCCCCTTCTACTTCCTCTAT | 4 |
| ABCC1 | NM_019900.1 | CTCTTGGGCATCACCACGCTGCTTGCTACCTTTTTAATTCAGCT | 5 |
| ABCC1 | NM_019900.1 | AGACTAGGAAGCAGCCGGTGAAGGTTGTGTACTCCTCCAAGGAT | 6 |
| ABCC2 | NM_000392.1 | GGTTTTGCTGATCCAATACAGCAGACAATGGTGTGTACAGAAAAACT | 7 |
| ABCC2 | NM_000392.1 | CAAGCGTCCTCTGACACTCGAGGATGTCTGGGAAGTTGATGAAG | 8 |
| ABCC2 | NM_000392.1 | ATTCACTGCGGCTCTCATTCAGTCTTTCTGCCTTCAGTGTTATTT | 9 |
| ABCG2 | NM_004827.2 | TGGAAGGTCCGGGTGACTCATCCCAACATTTACATCCTTAATTGT | 10 |
| ABCG2 | NM_004827.2 | TCCTGAGATCCTGAGCCTTTGGTTAAGACCGAGCTCTATTAAGCTG | 11 |
| ABCG2 | NM_004827.2 | CCTTGTCGAAAACCAGTTGAGAAAGAAATATTATCGAATATCAATGGGA | 12 |
| ABL1 | NM_007313.2 | AAGCCCTTCAGCGGCCAGTAGCATCTGACTTTGAGCCTCAG | 13 |
| ABL1 | NM_007313.2 | GTCTGCACCCGGGAGCCCCCGTTCTATATCATCACTGAGTT | 14 |
| ABL1 | NM_007313.2 | GACGAGGACCTCCAGGAGAGCTGCAGAGCACAGAGACACCACT | 15 |
| ACADS | NM_000017.1 | CTCTGTCCTAGGGCCTGGCGGCAGTTACACACCATCTACCAGTC | 16 |
| ACADS | NM_000017.1 | CAGACATGCCGGGACTTTGCCGAGAAGGAGTTGTTTCCCATT | 17 |
| ACADS | NM_000017.1 | AACAACTCTCTCTACCTGGGGCCCATCTTGAAGTTTGGCTCCAAG | 18 |
| ACE | NM_152830.1 | GCAGAACACCACTATCAAGCGGATCATAAAGAAGGTTCAGGACCTAG | 19 |
| ACE | NM_152830.1 | GGAGAGCCATCCTCCAGTTTTACCCGAAATACGTGGAACTCATCAAC | 20 |
| ACE | NM_152830.1 | GTAGATGCAGGGGACTCGTGGAGGTCTATGTACGAGACACCATCC | 21 |
| ACOT11 | NM_015547.2 | GTGGCCTCGGAGGACCTGTGCTCTGAGAAGCAGTGGAATGT | 22 |
| ACOT11 | NM_015547.2 | CTGAAGCAGATCACGCCGCGGACAGAAGAGGAGAAGATGGAG | 23 |
| ACOT11 | NM_015547.2 | GTGCCCACCCTACGCTGAAGGCCATTGAAATGTTCCACTTC | 24 |
| ACP5 | NM_001611.2 | GGACTGTGCAGATCCTGGGTGCAGACTTCATCCTGTCTCTAGGG | 25 |
| ACP5 | NM_001611.2 | GCTGGACACAGTGACACTATGTGGCAACTCAGATGACTTCCTCAGC | 26 |
| ACP5 | NM_001611.2 | AGGTCCCCAACGGCTATCTGCGCTTCCACTATGGGACTGAAGAC | 27 |
| ACTB | NM_001101.2 | GGAAGTCCCTTGCCATCCTAAAAGCCACCCCACTTCTCTCTAAG | 28 |
| ACTB | NM_001101.2 | TCCACACAGGGGAGGTGATAGCATTGCTTTCGTGTAAATTATGTAAT | 29 |
| ACTB | NM_001101.2 | CAATGAGCGGTTCCGCTGCCCTGAGGCACTCTTCCAG | 30 |
| ADM | NM_001124.1 | ATCCGAGTCAAGCGCTACCGCCAGAGCATGAACAACTTCCAG | 31 |
| ADM | NM_001124.1 | ACGGTGCAGAAGCTGGCACACCAGATCTACCAGTTCACAGATA | 32 |
| ADM | NM_001124.1 | TCCCCACTTTCTTTAGGATTTAGGCGCCCATGGTACAAGGAATAGTC | 33 |
| AFF3 | NM_002285.2 | CCAGATAGAAATGCATTACGGAGGAAAGAACGAGAAAGAAGAAATCAAG | 34 |
| AFF3 | NM_002285.2 | ACAGGATGATGGCACGTTTAATTCTAGTTACTCTCTCTTCAGTGAGCC | 35 |
| AFF3 | NM_002285.2 | CCAAGATCAGGCCCCTGATGAGTCTCCTAAGCTGAAGTCGTCT | 36 |
| AGT | NM_000029.2 | ACATACACCCCTTCCACCTCGTCATCCACAATGAGAGTACCTGTG | 37 |
| AGT | NM_000029.2 | CTGGCCAACTTCTTGGGCTTCCGTATATATGGCATGCACAGTGA | 38 |
| AGT | NM_000029.2 | TATACCCCTGTGGTCCTCCCACGCTCTCTGGACTTCACAGAACTG | 39 |
| AK3 | NM_016282.2 | ACCGTGTCGTCGCGCATCACTACACACTTCGAGCTGAAG | 40 |
| AK3 | NM_016282.2 | ACTTCCACAGGCAGAAGCCCTAGATAGAGCTTATCAGATCGACACA | 41 |
| AK3 | NM_016262.2 | TAAGGATGTGCCAAATGATTCGGATACTAAGATGCATCGTTTGAAAT | 42 |
| AKT1 | NM_001014432.1 | CTCACCCAGTGACAACTCAGGGGCTGAAGAGATGGAGGTGTCC | 43 |
| AKT1 | NM_001014432.1 | GCCCTGGGCTGTCTGTCACCAGCTATCTGTCATCTCTCTGGG | 44 |
| AKT1 | NM_001014432.1 | AGCCCCCCAGCACTAAGGCCGTGTCTCTGAGGACGTCATC | 45 |
| AKT2 | NM_001626.2 | CCAAGGAGGTCATGGAGCACAGGTTCTTCCTCAGCATCAACTG | 46 |
| AKT2 | NM_001626.2 | GCCCGGTTTTATGGTGCAGAGATTGTCTCGGCTCTTGAGTACT | 47 |
| AKT2 | NM_001626.2 | AGGTCACGTCCGAGGTCGACACAAGGTACTTCGATGATGAATT | 48 |
| AKT3 | NM_005465.3 | AGAACGACCAAAGCCAAACACATTTATAATCAGATGTCTCCAGTGG | 49 |
| AKT3 | NM_005465.3 | GGCTGTAGCAGACAGACTGCAGAGGCAAGAAGAGGAGAGAATGAAT | 50 |
| AKT3 | NM_005465.3 | GGAGGACCAGATGATGCAAAAGAAATTATGAGACACAGTTTCTTCTCTG | 51 |
| ALCAM | NM_001627.2 | AGAGGCAGCTTACACACGCCTTCCAGTCCCTCTACTCAGAGCAG | 52 |
| ALCAM | NM_001627.2 | TGTGCAGTACGACGATGTACCAGAATACAAAGACAGATTGAACCTCTC | 53 |
| ALCAM | NM_001627.2 | TGCAAGGATCAGTGATGAAAAGAGATTTGTGTGCATGCTAGTAACTG | 54 |
| ALDH6A1 | NM_005589.2 | GGTGGGAAATTCGTTGAATCCAAAAGTGACAAATGGATCGATATC | 55 |
| ALDH6A1 | NM_005589.2 | TTGGAACAAGGGAAGACCCTAGCTGATGCTGAAGGAGATGTATTTC | 56 |
| ALDH6A1 | NM_005589.2 | ATGGCCATGGTGTGTGGAAATACCTTCCTAATGAAACCATCTGAG | 57 |
| ANG | NM_001145.2 | CTATGATGCCAAACCACAGGGCCGGGATGACAGATACTGTGAAAG | 58 |
| ANG | NM_001145.2 | TGGAAACCCTCACAGAGAAAACCTAAGAATAAGCAAGTCTTCTTTCC | 59 |
| ANG | NM_001145.2 | GCCCAAAGAAAGAGCTACCTGGACCTTTTGTTTTCTGTTTGACAACAT | 60 |
| ANGPT2 | NM_001147.1 | AACTTTCGGAAGAGCATGGACAGCATAGGAAAGAAGCAATATCAGGT | 61 |
| ANGPT2 | NM_001147.1 | CATGGAAAACAACACTCAGTGGCTAATGAAGCTTGAGAATTATATCCA | 62 |
| ANGPT2 | NM_001147.1 | AATGCAGTACAGAACCAGACGGCTGTGATGATAGAAATAGGGACAAA | 63 |
| ANK3 | NM_001149.2 | CTCCGCTCCTTCAGTTCGGATAGGTCTTACACCTTGAACAGAAGCT | 64 |
| ANK3 | NM_001149.2 | ATCCCTCACTTTGGGTCCATGAGAGGAAAAGAGAGAGAACTCATTG | 65 |
| ANK3 | NM_001149.2 | TGGAAGGAGCATCAGTTTGACAGCAAAAATGAAGATTTAACCGAGTT | 66 |
| APOE | NM_000041.2 | TTGAGTCCTACTCAGCCCCAGCGGAGGTGAAGGACGTCCTTC | 67 |
| APOE | NM_000041.2 | GGATTACCTGCGCTGGGTGCAGACACTGTCTGAGCAGGTG | 68 |
| APOE | NM_000041.2 | GAACTGAGGGCGCTGATGGACGAGACCATGAAGGAGTTGAAG | 69 |
| AREG | NM_001657.2 | CTACCGCCGGCGCCGGTGGTGCTGTCGCTCTTGATACTC | 70 |
| AREG | NM_001657.2 | CCTCGGGAGCCGACTATGACTACTCAGAAGAGTATGATAACGAACC | 71 |
| AREG | NM_001657.2 | TTCAAAATTTCTGCATTCACGGAGAATGCAAATATATAGAGCACCTG | 72 |
| ARHGDIB | NM_001175.4 | GGAGATCTGGAAGCCCTCAAAAAGGAAACCATTGTGTTAAAGGAAG | 73 |
| ARHGDIB | NM_001175.4 | ATGGTTGGCAGCTATGGACCTCGGCCTGAGGAGTATGAGTTCCT | 74 |
| ARHGDIB | NM_001175.4 | CTCAGCTGGGAGTGGAACCTGTCGATTAAGAAGGAGTGGACAGAAT | 75 |
| ASNS | NM_133436.1 | GGCATTTGGGCGCTGTTTGGCAGTGATGATTGCCTTTCTGT | 76 |
| ASNS | NM_133436.1 | GATTGCACACAGAGGTCCAGATGCATTCCGTTTTGAGAATGTCAAT | 77 |
| ASNS | NM_133436.1 | TGCCAATAAGAAAGTGTTCCTGGGTAGAGATACATATGGAGTCAGACCT | 78 |
| ATAD2 | NM_014109.2 | AAGTTGAAACCTACCACCGGACACGTGCTTTAAGATCTTTGAGAAAAG | 79 |
| ATAD2 | NM_014109.2 | TCCAGTTACTCGGTCATTGAGGGCTAGAAACATCGTTCAAAGTACAGA | 80 |
| ATAD2 | NM_014109.2 | GATGTTGAAGTGCGTCGAAGTTGTAGGATTAGAAGTCGTTATAGTGGTG | 81 |
| ATF5 | NM_012068.2 | TCATTCCCTGTCCTCGGATCACAGTCTCTTCTCACTACAGTGTCG | 82 |
| ATF5 | NM_012068.2 | CATCAGTGCCCAGCACCTGTGCTACAGCCATGTCACTCCTG | 83 |
| ATF5 | NM_012068.2 | CCAGCTAGTGGGCTGGGATGGCTCGTAGACTATGGGAAACTCC | 84 |
| ATP5B | NM_001686.3 | GCATTTGGGTGAGAGCACAGTAAGGACTATTGCTATGGATGGTACAG | 85 |
| ATP5B | NM_001686.3 | CATGGAAATGAGTGTTGAGCAGGAAATTCTGGTGACTGGTATCAAG | 86 |
| ATP5B | NM_001686.3 | AATTGGGCTTTTTGGTGGTGCTGGAGTTGGCAAGACTGTACTGAT | 87 |
| ATP8B1 | NM_005603.2 | CCACGAACAACCTCACTTTATGAACACAAAATTCTTGTGTATTAAGGAGA | 88 |
| ATP8B1 | NM_005603.2 | AGGATGGCAGGTTCAAAGTTGCTAAGTGGAAAGAAATTCAAGTTG | 89 |
| ATP8B1 | NM_005603.2 | TTGTTCCAGCTGACATTCTCCTGCTGTCTAGCTCTGAGCCTAACAG | 90 |
| ATR | NM_001184.2 | GAGACTTCTGCGGATTGCAGCAACTCCCTCCTGTCATTTGTTAC | 91 |
| ATR | NM_001184.2 | CCAGTGGTCATGAGCCGATTTTTAAGTCAATTAGATGAACACATGG | 92 |
| ATR | NM_001184.2 | TGCAATTGTGTTTTTTAGAAGGCAAGAACTCTTACTTTGGCAGATAGGT | 93 |
| AURKB | NM_004217.2 | CCCCTTTCTCTCTAAGGATGGCCCAGAAGGAGAACTCCTACCCCT | 94 |
| AURKB | NM_004217.2 | TGCCCCTGGCCAGAAGGTGATGGAGAATAGCAGTGGGAC | 95 |
| AURKB | NM_004217.2 | AACGAGACCTATCGCCGCATCGTCAAGGTGGACCTAAAGTTC | 96 |
| BAD | NM_004322.2 | TCCAGATCCCAGAGTTTGAGCCGAGTGAGCAGGAAGACTCCAG | 97 |
| BAD | NM_004322.2 | GCCCTGGGCAGCCATCTTGAATATGGGCGGAAGTACTTC | 98 |
| BAD | NM_004322.2 | AAGCCACGGAAGGCTTGGTCCCATCGGAAGTTTTGGGTTTT | 99 |
| BAG1 | NM_004323.3 | ACCAGTTGTCCAAGACCTGGCCCAGGTTGTTGAAGAGGTCATA | 100 |
| BAG1 | NM_004323.3 | GGTTCCACAGTCTTTTCAGAAACTCATATTTAAGGGAAAATCTCTGAAGG | 101 |
| BAG1 | NM_004323.3 | ATACAAGATGGTTGCCGGGTCATGTTAATTGGGAAAAAGAACAGTC | 102 |
| BAK1 | NM_001188.2 | GTCCCTCGGGCTGCACAGGGACAAGTAAAGGCTACATCCAG | 103 |
| BAK1 | NM_001188.2 | CCATCATCGGGGACGACATCAACCGACGCTATGACTCAGAG | 104 |
| BAK1 | NM_001188.2 | GCTTCCTAGGCCAGGTGACCCGCTTCGTGGTCGACTTCATG | 105 |
| BBC3 | NM_014417.2 | CCCTCACCCTGGAGGGTCCTGTACAATCTCATCATGGGACTC | 106 |
| BBC3 | NM_014417.2 | AGGGGCCACAGAGCCCCCGAGATGGAGCCCAATTAGGT | 107 |
| BBC3 | NM_014417.2 | AGCGCGGGGGACTTTCTCTGCACCATGTAGCATACTGGACTC | 108 |
| BCAS2 | NM_005872.2 | GCAGACGCAGAAAACGCAGGCAAACCTGAGGTCCTCAGAAT | 109 |
| BCAS2 | NM_005872.2 | AGAGGTTGTGGTGGATGCGCTGCCGTATTTTGATCAAGGTTATG | 110 |
| BCAS2 | NM_005872.2 | GTGGAGGAGGAAACTCGCAGATACCGACCTACTAAGAACTACCTG | 111 |
| BCL2 | NM_000657.2 | GCGACTCCTGATTCATTGGGAAGTTTCAAATCAGCTATAACTGGA | 112 |
| BCL2 | NM_000657.2 | TGAAGATTGATGGGATCGTTGCCTTATGCATTTGTTTTGGTTTTAC | 113 |
| BCL2 | NM_000657.2 | CGTGCCTCATGAAATAAAGATCCGAAAGGAATTGGAATAAAAATTTCC | 114 |
| BCL2L1 | NM_001191.2 | GGTGTTTTGGACAATGGACTGGTTGAGCCCATCCCTATTATAAAAAT | 115 |
| BCL2L1 | NM_001191.2 | TCCTACAAGCTTTCCCAGAAAGGATACAGCTGGAGTCAGTTTAGTGAT | 116 |
| BCL2L1 | NM_001191.2 | CCAGCTCCACATCACCCCAGGGACAGCATATCAGAGCTTTGAA | 117 |
| BCL2L14 | NM_030766.1 | ACCATAGAATTCAAAATCCTCGCCTACTACACCAGACATCATGTCTTC | 118 |
| BCL2L14 | NM_030766.1 | GCAGGAGGCTTCAAGTCCAAAGAGATTTTTGTAACTGAGGGTCTCT | 119 |
| BCL2L14 | NM_030766.1 | GCCAAAATTGTTGAGCTGCTGAAATATTCAGGAGATCAGTTGGAAA | 120 |
| BHLHB2 | NM_003670.1 | ACCTACAAATTGCCGCACCGGCTCATCGAGAAAAAGAGACGT | 121 |
| BHLHB2 | NM_003670.1 | GGGTCACTTGGAAAAAGCAGTGGTTCTTGAACTTACCTTGAAGCAT | 122 |
| BHLHB2 | NM_003670.1 | CAGGGAGAAATGTCGAAACAGGTCAAGAGATGTTCTGCTCAGGTTT | 123 |
| BID | NM_197967.1 | GTTCCAGCCTCAGGGATGAGTGCATCACAAACCTACTGGTGTTTG | 124 |
| BID | NM_197967.1 | CCTGGCATGTCAACAGCGTTCCTAGAGAAGACAGGCTGGAAGATA | 125 |
| BID | NM_197967.1 | TGAATGGCCTTCATATCATCCACACATGAATCTGCACATCTGTAAATC | 126 |
| BIK | NM_001197.3 | TGACTCTGAAGAGGACCTGGACCCTATGGAGGACTTCGATTCTTT | 127 |
| BIK | NM_001197.3 | GACCAGACTGAGGACATCAGGGATGTTCTTAGAAGTTTCATGGACG | 128 |
| BIK | NM_001197.3 | TGGAATAGATTCCGAGGAGCAGGAGTGCTCAATAAAATGTTGGTTT | 129 |
| BIN1 | NM_139345.1 | CAGAAGCTGGGGAAGGCAGATGAGACCAAGGATGAGCAGTTT | 130 |
| BIN1 | NM_139345.1 | ACGAGGCTTCCAAGAAGCTGAATGAGTGTCTGCAGGAGGTGTAT | 131 |
| BIN1 | NM_139345.1 | GAGGAGGAGCTCATCAAAGCCCAGAAGGTGTTTGAGGAGATGAAT | 132 |
| BIRC5 | NM_001012270.1 | GGAAACGGGGTGAACTTCAGGTGGATGAGGAGACAGAATAGAGTGA | 133 |
| BIRC5 | NM_001012270.1 | CTCCCTCAGAAAAAGGCAGTGGCCTAAATCCTTTTTAAATGACTTGG | 134 |
| BIRC5 | NM_001012270.1 | GCTGTGGACCCTACTGGGTTTTTAAAATATTGTCAGTTTTTCATCG | 135 |
| BLM | NM_000057.1 | CCAACTGTAAAGAAATCCCGGGATACTGCTCTCAAGAAATTAGAATTT | 136 |
| BLM | NM_000057.1 | TGTTACACCACCCCAAAGTCACTTTGTAAGAGTAAGCACTGCTCAGAA | 137 |
| BLM | NM_000057.1 | GATGGCCCCATTGCTGAAGTGCATATAAATGAAGATGCTCAGGA | 138 |
| BMF | NM_033503.3 | TCAAACACTGTTGAAGGAGAGGCTGATGTGTCTGTGATGGTGAGAAT | 139 |
| BMF | NM_033503.3 | ACCAGTTGTCGAAGATGATCCGTTAGTGATGTTCTCTGGGAAGTG | 140 |
| BMF | NM_033503.3 | TGTGGTTTTTCCAGAGGAACTCAGTTAAGAAATCGAGAGTGGATTAGA | 141 |
| BNIP3 | NM_004052.2 | AATAATGGGAACGGGGGCAGCGTTCCAGCCTCGGTTTCTAT | 142 |
| BNIP3 | NM_004052.2 | CACCACAAGATACCAACAGGGCTTCTGAAACAGATACCCATAGCAT | 143 |
| BNIP3 | NM_004052.2 | TCATGTTGATCTATAATTACACCTATGGGATCAATAAGCATGTCAGACTGATT | 144 |
| BRAF | NM_004333.2 | CCAGCAAGCTAGATGCACTCCAACAAAGAGAACAACAGTTATTGGA | 145 |
| BRAF | NM_004333.2 | CAAGGTGTGGAGTTACAGTCCGAGACAGTCTAAAGAAAGCACTGATG | 146 |
| BRAF | NM_004333.2 | GAGAAGAAACCAATTGGTTGGGACACTGATATTTCCTGGCTTACTG | 147 |
| BRCA1 | NM_007306.2 | AAGCAGCATCTGGGTGTGAGAGTGAAACAAGCGTCTCTGAAGACT | 148 |
| BRCA1 | NM_007306.2 | CCACTCAGCAGAGGGATACCATGCAACATAACCTGATAAAGCTCCAG | 149 |
| BRCA1 | NM_007306.2 | CATGGGAGCCAGCCTTCTAACAGCTACCCTTCCATCATAAGTGACT | 150 |
| BRCA2 | NM_000059.1 | ATAATCAGCTGGCTTCAACTCCAATAATATTCAAAGAGCAAGGGCT | 151 |
| BRCA2 | NM_000059.1 | TTCCAATCATGATGAAAGTCTGAAGAAAAATGATAGATTTATCGCTTCTGT | 152 |
| BRCA2 | NM_000059.1 | TTTGGAAAAACATCAGGGAATTCATTTAAAGTAAATAGCTGCAAAGACC | 153 |
| BTG2 | NM_006763.2 | AGCGAGCTGACCCTGTGGGTGGACCCCTATGAGGTGTCCTAC | 154 |
| BTG2 | NM_006763.2 | TGACAACAGGCCACCACATACCTCAACCTGGGGAACTGTATTTTTA | 155 |
| BTG2 | NM_006763.2 | ATAGGAGGGGGAGCTGTTAGGGGGTAGACCTAGCCAAGGAGAAGT | 156 |
| BUB1 | NM_004336.2 | AGAGCTACAAGGGCAATGACCCTCTTGGTGAATGGGAAAGATAC | 157 |
| BUB1 | NM_004336.2 | CAGGCTGAACCCAGAGAGTTCCTGCAACAACAATACAGGTTATTTC | 158 |
| BUB1 | NM_004336.2 | TGGAACGAAGAGTGATCACGATTTCTAAATCAGAATATTCTGTGCACTC | 159 |
| C11orf17 | NM_020642.2 | GGTCCTTGCCCGGGAGGCGCCCCACCTAGAGAAACAG | 160 |
| C11orf17 | NM_020642.2 | AAAGACATCCCTTGGTCCTGGAGGCAGCTATCAAATATCAGAGCATG | 161 |
| C11orf17 | NM_020642.2 | CTGAGAACATCTCTAAGGACCTCTACATAGAAGTATATCCAGGGACCTATTC | 162 |
| C11orf30 | NM_020193.3 | TCTGGATCTCAGCAGGGATGAATGCAAAAGAATTCTTCGAAAATTG | 163 |
| C11orf30 | NM_020193.3 | TGAACGGTTAACAACAATTGCACATAATATGTCTGGACCTAATAGCTCT | 164 |
| C11orf30 | NM_020193.3 | AATGCATCTCTTCCAGTGCCTGCAGAAACAGGAAGCAAGGAAGT | 165 |
| C14orf155 | NM_032135.2 | TGAGGGAGCTCAACAGAATGACACCTAAGAAAGGGAAAGTCTTTGAC | 166 |
| C14orf155 | NM_032135.2 | TCTGGAAGCAAAGGCAGCTACTCTGCCAAAGCCTATGAGTCTATTAG | 167 |
| C14orf155 | NM_032135.2 | TGAATTGCCAGAGAGTGTTCAGGATGTAGAAATTCCACCAAACATAC | 168 |
| C3 | NM_000064.1 | TTACTGTCCACGACTTCCCAGGCAAAAAACTAGTGCTGTCCAGTG | 169 |
| C3 | NM_000064.1 | GGGCCAGTGGAAGATCCGAGCCTACTATGAAAACTCACCACAGC | 170 |
| C3 | NM_000064.1 | TGCCCAGTTTCGAGGTCATAGTGGAGCCTACAGAGAAATTCTACT | 171 |
| CACNG4 | NM_014405.2 | GCTGGCAGGATCTACAGCCGCAAGAACAACATCGTCCTCAGT | 172 |
| CACNG4 | NM_014405.2 | GGCGTCCTGGCTGTAAACATTTACATTGAGAAAAATAAAGAGTTGAG | 173 |
| CACNG4 | NM_014405.2 | ACAGGATGGCATGTGATCCTCAAGACGACGAACAATGAACTAAAG | 174 |
| CALR | NM_004343.2 | GCCCTGGCACCAAGAAGGTTCATGTCATCTTCAACTACAAGGG | 175 |
| CALR | NM_004343.2 | CTGTACACACTGATTGTGCGGCCAGACAACACCTATGAGGTGAAG | 176 |
| CALR | NM_004343.2 | GGAAGACGATTGGGACTTCCTGCCACCCAAGAAGATAAAGGATC | 177 |
| CASP2 | NM_001224.3 | TGTGTGGCATGCATCCTCATCATCAGGAAACTCTAAAAAAGAACC | 178 |
| CASP2 | NM_001224.3 | AATTTCGCTCTGGAGGGGATGTGGACCACAGTACTCTAGTCACCCT | 179 |
| CASP2 | NM_001224.3 | CGAGGTTCCTGGTACATCGAGGCTCTTGCTCAAGTGTTTTCTGA | 180 |
| CASP3 | NM_032991.2 | TGGAAGCGAATCAATGGACTCTGGAATATCCCTGGACAACAGTTATAA | 181 |
| CASP3 | NM_032991.2 | GAAATTGTGGAATTGATGCGTGATGTTTCTAAAGAAGATCACAGCAA | 182 |
| CASP3 | NM_032991.2 | TTGTGTGCTTCTGAGCCATGGTGAAGAAGGAATAATTTTTGGAACA | 183 |
| CASP8 | NM_033357.2 | GGTCATCCTGGGAGAAGGAAAGTTGGACATCCTGAAAAGAGTCTGTG | 184 |
| CASP8 | NM_033357.2 | AAATGAAAAGCAAACCTCGGGGATACTGTCTGATCATCAACAATCA | 185 |
| CASP8 | NM_033357.2 | AAAAGCACGGGAGAAAGTGCCCAAACTTCACAGCATTAGGGAC | 186 |
| CCNB1 | NM_031966.2 | AGGCCAAGAACAGCTCTTGGGGACATTGGTAACAAAGTCAGTGAA | 187 |
| CCNB1 | NM_031966.2 | GCAAAACCTTCAGCTACTGGAAAAGTCATTGATAAAAAACTACCAAAACC | 188 |
| CCNB1 | NM_031966.2 | TCAAATGAAATTCAGGTTGTTGCAGGAGACCATGTACATGACTGTCTC | 189 |
| CCNB2 | NM_004701.2 | CCAGTTCAACCCACCAAAACAACAAATGTCAACAAACAACTGAAAC | 190 |
| CCNB2 | NM_004701.2 | GTCCTTCTCCCACACCTGAGGATGTCTCCATGAAGGAAGAGAATC | 191 |
| CCNB2 | NM_004701.2 | TGCTTATACCAGTTCCCAAATCCGAGAAATGGAAACTCTAATTTTGAAA | 192 |
| CCND1 | NM_053056.2 | TTCCTCTCCAAAATGCCAGAGGCGGAGGAGAACAAACAGATCAT | 193 |
| CCND1 | NM_053056.2 | CAAGGCCTGAACCTGAGGAGCCCCAACAACTTCCTGTCCTACTA | 194 |
| CCND1 | NM_053056.2 | CGGAGCATTTTGATACCAGAAGGGAAAGCTTCATTCTCCTTGTTGT | 195 |
| CCND2 | NM_001759.2 | AGTTGAAGTGGAACCTGGCAGCTGTCACTCCTCATGACTTCATTG | 196 |
| CCND2 | NM_001759.2 | AGTTTGCCATGTACCCACCGTCGATGATCGCAACTGGAAGTGT | 197 |
| CCND2 | NM_001759.2 | GAGCAGATTGAGGCGGTGCTCCTCAATAGCCTGCAGCAGTAC | 198 |
| CCNE1 | NM_057182.1 | TGGGCAAATAGAGAGGAAGTCTGGAAAATCATGTTAAACAAGGAAAAGA | 199 |
| CCNE1 | NM_057182.1 | TCACAGGGAGACCTTTTACTTGGCACAAGATTTCTTTGACCGGTATAT | 200 |
| CCNE1 | NM_057182.1 | TTGCGTATGTGACAGATGGAGCTTGTTCAGGAGATGAAATTCTCAC | 201 |
| CCNE2 | NM_057749.1 | TATCTGGGGGGATCAGTCCTTGCATTATCATTGAAACACCTCACAA | 202 |
| CCNE2 | NM_057749.1 | ACCACCGAAGAGCACTGAAAAACCACCAGGAAAACACTAAAGAAGAT | 203 |
| CCNE2 | NM_057749.1 | TTGCCCTAGCCAATTCACAAGTTACACTGCCATTCTGATTTTAAAACT | 204 |
| CCNL2 | NM_030937.2 | GAGAGACCGTGTTGCAATGTTCCGTTCAGCTTGGTGTCAATG | 205 |
| CCNL2 | NM_030937.2 | CTCATGGGTAGCCTCTGAGGGTAAGTGACTAAGACTTCTCCTCTGC | 206 |
| CCNL2 | NM_030937.2 | ACCCAAGCGGGCTTTGGTCCCTCTTCCAAGTGGACTCCTTC | 207 |
| CD24 | NM_013230.2 | TCTGTTTTGAAGGCAAAATTGCAAATCTTGAAATTAAGAAGGCAAAA | 208 |
| CD24 | NM_013230.2 | CAACTATGGATCAGAATAGCCACATTTAGAACACTTTTTGTTATCAGTCAA | 209 |
| CD24 | NM_013230.2 | TGAATGAACACTCTTGCTTTATTCCAGAATGCTGTACATCTATTTTGGATT | 210 |
| CD274 | NM_014143.2 | TGTCACGGTTCCCAAGGACCTATATGTGGTAGAGTATGGTAGCAAT | 211 |
| CD274 | NM_014143.2 | TGGCTGCACTAATTGTCTATTGGGAAATGGAGGATAAGAACATTATTCA | 212 |
| CD274 | NM_014143.2 | CACATTTGGAGGAGACGTAATCCAGCATTGGAACTTCTGATCTTCAA | 213 |
| CD44 | NM_001001391.1 | CCCTCCCTCCGTCTTAGGTCACTGTTTTCAACCTCGAATAAAAACT | 214 |
| CD44 | NM_001001391.1 | AACAGTCGAAGAAGGTGTGGGCAGAAGAAAAAGCTAGTGATCAACA | 215 |
| CD44 | NM_001001391.1 | GGAGTCGTCAGAAACTCCAGACCAGTTTATGACAGCTGATGAGACA | 216 |
| CD68 | NM_001251.1 | CAGGGGACAGGGAATGACTGTCCTCACAAAAAATCAGCTACTTTG | 217 |
| CD68 | NM_001251.1 | GCACTGGAACAACCAGCCACAGGACTACCAAGAGCCACAAAAC | 218 |
| CD68 | NM_001251.1 | ACCACCAGCCATGGAAACGTCACAGTTCATCCAACAAGCAATA | 219 |
| CDC2 | NM_001786.2 | CTTCAGGATGTGCTTATGCAGGATTCCAGGTTATATCTCATCTTTGA | 220 |
| CDC2 | NM_001786.2 | GCACTCCCAATAATGAAGTGTGGCCAGAAGTGGAATCTTTACAGGACT | 221 |
| CDC2 | NM_001786.2 | AAACCAGGAAGCCTAGCATCCCATGTCAAAAACTTGGATGAAAAT | 222 |
| CDC20 | NM_001255.1 | CGAACTCCTGGCAAATCCAGTTCCAAGGTTCAGACCACTCCTAG | 223 |
| CDC20 | NM_001255.1 | AGAAAGCCTGGGCTTTGAACCTGAACGGTTTTGATGTAGAGGAAG | 224 |
| CDC20 | NM_001255.1 | CGCCAGAGGGTTATCAGAACAGACTGAAAGTACTCTACAGCCAAAAG | 225 |
| CDC25B | NM_021872.2 | CCAACCGCGTGACCTTGATTGAGTTAATGAACTTCACGCCTC | 226 |
| CDC25B | NM_021872.2 | AGGGGGATGTGCGAGGGTGTGGGATAAATCTTAATTCCTCC | 227 |
| CDC25B | NM_021872.2 | GCGGCTGCTGTTATTTTTCGAATATATAAGGAGGTGGAAGTGGC | 228 |
| CDC42BPA | NM_003607.2 | GGGAAGTGAATTGCTGATGCAAATCGGACTTTATTCATTAATGATG | 229 |
| CDC42BPA | NM_003607.2 | TGGGTGAAATTGAAGACGCTTCAGTTAAGTGAGGTTACTGGTGTGTT | 230 |
| CDC42BPA | NM_003607.2 | AATTCAGCACCAGCATTGCATGACAGTTGTTTGAATAACAAGTGGT | 231 |
| CDC42EP4 | NM_012121.4 | GGCGAGTCCTTGGACGAACAGCCCTCTTCTTCATCTTCCAAAC | 232 |
| CDC42EP4 | NM_012121.4 | CTCGATGAGCAGGCCTTTGGGGATCTGACAGATCTGCCTGTC | 233 |
| CDC42EP4 | NM_012121.4 | GTACGGGCTGAAGCATGCGGAGTCCATCATGTCCTTCCAC | 234 |
| CDC45L | NM_003504.3 | TGTTCCAGTGTGACCACGTGCAATATACGCTGGTTCCAGTTTCT | 235 |
| CDC45L | NM_003504.3 | TGACCTTGAAGTTCCCGCCTATGAAGACATCTTCAGGGATGAAG | 236 |
| CDC45L | NM_003504.3 | GGAGAGCCCCGAGAAGGATGGCTCAGGGACAGATCACTTCAT | 237 |
| CDC6 | NM_001254.3 | AAGCTAAAAACTCCAGTGATGCCAAACTAGAACCAACAAATGTCCAA | 238 |
| CDC6 | NM_001254.3 | AGAGAATGGTCCCCCTCACTCACATACACTTAAGGGACGAAGATTG | 239 |
| CDC6 | NM_001254.3 | GGAAAGGGAGATGGATGTCATCAGGAATTTCTTGAGGGAACACATCT | 240 |
| CDH1 | NM_004360.2 | ACAGTCAAAAGGCCTCTACGGTTTCATAACCCACAGATCCATTTCTT | 241 |
| CDH1 | NM_004360.2 | AAGAGAAACAGGATGGCTGAAGGTGACAGAGCCTCTGGATAGAGAAC | 242 |
| CDH1 | NM_004360.2 | GGGAATGCAGTTGAGGATCCAATGGAGATTTTGATCACGGTAAC | 243 |
| CDH2 | NM_001792.2 | TGGTGAAATCGCATTATGCAAGACTGGATTTCCTGAAGATGTTTAC | 244 |
| CDH2 | NM_001792.2 | CAATATGAGAGCAGTGAGCCTGCAGATTTTAAGGTGGATGAAGATG | 245 |
| CDH2 | NM_001792.2 | TCTTCTGAGCATGCCAAGTTCCTGATATATGCCCAAGACAAAGAGAC | 246 |
| CDH3 | NM_001793.3 | GCTGAGGAGTGCACTGGGTGTTCTTTTCTCCTCTAACCCAGAAC | 247 |
| CDH3 | NM_001793.3 | GGGCAAGAGCCAGCTCTGTTTAGCACTGATAATGATGACTTCACTG | 248 |
| CDH3 | NM_001793.3 | TCCATTGAAGATCTTCCCATCCAAACGTATCTTACGAAGACACAAGA | 249 |
| CDK4 | NM_000075.2 | GGTCTCCCTTGATCTGAGAATGGCTACCTCTCGATATGAGCCAGT | 250 |
| CDK4 | NM_000075.2 | ATCCCGAACTGACCGGGAGATCAAGGTAACCCTGGTGTTTGAG | 251 |
| CDK4 | NM_000075.2 | TTACACTCTGGTACCGAGCTCCCGAAGTTCTTCTGCAGTCCACATAT | 252 |
| CDKN1A | NM_078467.1 | GCAGAGGAAGACCATGTGGACCTGTCACTGTCTTGTACCCTTGTG | 253 |
| CDKN1A | NM_078467.1 | CAAAGGCCCGCTCTACATCTTCTGCCTTAGTCTCAGTTTGTGTGTCT | 254 |
| CDKN1A | NM_078467.1 | CCCCAGCCTCTGGCATTAGAATTATTTAAACAAAAACTAGGCGGT | 255 |
| CDKN1B | NM_004064.2 | GCAGACCCGGGAGAAAGATGTCAAACGTGCGAGTGTCTAAC | 256 |
| CDKN1B | NM_004064.2 | CACGAAGAGTTAACCCGGGACTTGGAGAAGCACTGCAGAGACAT | 257 |
| CDKN1B | NM_004064.2 | AGCGCAAGTGGAATTTCGATTTTCAGAATCACAAACCCCTAGAG | 258 |
| CDKN1C | NM_000076.1 | GAGCGTCTTGTCGCCCGTGGGACCTTCCCAGTACTAGTGC | 259 |
| CDKN1C | NM_000076.1 | CAGCGACTCGGTGCCCGCGTTCTACCGCGAGACGGT | 260 |
| CDKN1C | NM_000076.1 | GATTTCTTCGCCAAGCGCAAGAGATCAGCGCCTGAGAAGT | 261 |
| CDKN2A | NM_000077.3 | AGAGAGGCTCTGAGAAACCTCGGGAAACTTAGATCATCAGTCACCG | 262 |
| CDKN2A | NM_000077.3 | GCAGCCTCCGGAAGCTGTCGACTTCATGACAAGCATTTTGT | 263 |
| CDKN2A | NM_000077.3 | TAGGGAAGCTCAGGGGGGTTACTGGCTTCTCTTGAGTCACACTG | 264 |
| CDKN2B | NM_004936.3 | GAGGGTAATGAAGCTGAGCCCAGGTCTCCTAGGAAGGAGAGAGTG | 265 |
| CDKN2B | NM_004936.3 | CTCGACACTCACCATGAAGCGAAACACAGAGAAGCGGATTTC | 266 |
| CDKN2B | NM_004936.3 | AGGGGTCGTTTGCTTTTCAGGGTTTTCTGAGGGAAAGTGCATAT | 267 |
| CENPA | NM_001809.2 | AGTCGGCGGAGACAAGGTTGGCTAAAGGAGATCCGAAAGCTT | 268 |
| CENPA | NM_001809.2 | TGATACCGGGGACTCTCCAGAGCCATGACTAGATCCAATGGATTC | 269 |
| CENPA | NM_001809.2 | TGCATGACTTTCCTCTGTAACAGAGGTAATATATGAGACAATCAACACCG | 270 |
| CES1 | NM_001025194.1 | TCTCTGGACTTACAGGGAGACCCCAGAGAGAGTCAACCCCTTCTG | 271 |
| CES1 | NM_001025194.1 | CAGGGCTGGACAGCACAGTCCCTCTGAACTGCACAGAGACCT | 272 |
| CES1 | NM_001025194.1 | AGAAAGGTGATGTCAAGCCCTTGGCTGAGCAAATTGCTATCACTG | 273 |
| CGA | NM_000735.2 | AGCGCCATGGATTACTACAGAAAATATGCAGCTATCTTTCTGGTCA | 274 |
| CGA | NM_000735.2 | TCCAAAAGAACGTCACCTCAGAGTCCACTTGCTGTGTAGCTAAATCA | 275 |
| CGA | NM_000735.2 | AAGTGGAGAACCACACGGCGTGCCACTGCAGTACTTGTTATTATCA | 276 |
| CHEK1 | NM_001274.2 | TGGTCACAGGAGAGAAGGCAATATCCAATATTTATTTCTGGAGTACTG | 277 |
| CHEK1 | NM_001274.2 | CGAGTCACTTCAGGTGGTGTGTCAGAGTCTCCCAGTGGATTTTCTA | 278 |
| CHEK1 | NM_001274.2 | CAGTTCTCAGCCAGAACCCCGCACAGGTCTTTCCTTATGGGATA | 279 |
| CHEK2 | NM_145862.2 | CAGTCCTCTCACTCCAGCTCTGGGACACTGAGCTCCTTAGAGACAGT | 280 |
| CHEK2 | NM_145862.2 | TTGCTTTGATGAACCACTGCTGAAAAGAACAGATAAATACCGAACAT | 281 |
| CHEK2 | NM_145862.2 | GGAAAACGCCGTCCTTTGAATAACAATTCTGAAATTGCACTGTCACTA | 282 |
| CHI3L2 | NM_004000.2 | TTGGTTCCAAAGGGTTCCACCCTATGGTGGATTCTTCTACATCAC | 283 |
| CHI3L2 | NM_004000.2 | TCCATAATCCTGTTTCTGAGGAACCATAACTTTGATGGACTGGATGTAA | 284 |
| CHI3L2 | NM_004000.2 | TGTGGAATATGCTGTGGGGTACTGGATACATAAGGGAATGCCATCA | 285 |
| CKS2 | NM_001827.1 | CCCAGAGAACTTTCCAAACAAGTACCTAAAACTCATCTGATGTCTGAAGA | 286 |
| CKS2 | NM_001827.1 | TTCATCCATACCTGTGCATGAGCTGTATTCTTCACAGCAACAGAGC | 287 |
| CKS2 | NM_001827.1 | TGTTTAAGATAAAGTTCTTCCAGTCAGTTTTTCTCTTAAGTGCCTGTTTG | 288 |
| CLK2 | NM_001291.2 | ATCGTTCGTCCGACCGGAGGGTGTATGACCGGCGATACT | 289 |
| CLK2 | NM_001291.2 | TATAGCCGGGATCGGGGAGATGCCTACTATGACACAGACTATCGG | 290 |
| CLK2 | NM_001291.2 | TGCCTTGTACATAATACTATTCCATCCACACAGTTTCCACCCTCACCT | 291 |
| CNKSR1 | NM_006314.1 | GGGGGACTGTGCCAAGACCCCTATTGATGTCCTCTGTGCAG | 292 |
| CNKSR1 | NM_006314.1 | TCTCAGCATGCCAGGAGATCCGAGACTTGTTGGAGGAGCTGAG | 293 |
| CNKSR1 | NM_006314.1 | GCCCCATCTGAAGACGTCTTTGCCTTTGACCTGTCTTCAAACC | 294 |
| COL1BA1 | NM_130444.1 | CCCAGCCTCTTCTTCCGTGACTTCTCACTGCTGTTCCACAT | 295 |
| COL1BA1 | NM_130444.1 | AGGCCATGGTCTTGCTGGGCGTGAAGCTCTCTGGGGTG | 296 |
| COL1BA1 | NM_130444.1 | GCCTTCGTCGGCCAGTGGACACACTTAGCCCTCAGTGTG | 297 |
| COL4A2 | NM_001846.1 | TGTGAAGAAGTTTGATGTGCCGTGTGGAGGAAGAGATTGCAGT | 298 |
| COL4A2 | NM_001846.1 | CCCCAGGGGTACAATGGGCCACCAGGATTACAAGGATTCC | 299 |
| COL4A2 | NM_001846.1 | GACCAAAAGGGCAGAAAGGTGAGCCTTATGCACTGCCTAAAGAG | 300 |
| COL9A2 | NM_001852.3 | CTGGCCAGGCAATCAACGGCAAGGATGGAGATCGAGGGT | 301 |
| COL9A2 | NM_001852.3 | GATCCATCAAGGGGCCTTGAGCATCAGGCCCAGACAGAG | 302 |
| COL9A2 | NM_001852.3 | GGGTGGACATGCACCCATCCCCAGTCCAGGAAACCATCT | 303 |
| CRABP1 | NM_004378.1 | CGATGACGTGGTCTGCACCAGAATTTATGTCCGGGAATGAAG | 304 |
| CRABP1 | NM_004378.1 | TCAGGAAGGGATGCAGGTCCCCGAGGAATATGTCATAGTTCTGA | 305 |
| CRABP1 | NM_004378.1 | CCCTGGCCTTGGTGCCTCTTGTATCCCTAGTGCTGCATAGC | 306 |
| CRYAB | NM_001885.1 | GTTCCACAGGAAATACCGGATCCCAGCTGATGTAGACCCTCTCA | 307 |
| CRYAB | NM_001885.1 | CTGATGGGGTCCTCACTGTGAATGGACCAAGGAAACAGGTCTCT | 308 |
| CRYAB | NM_001885.1 | ACAAGAAAGTTTCCCCACCAGTGAATGAAAGTCTTGTGACTAGTGCT | 309 |
| CSF2RA | NM_006140.3 | CCATGCTTCTCCTGGTGACAAGCCTTCTGCTCTGTGAGTTACCAC | 310 |
| CSF2RA | NM_006140.3 | GGAGGGTACCGCTGCTCAGAATTTCTCCTGTTTCATCTACAATG | 311 |
| CSF2RA | NM_006140.3 | GGAGGGAGATCCGGTGTCCTTATTACATACAAGACTCAGGAACCC | 312 |
| CSF3 | NM_172219.1 | CAGGCTGCTTGAGCCAACTCCATAGCGGCCTTTTCCTCTAC | 313 |
| CSF3 | NM_172219.1 | AGGCCTCTGTGTCCTTCCCTGCATTTCTGAGTTTCATTCTCCTG | 314 |
| CSF3 | NM_172219.1 | GTCCTCCCATCCCCTGGACTGGGAGGTAGATAGGTAAATACCAAG | 315 |
| CSNK2B | NM_001320.5 | CCTGGGATTGGTAGTTCGCTTTCTCTCATTTAGCCAGTTTCTTTCTC | 316 |
| CSNK2B | NM_001320.5 | GGATGAAGACTACATCCAGGACAAATTTAATCTTACTGGACTCAATGAGC | 317 |
| CSNK2B | NM_001320.5 | TGGAAAAGTACCAGCAAGGAGACTTTGGTTACTGTCCTCGTGTGTACT | 318 |
| CST1 | NM_001898.2 | CCTCTGAGGAGACCATGGCCCAGTATCTGAGTACCCTGCTGCT | 319 |
| CST1 | NM_001898.2 | AGCGAGTATAACAAGGCCACCAAAGATGACTACTACAGACGTCCG | 320 |
| CST1 | NM_001898.2 | AAGGTCCCTGGTGAAATCCAGGTGTCAAGAATCCTAGGGATCTGT | 321 |
| CTGF | NM_001901.1 | TGCATCCGTACTCCCAAAATCTCCAAGCCTATCAAGTTTGAGCTTT | 322 |
| CTGF | NM_001901.1 | TGACGGCGAGGTCATGAAGAAGAACATGATGTTCATCAAGACCT | 323 |
| CTGF | NM_001901.1 | ACAACTGTCCCGGAGACAATGACATCTTTGAATCGCTGTACTACAG | 324 |
| CTNNA1 | NM_001903.2 | TGTCCATGCAGGCAACATAAACTTCAAGTGGGATCCTAAAAGTCTAG | 325 |
| CTNNA1 | NM_001903.2 | CTTGTTCAGCTGAAAGTTGTGGAAGATGGTATCTTGAAGTTGAGGAAT | 326 |
| CTNNA1 | NM_001903.2 | GGAGAACTGGCATATGCACTCAATAACTTTGACAAACAAATCATTGT | 327 |
| CTNNB1 | NM_001904.2 | CTCGAGCTCAGAGGGTACGAGCTGCTATGTTCCCTGAGACATTAG | 328 |
| CTNNB1 | NM_001904.2 | CGTTCTCCTCAGATGGTGTCTGCTATTGTACGTACCATGCAGAATAC | 329 |
| CTNNB1 | NM_001904.2 | AACCTTTCCCATCATCGTGAGGGCTTACTGGCCATCTTTAAGTCTG | 330 |
| CTSL2 | NM_001333.2 | AGGACAGCATGTCTGGGGAAATTTTATCTTGAAACTGACCAAACG | 331 |
| CTSL2 | NM_001333.2 | CCAAGTTGAGATTTTAATTCTGTGACATTTTTACAAGGGTAAAATGTTACCA | 332 |
| CTSL2 | NM_001333.2 | CCTCCGCTGTTCCAAAATTTGACCAAAATTTGGATACAAAGTGGTA | 333 |
| CX3CL1 | NM_002996.3 | GTGGCTGCTCCGCTTGGCCACCTTCTGCCATCTGACTGT | 334 |
| CX3CL1 | NM_002996.3 | CAACATCACGTGCAGCAAGATGACATCAAAGATACCTGTAGCTTTG | 335 |
| CX3CL1 | NM_002996.3 | TGCCCTAACTCGAAATGGCGGCACCTTCGAGAAGCAGATC | 336 |
| CXCL1 | NM_001511.1 | TTCTGGCTTAGAACAAAGGGGCTTAATTATTGATGTTTTCATAGAGAAT | 337 |
| CXCL1 | NM_001511.1 | AGGGTATGATTAACTCTACCTGCACACTGTCCTATTATATTCATTCTTTTTG | 338 |
| CXCL1 | NM_001511.1 | CCAATGAGATCATTGTGAAGGCAGGGGAATGTATGTGCACATCT | 339 |
| CXCL10 | NM_001565.1 | TGCCTCTCCCATCACTTCCCTACATGGAGTATATGTCAAGCCATAA | 340 |
| CXCL10 | NM_001565.1 | CCAATGATGGTCACCAAATCAGCTGCTACTACTCCTGTAGGAAGGTT | 341 |
| CXCL10 | NM_001565.1 | GGCCCAAATTCTTTCAGTGGCTACCTACATACAATTCCAAACACAT | 342 |
| CXCL14 | NM_004887.3 | AGGTCTCCTCCCCTCACCACATTGAGAAATCTCAGTGAGTCACC | 343 |
| CXCL14 | NM_004887.3 | ACCCAAGATCCGCTACAGCGACGTGAAGAAGCTGGAAATGAA | 344 |
| CXCL14 | NM_004887.3 | AAAGGCTTCCAGATGGGAGACCCATCTCTCTTGTGCTCCAGACTT | 345 |
| CXCR4 | NM_003467.2 | TGGATTGGTCATCCTGGTCATGGGTTACCAGAAGAAACTGAGAAGC | 346 |
| CXCR4 | NM_003467.2 | TTCCTATGCAAGGCAGTCCATGTCATCTACACAGTCAACCTCTACAG | 347 |
| CXCR4 | NM_003467.2 | TTCATCTTTGCCAACGTCAGTGAGGCAGATGACAGATATATCTGTGAC | 348 |
| CYP3A4 | NM_017460.3 | AGAACTGAATGAGAACCAACAAGTAAATATTTTTGGTCATTGTAATCACTG | 349 |
| CYP3A4 | NM_017460.3 | TGTTTTCAGCCCATCTCCTTTCATATTTCTGGGAGACAGAAAACAT | 350 |
| CYP3A4 | NM_017460.3 | CCTCAACACCCAACTGTCTCGATGCAATGAACACTTAATAAAAAACA | 351 |
| CYR61 | NM_001554.3 | TGGAGCCTCGCATCCTATACAACCCTTTACAAGGCCAGAAATGTATT | 352 |
| CYR61 | NM_001554.3 | CCAGTGCTCAAAGACCTGTGGAACTGGTATCTCCACACGAGTTAC | 353 |
| CYR61 | NM_001554.3 | TGCAGCAAGACCAAGAAATCCCCCGAACCAGTCAGGTTTACTTAC | 354 |
| DAD1 | NM_001344.1 | AGTGTCTGTCATTTCGCGGTTCTTAGAAGAGTACTTGAGCTCCACTC | 355 |
| DAD1 | NM_001344.1 | CTCTTTGCCAGCACCATCCTGCACCTTGTTGTCATGAACTTTGT | 356 |
| DAD1 | NM_001344.1 | TCTGGAGATGGCAGCTTATTGGACACATGGATTTTCTTCAGATTTG | 357 |
| DCBLD2 | NM_080927.3 | CTGGAGCCCAGCAAGGTGATGGATGTGGACACACTGTACTAGG | 358 |
| DCBLD2 | NM_080927.3 | CGCATCAAATTTGGTGACTTTGACATTGAAGATTCTGATTCTTGTCA | 359 |
| DCBLD2 | NM_080927.3 | GGCAATGAAATCACATTGCTGTTCATGAGTGGAATCCATGTTTCT | 360 |
| DCK | NM_000788.1 | TTGCCTCTCTGAATGGCAAGCTCAAAGATGCAGAGAAACCTGTAT | 361 |
| DCK | NM_000788.1 | TAACCAATTTGGCCAAAGCCTTGAATTGGATGGAATCATTTATCTT | 362 |
| DCK | NM_000788.1 | ACGGGGAAGAAATGAAGAGCAAGGCATTCCTCTTGAATATTTAGAGA | 363 |
| DDB1 | NM_001923.2 | GGGAGAGCAAGGACCTGCTGTTTATCTTGACAGCGAAGTACAAT | 364 |
| DDB1 | NM_001923.2 | CCTGGAGGAGCTGCATGTCATTGATGTCAAGTTCCTATATGGTTG | 365 |
| DDB1 | NM_001923.2 | TCATCATTGGACAGGAGTCAATCACCTATCACAATGGTGACAAATACC | 366 |
| DDEF1 | NM_018482.2 | TACAGCATGCATCAGCTCCAGGGCAATAAGGAATATGGCAGTGAA | 367 |
| DDEF1 | NM_018482.2 | CCAAGTTGAACCTTCTCACCTGCCAAGTAAAACCTAATGCCGAAGA | 368 |
| DDEF1 | NM_018482.2 | CTGGCTTTCAACCAACTTGGGTATTTTGACCTGTATAGAATGTTCTG | 369 |
| DEGS1 | NM_144780.1 | TCACCCAGTTGGGTGCATTTTACATAGTAAAAGACTTGGACTGGAAA | 370 |
| DEGS1 | NM_144780.1 | AAGCAATGTGGAATCGCTGGTTTGGAATGTTTGCTAATCTTCCTAT | 371 |
| DEGS1 | NM_144780.1 | CCTGGGTTTGCACCCAATTTCTGGACATTTTATAGCTGAGCATTA | 372 |
| DICER1 | NM_030621.2 | TGCTTGAAGCAGCTCTGGATCATAATACCATCGTCTGTTTAAACAC | 373 |
| DICER1 | NM_030621.2 | ACCAGGTTGCTCAACAAGTGTCAGCTGTCAGAACTCATTCAGATCTC | 374 |
| DICER1 | NM_030621.2 | TCCATCATGTCCTCGCATTTTGGGACTAACTGCTTCCATTTTAAATG | 375 |
| DLG7 | NM_014750.3 | GGTCGTCCAGACCGAGTGTTCTTTACTTTTTGTTTGGTTGAGGTT | 376 |
| DLG7 | NM_014750.3 | GTTCGAGCAATCCGACCTGGTCCAAGACAAACTTCTGAAAAGAAA | 377 |
| DLG7 | NM_014750.3 | CTGTAATGCCCACGTCGTTGAGAATGACTCGATCAGCTACTCAAG | 378 |
| DNAJA1 | NM_001539.2 | CCGGCAGTAGAAGATGGTGAAAGAAACAACTTACTACGATGTTTTGG | 379 |
| DNAJA1 | NM_001539.2 | TGGAAGAGACTGATGAGATGGACCAAGTAGAACTGGTGGACTTTGATC | 380 |
| DNAJA1 | NM_001539.2 | CACTGCTGGCATTTAATGTGCAGTAGTGAATGAGTGAAGGACTGTAA | 381 |
| DUSP4 | NM_001394.5 | GCGGCTATGAGAGGTTTTCCTCCGAGTACCCAGAATTCTGTTCTAAA | 382 |
| DUSP4 | NM_001394.5 | ACGACGAGGCCAGCCAGAATGGCAATAAGGACTCCGAATACAT | 383 |
| DUSP4 | NM_001394.5 | AGGAAGGGAGGGCAAAGGGATGAGAAGACAAGTTTCCCAGAAGT | 384 |
| E2F1 | NM_005225.1 | TGAAGCGGAGGCTGGACCTGGAAACTGACCATCAGTACCTG | 385 |
| E2F1 | NM_005225.1 | ATCCCCGGGGGAGAAGTCACGCTATGAGACCTCACTGAATCTGA | 386 |
| E2F1 | NM_005225.1 | GGAAGACCCCATCCCAGGAGGTCACTTCTGAGGAGGAGAAC | 387 |
| E2F2 | NM_004091.2 | GACTAGAGAGCGAGCCGCAAGGAAGTCGGTGCAGTCGAGAC | 388 |
| E2F2 | NM_004091.2 | CTCAGCAGCCCCCAGCTCTGCCCAGCTACTGCTACCTA | 389 |
| E2F2 | NM_004091.2 | GTATGACACTTCGCTGGGGCTGCTCACCAAGAAGTTCATTTACCT | 390 |
| EEF1A1 | NM_001402.5 | CCTTTGGTCAACACCGAGACATTTAGGTGAAAGACATCTAATTCTGG | 391 |
| EEF1A1 | NM_001402.5 | GGGTTAAAATGACTGGGCAGTGAAAGTTGACTATTTGCCATGACATA | 392 |
| EEF1A1 | NM_001402.5 | CCCTATGAGTGGAAGGGTCCATTTTGAAGTCAGTGGAGTAAGCTTTA | 393 |
| EFNA1 | NM_182685.1 | GGACTACACCATACATGTGCAGCTGAATGACTACGTGGACATCATCT | 394 |
| EFNA1 | NM_182685.1 | CTTCACACCTTTCACCCTGGGCAAGGAGTTCAAAGAAGGACAC | 395 |
| EFNA1 | NM_182685.1 | TCACCTAGCAGCCTCAAAACGGGTCAGTATTAAGGTTTTCAACCG | 396 |
| EFNB2 | NM_004093.2 | CAGAACTGCGATTTCCAAATCGATAGTTTTAGAGCCTATCTATTGGAA | 397 |
| EFNB2 | NM_004093.2 | TACCCCTCTCCTCAACTGTGCCAAACCAGACCAAGATATCAAATTC | 398 |
| EFNB2 | NM_004093.2 | AGAATTCAGCCCTAACCTCTGGGGTCTAGAATTTCAGAAGAACAAAGA | 399 |
| EGF | NM_001963.2 | CTTGGCAGGCTGCATTCAGAAGGTCTCTCAGTTGAAGAAAGAGCT | 400 |
| EGF | NM_001963.2 | TGCTCCAGCAAATCAAGCTGTTTTCTTTTGAAAGTTCAAACTCATC | 401 |
| EGF | NM_001963.2 | GGTGGATGCTGGTGTCTCAGTGATCATGGATTTTCATTATAATGAGA | 402 |
| EGFR | NM_201283.1 | AGTAACAAGCTCACGCAGTTGGGCACTTTTGAAGATCATTTTCTCAG | 403 |
| EGFR | NM_201283.1 | TGAGGTGGTCCTTGGGAATTTGGAAATTACCTATGTGCAGAGGAAT | 404 |
| EGFR | NM_201283.1 | CCAGTGGCGGGACATAGTCAGCAGTGACTTTCTCAGCAACATGT | 405 |
| EGR1 | NM_001964.2 | TCGGATCCTTTCCTCACTCGCCCACCATGGACAACTACCCTA | 406 |
| EGR1 | NM_001964.2 | CCCTCTTCAGCTTGGTCAGTGGCCTAGTGAGCATGACCAACCC | 407 |
| EGR1 | NM_001964.2 | CTTCCAGGTTCCCATGATCCCCGACTACCTGTTTCCACAGCAG | 408 |
| EIF1 | NM_005801.3 | CATGTTTCAGCCAAGCCCAGAGCCCTAAGATTACAAACAACTATGG | 409 |
| EIF1 | NM_005801.3 | ATGGGGTAAGGCAGAAGCACCAGCTGTACTACTAGAAGGGAGCTT | 410 |
| EIF1 | NM_005801.3 | TTGCCACAAAGGTCTGTTCGACCAGACATATCCTAGCTAAGGGATG | 411 |
| EIF2AK2 | NM_002759.1 | GGCTGGTGATCTTTCAGCAGGTTTCTTCATGGAGGAACTTAATACA | 412 |
| EIF2AK2 | NM_002759.1 | GCGGAGCGTGAAGTAAAAGCATTGGCAAAACTTGATCATGTAAATA | 413 |
| EIF2AK2 | NM_002759.1 | CAATGGCTGTTGGGATGGATTTGATTATGATCCTGAGACCAGTGAT | 414 |
| EIF4E | NM_001968.2 | CCAAATAATTTTTACCGCCACGCAAGATTTAGCCCTGAGGTCTTAAT | 415 |
| EIF4E | NM_001968.2 | GCCTAAACGACTCTGCATCGCCGCCTCTTTTTGAAACTAAGAGAA | 416 |
| EIF4E | NM_001968.2 | AGGCAACTTGTCCTGGGACCTCAACTAAGCAAATGAAGCCTTATT | 417 |
| EIF5B | NM_015904.3 | ACATTGATCTTGATGCCTTGGCTGCAGAAATAGAAGGAGCTGGTG | 418 |
| EIF5B | NM_015904.3 | GAAAGGACAGAAGGGCAAAAAACAGAGTTTTGATGATAATGATAGCGA | 419 |
| EIF5B | NM_015904.3 | AATCAGAAAAACAAGCCAGGTCCTAACATAGAAAGTGGGAATGAAGAT | 420 |
| EMP1 | NM_001423.1 | ACCGCAAAATTACACACCCCAGTACACCAGCAGAGGAAACTTATA | 421 |
| EMP1 | NM_001423.1 | AAGATGCCCTCAAGACAGTGCAGGCCTTCATGATTCTCTCTATCAT | 422 |
| EMP1 | NM_001423.1 | TTCTGGGTCATGCACTGAGGTCCACAGACCTACTGCACTGAGTTAA | 423 |
| ENG | NM_000118.1 | CGGGAGCTCCCTGCTGCCGGTCATACCACAGCCTTCAT | 424 |
| ENG | NM_000118.1 | CTCAGGCCCCCAATGCCATCCTTGAAGTCCATGTCCTCTTC | 425 |
| ENG | NM_000118.1 | CCACTGGAGAATACTCCTTCAAGATCTTTCCAGAGAAAAACATTCGT | 426 |
| ENO1 | NM_001428.2 | CTGGAGCCCTGTTGGCAGCTCTAGCTTTGCAGTCGTGTAATT | 427 |
| ENO1 | NM_001428.2 | GCCTCACTTTCCACCAAGTGTCTAGAGTCATGTGAGCCTCGT | 428 |
| ENO1 | NM_001428.2 | AGGCCCCCGACCAACACTTGCAGGGGTCCCTGCTAGTTAG | 429 |
| EP300 | NM_001429.2 | CCGGGCCGAAGAAGAGATTTCCTGAGGATTCTGGTTTTCCTC | 430 |
| EP300 | NM_001429.2 | GCCAGCGATGGCACAGATTTTGGCTCTCTATTTGACTTGGAG | 431 |
| EP300 | NM_001429.2 | GGCATGGTACAAGATGCAGCTTCTAAACATAAACAGCTGTCAGAATT | 432 |
| EP400 | NM_015409.3 | GGCACCCCAGTCTCCCAGTTATCAAATACAGCAGCTGATGAATAG | 433 |
| EP400 | NM_015409.3 | CAGGCGATGCCCTCCACAGGTATGGCAGAGCAGTCTAAGAG | 434 |
| EP400 | NM_015409.3 | AGCAGCCGCAAGTGGTAGAGGCCCAGACACAGCTCCAAATC | 435 |
| EPAS1 | NM_001430.3 | GAAGCCGAAGCTGACCAGCAGATGGACAACTTGTACCTGAAAG | 436 |
| EPAS1 | NM_001430.3 | CCAAGATGGCGACATGATCTTTCTGTCAGAAAACATCAGCAAGTTC | 437 |
| EPAS1 | NM_001430.3 | TTGACTTCACTCATCCCTGCGACCATGAGGAGATTCGTGAGAAC | 438 |
| EPO | NM_000799.2 | CTGGAGAGGTACCTCTTGGAGGCCAAGGAGGCCGAGAATATCAC | 439 |
| EPO | NM_000799.2 | TGAGAATATCACTGTCCCAGACACCAAAGTTAATTTCTATGCCTGGAAG | 440 |
| EPO | NM_000799.2 | CGAGTCTACTCCAATTTCCTCCGGGGAAAGCTGAAGCTGTACACAG | 441 |
| EPOR | NM_000121.2 | AAGAGCTTCTGTGCTTCACCGAGCGGTTGGAGGACTTGGTGT | 442 |
| EPOR | NM_000121.2 | CCGCCTGAGACACCCATGACGTCTCACATCCGCTACGAG | 443 |
| EPOR | NM_000121.2 | AGATCCTGGAGGGCCGCACCGAGTGTGTGCTGAGCAACCT | 444 |
| ERAS | NM_181532.2 | TTGGAAGGTGATCAGCACACAATAGGCATTCAATAAATGTTGAAATA | 445 |
| ERAS | NM_181532.2 | AGGACCACGACCCCACCATCCAGGATTCCTACTGGAAGGAGTT | 446 |
| ERAS | NM_181532.2 | CTTGTCCTCGTGGGCAACAAGTGTGACCTTGTGACCACTG | 447 |
| ERBB2 | NM_004448.2 | GCGGATTGTGCGAGGCACCCAGCTCTTTGAGGACAACTATG | 448 |
| ERBB2 | NM_004448.2 | TTCCACAAGAACAACCAGCTGGCTCTCACACTGATAGACACCAAC | 449 |
| ERBB2 | NM_004448.2 | GTAAGGGCTCCCGCTGCTGGGGAGAGAGTTCTGAGGATTGTC | 450 |
| ERBB3 | NM_001005915.1 | GACCGGCGATGCTGAGAACCAATACCAGACACTGTACAAGCTC | 451 |
| ERBB3 | NM_001005915.1 | GAGAGGTGTGAGGTGGTGATGGGGAACCTTGAGATTGTGCTCAC | 452 |
| ERBB3 | NM_001005915.1 | GTGCGAGGGACCCAGGTCTACGATGGGAAGTTTGCCATCTT | 453 |
| ERBB4 | NM_005235.1 | AGTACCGAGCCTTGCGCAAGTACTATGAAAACTGTGAGGTTGTCAT | 454 |
| ERBB4 | NM_005235.1 | CAGTTCTTGTGTGCGTGCCTGCCCTAGTTCCAAGATGGAAGTAGA | 455 |
| ERBB4 | NM_005235.1 | TGCTTATCCTCAAGCAACAGGGCATCACCTCTCTACAGTTCCAGTC | 456 |
| ERG | NM_004449.3 | CCATACTGGAATTCACCAACTGGGGGTATATACCCCAACACTAGGCTC | 457 |
| ERG | NM_004449.3 | GCCATATGCCTTCTCATCTGGGCACTTACTACTAAAGACCTGGCG | 458 |
| ERG | NM_004449.3 | AGGAGGATGCTAAAAATGTCACGAATATGGACATATCATCTGTGGACT | 459 |
| ERGIC3 | NM_015966.2 | ATGCTGCTACTGTTCCTGTCCGAGCTGCAGTATTACCTCACCAC | 460 |
| ERGIC3 | NM_015956.2 | GACAAGTCGCGGGGAGATAAACTGAAGATCAACATCGATGTACTTT | 461 |
| ERGIC3 | NM_015966.2 | CAGCACCTGTCATTTGGGGAGGACTATCCAGGCATTGTGAAC | 462 |
| ESPL1 | NM_012291.3 | ATCCTGAGGGCTTGCAACCAGCAGCTGACTGCTAAGCTAGCTT | 463 |
| ESPL1 | NM_012291.3 | GCAGAGCTGGCCTGTGATGGCTACTTAGTGTCTACCCCACAGC | 464 |
| ESPL1 | NM_012291.3 | TGGCCATGGTCTAAATGAAGCAGATGCTGATTTCCTAGATGACCT | 465 |
| ESR1 | NM_000125.2 | CCAGCACCTTTGTAATGCATATGAGCTCGGGAGACCAGTACTTAAAG | 466 |
| ESR1 | NM_000125.2 | CTGGACAGCAGCAAGCCCGCCGTGTACAACTACCCCGAG | 467 |
| ESR1 | NM_000125.2 | CCCACGGCCAGCAGGTGCCCTACTACCTGGAGAACGAGC | 468 |
| ETS1 | NM_005238.2 | GGAAAGAAAGGCAGCGGGAATTTGAGATTTTTGGGAAGAAAGTC | 469 |
| ETS1 | NM_005238.2 | CCTTCCCCCTGTTACTAATCCTCATTAAAAAGAAAAACAACAGTAACTGCA | 470 |
| ETS1 | NM_005238.2 | CACCTTGCAGAATGACTACTTTGCTATCAAACAAGAAGTCGTCACC | 471 |
| ETV1 | NM_004956.3 | AAGTTTGGCTTTTCATGGCCTGCCACTGAAAATCAAGAAAGAACC | 472 |
| ETV1 | NM_004956.3 | CCTGCAGTCAAGAACAGCCCTTTAAATTCAGCTATGGAGAAAAGTG | 473 |
| ETV1 | NM_004956.3 | TATGTTTGAAAAGGGCCCCAGGCAGTTTTATGATGACACCTGTGTT | 474 |
| ETV6 | NM_001987.3 | TGAGAACTTCCTGATCTCTCTCGCTGTGAGACATGTCTGAGACTCCT | 475 |
| ETV6 | NM_001987.3 | TGTGCTCTATGAACTCCTTCAGCATATTCTGAAGCAGAGGAAACCT | 476 |
| ETV6 | NM_001987.3 | CCACCAGGAGTCCTACCCTCTGTCAGTGTCTCCCATGGAGAATAAT | 477 |
| EXT1 | NM_000127.2 | CGGAGTCTTGGAGCCGCTGCAGAAGGGAATAAAGAGAGATGC | 478 |
| EXT1 | NM_000127.2 | TCTTTTCCTCCGTCTTGTTGCATGCAAGAAAATTACAGTCCGCTG | 479 |
| EXT1 | NM_000127.2 | GGAAGATGGCGGACTGGAGCTGAAAGTGTTGATTGGGAAACTT | 480 |
| EZH2 | NM_004456.3 | CCCACCTCGGAAATTTCCTTCTGATAAAATTTTTGAAGCCATTTC | 481 |
| EZH2 | NM_004456.3 | CCCCACCATTAATGTGCTGGAATCAAAGGATACAGACAGTGATAGG | 482 |
| EZH2 | NM_004456.3 | GTGGTGCTGAAGCCTCAATGTTTAGAGTCCTCATTGGCACTTACTAT | 483 |
| F2 | NM_000506.2 | CTGTAGCGATGACTCCACGCTCCGAAGGCTCCAGTGTGAATCT | 484 |
| F2 | NM_000506.2 | TGTTCGAGAAGAAGTCGCTGGAGGACAAAACCGAAAGAGAGCT | 485 |
| F2 | NM_000506.2 | CCTGTACCCGCCCTGGGACAAGAACTTCACCGAGAATGAC | 486 |
| F2R | NM_001992.2 | GATCCCCGGTCATTTCTTCTCAGGAACCCCAATGATAAATATGAAC | 487 |
| F2R | NM_001992.2 | GGGAGGATGAGGAGAAAAATGAAAGTGGGTTAACTGAATACAGATTAGTC | 488 |
| F2R | NM_001992.2 | CTGTTTGTGTCTGTGCTCCCCTTTAAGATCAGCTATTACTTTTCCG | 489 |
| F3 | NM_001993.2 | CAGGAGATTGGAAAAGCAAATGCTTTTACACAACAGACACAGAGTGTG | 490 |
| F3 | NM_001993.2 | ACACTTTCCTAAGCCTCCGGGATGTTTTTGGCAAGGACTTAATTT | 491 |
| F3 | NM_001993.2 | AGCAGTGATTCCCTCCCGAACAGTTAACCGGAAGAGTACAGACA | 492 |
| FAS | NM_152874.1 | TCGTCCAAAAGTGTTAATGCCCAAGTGACTGACATCAACTCCAAG | 493 |
| FAS | NM_152874.1 | TCACCACTATTGCTGGAGTCATGACACTAAGTCAAGTTAAAGGCTTTGT | 494 |
| FAS | NM_152874.1 | AGAATGGTGTCAATGAAGCCAAAATAGATGAGATCAAGAATGACAATG | 495 |
| FEN1 | NM_004111.4 | GGAGAAGGGTACGCCAGGGTCGCTGAGAGACTCTGTTCTCCCT | 496 |
| FEN1 | NM_004111.4 | GAACGTCAGGCCACCCGCCGCTAAGCTGAGAAGGGAGAG | 497 |
| FEN1 | NM_004111.4 | ATGGGAATTCAAGGCCTGGCCAAACTAATTGCTGATGTGGC | 498 |
| FGF1 | NM_033137.1 | CCTCCAGGGAATTACAAGAAGCCCAAACTCCTCTACTGTAGCAACG | 499 |
| FGF1 | NM_033137.1 | TGTTTGTTCCTGGAAAGGCTGGAGGAGAACCATTACAACACCTATA | 500 |
| FGF1 | NM_033137.1 | GAAAGCAATCTTGTTTCTCCCCCTGCCAGTCTCTTCTGATTAAAGAG | 501 |
| FGF2 | NM_002006.3 | TCAAGCAGAAGAGAGAGGAGTTGTGTCTATCAAAGGAGTGTGTGCTAAC | 502 |
| FGF2 | NM_002006.3 | ATGTGGCACTGAAACGAACTGGGCAGTATAAACTTGGATCCAAAAC | 503 |
| FGF2 | NM_002006.3 | TCTTCCAATGTCTGCTAAGAGCTGATTTTAATGGCCACATCTAATCTC | 504 |
| FGF4 | NM_002007.1 | CCGATGAGTGCACGTTCAAGGAGATTCTCCTTCCCAACAACTAC | 505 |
| FGF4 | NM_002007.1 | GGCATGTTCATCGCCCTGAGCAAGAATGGGAAGACCAAGAAG | 506 |
| FGF4 | NM_002007.1 | GTCACCCACTTCCTCCCCAGGCTGTGACCCTCCAGAGGAC | 507 |
| FGFR1 | NM_023105.1 | TTGAAAAGGAGGATCGAGCTCACTGTGGAGTATCCATGGAGATGT | 508 |
| FGFR1 | NM_023105.1 | AACTGCAGAACTGGGATGTGGAGCTGGAAGTGCCTCCTCTTCT | 509 |
| FGFR1 | NM_023105.1 | GCTCCATATTGGACATCCCCAGAAAAGATGGAAAAGAAATTGCAT | 510 |
| FGFR2 | NM_022972.1 | TCCATGCCCGTAGAGGAAGTGTNCAGATGGGATTAACGTCCAC | 511 |
| FGFR2 | NM_022972.1 | GGAAGAGGACCGGGGATTGGTACCGTAACCATGGTCAGCT | 512 |
| FGFR2 | NM_022972.1 | AATGCCAACCATGCGGTGGCTGAAAAACGGGAAGGAGTTTA | 513 |
| FGFR4 | NM_022963.2 | GCTCCCAGCCTGGAGCAGCAAGAGCAGGAGCTGACAGTAG | 514 |
| FGFR4 | NM_022963.2 | GACACACCCCCAGCGCATGGAGAAGAAACTGCATGCAGTAC | 515 |
| FGFR4 | NM_022963.2 | CGCCGGCCTCGTGAGTCTAGATCTACCTCTCGACCCACTATG | 516 |
| FHIT | NM_002012.1 | CATGTCGTTCAGATTTGGCCAACATCTCATCAAGCCCTCTGTAGT | 517 |
| FHIT | NM_002012.1 | CATGACAAGGAGGACTTTCCTGCCTCTTGGAGATCAGAGGAGGA | 518 |
| FHIT | NM_002012.1 | CCTCGGTCACTCCAACTCCCTTAAAATACCTAGACCTAAACGGCT | 519 |
| FIBP | NM_198897.1 | TTGCTAACAACCGCTTTGAGACAGGGAAGAAAAAACTGCAGTATCTG | 520 |
| FIBP | NM_198897.1 | CGCCAAGCTGACCCACAATAAAGATGTCAGAGACCTGTTTG | 521 |
| FIBP | NM_198897.1 | ACTGGCCACTCAGCGACGTGCGGTTCTTCCTGAATCAGTATTC | 522 |
| FKBP1A | NM_054014.1 | GAAATTTGATTCCTCCCGGGACAGAAACAAGCCCTTTAAGTTTATG | 523 |
| FK6P1A | NM_054014.1 | GTGGGTCAGAGAGCCAAACTGACTATATCTCCAGATTATGCCTATGG | 524 |
| FK8P1A | NM_054014.1 | CCACTCTCGTCTTCGATGTGGAGCTTCTAAAACTGGAATGACAGG | 525 |
| FKBP2 | NM_057092.1 | ATCGGGGTCAAGAAGCGGGTGGACCACTGTCCCATCAAATC | 526 |
| FKBP2 | NM_057092.1 | TGGAGCTGCTCAAAATAGAGCGACGAACTGAGCTGTAACCAGACTG | 527 |
| FKBP2 | NM_057092.1 | AGTAAGCCTGTGTGTTTGTGGGCCCTGAGAGACTCAGAGACCTCAG | 528 |
| FKBP4 | NM_002014.2 | CTTCCTCCATTGCACATGAACATATGTCCATCCATATATATTCATCAG | 529 |
| FKBP4 | NM_002014.2 | TTCTAAGGGTAGAAGAGGCAAGTGGTAGGGATGAGGTCTGATAAGAAC | 530 |
| FKBP4 | NM_002014.2 | TTGTGTCCCAAAATCCCCTCAGCCTCTTCTCTGCACGTTGCT | 531 |
| FLII | NM_002018.2 | AGTCTGAAGAATTCCGGAGTCCCCGATGACATCTTCAAGCTAGATGA | 532 |
| FLII | NM_002018.2 | CCAACCAGCTCTTCATCAACCTCACTGACCTACTATACCTGGACCTC | 533 |
| FLII | NM_002018.2 | AGCCATTTGCAAGCTGAGCAAGCTGAAGAAGCTGTACCTGAATT | 534 |
| FLNB | NM_001457.1 | ACAAGTGACCCCTGACAGCGACAAGAACAAGACATACTCTGTGGA | 535 |
| FLNB | NM_001457.1 | CAGGACAGCACATCTCCAAGAGCCCATTTGAAGTGAGTGTTGACAA | 536 |
| FLNB | NM_001457.1 | CATTGAAGGCCCCTCTCAGGCAAAGATTGAGTACAACGACCAG | 537 |
| FLT1 | NM_002019.2 | CCTGTGGAAGAAATGGCAAACAATTCTGCAGTACTTTAACCTTGAA | 538 |
| FLT1 | NM_002019.2 | GATGGAAAACGCATAATCTGGGACAGTAGAAAGGGCTTCATCATATC | 539 |
| FLT1 | NM_002019.2 | GGGCTTCTGACCTGTGAAGCAACAGTCAATGGGCATTTGTATAAG | 540 |
| FLT3 | NM_004119.1 | TGACAGAAACCCAAGCTGGAGAATACCTACTTTTTATTCAGAGTGAAGC | 541 |
| FLT3 | NM_004119.1 | AAGCACTCGAGGAGGGCAACTACTTTGAGATGAGTACCTATTCAACA | 542 |
| FLT3 | NM_004119.1 | TCATCAGTGGCAAGAAACGACACCGGATACTACACTTGTTCCTCTT | 543 |
| FLT4 | NM_002020.1 | CAACGACACAGGCAGCTACGTCTGCTACTACAAGTACATCAAGGCA | 544 |
| FLT4 | NM_002020.1 | CATTCATCAACAAGCCTGACACGCTCTTGGTCAACAGGAAGGAC | 545 |
| FLT4 | NM_002020.1 | GAGCGACGCTCCCAACAGACCCACACAGAACTCTCCAGCATC | 546 |
| FN1 | NM_212474.1 | CACTGGGAACACTTACCGAGTGGGTGACACTTATGAGCGTCCTAA | 547 |
| FN1 | NM_212474.1 | TGCCATGAAGGGGGTCAGTCCTACAAGATTGGTGACACCTG | 548 |
| FN1 | NM_212474.1 | ATGCAACGATCAGGACACAAGGACATCCTATAGAATTGGAGACACC | 549 |
| FOXA1 | NM_004496.2 | GATGGTTGTATTGGGCAGGGTGGCTCCAGGATGTTAGGAACTGT | 550 |
| FOXA1 | NM_004496.2 | ACATGAACTCAGGCCTGGGCTCCATGAACTCCATGAACACCTAC | 551 |
| FOXA1 | NM_004496.2 | CAACATGACCCCGGCGTCCTTCAACATGTCCTATGCCAAC | 552 |
| FOXC1 | NM_001453.1 | GCCGTGGACAACCCCCTGCCCGACTACTCTCTGCCTCC | 553 |
| FOXC1 | NM_001453.1 | AGAACTTCCACTCGGTGCGGGAGATGTTCGAGTCACAGAGGAT | 554 |
| FOXC1 | NM_001453.1 | GCGCTTCAAGAAGAAGGACGCGGTGAAGGACAAGGAGGAGAAG | 555 |
| FOXM1 | NM_202002.1 | GTAGTGGCCATCCCCAACAATGCTAATATTCACAGCATCATCACAG | 556 |
| FOXM1 | NM_202002.1 | TGGGACCAAAACCTGCAGCTAGGGATGTGAATCTTCCTAGACCAC | 557 |
| FOXM1 | NM_202002.1 | AGATGGTGAGGCAGCAGGCTGCACTATCAACAATAGCCTATCCA | 558 |
| FRAG1 | NM_014489.1 | CTCCGAGGACTTCACCATCCACGAAAATGCTTTCATTGTGTTCAT | 559 |
| FRAG1 | NM_014489.1 | GCACACAGTAAGTCAGGAGGATCGCAAGTCCTACAGCTGGAAACAG | 560 |
| FRAG1 | NM_014489.1 | TGGAGTGTACACCATCTTTGCCATCCTGGAGTACACTGTTGTCTTAA | 561 |
| FRAP1 | NM_004958.2 | GTGGGAATGCCACCCGAATTGGCAGATTTGCCAACTATCTTC | 562 |
| FRAP1 | NM_004958.2 | TCTTCCAGCAAGTGCAACCCTTCTTTGACAACATTTTTGTGG | 563 |
| FRAP1 | NM_004958.2 | ACTGCAAAGATCTCATGGGCTTCGGAACAAAACCTCGTCACATTAC | 564 |
| FUT8 | NM_178157.1 | GGACGGGCCTATATCCCTCCTACAAAGTTCGAGAGAAGATAGAAACG | 565 |
| FUT8 | NM_178157.1 | CCCCACATATCCTGAGGCTGAGAAATAAAGCTCAGATGGAAGAGAT | 566 |
| FUT8 | NM_178157.1 | TAACAAGGGCTGCAATGCCCTCATACCCATGCACAGTACAATAAT | 567 |
| FZD7 | NM_003507.1 | GAAAAGAACTGCTGGGTGGGGGCCTGTTTCTGTAACTTTCTCCC | 568 |
| FZD7 | NM_003507.1 | TTGGATGAAAAGATTTCAGGCAAAGACTTGCAGGAAGATGATGATAA | 569 |
| FZD7 | NM_003507.1 | AAAGGTACGGGCCAGCTTGTGCCTAATAGAAGGTTGAGACCAGC | 570 |
| GAB2 | NM_080491.1 | GCCACCCCACTCTCAGCCTACCAGATCCCTAGGACATTCACTCT | 571 |
| GAB2 | NM_080491.1 | ATTGTGGGCCGATCGGACAGCACCAATTCTGAAGACAACTATGT | 572 |
| GAB2 | NM_080491.1 | GGCCATGGAACGAGCAGGTGATAATTCCCAGAGCGTCTACAT | 573 |
| GADD45A | NM_001924.2 | TCATCTCAATGGAAGGATCCTGCCTTAAGTCAACTTATTTGTTTTTGC | 574 |
| GADD45A | NM_001924.2 | GAAACTGATGCCAAGGGGCTGAGTGAGTTCAACTACATGTTCTGG | 575 |
| GADD45A | NM_001924.2 | TGAAGAAGGAAGCTGTGTTGAAACAGAAAAATAAGTCAAAAGGAACAAAA | 576 |
| GAPDH | NM_002046.3 | CTCTGCTCCTCCTGTTCGACAGTCAGCCGCATCTTCTTTT | 577 |
| GAPDH | NM_002046.3 | AGCCCCAGCAAGAGCACAAGAGGAAGAGAGAGACCCTCACT | 578 |
| GAPDH | NM_002046.3 | CTCCTCTGACTTCAACAGCGACACCCACTCCTCCACCTTTGAC | 579 |
| GAS2 | NM_005256.2 | TGGCTAGCCAGCAGACATGAAGCTAATTTGCTACCAATGAAAGAAG | 580 |
| GAS2 | NM_005256.2 | CTGGTGCCGAGATTTAGGGGTGGATGAAACGTGTCTATTTGAATC | 581 |
| GAS2 | NM_005256.2 | TATGGTGTGGAGCCTCCTGGTTTGATAAAGCTGGAAAAAGAGATTG | 582 |
| GATA3 | NM_001002295.1 | CAGAGTCGTCGCCCCTTTTTACAACCTGGTCCCGTTTTATTCT | 583 |
| GATA3 | NM_001002295.1 | GCCGGAGGAGGTGGATGTGCTTTTTAACATCGACGGTCAAG | 584 |
| GATA3 | NM_001002295.1 | GCCCGGCAGGACGAGAAAGAGTGCCTCAAGTACCAGGT | 585 |
| GBE1 | NM_000158.1 | GGTTGGAATCCATTTTCGTACCCATACAAAAAACTGGATTATGGAAA | 586 |
| GBE1 | NM_000158.1 | AGACCAAAGAAGCCACGGAGTCTAAGAATTTATGAATCTCATGTGG | 587 |
| GBE1 | NM_000158.1 | GTTGATGGCAATCATGGAGCATGCTTACTATGCCAGCTTTGGTTA | 588 |
| GBX2 | NM_001485.2 | GTCCGAGGGCAAGGGAAAGACGAGTCAAAGGTGGAAGACGAC | 589 |
| GBX2 | NM_001485.2 | TCTCGCTGGAGAGCGATGTGGACTACAGCTCGGATGACAATC | 590 |
| GBX2 | NM_001485.2 | AAAGTCACAGCCCAGCTGTGGCCATCCCAAGCAAATTGAGAA | 591 |
| GGH | NM_003878.1 | TCCCTGGAGGAAGTGTTGACCTCAGACGCTCAGATTATGCTAAAGT | 592 |
| GGH | NM_003878.1 | CAATTGCACAGCAGAATGTTCCAGAATTTTCCTACTGAGTTGTTGCT | 593 |
| GGH | NM_003878.1 | TGTCCAGTGGCATCCAGAGAAAGCACCTTATGAGTGGAAGAATTT | 594 |
| GMPS | NM_003875.2 | CTGGATGCTGGTGCTCAGTACGGGAAAGTCATAGACCGAAGAGTG | 595 |
| GMPS | NM_003875.2 | AATTTTCCCCTTGGAAACACCAGCATTTGCTATAAAGGAACAAGGAT | 596 |
| GMPS | NM_003875.2 | GCAAGCCTGTTCTTGGAATTTGCTATGGTATGCAGATGATGAATAAG | 597 |
| GNAZ | NM_002073.2 | CACCGTCGCCGAGGACAGGGAATGACTACGGCAAATCAG | 598 |
| GNAZ | NM_002073.2 | GCCAGACCATGGGATGTCGGCAAAGCTCAGAGGAAAAAGAAG | 599 |
| GNAZ | NM_002073.2 | AGGCCTGCAAGGAGTACAAGCCCCTCATCATCTACAATGCCATC | 600 |
| GOLPH2 | NM_016548.2 | GGCCTGCATCATCGTCTTGGGCTTCAACTACTGGATTGCGAG | 601 |
| GOLPH2 | NM_016548.2 | ATTACGGCAGGCTGCAGCAGGATGTCCTCCAGTTTCAGAAGA | 602 |
| GOLPH2 | NM_016548.2 | CAATCAGATGAAGGAGGTGAAGGAACAGTGTGAGGAGCGAATAGAAG | 603 |
| GPR56 | NM_201524.1 | ATCCTTCCCTGACCCCAGGGGCCTCTACCACTTCTGCCTCTAC | 604 |
| GPR56 | NM_201524.1 | TATGGCAAGCGTGACTTCTTGCTGAGTGACAAAGCCTCTAGCCT | 605 |
| GPR56 | NM_201524.1 | CATGGAGTACTCGGTGCTGCTGCCTCGAACACTCTTCCAGAGG | 606 |
| GPX4 | NM_002085.2 | CTCCCAGTGAGGCAAGACCGAAGTAAACTACACTCAGCTCGTCG | 607 |
| GPX4 | NM_002085.2 | TAACCAGTTCGGGAAGCAGGAGCCAGGGAGTAACGAAGAGATCA | 608 |
| GPX4 | NM_002085.2 | CGCGGGCTACAACGTCAAATTCGATATGTTCAGCAAGATCTGC | 609 |
| GRB7 | NM_005310.2 | CGGAGATAGCCGCTTCGTCTTCCGGAAAAACTTCGCCAAGTAC | 610 |
| GRB7 | NM_005310.2 | TCAAGAGCTCCCCACACTCCCTGTTCCCAGAAAAAATGGTCTC | 611 |
| GRB7 | NM_005310.2 | CGCTTTTTCTGCTTCTTGCGCCGATCTGGCCTCTATTACTCCAC | 612 |
| GSN | NM_000177.3 | CTGAAGACAGTGCAGCTGAGGAACGGAAATCTGCAGTATGACCTC | 613 |
| GSN | NM_000177.3 | GTCCAGGGCTTCGAGTCGGCCACCTTCCTAGGCTACTTCAAG | 614 |
| GSN | NM_000177.3 | AGGGCGGTGAGACCCCACTGTTCAAGCAGTTCTTCAAGAAC | 615 |
| GSPT1 | NM_002094.1 | TTTTCCCAAGATTCCTGTCCCTAGCCCTCACTTCAAACTCTGCTTC | 616 |
| GSPT1 | NM_002094.1 | TGCAGAAGCCTACTTCACACCGCCTTCTCTTATTTTCTGCCCATT | 617 |
| GSPT1 | NM_002094.1 | CATGAAATGATGGAGGAGGAAGAGGAAATCCCAAAACCTAAGTCTGT | 618 |
| GSR | NM_000637.2 | GCTGTCCACTCTGAATTCATGCATGATCATGCTGATTATGGCTTT | 619 |
| GSR | NM_000637.2 | TGTGAGGGTAAATTCAATTGGCGTGTTATTAAGGAAAAGCGGGAT | 620 |
| GSR | NM_000637.2 | AGATCCCCGGTGCCAGCTTAGGAATAACCAGCGATGGATTTTT | 621 |
| GSTM3 | NM_000849.3 | GCTCCTGGAGTTCACGGATACCTCTTATGAGGAGAAACGGTACAC | 622 |
| GSTM3 | NM_000849.3 | TGAAGAAGAAAAGATTCGAGTGGACATCATAGAGAACCAAGTAATGGATTT | 623 |
| GSTM3 | NM_000849.3 | TCACCTTTGTGGATTTTCTCACCTATGATATCTTGGATCAGAACCGTAT | 624 |
| GSTP1 | NM_000852.2 | AGTTCCAGGACGGAGACCTCACCCTGTACCAGTCCAATACCATC | 625 |
| GSTP1 | NM_000852.2 | AAGGACCAGCAGGAGGCAGCCCTGGTGGACATGGTGAATG | 626 |
| GSTP1 | NM_000852.2 | TGACTACAACCTGCTGGACTTGCTGCTGATCCATGAGGTCCTAG | 627 |
| GTF2H3 | NM_001516.3 | GCAGAAGACAGTGCGTTGCAGTATATGAACTTCATGAATGTCATCTT | 628 |
| GTF2H3 | NM_001516.3 | GGGTGTTTCTTCCCGATCAAGATCAGAGATCTCAGTTAATCCTCCC | 629 |
| GTF2H3 | NM_001516.3 | GGTCCTCATTGTGAAATGCATGCCATACGAAATTTGAACGTAGCTTT | 630 |
| GTSE1 | NM_016426.4 | GGACGTGAACATGGATGACCCTAAGAAGGAAGACATTCTTCTTTTG | 631 |
| GTSE1 | NM_016426.4 | TGATGAAGTCTTCTTCGGACCCTTTGGACATAAAGAAAGATGTATTGCT | 632 |
| GTSE1 | NM_016426.4 | CGTGGAGGTGTACAAAGAAGCTCACTTACTGGCTTTACACATTGAGAG | 633 |
| GUSB | NM_000181.1 | AAAAAGGGGATCTTCACTCGGCAGAGACAACCAAAAAGTGCAG | 634 |
| GUSB | NM_000181.1 | GATTGCCAATGAAACCAGGTATCCCCACTCAGTAGCCAAGTCACAAT | 635 |
| GUSB | NM_000181.1 | TGGTCATCTATTCTAGCAGGGAACACTAAAGGTGGAAATAAAAGATTTTC | 636 |
| H19 | NR_002196.1 | GGGAGCCAGGCATTCATCCCGGTCACTTTTGGTTACAGGAC | 637 |
| H19 | NR_002196.1 | CTCGCTTCCCCAGCCTTCTGAAAGAAGGAGGTTTAGGGGAT | 638 |
| H19 | NR_002196.1 | CAGGATGGGGGCAGGAGAGTTAGCAAAGGTGACATCTTCTC | 639 |
| H2AFZ | NM_002106.3 | CAATCCGAGTTCCCGGATGAGGGAACATTCTGCAGTATAAAGGG | 640 |
| H2AFZ | NM_002106.3 | AGTTTGAATCGCGGTGCGACGAAGGAGTAGGTGGTGGGATCT | 641 |
| H2AFZ | NM_002106.3 | GCCTGGATTCCTTGTTATCTCAGGACTCTAAATACTCTAACAGCTGTCCA | 642 |
| HCFC1 | NM_005334.1 | TGTTTGGTGGGATGGTGGAGTATGGGAAATACAGCAATGACCTCTA | 643 |
| HCFC1 | NM_005334.1 | ACCCCGGGAGTCACATACTGCCGTGGTCTACACCGAAAAAGAC | 644 |
| HCFC1 | NM_005334.1 | ATGGCCTGGGAGACCATCCTGATGGATACACTGGAGGACAAC | 645 |
| HDAC1 | NM_004964.2 | TGTCCAGTATTCGATGGCCTGTTTGAGTTCTGTCAGTTGTCTACTGG | 646 |
| HDAC1 | NM_004964.2 | GACCGGGTCATGACTGTGTCCTTTCATAAGTATGGAGAGTACTTCCC | 647 |
| HDAC1 | NM_004964.2 | AGATGTTCCAGCCTAGTGCGGTGGTCTTACAGTGTGGCTCAGACT | 648 |
| HDAC2 | NM_001527.1 | CATGAAGCCTCATAGAATCCGCATGACCCATAACTTGCTGTTAAATT | 649 |
| HDAC2 | NM_001527.1 | GCTGGAGCTGTGAAGTTAAACCGACAACAGACTGATATGGCTGTTA | 650 |
| HDAC2 | NM_001527.1 | TATTGGTGCTGGAAAAGGCAAATACTATGCTGTCAATTTTCCAAT | 651 |
| HDGFRP3 | NM_016073.2 | AGAAATCCTCTAAACAGTCCCGGAAATCTCCAGGAGATGAAGATGAC | 652 |
| HDGFRP3 | NM_016073.2 | CTTGCAGAAAACCAGTGAAGGGACCTAACTACCATAATGAATGCTGC | 653 |
| HDGFRP3 | NM_016073.2 | TGCGCAGACTTATACATGTCTAGGATCCTTTTATCAAGGCAGTTATGAT | 654 |
| HIF1A | NM_181054.1 | TCTCGAGATGCAGCCAGATCTCGGCGAAGTAAAGAATCTGAAGTTT | 655 |
| HIF1A | NM_181054.1 | TGAAGATGACATGAAAGCACAGATGAATTGCTTTTATTTGAAAGCCTT | 656 |
| HIF1A | NM_181054.1 | GAACAAAACACACAGCGAAGCTTTTTTCTCAGAATGAAGTGTACCCTA | 657 |
| HIG2 | NM_013332.1 | CCCATTCCTAGCAGACAAGCTGAGCACCGTTGTAACCAGAGAACTATT | 658 |
| HIG2 | NM_013332.1 | GCACAGGTGTGAGTGGATTGCTTATGGCTATGAGATAGGTTGATCT | 659 |
| HIG2 | NM_013332.1 | TGGTGTATGCTGTGCTTTCCTCAGCAGTATGGCTCTGACATCTCTTA | 660 |
| HMGA1 | NM_145903.1 | CCTTGGCCTCCAAGCAGGAAAAGGACGGCACTGAGAAG | 661 |
| HMGA1 | NM_145903.1 | AGGAGCCCAGCGAAGTGCCAACACCTAAGAGACCTCGGG | 662 |
| HMGA1 | NM_145903.1 | GCGTCCCCACTCCCTTGGTGGTGGGGACATTGCTCTCT | 663 |
| HOXA5 | NM_019102.2 | GGCCTTCCGTCCCTGAGTATCTGAGCGTTTAAAGTACTGAGCAGTA | 664 |
| HOXA5 | NM_019102.2 | CTGTGAAGAAGCCCTGTTCTCGTTGCCCTAATTCATCTTTTAATCAT | 665 |
| HOXA5 | NM_019102.2 | GCGTGGAAGTGTTCCTGTCTCAATAGCTCCAAGCTGTTAAAGATATT | 666 |
| HPSE | NM_006665.2 | TTTTCGATCCCAAGAAGGAATCAACCTTTGAAGAGAGAAGTTACTGG | 667 |
| HPSE | NM_006665.2 | GACTTGATCTTTGGCCTAAATGCGTTATTAAGAACAGCAGATTTGCAG | 668 |
| HPSE | NM_006665.2 | TGAATGGACGGACTGCTACCAGGGAAGATTTTCTAAACCCTGATGT | 669 |
| HRAS | NM_176795.2 | GGTCATTGATGGGGAGACGTGCCTGTTGGACATCCTGGATAC | 670 |
| HRAS | NM_176795.2 | GAGGGCTTCCTGTGTGTGTTTGCCATCAACAACACCAAGTCTTTT | 671 |
| HRAS | NM_176795.2 | GCTGACCATCCAGCTGATCCAGAACCATTTTGTGGACGAATAC | 672 |
| HRASLS | NM_020386.2 | ATTCCTGCGTCCTTTACAAGCGCCAAGTCTGTATTCAGCAGTAAGG | 673 |
| HRASLS | NM_020386.2 | TGTTGTGGGAAATGACACATACAGAATAAACAATAAATACGATGAAACGT | 674 |
| HRASLS | NM_020386.2 | GCGGTCAGAGTTTGTAATTGGACAGGAGGTGGCCTATAACTTACTTGT | 675 |
| HSD17B4 | NM_000414.1 | GGGAGCGGACTCTTGGAGCTATTGTAAGACAAAAGAATCACCCAAT | 676 |
| HSD17B4 | NM_000414.1 | TATTGGCCAGAAACTCCCTCCATTTTCTTATGCTTATACGGAACTG | 677 |
| HSD17B4 | NM_000414.1 | TGTTTGCCCACCTTCGGAGTTATCATAGGTCAGAAATCTATGATGG | 678 |
| HSPA5 | NM_005347.2 | GCACAGACAGATTGACCTATTGGGGTGTTTCGCGAGTGTGAGAG | 679 |
| HSPA5 | NM_005347.2 | AACGTCTGATTGGCGATGCCGCCAAGAACCAGCTCACCTC | 680 |
| HSPA5 | NM_005347.2 | ACCCATGCAGTTGTTACTGTACCAGCCTATTTTAATGATGCCCAAC | 681 |
| ID1 | NM_002165.2 | ATTCTGTTTCAGCCAGTCGCCAAGAATCATGAAAGTCGCCAGT | 682 |
| ID1 | NM_002165.2 | AGGAGAGGGCGCTCCTCTCTGCACACCTACTAGTCACCAGAGAC | 683 |
| ID1 | NM_002165.2 | TTTTAAAAAATGGTCACGTTTGGTGCTTCTCAGATTTCTGAGGAA | 684 |
| IFNG | NM_000619.2 | GGCATTTTGAAGAATTGGAAAGAGGAGAGTGACAGAAAAATAATGCAGA | 685 |
| IFNG | NM_000619.2 | GCAACAAAAGAAACGAGATGACTTCGAAAAGCTGACTAATTATTCGGTAA | 686 |
| IFNG | NM_000619.2 | TGAATGTCCAACGCAAAGCAATACATGAACTCATCCAAGTGATG | 687 |
| IGF1 | NM_000618.2 | TCAGAGCAGATTAGAGCCTGCGCAATGGAATAAAGTCCTCAAAATT | 688 |
| IGF1 | NM_000618.2 | ACGCAAGTAGAGGGAGTGCAGGAAACAAGAACTACAGGATGTAGGAA | 689 |
| IGF1 | NM_000618.2 | CACCGCAGGATCCTTTGCTCTGCACGAGTTACCTGTTAAACTTTG | 690 |
| IGF1R | NM_000875.2 | TTGAGAAAGGGAATTTCATCCCAAATAAAAGGAATGAAGTCTGGCT | 691 |
| IGF1R | NM_000875.2 | GCCAGGCATCGACATCCGCAACGACTATCAGCAGCTGAAG | 692 |
| IGF1R | NM_000875.2 | CTGTGGACTGGTCCCTGATCCTGGATGCGGTGTCCAATAACTAC | 693 |
| IGFBP2 | NM_000597.2 | GGAGCAGGTTGCAGACAATGGCGATGACCACTCAGAAGGAGG | 694 |
| IGFBP2 | NM_000597.2 | ATCCCCAACTGTGACAAGCATGGCCTGTACAACCTCAAACAGTG | 695 |
| IGFBP2 | NM_000597.2 | GGGACCCCGAGTGTCATCTCTTCTACAATGAGCAGCAGGAG | 696 |
| IGFBP3 | NM_001013398.1 | ACAGCCAGCGCTACAAAGTTGACTACGAGTCTCAGAGCACAGATAC | 697 |
| IGFBP3 | NM_001013398.1 | CGGGAGACAGAATATGGTCCCTGCCGTAGAGAAATGGAAGACACAC | 698 |
| IGFBP3 | NM_001013398.1 | GCTGAGTCCCAGGGGTGTACACATTCCCAACTGTGACAAGAAG | 699 |
| IGFBP4 | NM_001552.2 | CATCCAGGAAAGCCTGCAGCCCTCTGACAAGGACGAGGGT | 700 |
| IGFBP4 | NM_001552.2 | CATGACCGCAGGTGCCTGCAGAAGCACTTCGCCAAAATT | 701 |
| IGFBP4 | NM_001552.2 | ACGGCAACTTCCACCCCAAGCAGTGTCACCCAGCTCTGGAT | 702 |
| IGFBP5 | NM_000599.2 | TCTCTTTGGAAACTTCTGCAGGGGAAAAGAGCTAGGAAAGAGCTG | 703 |
| IGFBP5 | NM_000599.2 | GCGGGGTGTATTTTAGATTTTAAGCAAAAATTTTAAAGATAAATCCATTTTTC | 704 |
| IGFBP5 | NM_000599.2 | CTGCTTCCCCCAACCTGTTGCAAGGCTTTAATTCTTGCAACT | 705 |
| IGFBP7 | NM_001553.1 | CCTTCCATAGTGACGCCCCCCAAGGACATCTGGAATGTCACT | 706 |
| IGFBP7 | NM_001553.1 | TCTCCTCTAAGTAAGGAAGATGCTGGAGAATATGAGTGCCATGCATC | 707 |
| IGFBP7 | NM_001553.1 | TGAAGGTGCCGAGCTATAAACCTCCAGAATATTATTAGTCTGCATGGT | 708 |
| IL10 | NM_000572.2 | GTTACCTGGGTTGCCAAGCCTTGTCTGAGATGATCCAGTTTTACC | 709 |
| IL10 | NM_000572.2 | AAGGCATCTACAAAGCCATGAGTGAGTTTGACATCTTCATCAACTACAT | 710 |
| IL10 | NM_000572.2 | CTCTGGGATAGCTGACCCAGCCCCTTGAGAAACCTTATTGTACCT | 711 |
| IL11 | NM_000641.2 | ACTGGGGTCCCGGATTCTTGGGTCTCCAAGAAGTCTGTCCAC | 712 |
| IL11 | NM_000641.2 | GGAAAGGGAAGCCTGGGTTTTTGTACAAAAATGTGAGAAACCTTTG | 713 |
| IL11 | NM_000641.2 | TGGAAGGTTCCACAAGTCACCCTGTGATCAACAGTACCCGTATG | 714 |
| IL12A | NM_000882.2 | TGTCACCGAGAAGCTGATGTAGAGAGAGACACAGAAGGAGACAGAAAG | 715 |
| IL12A | NM_000882.2 | CTGTGCCACAAAAATCCTCCCTTGAAGAACCGGATTTTTATAAAAC | 716 |
| IL12A | NM_000882.2 | TTCATGCTTTCAAATTCGGGCAGTGACTATTGATAGAGTGATGAGC | 717 |
| IL18 | NM_001562.2 | TGCACCCCGGACCATATTTATTATAAGTATGTATAAAGATAGCCAGCC | 718 |
| IL18 | NM_001562.2 | TGCAATTTGAATCTTCATCATACGAAGGATACTTTCTAGCTTGTGAAAAA | 719 |
| IL18 | NM_001562.2 | AAAAAAGAGGATGAATTGGGGGATAGATCTATAATGTTCACTGTTCAAAA | 720 |
| IL1A | NM_000575.3 | AAGACCAGGCTTCTCTCTGGTCCTTGGTAGAGGGCTACTTTACTGTA | 721 |
| IL1A | NM_000575.3 | TCCTGAAGCTCCATCCCCTCTATAGGAAATGTGTTGACAATATTCA | 722 |
| IL1A | NM_000575.3 | AGGAGCTTGTCACCCCAAACTCTGAGGTGATTTATGCCTTAATCAAG | 723 |
| IL1B | NM_000576.2 | TGGAAAAGCGATTTGTCTTCAACAAGATAGAAATCAATAACAAGCTGG | 724 |
| IL1B | NM_000576.2 | TCACCATGCAATTTGTGTCTTCCTAAAGAGAGCTGTACCCAGAGAGT | 725 |
| IL1B | NM_000576.2 | AATCCCTAGGGCTGGCAGAAAGGGAACAGAAAGGTTTTTGAGTAC | 726 |
| IL20 | NM_018724.3 | TCCTGTGGTCTCCAGATTTCAGGCCTAAGATGAAAGCCTCTAGTCTTG | 727 |
| IL20 | NM_018724.3 | CCTGCGCCATTTGCTAAGACTCTATCTGGACAGGGTATTTAAAAAC | 728 |
| IL20 | NM_018724.3 | CATTGTGGGGAGGAAGCAATGAAGAAATACAGCCAGATTCTGAGT | 729 |
| IL6 | NM_000600.1 | GCCTGGTGAAAATCATCACTGGTCTTTTGGAGTTTGAGGTATACCT | 730 |
| IL6 | NM_000600.1 | GAACAAGCCAGAGCTGTGCAGATGAGTACAAAAGTCCTGATCCAGTT | 731 |
| IL6 | NM_000600.1 | TCTGGTCAGAAACCTGTCCACTGGGCACAGAACTTATGTTGTTCTCT | 732 |
| IL8 | NM_000584.2 | GCAGTTTTGCCAAGGAGTGCTAAAGAACTTAGATGTCAGTGCATAAAG | 733 |
| IL8 | NM_000584.2 | TCCAAGAATCAGTGAAGATGCCAGTGAAACTTCAAGCAAATCTACTT | 734 |
| IL8 | NM_000584.2 | GCCAAGGGCCAAGAGAATATCCGAACTTTAATTTCAGGAATTGAATG | 735 |
| ILF2 | NM_004515.2 | TGAAGAAGTTCGACAGGTGGGATCCTATAAAAAGGGGACAATGACTAC | 736 |
| ILF2 | NM_004515.2 | GCTGACCAACGAAACTGGCTTTGAAATCAGTTCTTCTGATGCTACA | 737 |
| ILF2 | NM_004515.2 | GGCTGCAGGACTGTTCCTGCCAGGTTCAGTGGGTATCACTGA | 738 |
| ILK | NM_001014794.1 | CACTATGCCTGTTTTTGGGGCCAAGATCAAGTGGCAGAGGAC | 739 |
| ILK | NM_001014794.1 | AAGATGGGCCAGAATCTCAACCGTATTCCATACAAGGACACATTCT | 740 |
| ILK | NM_001014794.1 | GAACCCTGAACAAACACTCTGGCATTGACTTCAAACAGCTTAACTTC | 741 |
| IREB2 | NM_004136.1 | GGGTCTTGTTGGAAGCTGCTGTACGAAATTGTGATGGCTTTTTAAT | 742 |
| IREB2 | NM_004138.1 | GGATTTTGCTGCTATGAGGGAGGCAGTGAAAACTCTTGGAGGTGAT | 743 |
| IREB2 | NM_004136.1 | CAGGCAAGTAGGAGTGGCTGGAAAGTTTGTTGAGTTTTTTGGAAGT | 744 |
| IRF1 | NM_002198.1 | CACTCGGATGCGCATGAGACCCTGGCTAGAGATGCAGATTAATT | 745 |
| IRF1 | NM_002198.1 | CAACAAACGTGGATGGGAAGGGGTACCTACTCAATGAACCTGGA | 746 |
| IRF1 | NM_002198.1 | ATTGGGCTGAGTCTACAGCGTGTCTTCACAGATCTGAAGAACATG | 747 |
| ITGAV | NM_002210.2 | TTATGCCAAGGATGATCCATTGGAATTTAAGTCCCATCAGTGGTTT | 748 |
| ITGAV | NM_002210.2 | CCTGTGCCCCATTGTACCATTGGAGAACTGAGATGAAACAGGAG | 749 |
| ITGAV | NM_002210.2 | CAGCTTATTTCGGATCAAGTGGCAGAAATCGTATCTAAATACGACCC | 750 |
| ITGB3BP | NM_014288.3 | GCTTTCCCGAATCTCAGAATGCCTGTTAAAAGATCACTGAAGTTGG | 751 |
| ITGB3BP | NM_014288.3 | CTTCCTCACAAAGCATCACGTCATCTTGACAGCTATGAATTCCTTAA | 752 |
| ITGB3BP | NM_014288.3 | CACTCACCATGAGCACCAACTTCTGCATCTGCCTGATCATATTTAA | 753 |
| JAG1 | NM_000214.1 | TGTTTTCCAGTCGTGCATGCTCCAATCGGCGGAGTATATTAGAG | 754 |
| JAG1 | NM_000214.1 | GCCGCCCCAGAGATGACTTCTTTGGACACTATGCCTGTGAC | 755 |
| JAG1 | NM_000214.1 | GTGCCAGTATGGCTGGCAAGGCCTGTACTGTGATAAGTGCATC | 756 |
| KDR | NM_002253.1 | AGTGCAGCGATGGCCTCTTCTGTAAGACACTCACAATTCCAAAAG | 757 |
| KDR | NM_002253.1 | TGCTTCTGTTAGTGACCAACATGGAGTCGTGTACATTACTGAGAACAAA | 758 |
| KDR | NM_002253.1 | ATGATCAGCTATGCTGGCATGGTCTTCTGTGAAGCAAAAATTAATG | 759 |
| KIF20A | NM_005733.1 | GGGACAGGCATCCTTCTTCAACCTAACTGTGAAGGAGATGGTAAAG | 760 |
| KIF20A | NM_005733.1 | TGATCTGAAGCCCTTGCTCTCCAATGAGGTAATCTGGCTAGACAG | 761 |
| KIF20A | NM_005733.1 | GCTGTCCACTTCCTTGAAGAGGAGTGTCTACATCGAAAGTCGGATAG | 762 |
| KIF23 | NM_004856.4 | AGTATTTGGCACTCACACCACCCAGAAGGAACTCTTTGATGTTGTG | 763 |
| KIF23 | NM_004856.4 | CATATGGTGTGACGGGAAGTGGAAAAACTCACACAATGACTGGTT | 764 |
| KIF23 | NM_004856.4 | CCACAATCTAAATTGCTTCGTGAAGATAAGAACCATAACATGTATGTTGC | 765 |
| KIF2C | NM_006845.2 | TGATGTGGCTGCAATAAACCCAGAACTCTTACAGCTTCTTCCCTTA | 766 |
| KIF2C | NM_006845.2 | CAAACTGGGAATTTGCCCGAATGATTAAAGAATTTCGGGCTACTTT | 767 |
| KIF2C | NM_006845.2 | CACAGCAAGGCCACTGGTACAGACAATCTTTGAAGGTGGAAAAG | 768 |
| KIT | NM_000222.1 | TTTTGAGATCCTGGATGAAACGAATGAGAATAAGCAGAATGAATGGAT | 769 |
| KIT | NM_000222.1 | CAAGCTTTTCCTTGTTGACCGCTCCTTGTATGGGAAAGAAGACAAC | 770 |
| KIT | NM_000222.1 | AGCTGTGCCTGTTGTGTCTGTGTCCAAAGCAAGCTATCTTCTTAGG | 771 |
| KNTC2 | NM_006101.1 | CGCCTCTCCATGCAGGAGTTAAGATCCCAGGATGTAAATAAACAAG | 772 |
| KNTC2 | NM_006101,1 | ACCAAAGAGAAACCAACCTTTGGAAAGTTGAGTATAAACAAACCGACA | 773 |
| KNTC2 | NM_006101.1 | GCAATTTGGAGTCTCATTCAGCCATTCTTGACCAGAAATTAAATGGT | 774 |
| KPNA2 | NM_002266.2 | TGTCATCTTTAGCATGTGGCTACTTACGTAATCTTACCTGGACACTTT | 775 |
| KPNA2 | NM_002266.2 | TGAGAAGTATTTCTCTGTAGAGGAAGAGGAAGATCAAAACGTTGTACCAGAA | 776 |
| KPNA2 | NM_002266.2 | CCGCTTCGCAGCTTTCTCCCTTTGTCTCATAACCATGTCCAC | 777 |
| KRAS | NM_033360.2 | TACATGAGGACTGGGGAGGGCTTTCTTTGTGTATTTGCCATAAAT | 778 |
| KRAS | NM_033360.2 | TTCCTCTAAGTGCCAGTATTCCCAGAGTTTTGGTTTTTGAACTAGCA | 779 |
| KRAS | NM_033360.2 | GCAGACCCAGTATGAAATGGGGATTATTATAGCAACCATTTTGGG | 780 |
| KRT1 | NM_006121.2 | CCAGCGTGAGGTTTGTTTCTACCACTTATTCCGGAGTAACCAGATAA | 781 |
| KRT1 | NM_006121.2 | GCTCTAGTTCTCCCCCAGCATCACTAACAAATATGCTTGGCAAGAC | 782 |
| KRT1 | NM_006121.2 | CAGTGACCACCACCCACATGACATTTCAAAGCACCTCCTTAAG | 783 |
| KRT13 | NM_153490.1 | CCAAGCAAGCTTCTATCTGCACCTGCTCTCAATCCTGCTCTCAC | 784 |
| KRT13 | NM_153490.1 | CCGTAGCACCTCTGTTACCACGACTTCTAGTGCCTCTGTTACCAC | 785 |
| KRT13 | NM_153490.1 | GTCGCCGCACTTCTGATGTCCGTAGGCCTTAAATCTGCCTG | 786 |
| KRT17 | NM_000422.1 | GACCACCCGTCAGGTGCGTACCATTGTGGAAGAGGTCCAG | 787 |
| KRT17 | NM_000422.1 | AGGCAGGGAGCAGCCGCCCCATCTGCCCCACAGTCTC | 788 |
| KRT17 | NM_000422.1 | AGTGAGCTGGTGCAGAGTGGCAAGAGTGAGATCTCGGAGCTC | 789 |
| KRT19 | NM_002276.3 | GTATCCGTGTCCTCCGCCCGCTTTGTGTCCTCGTCCTCCT | 790 |
| KRT19 | NM_002276.3 | GGCCAAGTGGGAGGCCAGGTCAGTGTGGAGGTGGATTC | 791 |
| KRT19 | NM_002276.3 | CACACGGAGCAGCTCCAGATGAGCAGGTCCGAGGTTACT | 792 |
| KRT5 | NM_000424.2 | CCTCGGTGGAGGTCTTGCCGGAGGTAGCAGTGGAAGCTACTAC | 793 |
| KRT5 | NM_000424.2 | CTAGGCAGTTGCTCAAGCCATGTTTTATCCTTTTCTGGAGAGTAGTC | 794 |
| KRT5 | NM_000424.2 | ATTTCCCAGCCCCTGGTCTCCCGTGCCGCAGTTCTATATTCTG | 795 |
| KRT6B | NM_005555.2 | TCAATACCTGTTCCACTGAGCTCCTGTTGCTTACCATCAAGTCAAC | 796 |
| KRT6B | NM_005555.2 | GCACTCAGACATGCGAATGTCCTTTTTAGTTCCCGTATTATTACAGG | 797 |
| KRT6B | NM_005555.2 | GCAGTGTCCCTGAATGGCAAGTGATGTACCTTCTGATGCAGTCT | 798 |
| L1CAM | NM_000425.2 | GCTGGACGAGGGATGGTGTCCACTTCAAACCCAAGGAAGAG | 799 |
| L1CAM | NM_000425.2 | CTTCACCATCACGGGCAACAACAGCAACTTTGCTCAGAGGTT | 800 |
| L1CAM | NM_000425.2 | GTGACGATGGGCCAGAACGGCAACCTCTACTTTGCCAATGT | 801 |
| LAMC2 | NM_018891.1 | CAGGCAGTGTATCTTTGATCGGGAACTTCACAGACAAACTGGTAATG | 802 |
| LAMC2 | NM_018891.1 | CACTGATGGCATTCACTGCGAGAAGTGCAAGAATGGCTTTTAC | 803 |
| LAMC2 | NM_018891.1 | CAAGCAATAATTGGAGCCCCCAGCTGAGTTACTTTGAGTATCGAA | 804 |
| LAPTM4B | NM_018407.4 | ACCATCCTGCTCGGCGTCTGGTATCTGATCATCAATGCTGTG | 805 |
| LAPTM4B | NM_018407.4 | TTTGCCCTGAACATGTTGGTTGCAATCACTGTGCTTATTTATCCAA | 806 |
| LAPTM4B | NM_018407.4 | AGCTGTGTTTGGAACTGCTACCGATACATCAATGGTAGGAACTCCT | 807 |
| LDHA | NM_005566.1 | TGGTTCCAAGTCCAATATGGCAACTCTAAAGGATCAGCTGATTTATAA | 808 |
| LDHA | NM_005566.1 | CACCTCTGACGCACCACTGCCAATGCTGTACGTACTGCATTT | 809 |
| LDHA | NM_005566.1 | TCAAAGGCTACACATCCTGGGCTATTGGACTCTCTGTAGCAGATTT | 810 |
| LMNA | NM_170708.1 | GGGGATGCCCGCAAGACCCTTGACTCAGTAGCCAAGGAG | 811 |
| LMNA | NM_170708.1 | GAGGCAGCCCTAGGTGAGGCCAAGAAGCAACTTCAGGATGAG | 812 |
| LMNA | NM_170708.1 | CAAGCGCCGTCATGAGACCCGACTGGTGGAGATTGACAATG | 813 |
| LOX | NM_002317.3 | CCTCACGTGATTTGAGCCCCGTTTTATTTTCTGTGAGCCAC | 814 |
| LOX | NM_002317.3 | ACTACATCCAGGCGTCCACGTACGTGCAGAAGATGTCCATGTAC | 815 |
| LOX | NM_002317.3 | CAGCATACAGGGCAGATGTCAGAGATTATGATCACAGGGTGCT | 816 |
| LOXL2 | NM_002318.2 | GCACAGTATGACAGCTGGCCCCATTACCCCGAGTACTTCCAG | 817 |
| LOXL2 | NM_002318.2 | CTACGGCAAGGGAGAAGGGCCCATCTGGTTAGACAATCTCCAC | 818 |
| LOXL2 | NM_002318.2 | CCTGGGTTCAAATTTGACAATTCGTTGATCAACCAGATAGAGAACCT | 819 |
| LRBA | NM_006726.1 | CCGTGTTGACCGGTTTGGTTGAAGTTGGAGAAGTATCCAATAGG | 820 |
| LRBA | NM_006726.1 | GGTTGACATGTTGGGAGTGCTGGCTAGCTATAATTTGACAGTTCGC | 821 |
| LRBA | NM_006726.1 | CATGCTGGGAAGTTGCTGTCTGTGTTAAAGCATATGCCTCAGAAGTA | 822 |
| LRP2 | NM_004525.1 | TCATCAGATAACATGCTCCAATGGTCAGTGTATCCCAAGTGAATACAG | 823 |
| LRP2 | NM_004525.1 | GCTTACTTGTGACAATGGGGCCTGCTATAACACCAGTCAGAAGTGT | 824 |
| LRP2 | NM_004525.1 | ACAATGAGTTTTCATGTGGCAATGGAGAGTGTATCCCTCGTGCTTAT | 825 |
| LTA | NM_000595.2 | TTCCATGTGCCTCTCCTCAGCTCCCAGAAGATGGTGTATCCAG | 826 |
| LTA | NM_000595.2 | GCATCCCCCACCTAGTCCTCAGCCCTAGTACTGTCTTCTTTGGAG | 827 |
| LTA | NM_000595.2 | CTCTCCTTTGGCCATTCCAACAGCTCAAGTCTTCCCTGATCAAGT | 828 |
| LTBP1 | NM_206943.1 | GCTGTGAGAAGGGGAACACCACCACTCTCATTAGTGAGAATGGTCA | 829 |
| LTBP1 | NM_206943.1 | CAAGGGCTTCCTGTCCAGAAGACCCAGACCATACATTCCACATACTC | 830 |
| LTBP1 | NM_206943.1 | CCAAATGATGGAATGCCTACCGGGTTATAAGCGGGTTAACAACAC | 831 |
| LY6D | NM_303695.2 | CACGTGTGCACCAGCTCCAGCAACTGCAAGCATTCTGTGGT | 832 |
| LY6D | NM_003695.2 | AACACAGTGGAGCCTCTGAGGGGGAATCTGGTGAAGAAGGACTGT | 833 |
| LY6D | NM_003695.2 | CACTCCTTCTGTTTTGTTGCCGTTTATTTTTGTACTCAAATCTCTACATG | 834 |
| MAD2L1 | NM_002358.2 | GAAAGCTATCCAGGATGAAATCCGTTCAGTGATCAGACAGATCACAG | 835 |
| MAD2L1 | NM_002358.2 | ACCAATTCTGAGGAAGTCCGCCTTCGTTCATTTACTACTACAATCCA | 836 |
| MAD2L1 | NM_002358.2 | TGGTTTTCCTGAAATCAGGTCATCTATAGTTGATATGTTTTATTTCATTGG | 837 |
| MAL2 | NM_052886.1 | GGTTGCCTCCTCCAATGTTCCTCTACCTCTACTACAAGGATGGGT | 838 |
| MAL2 | NM_052886.1 | GGCAGTCGTATGTTAGTTTCACTTGTCTACTTTATATGTCTGATCAATTTGG | 839 |
| MAL2 | NM_052886.1 | TGCATTTTCTTGAACTGATCATTGAAAACTTATAAACCTAACAGAAAAGCC | 840 |
| MAP2K4 | NM_003010.2 | CCTTGGAGAAATTGGACGAGGAGCTTATGGTTCTGTCAACAAAATG | 841 |
| MAP2K4 | NM_003010.2 | TTCGGTCAACAGTGGATGAAAAAGAACAAAAACAACTTCTTATGGATT | 842 |
| MAP2K4 | NM_003010.2 | CTGAAAGAATAGACCCAAGCGCATCACGACAAGGATATGATGTC | 843 |
| MAPK1 | NM_002745.4 | AATGCTGACTCCAAAGCTCTGGACTTATTGGACAAAATGTTGACATT | 844 |
| MAPK1 | NM_002745.4 | AAGTAGAACAGGCTCTGGCCCACCCATATCTGGAGCAGTATTACGAC | 845 |
| MAPK1 | NM_002745.4 | GACATGGAATTGGATGACTTGCCTAAGGAAAAGCTCAAAGAACTAAT | 846 |
| MAPK14 | NM_001315.1 | CACAAAAACGGGGTTACGTGTGGCAGTGAAGAAGCTCTCCAGAC | 847 |
| MAPK14 | NM_001315.1 | GGGGGCAGATCTGAACAACATTGTGAAATGTCAGAAGCTTACAGAT | 848 |
| MAPK14 | NM_001315.1 | CATAATGGCCGAGCTGTTGACTGGAAGAACATTGTTTCCTGGTAC | 849 |
| MAPT | NM_016834.2 | CTCCCGTCCTCGCCTCTGTCGACTATCAGGTGAACTTTGAACC | 850 |
| MAPT | NM_016834.2 | CGATGACAAAAAAGCCAAGGGGGCTGATGGTAAAACGAAGATC | 851 |
| MAPT | NM_016834.2 | CCAGTTGACCTGAGCAAGGTGACCTCCAAGTGTGGCTCATTAG | 852 |
| MBNL2 | NM_144778.2 | ACCCTGACCTTATGAGTGGATGAAGATACCTCAGTTGTCTGACTTTG | 853 |
| MBNL2 | NM_144778.2 | TCGTCAATAGCTGTGAGCGTCAGCATTAAATATTCTCCCAAGGAGTG | 854 |
| MBNL2 | NM_144778.2 | CACTTTCCCTGTAGGTCCCGCGATAGGGACAAATACGGCTATTAG | 855 |
| MCL1 | NM_021960.3 | AGGACGAGTTGTACCGGCAGTCGCTGGAGATTATCTCTCGGTACC | 856 |
| MCL1 | NM_021960.3 | ATGGGTTTGTGGAGTTCTTCCATGTAGAGGACCTAGAAGGTGGC | 857 |
| MCL1 | NM_021960.3 | GTGTTGCTGGAGTAGGAGCTGGTTTGGCATATCTAATAAGATAGCCTT | 858 |
| MCM2 | NM_004526.2 | CCTATGAGGCCGAGGGACTGGCTCTGGATGATGAGGACGTA | 859 |
| MCM2 | NM_004526.2 | ACGAGGAGATGATCGAGAGCATCGAGAACCTGGAGGATCTCAAAG | 860 |
| MCM2 | NM_004526.2 | GAACCGTGAGAGCCTGGTGGTGAACTATGAGGACTTGGCAG | 861 |
| MCM6 | NM_005915.4 | TTTCAGAGCAGCGATGGAGAAATTAAATACTTGCAATTAGCAGAGG | 862 |
| MCM6 | NM_005915.4 | TGAGCTTCCTCGAGGGAGTATCCCCCGCAGTTTAGAAGTAATTTTAA | 863 |
| MCM6 | NM_005915.4 | TGTGGAATCAGCTCAAGCTGGTGACAAGTGTGACTTTACAGGGAC | 864 |
| MDM2 | NM_006882.2 | CAAATGTGCAATACCAACATGTCTGTACCTACTGATGGTGCTGTAAC | 865 |
| MDM2 | NM_006882.2 | TTAGACCAAAGCCATTGCTTTTGAAGTTATTAAAGTCTGTTGGTGCA | 866 |
| MDM2 | NM_006882.2 | TCTTGGCCAGTATATTATGACTAAACGATTATATGATGAGAAGCAACAACA | 867 |
| MELK | NM_014791.2 | CGGAGATTGAGGCCTTGAAGAACCTGAGACATCAGCATATATGTCA | 868 |
| MELK | NM_014791.2 | CAGACATGCTGTGGGAGTCTGGCTTATGCAGCACCTGAGTTAATAC | 869 |
| MELK | NM_014791.2 | TGGACCCAAAGAAACGGATTTCTATGAAAAATCTATTGAACCATCC | 870 |
| MFGE8 | NM_005928.1 | AGCCACTGGGCATGGAGAATGGGAACATTGCCAACTCACAGAT | 871 |
| MFGE8 | NM_005928.1 | GCCTACAGCCTAATGGACACGAATTCGATTTCATCCATGATGTTAAT | 872 |
| MFGE8 | NM_005928.1 | GTAACTGGAACAAAAACGCGGTGCATGTCAACCTGTTTGAGACC | 873 |
| MGST3 | NM_004528.2 | CGCAAGATGGCTGTCCTCTCTAAGGAATATGGTTTTGTGCTTCTAACT | 874 |
| MGST3 | NM_004528.2 | AGCACGGACCCTGAAAATGGGCACATCTTCAACTGCATTCAG | 875 |
| MGST3 | NM_004528.2 | GCCTGGATTGTTGGACGAGTTCTTTATGCTTATGGCTATTACACG | 876 |
| MKI67 | NM_002417.2 | CATCCGTATCCAGCTTCCTGTTGTGTCAAAACAACATTGCAAAATT | 877 |
| MKI67 | NM_002417.2 | TTCAGTTCCACAAATCCAACACAAGTAAATGGGTCTGTTATTGATGAG | 878 |
| MKI67 | NM_002417.2 | TGAGAAAGCTCAAGATTCCAAGGCCTATTCAAAAATCACTGAAGGAAA | 879 |
| MLF1IP | NM_024629.2 | GCAAGCCTATTGACGTGTTCGACTTTCCTGATAATTCTGATGTCTC | 880 |
| MLF1IP | NM_024629.2 | TCAGGCCCATTAGTGATGACTCTGAAAGCATTGAAGAAAGTGATACAA | 881 |
| MLF1IP | NM_024629.2 | CAGCCATCGCCACATTTTATGTTAATGTTAAAGAACAATTCATCAAAA | 882 |
| MLH1 | NM_000249.2 | GCATAAGCCATGTGGCTCATGTTACTATTACAACGAAAACAGCTGA | 883 |
| MLH1 | NM_000249.2 | CATAGCCACGAGGAGAAAAGCTTTAAAAAATCCAAGTGAAGAATATGG | 884 |
| MLH1 | NM_000249.2 | TGGATGTGAGGATAAAACCCTAGCCTTCAAAATGAATGGTTACATATCC | 885 |
| MLLT10 | NM_004641.2 | GGTAATGGTGCCGATAATGTCCAATACTGTGGCTACTGTAAATACCAT | 886 |
| MLLT10 | NM_004641.2 | GTCTCCCCAGGATTTCCTGAGCTTTACAGACTCAGATCTGCGTAAT | 887 |
| MLLT10 | NM_004641.2 | CCAACAGTCATCAGCAACCAAAGATGTACATAAAGGAGAGTCTGGAA | 888 |
| MLPH | NM_024101.4 | TCGTGAAGATCGGCTCACTGGAGTGGTACTATGAGCATGTGAAAG | 889 |
| MLPH | NM_024101.4 | GAAGAGAGAAGTGGAGACAGCGACCAGACAGATGAGGATGGAGAAC | 890 |
| MLPH | NM_024101.4 | GTCCACGACTTCGACTTCGAGGGAGACTCAGATGACTCCACTCAG | 891 |
| MMP1 | NM_002421.2 | AACCTGAAGAATGATGGGAGGCAAGTTGAAAAGCGGAGAAATAGT | 892 |
| MMP1 | NM_002421.2 | CATTCACCAAGGTCTCTGAGGGTCAAGCAGACATCATGATATCTTTTG | 893 |
| MMP1 | NM_002421.2 | GCTCATGAACTCGGCCATTCTCTTGGACTCTCCCATTCTACTGATAT | 894 |
| MMP11 | NM_005940.3 | AAGGTATGGAGCGATGTGACGCCACTCACCTTTACTGAGGTGCA | 895 |
| MMP11 | NM_005940.3 | ACTCACCGAGAAGGGGATGTCCACTTCGACTATGATGAGACCTG | 896 |
| MMP11 | NM_005940.3 | CCCTGATGTCCGCCTTCTACACCTTTCGCTACCCACTGAGTCT | 897 |
| MMP2 | NM_004530.2 | CCCAAGGAGAGCTGCAACCTGTTTGTGCTGAAGGACACACTA | 898 |
| MMP2 | NM_004530.2 | GCCCCAGACAGGTGATCTTGACCAGAATACCATCGAGACCATG | 899 |
| MMP2 | NM_004530.2 | CTGCGGCAACCCAGATGTGGCCAACTACAACTTCTTCCCTC | 900 |
| MMP3 | NM_002422.3 | AGGCAAGACAGCAAGGCATAGAGACAACATAGAGCTAAGTAAAGCCA | 901 |
| MMP3 | NM_002422.3 | TGACTCGAGTCACACTCAAGGGAACTTGAGCGTGAATCTGTATCTT | 902 |
| MMP3 | NM_002422.3 | CAAATGGGCTGCTGCTTAGCTTGCACCTTGTCACATAGAGTGATCT | 903 |
| MMP7 | NM_002423.3 | AGCCAAACTCAAGGAGATGCAAAAATTCTTTGGCCTACCTATAACTG | 904 |
| MMP7 | NM_002423.3 | TGGACTTCCAAAGTGGTCACCTACAGGATCGTATCATATACTCGAG | 905 |
| MMP7 | NM_002423.3 | CATGTGGGGCAAAGAGATCCCCCTGCATTTCAGGAAAGTTGTAT | 906 |
| MMP9 | NM_004994.2 | CCACCCTTGTGCTCTTCCCTGGAGACCTGAGAACCAATCTCAC | 907 |
| MMP9 | NM_004994.2 | GGCAGCTGGCAGAGGAATACCTGTACCGCTATGGTTACACTCG | 908 |
| MMP9 | NM_004994.2 | TCAAGTGGCACCACCACAACATCACCTATTGGATCCAAAACTACTC | 909 |
| MRPS12 | NM_021107.1 | ATTCAAGTCCTGGCTCCGCCTCTTCCATCAGGACCACTATTAAG | 910 |
| MRPS12 | NM_021107.1 | AGGGTGCCCCTCTGTCAACACCCTTGGCTCCTGTGTTTAGAG | 911 |
| MRPS12 | NM_021107.1 | AGGACCTTTTCTGCTGGGACAAGACACTGTACTGCCCTGTGCT | 912 |
| MSH2 | NM_000251.1 | TCCTGGCAATCTCTCTCAGTTTGAAGACATTCTCTTTGGTAACAATGA | 913 |
| MSH2 | NM_000251.1 | TGGCCAGAGACAGGTTGGAGTTGGGTATGTGGATTCCATACAGA | 914 |
| MSH2 | NM_000251.1 | TCACTGTCTGCGGTAATCAAGTTTTTAGAACTCTTATCAGATGATTCCAA | 915 |
| MSH6 | NM_000179.1 | CGAGAAAGGGAAATCAGTCCGTGTTCATGTACAGTTTTTTGATGACA | 916 |
| MSH6 | NM_000179.1 | AAAATCAAAGGAAGCCCAGAAGGGAGGTCATTTTTACAGTGCAAAG | 917 |
| MSH6 | NM_000179.1 | TCTGAGAGTGACATTGGTGGCTCTGATGTGGAATTTAAGCCAGAC | 918 |
| MUC1 | NM_002456.4 | GGGGTTTTCTGGGCCTCTCCAATATTAAGTTCAGGCCAGGATC | 919 |
| MUC1 | NM_002456.4 | ATCAATGTCCACGACGTGGAGACACAGTTGAATCAGTATAAAACGG | 920 |
| MUC1 | NM_002456.4 | AAGGTTTCTGCAGGTAATGGTGGCAGCAGCCTCTCTTACACAAAC | 921 |
| MYB | NM_005375.2 | CCAGCCCACTGTTAACAACGACTATTCCTATTACCACATTTCTGAAG | 922 |
| MYB | NM_005375.2 | AGACCCTGAGAAGGAAAAGCGAATAAAGGAATTAGAATTGCTCCTAA | 923 |
| MYB | NM_005375.2 | ACCAGGGCACCATTCTGGATAATGTTAAGAACCTCTTAGAATTTGCA | 924 |
| MYBL2 | NM_002466.2 | AGCAATGGCAGTACAGGTGGCTGAGAGTTTTGAATCCAGACCTT | 925 |
| MYBL2 | NM_002466.2 | GCTGGCACAACCACCTCAACCCTGAGGTGAAGAAGTCTTGCT | 926 |
| MYBL2 | NM_002466.2 | GACAATGCTGTGAAGAATCACTGGAACTCTACCATCAAAAGGAAGGT | 927 |
| MYC | NM_002467.3 | GCTGAGTATAAAAGCCGGTTTTCGGGGCTTTATCTAACTCGCTGTAGT | 928 |
| MYC | NM_002467.3 | GCGACGATGCCCCTCAACGTTAGCTTCACCAACAGGAAC | 929 |
| MYC | NM_002467.3 | CGAGCTGCTGGGAGGAGACATGGTGAACCAGAGTTTCATCTGC | 930 |
| MYST2 | NM_007067.3 | GGCAGTAGTTCAGATGGAACCGAAGATTCCGATTTTTCTACAGATCT | 931 |
| MYST2 | NM_007067.3 | TGCAGTCTTTTGGCACTGAGGAGCCTGCTTACTCTACCAGAAGAGT | 932 |
| MYST2 | NM_007067.3 | GAGAGCACAGAGCCGGGATAAGCAGATAGAAGAAAGGATGCTGTCT | 933 |
| NAT1 | NM_000662.4 | CAAGCCAGGAAGAAGCAGCAATCTGTCTTCTGGATTAAAACTGAAG | 934 |
| NAT1 | NM_000662.4 | TGTCATCCAGCTCACCAGTTATCAACTGACGACCTATCATGTATCTTC | 935 |
| NAT1 | NM_000662.4 | CCTCATAGACCTTGGATGTGGGAGGATTGCATTCAGTCTAGTTCCT | 936 |
| NCOA3 | NM_181659.1 | TTGCTGGATGGTGGACTCAGAGACCAATAAAAATAAACTGCTTGAA | 937 |
| NCOA3 | NM_181659.1 | TCCTGGACAAATGAGACCCAAAGACAAAAAAGCCATACATTTAATTG | 938 |
| NCOA3 | NM_181659.1 | TTGTATGATCTGTGTGGCACGCCGCATTACTACAGGAGAAAGAACA | 939 |
| NDP | NM_000266.1 | AAGCATTTGGAAGTAACAGGACCTCTTTCTAGCTCTCAGAAAAGTCTGA | 940 |
| NDP | NM_000266.1 | GATGATGGATTGCAAGTGCAAAGAGTAAGACAAAACTCCAGCACATA | 941 |
| NDP | NM_000266.1 | CTGCTGTGTGTGGCTTCTGGATGGGACAACTGTAGAGGCAGTTC | 942 |
| NDRG1 | NM_006096.2 | GTGACAGCAGGGACATGTCTCGGGAGATGCAGGATGTAGACCTC | 943 |
| NDRG1 | NM_006096.2 | TGCGCCTAACTCGGTATTAATCCAAAGCTTATTTTGTAAGAGTGAGCTC | 944 |
| NDRG1 | NM_006096.2 | GGAGAAGCTGATCCAGTTTCCGGAAACAAAATCCTTTTCTCATTTG | 945 |
| NES | NM_006617.1 | CTTCTCCCGGTGCCCCGCGTCTGTCCATCCTCAGTGG | 946 |
| NES | NM_006617.1 | AGGATGGAGGGCTGCATGGGGGAGGAGTCGTTTCAGATGT | 947 |
| NES | NM_006617.1 | CGGGTCAAGGCGCrGGAGGAGCAGAATGAGCTGCTCAG | 948 |
| NFAT5 | NM_173215.1 | CAGCTCCTTTACCACCTCTTCCAGCCCTACCATTTATTCTACCTCAG | 949 |
| NFAT5 | NM_173215.1 | CAGCATCCATCAACACCGAAGAGGCACACAGTCTTGTACATCTCA | 950 |
| NFAT5 | NM_173215.1 | GCAGTATGTGGATGGAGGATTCCCCCTCCAACTTCAGTAACATGAG | 951 |
| NFYA | NM_002505.3 | GGACAAGGTCAAACCATCATGCAAGTACCTGTTTCTGGAACACAG | 952 |
| NFYA | NM_002505.3 | ACACAACCAGCAGTGGGCAAGGGACTGTCACTGTGACACTACCA | 953 |
| NFYA | NM_002505.3 | GCTGGCTCTGTGCCTGCTATCCAAAGAATCCCTCTACCTGGAG | 954 |
| NGFR | NM_002507.1 | GCCAAGGAGGCATGCCCCACAGGCCTGTACACACACAG | 955 |
| NGFR | NM_002507.1 | GTGGCCCAGCCTTGTGGAGCCAACCAGACCGTGTGTGAG | 956 |
| NGFR | NM_002507.1 | AGCACCCAGGAGCCTGAGGCACCTCCAGAACAAGACCTCATA | 957 |
| NM_0010084 | NM_001008490.1 | CGAGCCCTGCTATGTTTCAGCCTCAGAAATCAAATTTGACAGC | 958 |
| 90.1 | | | |
| NM_0010084 | NM_001008490.1 | TCGGGAGAAAAAGGAGGAATCCGAACTGAAGATATCTTCCAGTCCT | 959 |
| 90.1 | | | |
| NM_0010084 | NM_001008490.1 | CTGAGGGAGCAGAGAGGTGGATCCTGTAGGCTAAAAGGCTTCC | 960 |
| 90.1 | | | |
| NM_002038 | NM_022872.1 | CACCATGCGGCAGAAGGCGGTATCGCTTTTCTTGTGCTAC | 961 |
| NM_002038 | NM_022872.1 | GTGGCAGCAGCGTCGTCATAGGTAATATTGGTGCCCTGATG | 962 |
| NM_002038 | NM_022872.1 | CGATGCCCAGAATCCAGAACTTTGTCTATCACTCTCCCCAACAAC | 963 |
| NM_012428 | NM_017455.1 | GAGAGCTGAGGATTCAGGCGAATACCACTGCGTATATCACTTTGT | 964 |
| NM_012428 | NM_017455.1 | TACCTCTGGCCGCTTCTTCATCATCAACAAGGAAAATTACACTGAG | 965 |
| NM_012428 | NM_017455.1 | TCAAGTGAGCAACACCACAATGACTGTCTAAAGCATGCCTTATTTAG | 966 |
| NM_016095 | NM_016095.1 | CGAGGTCGAATTCCTCGCCGAGAAGGAGCTGGTTACCATTAT | 967 |
| NM_016095 | NM_016095.1 | AAACTCCGCACGAACCTCCAGCCTCTGGAGAGTACTCAGTCTCAG | 968 |
| NM_016095 | NM_016095.1 | CTTGCTGGGGGATGTGAGCGCTCAGGATGTGATGAGGTACTC | 969 |
| NM_018455 | NM_018455.3 | CCAGGTCCTAACGGAGCCTATGTGTAAGTCCACTACTGGTGCAAG | 970 |
| NM_018455 | NM_018455.3 | TGGATGAGACTGTTGCTGAGTTCATCAAGAGGACCATCTTGAAAAT | 971 |
| NM_018455 | NM_018455.3 | GACAACAATCCTGAAGGCCrGGGATTTTTTGTCTGAAAATCAACTG | 972 |
| NM_145914 | NM_145914.2 | CACCGTAACTTTCAAGCGCTCCTGTTGTTGTCGTTGTTTTAAACTT | 973 |
| NM_145914 | NM_145914.2 | GCAGCATCGATTCCGGTGATAGAGTTTGTATCACTCAACATCAGG | 974 |
| NM_145914 | NM_145914.2 | TGCCAGCATTACCTTTTGCGTAGTTAAACAGACGTGTATCCAGTCT | 975 |
| NM_198433 | NM_198434.1 | CAGGCCAATCGGCTTTCTAGCTAGAGGGTTTAACTCCTATTTAAAAA | 976 |
| NM_198433 | NM_198434.1 | TGTATTTTTTCTCTGGTGGCATTCCTTTAGGAATGCTGTGTGTCTGT | 977 |
| NM_198433 | NM_198434.1 | TCCTCCTTAACCACTTATCTCCCATATGAGAGTGTGAAAAATAGGAAC | 978 |
| NME1 | NM_000269.2 | AGGAGATCGGCTTGTGGTTTCACCCTGAGGAACTGGTAGATTACA | 979 |
| NME1 | NM_000269.2 | GGAGGGAAGCTCTTGGAGCTGTGAGTTCTCCCTGTACAGTGTTACC | 980 |
| NME1 | NM_000269.2 | CCTCCCAGCATAGGATTCATTGAGTTGGTTACTTCATATTGTTGCAT | 981 |
| NOTCH2 | NM_024408.2 | TTTGAAGGGAGCACCTGTGAGAGGAATATTGATGACTGCCCTAAC | 982 |
| NOTCH2 | NM_024408.2 | TTTCAAAGGTGTGCATTGTGAATTAGAAATAAATGAATGTCAGAGCAA | 983 |
| NOTCH2 | NM_024408.2 | GTACATGGGCGCCATCTGCAGTGACCAGATTGATGAATGTTAC | 984 |
| NOTCH4 | NM_004557.3 | AGCTTCTTGTGCACTTGCCTCCCTGGCTTCACTGGTGAGAGAT | 985 |
| NOTCH4 | NM_004557.3 | CAGGTGAGCAGTGCCAGCTTCGGGACTTCTGTTCAGCCAAC | 986 |
| NOTCH4 | NM_004557.3 | TTAATGGAGGGGTGTGTCTGGCCACATACCCCCAGATCCAGT | 987 |
| NPY1R | NM_000909.4 | AAGAATGCCCAGCTTCTGGCTTTTGAAAATGATGATTGTCATCTG | 988 |
| NPY1R | NM_000909.4 | CCTCGAGGGTGGAGACCAAATAATAGACATGCTTATGTAGGTATTGC | 989 |
| NPY1R | NM_000909.4 | GCTGTGGCTTCTTCTTTGCCTTTCCTGATCTACCAAGTAATGACTG | 990 |
| NRAS | NM_002524.2 | CGCACTGACAATCCAGCTAATCCAGAACCACTTTGTAGATGAATATGA | 991 |
| NRAS | NM_002524.2 | CCAATACATGAGGACAGGCGAAGGCTTCCTCTGTGTATTTGCCAT | 992 |
| NRAS | NM_002524.2 | CTGGTCCTGACTTCCTGGAGGAGAAGTATTCCTGTTGCTGTCTTC | 993 |
| NRP1 | NM_001024628.1 | GAAAGCCCCGGGTACCTTACATCTCCTGGTTATCCTCATTCTTATC | 994 |
| NRP1 | NM_001024628.1 | ATTCAGGCTCCGGACCCATACCAGAGAATTATGATCAACTTCAACC | 995 |
| NRP1 | NM_001024628.1 | TCAAGAGAGGTCCTGAATGTTCCCAGAACTACACAACACCTAGTGGAG | 996 |
| NTRK3 | NM_001012338.1 | GCTTGCCCTGCAAATTGTGTCTGCAGCAAGACTGAGATCAATTG | 997 |
| NTRK3 | NM_001012338.1 | CCTTTGCCAAGAACCCCCATTTGCGTTATATAAACCTGTCAAGT | 998 |
| NTRK3 | NM_001012338.1 | TCTTCGGGAATTGCAGTTGGAGCAGAACTTTTTCAACTGCAGCT | 999 |
| NUSAP1 | NM_016359.2 | TCATCCCCTCTCTAGAGGAGCTGGACTCCCTCAAGTACAGTGACCT | 1000 |
| NUSAP1 | NM_016359.2 | TCATGAAAAGCAGGAAAGCCAGGATCTCAGAGCTACTGCAAAAGTT | 1001 |
| NUSAP1 | NM_016359.2 | CACAGATGAGTCATCCAAACCTGGAAAAAATAAAAGAACTGCAATCACT | 1002 |
| ORC3L | NM_012381.2 | AGAATTCAAGAGACTTGGGCGGTCAAATAAAACTCAGAGAAATTCCAA | 1003 |
| ORC3L | NM_012381.2 | AGGAAAGTGTTCACGTCACCCAAAGAAAGACACATTATTCAATGGA | 1004 |
| ORC3L | NM_012381.2 | TAGCCAATGGCAGTCTCCTCCTGTTGTCGTTATCTTGAAGGATATG | 1005 |
| ORC6L | NM_014321.2 | TGAGTCCAGTCTTCCCCAGACACAGCAAGTGGATCTTGACTTATC | 1006 |
| ORC6L | NM_014321.2 | TGGAGAAGGTAGAGGAGATGCCACATAAACCACAGAAAGATGAAGATC | 1007 |
| ORC6L | NM_014321.2 | CATTAGACCAGCCACAGTGCCTGATTGGTATAGCCTTATGTGCTTT | 1008 |
| OXCT1 | NM_000436.2 | TCCTTTTCCACCAGTGCTCATCGCCATACCAAGTTTTATACAGATCC | 1009 |
| OXCT1 | NM_000436.2 | AACTCATGCCAATGCAGCAGATCGCAAATTGAAATATGGATATTTG | 1010 |
| OXCT1 | NM_000436.2 | TGTGTTTCAGACTTTATGCAGCCATATAAACTGTTCTCTAGGCATGCT | 1011 |
| P4HA1 | NM_001017962.1 | AGTCTTTGGCTCATCCAGGCTTTTTTACTTCAATTGGTCAGATGACT | 1012 |
| P4HA1 | NM_001017962.1 | TGAGTTGGGCAAAGTGGCCTATACAGAAGCAGATTATTACCATACG | 1013 |
| P4HA1 | NM_001017962.1 | CAAGCCCTAAGGCAACTGGATGAAGGCGAGATTTCTACCATAGATA | 1014 |
| PARP4 | NM_006437.2 | TGAATTCAAGCACTCTGAGCCAAGAGGTGAGCGATTTAGTAGAGAT | 1015 |
| PARP4 | NM_006437.2 | CAAGGCAGAGGGGATTCTCCTTCTAGTAAAGGCAGCACTGAAAAAT | 1016 |
| PARP4 | NM_006437.2 | AAATACCGAGCTTTGAGGTGCAAAATTGAGCATGTTGAACAGAATAC | 1017 |
| PBP | NM_002567.2 | GGGTGAGACCTGACCAGTCAGATGGTAGTTGAGGGTGACTTTTCCT | 1018 |
| PBP | NM_002567.2 | CAAATTTGAACTTCATTTTGGGGGGTATTTTGGTACTGTGATGGGG | 1019 |
| PBP | NM_002567.2 | ACAACCAGAGGCTGGCATTGAGGCTAACCTCCAACACAGTGCAT | 1020 |
| PCNA | NM_182649.1 | AAATACTAAAATGCGCCGGCAATGAAGATATCATTACACTAAGGGCC | 1021 |
| PCNA | NM_182649.1 | GATGCCTTCTGGTGAATTTGCACGTATATGCCGAGATCTCAGC | 1022 |
| PCNA | NM_182649.1 | TTCCTGTGCAAAAGACGGAGTGAAATTTTCTGCAAGTGGAGAACT | 1023 |
| PCTK1 | NM_006201.3 | CACGTCCTCGGATGAGGTGCAGTCTCCAGTGAGAGTGCGTAT | 1024 |
| PCTK1 | NM_006201.3 | CCACTGAGGACATCAACAAGCGCCTATCACTACCAGCTGACATCC | 1025 |
| PCTK1 | NM_006201.3 | GATCTCCGCAGAGGATGCCATGAAACATCCATTCTTCCTCAGTC | 1026 |
| PDCD5 | NM_004708.2 | GCTGACGCCGAGCCATGGCGGACGAGGAGCTTGAG | 1027 |
| PDCD5 | NM_004708.2 | AATGGACTCTGATGAAGATGACGATTATTGAACTACAAGTGCTCACAG | 1028 |
| PDCD5 | NM_004708.2 | CGGAACAGTCTAGGACAGAAGTTAAGATCTGATTATTTACTTTGTTTATTGTC | 1029 |
| PDGFA | NM_002607.4 | CGGAGTTCTTCTTGGGGCTGATGTCCGCAAATATGCAGAATTAC | 1030 |
| PDGFA | NM_002607.4 | AGCCAGCGCCTCGGGACGCGATGAGGACCTTGGCTT | 1031 |
| PDGFA | NM_002607.4 | GGACCTCCAGCGACTCCTGGAGATAGACTCCGTAGGGAGTGAG | 1032 |
| PDGFB | NM_033016.1 | GATGCTGAGTGACCACTCGATCCGCTCCTTTGATGATCTCCAAC | 1033 |
| PDGFB | NM_033016.1 | GTGAGAAAGATCGAGATTGTGCGGAAGAAGCCAATCTTTAAGAAGG | 1034 |
| PDGFB | NM_033016.1 | GGAGAGTGTGTGGGCAGGGTTATTTAATATGGTATTTGCTGTATTGC | 1035 |
| PDLIM5 | NM_001011516.1 | AGGAATGACTCATCTTGAAGCCCAGAATAAGATTAAGGGTTGTACAGG | 1036 |
| PDLIM5 | NM_001011516.1 | CCCACCAAGAAAACACATTGTGGAGCGCTATACAGAGTTTTATCATG | 1037 |
| PDLIM5 | NM_001011516.1 | GAAGACTGGCGTCCAAGGACTGGAACAACTCAGTCTCGCTCTTT | 1038 |
| PDPN | NM_001006624.1 | GACTCCAGGAACCAGCGAAGACCGCTATAAGTCTGGCTTGACAA | 1039 |
| PDPN | NM_001006624.1 | ACCATGTGTCTCCGTCTGACCATTCTTGTTATTGTTAAAATGCAGAG | 1040 |
| PDPN | NM_001006624.1 | GAGTCCTTGGATCCAGTGCTACGTCAGTAAATAGCACCAGCATTTT | 1041 |
| PERLD1 | NM_033419.3 | AGCAGAACTGCTCTGGGGGCGCTCTGAATCACTTCCGCTC | 1042 |
| PERLD1 | NM_033419.3 | CTGGACCTGTCGGGACGACTGTAAGTATGAGTGTATGTGGGTCAC | 1043 |
| PERLD1 | NM_033419.3 | GGAAGATGACAGCCTGTACCTGCTGAAGGAATCAGAGGACAAGTTC | 1044 |
| PERP | NM_022121.2 | GGGCTAAGGAGAAGAGGAAGATAAGGTTAAAAGTTGTTAATGACCAAACAT | 1045 |
| PERP | NM_022121.2 | CCTGAATCATTCATTTTAGCTAAGGCTTCATGTTGACTCGATATGTCAT | 1046 |
| PERP | NM_022121.2 | CCAGAGTAGACTGGATTGAAAGATGGACTGGGTCTAATTTATCATGACTG | 1047 |
| PFKP | NM_002627.3 | ATCTCCACCAGAGGAAGGCTGGGAGGAGCAGATGTGTGTCAAAC | 1048 |
| PFKP | NM_002627.3 | TTGTCGTCACGCAGCTGGGCTATGACACACGTGTGACCAT | 1049 |
| PFKP | NM_002627.3 | GAAACTTTGGAACCAAAATCTCTGCCAGAGCTATGGAGTGGATCACT | 1050 |
| PGK1 | NM_000291.2 | GCAGTGGAGAGATGGGACAATTAGATAAATGTCCATTCTTTATCAAGG | 1051 |
| PGK1 | NM_000291.2 | TCCCATTCAAGATTCCCACTCCCCAGAGGTGACCACTTTCAACT | 1052 |
| PGK1 | NM_000291.2 | TCATACCATGGAGGAAGGCTCTGTTCCACATATATTTCCACTTCTTC | 1053 |
| PGR | NM_000926.2 | GCAGCAGGAGAAACTTGAAAGCATTCACTTTTATGGAACTCATAAGG | 1054 |
| PGR | NM_000926.2 | TGAGGTTCCATCCCAAAGAACCTGCTATTGAGAGTAGCATTCAGAA | 1055 |
| PGR | NM_000926.2 | GGCGTTGTTAGAAAGCTGTCTGGCCAGTCCACAGCTGTCACTAAT | 1056 |
| PIK3CA | NM_006218.2 | GTGGGGCATCCACTTGATGCCCCCAAGAATCCTAGTAGAATGTT | 1057 |
| PIK3CA | NM_006218.2 | TTTAGAATGCCTCCGTGAGGCTACATTAATAACCATAAAGCATGAAC | 1058 |
| PIK3CA | NM_006218.2 | CTTTGTGACCTTCGGCTTTTTCAACCCTTTTTAAAAGTAATTGAACC | 1059 |
| PIK3R1 | NM_181504.2 | CCAAGAGCGGTACAGCAAAGAATACATAGAAAAGTTTAAACGTGAAGG | 1060 |
| PIK3R1 | NM_181504.2 | GACTTGAAGAAGCAGGCAGCTGAGTATCGAGAAATTGACAAACGTAT | 1061 |
| PIK3R1 | NM_181504.2 | GCCACAACCACATACAACACAAAGAGAAAAAGAAATGCAAAAATCTCT | 1062 |
| PKMYT1 | NM_004203.3 | GAGTGAAGTCAGCCGCGGCCCTGCCTGGGAGGAACTTAC | 1063 |
| PKMYT1 | NM_004203.3 | CCTACTTCCGCCACGCAGAACCTGGATTCTCCCTCAAGAG | 1064 |
| PKMYT1 | NM_004203.3 | GTGTCATTCCGGGGCGAGGCCTCAGAGACTCTGCAGAGC | 1065 |
| PLA2R1 | NM_007366.3 | GGAAATGGGTTTCAAACCATGGCCTCTTTAACATAGGAGGCAGTG | 1066 |
| PLA2R1 | NM_007366.3 | CTGAATTTCTCCGCCCCAGAGCAGCCATTAAGCTTATATGAATG | 1067 |
| PLA2R1 | NM_007366.3 | AGTGGTGGCCTCACGGAAGTATATTCATAAGTGGATTTCTTATGGGT | 1068 |
| PLAT | NM_000931.2 | TAAGGAGGCCGGAGCTGTGGGGAGCTCAGAGCTGAGATCCTAC | 1069 |
| PLAT | NM_000931.2 | TGGTGCTACGTCTTTAAGGCGGGGAAGTACAGCTCAGAGTTCTGC | 1070 |
| PLAT | NM_000931.2 | TATTCGGAGCGGCTGAAGGAGGCTCATGTCAGACTGTACCCATC | 1071 |
| PLAU | NM_002658.2 | AATGGAGGAACATGTGTGTCCAACAAGTACTTCTCCAACATTCACTG | 1072 |
| PLAU | NM_002658.2 | AAGAAATTCGGAGGGCAGCACTGTGAAATAGATAAGTCAAAAACCTG | 1073 |
| PLAU | NM_002658.2 | GGGAGATGAAGTTTGAGGTGGAAAACCTCATCCTACACAAGGACTAC | 1074 |
| PLAUR | NM_001005377.1 | CTGGTGGAGAAAAGCTGTACCCACTCAGAGAAGACCAACAGGAC | 1075 |
| PLAUR | NM_001005377.1 | CACCAGCCTTACCGAGGTTGTGTGTGGGTTAGACTTGTGCAAC | 1076 |
| PLAUR | NM_001005377.1 | CTCGAATGCATTTCCTGTGGCTCATCAGACATGAGCTGTGAGAG | 1077 |
| PLK1 | NM_005030.3 | CAAACCACCTTTTGAGACTTCTTGCCTAAAAGAGACCTACCTCCGGAT | 1078 |
| PLK1 | NM_005030.3 | TGCCAGTACCTGCACCGAAACCGAGTTATTCATCGAGACCTCAA | 1079 |
| PLK1 | NM_005030.3 | GCTCTTCAATGACTCAACACGCCTCATCCTCTACAATGATGGTGAC | 1080 |
| PMS1 | NM_000534.3 | CGCTAGCAGGAAGCTGCTCTGTTAAAAGCGAAAATGAAACAATT | 1081 |
| PMS1 | NM_000534.3 | GGGTATCAAGGCTGTUGATGCACCTGTAATGGCAATGAAGTACTACA | 1082 |
| PMS1 | NM_000534.3 | AATTACAACAAGAACGGCTGCTGATAATTTTAGCACCCAGTATGTTTT | 1083 |
| PMS2 | NM_000535.3 | GCCAAAATGGTCCAGGTCTTACATGCATACTGTATCATTTCAGCAG | 1084 |
| PMS2 | NM_000535.3 | CCTGTGGTATGCACAGGTGGAAGCCCCAGCATAAAGGAAAATA | 1085 |
| PMS2 | NM_000535.3 | CTCCAGATAAAAGGCAAATTTTGCTACAAGAGGAAAAGCTTTTGTT | 1086 |
| POLQ | NM_199420.2 | TGCAGGAGAATGCAAGCCTACAGTTCCTGACTACGAAATAGACAAG | 1087 |
| POLQ | NM_199420.2 | TGGGGACTTCCTAAAGCAGTTCTGGAAAAATACCACAGTTTTGGTGTA | 1088 |
| POLQ | NM_199420.2 | AATGGTCTGATCAATCGCCTCATAGAGGAAAATAAGATGGATCTGTT | 1089 |
| PPAPDC1B | NM_032483.2 | GCTGCTTCCCTGATGGGCTAGCCCATTCTGACTTGATGTGTACA | 1090 |
| PPAPDC1B | NM_032483.2 | GCGTCCTTCTACCTGGCAGGGAAGTTACACTGCTTCACACCAC | 1091 |
| PPAPDC1B | NM_032483.2 | AAATGGTGAAAATGGGCAGATGAATAGCAATAAGTGGACCTTTGTTA | 1092 |
| PPARBP | NM_004774.2 | TGAGTTCTCTCCTGGAACGGCTCCATGCAAAATTTAACCAAAATAG | 1093 |
| PPARBP | NM_004774.2 | GCAACTAATGCTGGTCCCTTGGATAAGATTCTTCATGGAAGTGTTG | 1094 |
| PPARBP | NM_004774.2 | TTCTTCTTGAAATTTCCCCAGCCAATCCCAGTATCTAGAGCATTTGT | 1095 |
| PPP1CC | NM_002710.1 | AATTCTCTGTTCCTTTTGCAAACAATTTTAATGATGGTGTTAAAGCTGT | 1096 |
| PPP1CC | NM_002710.1 | AGAGCCCTAGGGTGCTCTGAATCTGTACATGTTCTTGTCATAAAATGC | 1097 |
| PPP1CC | NM_002710.1 | TAAAGCACACTTTTCCCCGACCGTATACTTAAAATGACAAAGCCATT | 1098 |
| PPP2R1A | NM_014225.3 | TGCCAAGGTGCTGGAGCTGGACAACGTCAAGAGTGAGATCAT | 1099 |
| PPP2R1A | NM_014225.3 | ACCAAGACAGACCTGGTCCCTGCCTTCCAGAACCTGATGAAAGAC | 1100 |
| PPP2R1A | NM_014225.3 | CCTCTCAGCTGACTGTCGGGAGAATGTGATCATGTCCCAGATCT | 1101 |
| PPP4C | NM_002720.1 | AAACGTTCCTCCTGCTGCTGGCACTTAAGGTTCGCTATCCTGAT | 1102 |
| PPP4C | NM_002720.1 | GAGAGTCGCCAGATCACGCAGGTCTATGGCTTCTACGATGAGT | 1103 |
| PPP4C | NM_002720.1 | GTGGCCCAGTTCAACGCAGCCAATGACATTGACATGATCTG | 1104 |
| PRAME | NM_206954.1 | GTTCCTCAAGGAAGGTGCCTGTGATGAATTGTTCTCCTACCTCATT | 1105 |
| PRAME | NM_206954.1 | ATCCTGAAAATGGTGCAGCTGGACTCTATTGAAGATTTGGAAGTGA | 1106 |
| PRAME | NM_206954.1 | GCGAAATTTTCTCCTTACCTGGGCCAGATGATTAATCTGCGTAGACT | 1107 |
| PRC1 | NM_003981.2 | TTGCTGAAGAGGAAAGCCTGAAGGAAAGACTCATCAAAAGCATATCC | 1108 |
| PRC1 | NM_003981.2 | TATTGACAGTGCCTCAGTGCCCAGCTTAGAAGAGCTGAACCAGTT | 1109 |
| PRC1 | NM_003981.2 | GAAGCAGTGTGTGAGGGGCTGCGTACTCAAATCCGAGAGCTCT | 1110 |
| PRDX4 | NM_006406.1 | GGGAAGGAACAGCTGTGATCGATGGAGAATTTAAGGAGCTGAAGTTAA | 1111 |
| PRDX4 | NM_006406.1 | GAAGACAAGGAGGACTTGGGCCAATAAGGATTCCACTTCTTTCAGA | 1112 |
| PRDX4 | NM_006406.1 | CAGATCCAGCTGGAAAGCTGAAGTATTTCGATAAACTGAATTGAGAA | 1113 |
| PRKDC | NM_006904.6 | TGAGCTCCTAGGATTATTGGGTGAAGTTCATCCTAGTGAGATGATAAATAA | 1114 |
| PRKDC | NM_006904.6 | CATGCATCTCAGTTTAGCACCTGCCTTCTGGACAACTACGTGTCTCT | 1115 |
| PRKDC | NM_006904.6 | CTTGTTAAAGTGGTGTGCCCACACAAATGTAGAATTGAAAAAAGCTG | 1116 |
| PRPSAP1 | NM_002766.1 | TGTTTCCTTGCAAGGGAGGACTCGAAACAGCCTGGAGTTAGATATC | 1117 |
| PRPSAP1 | NM_002766.1 | TGATGGGGAGGAGGGATTAAAAGAGTCAGGAAGAAGACAGAGCTAAT | 1118 |
| PRPSAP1 | NM_002766.1 | ACATGTCTGCTGTCATCAGCCCTGTTCCTTAAAAGTTCTAGCTGCT | 1119 |
| PSMC2 | NM_002803.2 | AAGACACCACCGGAAGCAAGGAAGGTGCTGTGTAATCATTAAGG | 1120 |
| PSMC2 | NM_002803.2 | CCCTGAAGGCTTTCAAGTGAAAACTTTAAATTGGAATCCTAACCTTAT | 1121 |
| PSMC2 | NM_002803.2 | GGCGAAAAATTGCTACCGAGAAGGATTTCTTGGAAGCTGTAAATAAG | 1122 |
| PSMD2 | NM_002808.3 | GCCTCTCAAATTTCTGCGTCCACACTATGGCAAACTGAAGGAAAT | 1123 |
| PSMD2 | NM_002808.3 | TGTGTGAATTACGTGCCTGAGCCTGAGAACTCAGCCCTACTGC | 1124 |
| PSMD2 | NM_002808.3 | AGATTGGCATTGATGCTCAATGACATGGAGTTGGTAGAAGACATCTT | 1125 |
| PSMD7 | NM_002811.3 | CGTGTTGTTGGTGTGCTTTTGGGGTCATGGCAAAAGAAAGTACTT | 1126 |
| PSMD7 | NM_002811.3 | CCTTTTGATGAAGATGACAAAGACGATTCTGTATGGTTTTTAGACCATG | 1127 |
| PSMD7 | NM_002811.3 | AAGCCGAAGGACCTAGGGCTGCCTACAGAAGCGTACATTTCAGTG | 1128 |
| PTDSS1 | NM_014754.1 | CATGTGATCACCTGGGAGAGGATTATCAGCCACTTTGATATTTTTG | 1129 |
| PTDSS1 | NM_014754.1 | GGCCTTGCTGATCCGTAGTTACGGTCTCTGCTGGACAATCAGTATT | 1130 |
| PTDSS1 | NM_014754.1 | CGATGGTTTGACCCCAAATCTTCTTTTCAGAGAGTAGCTGGAGTGTA | 1131 |
| PTEN | NM_000314.3 | GCTCCCAGACATGACAGCCATCATCAAAGAGATCGTTAGCAGAA | 1132 |
| PTEN | NM_000314.3 | GGATGGATTCGACTTAGACTTGACCTATATTTATCCAAACATTATTGCTATG | 1133 |
| PTEN | NM_000314.3 | CCTGCAGAAAGACTTGAAGGCGTATACAGGAACAATATTGATGATGT | 1134 |
| PTGS2 | NM_000963.1 | TGTGAATAACATTCCCTTCCTTCGAAATGCAATTATGAGTTATGTCTTG | 1135 |
| PTGS2 | NM_000963.1 | TCACATTTGATTGACAGTCCACCAACTTACAATGCTGACTATGGCTAC | 1136 |
| PTGS2 | NM_000963.1 | CATTCTTTGCCCAGCACTTCACGCATCAGTTTTTCAAGACAGAT | 1137 |
| PTN | NM_002825.5 | GGAAAATCCAAAGTGGAGAGAGGGGAAGAAAGAGACCAGTGAGTCATC | 1138 |
| PTN | NM_002825.5 | CTGGAGCTGAGTGCAAGCAAACCATGAAGACCCAGAGATGTAAGA | 1139 |
| PTN | NM_002825.5 | GAAAAAGGAAGGCAAGAAACAGGAGAAGATGCTGGATTAAAAGATGTC | 1140 |
| PTP4A2 | NM_080392.1 | CAGTCCCCAGCTCGCCAGCGTTTTTCGTGGAATATACGTT | 1141 |
| PTP4A2 | NM_080392.1 | CTCCAGTTGAAAAAGAAGGAATCCACGTTCTAAAAAAGAAGGGGAGC | 1142 |
| PTP4A2 | NM_080392.1 | CAGTAGAAGGAAATGTAAACGAAGGCTGACTTGATTGTGCCATTTAGAG | 1143 |
| RAB31 | NM_006868.2 | AATCCATAGGTGCCATCGTGGTTGAGACAAGTGCAAAAAATGCTA | 1144 |
| RAB31 | NM_006868 2 | GGACCCCCATGAAAATGGAAACAATGGAACAATCAAAGTTGAGAA | 1145 |
| RAB31 | NM_006868.2 | TGTGCTACCTATCCCAAATTCCCAGTAACTACTTCAGTGTCATTGCCT | 1146 |
| RAB6B | NM_016577.2 | CATTGAGACCAGTGCGAAGACTGGCTACAACGTGAAGCAGCTTTT | 1147 |
| RAB6B | NM_016577.2 | TTGGTTGAACACATCAGCCTCTGAAAAGGTAGCTCTGACTCTTGTCT | 1148 |
| RAB6B | NM_016577.2 | AAAAGCCTTGAAGGGGGTTGAGGGTACAGGCAACCTTGTGTTCT | 1149 |
| RAB7 | NM_004637.5 | CGGGAAGACATCACTCATGAACCAGTATGTGAATAAGAAATTCAGCAA | 1150 |
| RAB7 | NM_004637.5 | ACAGGCCTGGTGCTACAGCAAAAACAACATTCCCTACTTTGAGAC | 1151 |
| RAB7 | NM_004637.5 | AAACGGAGGTGGAGCTGTACAACGAATTTCCTGAACCTATCAAACTG | 1152 |
| RAC1 | NM_198829.1 | CACTGAACTTGCAAGACCTTCGTCTTTGAGAAGACGGTAGCTTCT | 1153 |
| RAC1 | NM_198829.1 | AGCACGTGTTCCCGACATAACATTGTACTGTAATGGAGTGAGCGTAG | 1154 |
| RAC1 | NM_198829.1 | GCTCTTTGGATCAGTCTTTGTGATTTCATAGCGAGTTTTCTGACCAG | 1155 |
| RACGAP1 | NM_013277.2 | TGGACTAAATAATACATGGGGGGAAATAAACAAGTATTCATGAGGGTGA | 1156 |
| RACGAP1 | NM_013277.2 | TGGCGAAGGACTTTGAGGATTTCCGTAAAAAGTGGCAGAGGACTG | 1157 |
| RACGAP1 | NM_013277.2 | TGTTCCATGTGGAAAGCGGATAAAA1TTGGCAAATTATCTCTGAAGT | 1158 |
| RAD21 | NM_006265.1 | GGGATAAGAAGCTAACCAAAGCCCATGTGTTCGAGTGTAATTTAGAGAG | 1159 |
| RAD21 | NM_006265.1 | GAGGAAAATCGGGAAGCAGCTTATAATGCCATTACTTTACCTGAAG | 1160 |
| RAD21 | NM_006265.1 | TGATTTTGGAATGGATGATCGTGAGATAATGAGAGAAGGCAGTGCTT | 1161 |
| RAN | NM_006325.2 | AGCAAGTGAACTCATCCCTTGTTTATAAATAGCATTTGGAAACCACTA | 1162 |
| RAN | NM_006325.2 | TTTTGTACATTTGAGCCATGTCACACAAACTGATGATGACAGGTCAG | 1163 |
| RAN | NM_006325.2 | CACCTAGGGAAGCACTTGCTCAAAATCTGTGACCTGTCAGAATAAAA | 1164 |
| RAP1GDS1 | NM_021159.3 | GCAGTTGACCAAGCAGGTGGTGCACAGATTGTAATTGACCATTTAA | 1165 |
| RAP1GDS1 | NM_021159.3 | TCGCTTCAAGCTCAGCTTATCAATATGGGTGTTATTCCTACCTTAGT | 1166 |
| RAP1GDS1 | NM_021159.3 | GCTGGTTGAAGCAGGCCTAGTAGAGTGTCTACTAGAGATTGTTCAGCA | 1167 |
| RARA | NM_001024809.2 | CATGCCGCCTCTCATCCAGGAAATGTTGGAGAACTCAGAGG | 1168 |
| RARA | NM_001024809.2 | TGTTCATCAAGACACCCCTCTGCCCAGCTCACCACATCTTCATC | 1169 |
| RARA | NM_001024809.2 | CTTCCCCTGGAGCCCGTGGGTGCACCTGTTACTGTTGG | 1170 |
| RARRES3 | NM_004585.2 | GCGAAGGAGATGGTTGGTCAGAAGATGAAGTACAGTATTGTGAGCAG | 1171 |
| RARRES3 | NM_004585.2 | AAAAGCAACAGCCTGAAGCAGCCACAAAATCCTGTGTTAGAAGCA | 1172 |
| RARRES3 | NM_004585.2 | TCTCTCGCTGGCAAAAGTATGATCTAATTGAAACAAGACTGAAGGATC | 1173 |
| RB1 | NM_000321.1 | CGGTTTTTCTCAGGGGACGTTGAAATTATTTTTGTAACGGGAGTC | 1174 |
| RB1 | NM_000321.1 | TGAGTTTGAAGAAACAGAAGAACCTGATTTTACTGCATTATGTCAGAAATT | 1175 |
| RB1 | NM_000321.1 | AAGAAAAAGGAACTGTGGGGAATCTGTATCTTTATTGCACGAGTTGAC | 1176 |
| RBP3 | NM_002900.2 | CCCCTGGGTCCCCATGATGAGAGAATGGGTTCTGCTCAT | 1177 |
| RBP3 | NM_002900.2 | CCTGAACGATCCTCGCCTGGTCATCTCCTATGAGCCCAG | 1178 |
| RBP3 | NM_002900.2 | CTACCTGCACCCAGGGAACACCATCCTGCACGTGGACACTA | 1179 |
| RBP7 | NM_052960.1 | CACGAACAGCAGCCTAAGGAACTACTTTGTGAAATTTAAAGTTGGAG | 1180 |
| RBP7 | NM_052960.1 | TGGCTGCAGCTTTATGCCAAATTATATTGCAGACTGAACAGACGT | 1181 |
| RBP7 | NM_052960.1 | AGCCACACAGCGTGTAACCTGAAGTCATCTAGATTATGGGGAAACT | 1182 |
| RERG | NM_032918.1 | ACCAAGCAACCATCGATGATGAAGTTGTTTCCATGGAGATACTAGA | 1183 |
| RERG | NM_032918.1 | CGAGGAAGTTTTGAGGAAGTGCTGCCACTTAAGAACATCCTAGATGA | 1184 |
| RERG | NM_032918.1 | GACTTGGACCACTCCAGGCAGGTTAGCACAGAAGAAGGAGAGAA | 1185 |
| RFC4 | NM_181573.1 | AGTTGCTTTCCAGGAAGAAGTGGTTGCAGTGCTGAAAAAATCTTTAG | 1186 |
| RFC4 | NM_181573.1 | CTCTTGTTTTACGGACCACCTGGAACTGGAAAAACATCCACTATTTT | 1187 |
| RFC4 | NM_181573.1 | CCGTGTCCGCCTTTTAAGATTGTGATTCTGGATGAAGCAGATTCTAT | 1188 |
| RGS10 | NM_001005339.1 | TTAAAACACAAGCGAACCGAGGAAGAGGAAGAAGATTTGCCTGAT | 1189 |
| RGS10 | NM_001005339.1 | CCCAAAAAGCCGGGACTGGCAGCTTTAAGAAGCAAAGGAATT | 1190 |
| RGS10 | NM_001005339.1 | GCCGGGTTTATCATTGCTTTGTTATTTGTAAGGACTGAAATGTACAAA | 1191 |
| RHEB | NM_005614.2 | GTGGGAGGGTCATGACGCAGCGAGTTTCAGTCGTGACTTTTCT | 1192 |
| RHEB | NM_005614.2 | ACTGCTGTGGATGTTTTTCGAAGGATAATTTTGGAGGCAGAAAA | 1193 |
| RHEB | NM_005614.2 | TGATTCTGCTGCAAAGCCTGAGGACACTGGGAATATATTCTACCTGA | 1194 |
| RHOB | NM_004040.2 | CCACCGCAGTCTGGTTGGAGCTGTTGTCTTGTATGCTCAGC | 1195 |
| RHOB | NM_004040.2 | GCTCCCAGAACGGCTGCATCAACTGCTGCAAGGTGCTAT | 1196 |
| RHOB | NM_004040.2 | ACTGAGTGCCAAGGGTCCCCTGAGCATGCTTTTCTGAAGAG | 1197 |
| RHOJ | NM_020663.2 | AAAAAGCCCAGCTTTCCTCCATGTTAGATGTGACTTGGAAAATGAG | 1198 |
| RHOJ | NM_020663.2 | GATCGGAGCACAGTGCTACTTGGAATGTTCAGCTCTGACTCAGAAA | 1199 |
| RHOJ | NM_020663.2 | AATCCTCACCATITTCCACCCCAAGAAAAAGAAGAAACGCTGTTC | 1200 |
| RIS1 | NM_015444.1 | CTCGGGGTGCCCTCCAATGCTTCAGTCAACGCGTCCT | 1201 |
| RIS1 | NM_015444.1 | CGGGGCTTCCAGTGCGACCTACTGCTCTTCTCCACCAAC | 1202 |
| RIS1 | NM_015444.1 | GTGGCCTGCTTCATGACCCTGGTCATCGTGGTGTGGAGC | 1203 |
| RNF11 | NM_014372.3 | ACCCAACACCTAGCCAGACTCGGCTAGCAACTCAGCTGACTGAAG | 1204 |
| RNF11 | NM_014372.3 | TCCTATGAGACTAATTGAGCCAGGGTCTCTTATCTGACTTCAAGTGAACC | 1205 |
| RNF11 | NM_014372.3 | AGCCCAAAGAGCCAGGGATTAGGAATTAAGATCGTGCACAAAAGT | 1206 |
| RNF2 | NM_007212.3 | TGTCTCAGGCTGTGCAGACAAACGGAACTCAACCATTAGCAAAAC | 1207 |
| RNF2 | NM_007212.3 | CAACGAACACCTCAGGAGGCAATAACAGATGGCTTAGAAATTGTG | 1208 |
| RNF2 | NM_007212.3 | GTGCAGACTGCATCATCACAGCCCTTAGAAGTGGCAACAAAGAAT | 1209 |
| RPRM | NM_019845.2 | GCGAAGCAAACCTGTCGGAGTCAATTA1TTCTCTCGACTTCG | 1210 |
| RPRM | NM_019845.2 | GCAGTCGGAGGAGAGCGCCCAGACTCTGAACTCAGCAGAAA | 1211 |
| RPRM | NM_019845.2 | CGATTAGGGCGCAGAACTTTGGAAGCTGCTACTTACTTGGAATG | 1212 |
| RUNX1T1 | NM_004349.2 | TGGCTTTGACAGAGAGCCTTTGCACTCAGAACATCCAAGCAAG | 1213 |
| RUNX1T1 | NM_004349.2 | CCAGGCCAGCGGTACAGTCCAAATAACGGCTTATCCTACCAG | 1214 |
| RUNX1T1 | NM_004349.2 | ATATGGCCATTGCCCACCACTACAGGGACTCCTATCGACAC | 1215 |
| RUNX3 | NM_001031680.1 | CCCGAGGCTCACTCAGCACCACAAGCCACTTCAGCAGC | 1216 |
| RUNX3 | NM_001031680.1 | CTGGAGGCGGGGACCCTAACAACCTTCAAGACCAGTGATG | 1217 |
| RUNX3 | NM_001031680.1 | CCAGATCCTGGCCGTCTCATCCCATACTTCTGTGGGGAATCAG | 1218 |
| S100A10 | NM_002966.1 | ATGCCATCTCAAATGGAACACGCCATGGAAACCATGATGTTTAC | 1219 |
| S100A10 | NM_002966.1 | TGAGCAGTTCGCTCCTCCCTGATAAGAGTTGTCCAAAGGGTC | 1220 |
| S100A10 | NM_002966.1 | TCTCATTTGACAAGCAGAGAAAGAAAAGTTAAATACCAGATAAGCTTTTGA | 1221 |
| S100A4 | NM_019554.1 | GACAGATGAAGCTGCTTTCCAGAAGCTGATGAGCAACTTGGACAG | 1222 |
| S100A4 | NM_019554.1 | TCCTGCATCGCCATGATGTGTAACGAATTCTTTGAAGGCTT | 1223 |
| S100A4 | NM_019554.1 | TCAGACACGTGCTTGATGCTGAGCAAGTTCAATAAAGATTCTTGGA | 1224 |
| SCGB3A1 | NM_052863.2 | GCATCCCCGTGAACCACCTCATAGAGGGCTCCCAGAAGTGT | 1225 |
| SCGB3A1 | NM_052863.2 | CTGAAGGCCCTGCTGGGGGCCCTGACAGTGTTTGGCT | 1226 |
| SCGB3A1 | NM_052863.2 | CCGAGACTGGAGCATCTACACCTGAGGACAAGACGCTGCC | 1227 |
| SCNN1G | NM_001039.2 | CCATGGCACCCGGAGAGAAGATCAAAGCCAAAATCAAGAAG | 1228 |
| SCNN1G | NM_001039.2 | CTCCCACCGGATTCCGCTGCTGATCTTTGATCAGGATGAGA | 1229 |
| SCNN1G | NM_001039.2 | AAGCGGAAAGTCGGCGGTAGCATCATTCACAAGGCTTCAAAT | 1230 |
| SCO2 | NM_005138.1 | AGAGCCTGGTTTGCCTCCAGTGCAGCCTGTCTTCATCACTGT | 1231 |
| SCO2 | NM_005138.1 | CGCTACGTCCAGGACTTCCACCCAAGACTGTTGGGTCTGACC | 1232 |
| SCO2 | NM_005138.1 | CCATCTACCTGCTCAACCCTGACGGCCTCTTCACGGATTACTAC | 1233 |
| SCUBE2 | NM_020974.1 | TGGAAATGAGCTCAATGGAGGCTGTGTCCATGACTGTTTGAATATT | 1234 |
| SCUBE2 | NM_020974.1 | CAACAATGGAGGCTGTGACCGCACCTGTAAGGATACTTCGACAG | 1235 |
| SCUBE2 | NM_020974.1 | TGTCACCACCATCAGGACAAGTGTAACCTTTAAGCTAAATGAAGGC | 1236 |
| SDC4 | NM_002999.2 | GCCTTTCTGAAGGCAAGACTGGGATTGGATCACTTCTTAAACTTCC | 1237 |
| SDC4 | NM_002999.2 | TGGGTACTTGTGATCACACTACGGGAATCTCTGTGGTATATACCTGGG | 1238 |
| SDC4 | NM_002999.2 | GGGAGGATGGGGAAAAGAGCTGAGAGTTTATGCTGAAATGGATTT | 1239 |
| SDF2 | NM_006923.2 | GTGCTTTTGGTGAGGAAGGTGAAGGTGATTATCTGGATGACTGGAC | 1240 |
| SDF2 | NM_006923.2 | GAGAGATGGTGAGGTGCGGTTCAAACACTCTTCCACTGAGGTACT | 1241 |
| SDF2 | NM_006923.2 | GTCACTCTCCCAGACTTGCGTGGGTCAGTTCTTTCTGAGTAGAGGAC | 1242 |
| SELENBP1 | NM_003944.2 | GAAACACAGGCACTGAGGCCCCAGATTATCTGGCCACTGTG | 1243 |
| SELENBP1 | NM_003944.2 | TGACTTCTGGTACCAGCCTCGACACAATGTCATGATCAGCACTG | 1244 |
| SELENBP1 | NM_003944.2 | ATCCTGCTCTCCCTGGACGACCGCTTCCTCTACTTCAGCAACT | 1245 |
| SEMA3F | NM_004186.2 | CCACTTCTTCAACTTCCTGCTCAACACAACCGACTACCGAATCTT | 1246 |
| SEMA3F | NM_004186.2 | GCTCATTCCTGACAGTGCGGAGCGCAATGATGATAAGCTTTACTTC | 1247 |
| SEMA3F | NM_004186.2 | CCGTGTGTGTCTACTCCATGGCTGATATTCGCATGGTCTTTCAAC | 1248 |
| SERPINA3 | NM_001085.4 | AACGTGGACTTCGCTTTCAGCCTGTACAAGCAGTTAGTCCTGAAG | 1249 |
| SERPINA3 | NM_001085.4 | CTGACTTTCAGGACTCAGCTGCAGCTAAGAAGCTCATCAACGACTAC | 1250 |
| SERPINA3 | NM_001085.4 | TCAAGGACCTTGACTCGCAGACAATGATGGTCCTGGTGAATTAC | 1251 |
| SERPINB1 | NM_030666.2 | GCTTCGGGCATGGTTGATAACATGACCAAACTTGTGCTAGTAAATG | 1252 |
| SERPINB1 | NM_030666.2 | GTCAGCTTGCCCAGGTTCAAACTGGAAGAGAGTTACACTCTCAACTC | 1253 |
| SERPINB1 | NM_030666.2 | CAAGGCTGATCTGTCTGGCATGTCAGGAGCCAGAGATATTTTTATAT | 1254 |
| SERPINB2 | NM_002575.1 | GGAGGATCTTTGTGTGGCAAACACACTCTTTGCCCTCAATTTATTC | 1255 |
| SERPINB2 | NM_002575.1 | AGTGGGAGCCAATGCAGTTACCCCCATGACTCCAGAGAACTTTAC | 1256 |
| SERPINB2 | NM_002575.1 | CAGCGCACACCTGTACAGATGATGTACTTGCGTGAAAAGCTAAAC | 1257 |
| SERPINE1 | NM_000602.1 | CGGAGCACGGTCAAGCAAGTGGACTTTTCAGAGGTGGAGAGAG | 1258 |
| SERPINE1 | NM_000602.1 | AGTTCACCACGCCCGATGGCCATTACTACGACATCCTGGAAC | 1259 |
| SERPINE1 | NM_000602.1 | TGAAAAAGAGGTGCCTCTCTCTGCCCTCACCAACATTCTGAGTGC | 1260 |
| SERPINF1 | NM_002615.4 | GCGAACAGAATCCATCATTCACCGGGCTCTCTACTATGACTTGATCA | 1261 |
| SERPINF1 | NM_002615.4 | GCATAAAATCCAGCTTTGTGGCACCTCTGGAAAAGTCATATGGGAC | 1262 |
| SERPINF1 | NM_002615.4 | CCAGAAAGACTTCCCTCGAGGATTTCTACTTGGATGAAGAGAGGAC | 1263 |
| SFRP1 | NM_003012.3 | GTTCTTCGGCTTCTACTGGCCCGAGATGCTTAAGTGTGACAAGTTC | 1264 |
| SFRP1 | NM_003012.3 | TGTGACAACGAGTTGAAATCTGAGGCCATCA1TGAACATCTCTGTGC | 1265 |
| SFRP1 | NM_003012.3 | GGCCCATCAAGAAGAAGGACCTGAAGAAGCTTGTGCTGTACCT | 1266 |
| SIP1 | NM_003616.2 | CAGGAATACCTGAGGCGGGTCCAGATCGAAGCAGCTCAATGT | 1267 |
| SIP1 | NM_003616.2 | GCTCAAATTGACCCAAAGAAGTTGAAAAGGAAGCAAAGTGTGAATATT | 1268 |
| SIP1 | NM_003616.2 | ATTGGCTTGTCTTGAAAAGCCTTTGTTACCTGAGGCTCATTCACT | 1269 |
| SIPA1 | NM_006747.2 | TTCCCACCAGTGCTTGAGCCTCGATGGTTTGCCCACTATGA | 1270 |
| SIPA1 | NM_006747.2 | AGGTCTCAGGGGATGGGGAGCCACTCAGAGGCCAGCTCT | 1271 |
| SIPA1 | NM_006747.2 | CACGCAGACCTGGGTGCTGGCTACTACCGCAAATACTTCTATGG | 1272 |
| SLC14A1 | NM_015865.1 | GAGATAGCCATGGAGGACAGCCCCACTATGGTTAGAGTGGACAGC | 1273 |
| SLC14A1 | NM_015865.1 | GCTACAATGCCACCCTGGTGGGAGTACTCATGGCTGTCTTTTC | 1274 |
| SLC14A1 | NM_015865.1 | ACTCAGTCTTTCAGCCCCATTTGAGAACATCTACTTTGGACTCTGG | 1275 |
| SLC2A1 | NM_006516.1 | GCCGTGCTCATGGGCTTCTCGAAACTGGGCAAGTCCTTT | 1276 |
| SLC2A1 | NM_006516.1 | AACAAGGACCTGTGGCCCCTGCTGCTGAGCATCATCTTCAT | 1277 |
| SLC2A1 | NM_006516.1 | AGCTGACGTGACCCATGACCTGCAGGAGATGAAGGAAGAGAGTC | 1278 |
| SLC2A3 | NM_006931.1 | CCCTTTCAGGCTCCACCCTTTGCGGAGATTATAAATAGTCATGA | 1279 |
| SLC2A3 | NM_006931.1 | TTTGGATCCTTCCTGAGGACGTGGAGAAAACTTTCTGCTGAGAAG | 1280 |
| SLC2A3 | NM_006931.1 | TTGGCTGAAAAAGCTGTTTCTGGAATCACCCCTAGATCTTTCTTGA | 1281 |
| SLC35A1 | NM_006416.2 | GCTGGCGTCTACTTGTCAGATGGAGCTGAAATTAAGAAAAAGGATT | 1282 |
| SLC35A1 | NM_006416.2 | TGCAAGTGTTGGTGGCCTCTACACTTCTGTTGTGGTTAAGTACACAG | 1283 |
| SLC35A1 | NM_006416.2 | CCAACAAGGAGAAACAGCTTCAAAGGAGAGAGTTATTGGTGTGTGATT | 1284 |
| SLC39A6 | NM_012319.2 | TGTTGACTTGGCAATTTCCACACGGCAATATCATCTACAACAGCTTT | 1285 |
| SLC39A6 | NM_012319.2 | CAGACCACGAGCATCACTCTGACCATAATCATGCTGCTTCTGGTAA | 1286 |
| SLC39A6 | NM_012319.2 | ACAAATAGCCTGGGTTGGTGGTTTTATAGCCATTTCCATCATCAGT | 1287 |
| SLIT2 | NM_004787.1 | GAGGCGTGTGCCTGAGTGGGCTCTACTGCCTTGTTCCATATTA | 1288 |
| SLIT2 | NM_004787.1 | TTAGCACCATTGAAAGAGGAGCATTCCAGGATCTTAAAGAACTAGAGA | 1289 |
| SLIT2 | NM_004787.1 | CAATCCCAAGGAAAGCTTTCCGTGGGGCAGTTGACATAAAAAAT | 1290 |
| SMARCA4 | NM_003072.2 | AGGCCACTGTCTGCAGCTCCCGTGAAGATGTCCACTCCAGAC | 1291 |
| SMARCA4 | NM_003072.2 | CATGTCGGACGACCCGCGCTACAACCAGATGAAAGGAATG | 1292 |
| SMARCA4 | NM_003072.2 | ACCAGCTGCACCAGCTCAGAGCTCAGATCATGGCCTACAAGAT | 1293 |
| SNAI1 | NM_005985.2 | CAGGGTGGCAGAGCTGACCTCCCTGTCAGATGAGGACAGTG | 1294 |
| SNAI1 | NM_005985.2 | ACTTCTGGCCACATCAGCCCCACAGGACTTTGATGAAGACCAT | 1295 |
| SNAI1 | NM_005985.2 | ACAAGGAACCCTCAGGCCACCCTCCACGAGGTGTGACTAACTAT | 1296 |
| SNAI2 | NM_003068.3 | AGACCCCCATGCCATTGAAGCTGAAAAGTTTCAGTGCAATTTAT | 1297 |
| SNAI2 | NM_003068.3 | AATACCAGTGCAAAAACTGCTCCAAAACCTTCTCCAGAATGTCTCTC | 1298 |
| SNAI2 | NM_003068.3 | GCTGTGTAGCACACTGAGTGACGCAATCAATGTTTACTCGAACAGAA | 1299 |
| SNCG | NM_003087.1 | TAGAGGGCTACAGGCCAGCGTGGATGACCTGAAGAGCGCTC | 1300 |
| SNCG | NM_003087.1 | CAGCACAACCCTGCACACCCACCATGGATGTCTTCAAGAAG | 1301 |
| SNCG | NM_003087.1 | CCCCCAACAGGAGGGTGTGGCATCCAAAGAGAAAGAGGAAGT | 1302 |
| SPP1 | NM_000582.2 | CAGGACTCCATTGACTCGAACGACTCTGATGATGTAGATGACACTG | 1303 |
| SPP1 | NM_000582.2 | GACCAGAGTGCTGAAACCCACAGCCACAAGCAGTCCAGATTATATA | 1304 |
| SPP1 | NM_000582.2 | GCAATGAGCATTCCGATGTGATTGATAGTCAGGAACTTTCCAAAGT | 1305 |
| SQLE | NM_003129.3 | CAGCGAAACGGGAGGCCTCTAAATCTTTAGGTTGGGGCT | 1306 |
| SQLE | NM_003129.3 | ACTGCTTTCTACGCCCTATACAACTTGGCTTCACATACTTTTACACTAAC | 1307 |
| SQLE | NM_003129.3 | TTTTCTGGGCATTGCCACTTTCACCTATTTTTATAAGAAGTTCGGG | 1308 |
| SRGAP1 | NM_020762.1 | TTGAGACGGAATATTCCCGGAATCTAGAGAAGTTAGCAGAAAGGTTC | 1309 |
| SRGAP1 | NM_020762.1 | CTTGGCTACCATGCAAGTCTGAACAGAGCCCTAAGAACATATCTGTC | 1310 |
| SRGAP1 | NM_020762.1 | GAAACCTCCAGACATGAGGGCTTAGACATTATTGAGAATGCAGTTG | 1311 |
| STAT5A | NM_003152.2 | ATATTCACTGCTGTGGCAAGGCCTGTAGAGAGTTTCGAAGTTAGGA | 1312 |
| STAT5A | NM_003152.2 | TATGTGTTTCCTGACCGCCCCAAGGATGAGGTCTTCTCCAAGTA | 1313 |
| STAT5A | NM_003152.2 | CCTCTCATGAATGTTTGAATCCCACGCTTCTCTTTGGAAACAATATG | 1314 |
| STC2 | NM_003714.2 | GAGATGGAGATAACTTCCCCGGATTTAGCTTTTTTGTCTTTGTTTTTG | 1315 |
| STC2 | NM_003714.2 | AGGGCAGTTGCTCAGACCAAATACTGTATCTAGTGCTTCTGCTCCTA | 1316 |
| STC2 | NM_003714.2 | AATCTCACTGAATTCCAAACGGCGGAAAGAGGAAACTTTCCCAAC | 1317 |
| STK11 | NM_000455.4 | GTGGGCCTGAGGTCCCCGGAGGATGACCTAGCACTGAAA | 1318 |
| STK11 | NM_000455.4 | GAAGTTGACCCTGACCGGGCCGTCTCCCAGTTCTGAGGC | 1319 |
| STK11 | NM_000455.4 | AAATTTTGGAGAAGGGAAGTCGGAACACAAGGAAGGACCGCT | 1320 |
| STK25 | NM_006374.3 | TGAGATCGAGGACATCCAGCAGGAGATCACTGTCCTCAGTCAGT | 1321 |
| STK25 | NM_006374.3 | TCCTGAAGCACAAGTTCATCACACGCTACACCAAGAAGACCTCCTTC | 1322 |
| STK25 | NM_006374.3 | AGTCAGAGGGGCATGGCGAGGAGTCCAGCTCTGAGGACTCT | 1323 |
| STK3 | NM_006281.1 | ATGAGCTGGATTCCCACACCATGGTGAAGACTAGTGTGGGAGAGT | 1324 |
| STK3 | NM_006281.1 | GATGAGTGAAGGGGCCCAGACCATGATTGAACATAATAGCACGAT | 1325 |
| STK3 | NM_006281.1 | CATGCATGAACCCTTCCCTATGTCCAAAAACGTTTTTCCTGATAACT | 1326 |
| SUPT16H | NM_007192.2 | GGACCCGGAAGCGGAAAGGGCATCTTTGAGGTCGATACTT | 1327 |
| SUPT16H | NM_007192.2 | TCTGGACAAAGACGCTTATTATCGGCGAGTGAAGAGACTGTACAGCAA | 1328 |
| SUPT16H | NM_007192.2 | ACCATCGCTGTAAAGGAGGATGGGGAGCTCAACCTAATGAAGA | 1329 |
| SVIL | NM_003174.2 | CCCACAGTCTGGAGTCCAAAGCCGAAAGAATTGCAAGGTACAAAG | 1330 |
| SVIL | NM_003174.2 | CTGATGCTGTCGAGAAGCGGGGAGGAAAAAGTGACAAACAGG | 1331 |
| SVIL | NM_003174.2 | CTAAGCTTGGCCGAAAAGTTGGCCTTGTTTAACAAATTGTCCCAG | 1332 |
| TACC2 | NM_206861.1 | ACGGAGGAAGTCCACGGATTCCGTCCCCATCTCTAAGTCTACACT | 1333 |
| TACC2 | NM_206861.1 | ACGGGTTCCAGCAGTGCTTCTAGTACCCTTAAGCGAACTAAAAAAC | 1334 |
| TACC2 | NM_206861.1 | GTGAAGGAGACGCAACAGGAGCCAGATGAAGAGAGCCTTGTCC | 1335 |
| TACSTD1 | NM_002354.1 | TGTGAAAACTACAAGCTGGCCGTAAACTGCTTTGTGAATAATAATCG | 1336 |
| TACSTD1 | NM_002354.1 | GCCAAATGTTTGGTGATGAAGGCAGAAATGAATGGCTCAAAACTT | 1337 |
| TACSTD1 | NM_002354.1 | GTGTGAACACTGCTGGGGTCAGAAGAACAGACAAGGACACTGAA | 1338 |
| TACSTD2 | NM_002353.1 | TCCCTACCTGTCAGGACTGGTGTTAGGATGAGATAATGTTTGTGAAC | 1339 |
| TACSTD2 | NM_002353.1 | CGTGTGCTACTGTGAGAACTGGAACAAAGAAGAGAGGGAGTGAGAGA | 1340 |
| TACSTD2 | NM_002353.1 | ACAGTCGCGAGCCACACTTTGCAATGAAACTCTTTAGACTTTCTGC | 1341 |
| TAGLN | NM_001001522.1 | CTTCCTATGGCATGAGCCGCGAAGTGCAGTCCAAAATCGAG | 1342 |
| TAGLN | NM_001001522.1 | ATGGCGTGATTCTGAGCAAGCTGGTGAACAGCCTGTACCCTGAT | 1343 |
| TAGLN | NM_001001522.1 | TGGTTTATGAAGAAAGCGCAGGAGCATAAGAGGGAATTCACAGAGA | 1344 |
| TBPL1 | NM_004865.2 | TGTGATCTTCGTGGTGGAAAGCTAAATTTTAAAACCACCCCAAT | 1345 |
| TBPL1 | NM_004865.2 | AGGTTGTAAACGTTCTGGCAGTGTGTAACATGCCATTTGAAATCC | 1346 |
| TBPL1 | NM_004865.2 | CGAACCTGAACTTCATCCTGCTGTGTGCTATCGGATAAAATCTCTAAG | 1347 |
| TCF4 | NM_003199.1 | TCCTCCGATGTCCACTTTCCATCGTAGTGGTACAAACCATTACA | 1348 |
| TCF4 | NM_003199.1 | GGTCTAGAAATGGAGGACAGGCCTCATCGTCTCCTAATTATGAAGGAC | 1349 |
| TCF4 | NM_003199.1 | GCAAAGCCGAATTGAAGATCGTTTAGAAAGACTGGATGATGCTATT | 1350 |
| TCF8 | NM_030751.2 | GGAACACCAGATGCATTTTCACAATTACTCACCTGTCCATATTGTGAT | 1351 |
| TCF8 | NM_030751.2 | GTGAATGGGCGACCAAGAACAGGACTCAAGACATCTCAGTGTTCT | 1352 |
| TCF8 | NM_030751.2 | ACACGACCACAGATACGGCAAAAGATAGAGAATAAACCCCTTCAAG | 1353 |
| TDGF1 | NM_003212.1 | TGCCTTAAAATAATGAATACAATTTCCAAAATGGTCTCTAACATTTCCTTACA | 1354 |
| TDGF1 | NM_003212.1 | AAAGAAAGTCAGCCATATCTCCATTGTGCCTAAGTCCAGTGTTTCTTTT | 1355 |
| TDGF1 | NM_003212.1 | TTCTGGGGAAAACGAATTTCTCATTTTCTTCTTAAATTGCCATTTTC | 1356 |
| TEP1 | NM_007110.3 | CAAGTTGGAGGGCTCAGCATTTCTCTAAGGGACTAGACCTTTCAAC | 1357 |
| TEP1 | NM_007110.3 | GGATCTGGCCGTGAAGCTCACCTCTGGAGACTCTGAATCTCATC | 1358 |
| TEP1 | NM_007110.3 | GCTCTACTGAGCTTGCTGTGCTCTACTCTGGTCTCAGAAGTAAACATG | 1359 |
| TERT | NM_198254.1 | CCTTCACCACCAGCGTGCGCAGCTACCTGCCCAACAC | 1360 |
| TERT | NM_198254.1 | GTCTGGGATGCGAACGGGCCTGGAACCATAGCGTCAG | 1361 |
| TERT | NM_198254.1 | GCGTGGACCGAGTGACCGTGGTTTCTGTGTGGTGTCACCT | 1362 |
| TFAP2C | NM_003222.3 | GCCGAATATCAGCCGCCACCCTACTTTCCCCCTCCCTAC | 1363 |
| TFAP2C | NM_003222.3 | GACCAAGAACCCTCTGAACCTCCCCTGTCAGAAGGAGCTGGTG | 1364 |
| TFAP2C | NM_003222.3 | TCAGTCCCTGGAAGATTGTCGCTCCTCAGCTCTACGTCTAAATACA | 1365 |
| TFAP4 | NM_003223.1 | CCCTCTTTGCAACATTTCAGGAAAACAGAGAAAGAAGTGATAGGAGG | 1366 |
| TFAP4 | NM_003223.1 | AGCCATTCTCCAGCAGACAGCCGAGTACATCTTCTCCCTGGAG | 1367 |
| TFAP4 | NM_003223.1 | CACCATGGGCCCCTCCTCGGTCATCAACTCTGTTTCCACAT | 1368 |
| TFF1 | NM_003225.2 | CAGAGAGGAGGCAATGGCCACCATGGAGAACAAGGTGATCTG | 1369 |
| TFF1 | NM_003225.2 | TTGTGGTTTTCCTGGTGTCACGCCCTCCCAGTGTGCAAATAAG | 1370 |
| TFF1 | NM_003225.2 | GTTCGTGGGGTCCCCTGGTGCTTCTATCCTAATACCATCGACG | 1371 |
| TFF3 | NM_003226.2 | GACCTCTCCCCTTTGGGAGAGAAAAACTGTCTGGGAGCTTG | 1372 |
| TFF3 | NM_003226.2 | CTGCTTTGACTCCAGGATCCCTGGAGTGCCTTGGTGTTTCAAG | 1373 |
| TFF3 | NM_003226.2 | CCCTTTGCTCCCGGCAAGCGCTTCTGCTGAAAGTTCATATC | 1374 |
| TFPI | NM_006287.3 | CAGATACGGAGTTGCCACCACTGAAACTTATGCATTCATTTTGTG | 1375 |
| TFPI | NM_006287.3 | TGCTTTTTGGAAGAAGATCCTGGAATATGTCGAGGTTATATTACCAGG | 1376 |
| TFPI | NM_006287.3 | GTCCGAATGGTTTCCAGGTGGATAATTATGGAACCCAGCTCAAT | 1377 |
| TFRC | NM_003234.1 | TGGCTACTTGGGCTATTGTAAAGGGGTAGAACCAAAAACTGAGTGTGAG | 1378 |
| TFRC | NM_003234.1 | AATTCATATGTCCCTCGTGAGGCTGGATCTCAAAAAGATGAAAATCT | 1379 |
| TFRC | NM_003234.1 | AACTCAGCAAAGTCTGGCGTGATCAACATTTTGTTAAGATTCAGGT | 1380 |
| TGFA | NM_003236.1 | AGTTTGGCCAGGTGGACTGTGGCAGATCAATAAAGAAAGGCTTCT | 1381 |
| TGFA | NM_003236.1 | GCGGACCACGATTTCAAGACTTGTTAAAAAAGAACTGCAAAGAGAC | 1382 |
| TGFA | NM_003236.1 | TGCCTACTGGGGAAGAAAGTGAAGGAGGGGAAACTGTTTAATATCAC | 1383 |
| TGFB1 | NM_000660.3 | CCACAGATCCCCTATTCAAGACCACCCACCTTCTGGTACCAGATC | 1384 |
| TGFB1 | NM_000660.3 | CCGCGGGACTATCCACCTGCAAGACTATCGACATGGAGCTG | 1385 |
| TGFB1 | NM_000660.3 | CAAGTTCAAGCAGAGTACACACAGCATATATATGTTCTTCAACACATCAGAG | 1386 |
| TGFB3 | NM_003239.1 | GCTGAACTTTGCCACGGTCAGCCTCTCTCTGTCCACTTGCAC | 1387 |
| TGFB3 | NM_003239.1 | CAGGAAAACACCGAGTCGGAATACTATGCCAAAGAAATCCATAAAT | 1388 |
| TGFB3 | NM_003239.1 | GATGAGCACATTGCCAAACAGCGCTATATCGGTGGCAAGAATCT | 1389 |
| THBS1 | NM_003246.2 | GTCTGGCGGAGACAACAGCGTGTTTGACATCTTTGAACTCACC | 1390 |
| THBS1 | NM_003246.2 | CGTCCAAGGAAAGCAGCACGTGGTGTCTGTGGAAGAAGCTCTC | 1391 |
| THBS1 | NM_003246.2 | GCAGGAAGACAGGGCCCAGCTGTACATCGACTGTGAAAAGAT | 1392 |
| THBS4 | NM_003248.3 | TGATTTCCACCTTCAAGCTGCAGACTAAAAGTTCAGCCACCATCT | 1393 |
| THBS4 | NM_003248.3 | CCTGAAGAACGATGGGAAGGTGCATTTGGTGGTTTTCAACAAC | 1394 |
| THBS4 | NM_003248.3 | AGCAATTTGCAGCGAGGGGCCGGCTCCCTAGAGCTCTAC | 1395 |
| THRAP4 | NM_014815.2 | TGACTACCAATGGGCAATCAACATGAAGAAATTCTTTCCTAAAGGAG | 1396 |
| THRAP4 | NM_014815.2 | ATTGGACCATCCCCCAATCCTCTCATCTTGTCCTACCTGAAGTAT | 1397 |
| THRAP4 | NM_014815.2 | CCTGTGTGTCCAGGCATTGCTGGACATCATGGACATGTTTTGT | 1398 |
| THRSP | NM_003251.2 | CAGGCTGAGGCCCCTGATCTCTACACCTACTTCACCATGCTC | 1399 |
| THRSP | NM_003251.2 | TGAGCACCAATTCCTGGATTCCAGTCACTGGCTCACCTTTAGAAT | 1400 |
| THRSP | NM_003251.2 | GAGTGTAGGTGTTGGCACGTGACCAAAATTCACATCCCTCCTCAT | 1401 |
| TIMP1 | NM_003254.2 | CTTCTGCACTGATGGTGGGTGGATGAGTAATGCATCCAGGAAG | 1402 |
| TIMP1 | NM_003254.2 | AACCAGACCACCTTATACCAGCGTTATGAGATCAAGATGACCAAGAT | 1403 |
| TIMP1 | NM_003254.2 | TTCTCATTGCTGGAAAACTGCAGGATGGACTCTTGCACATCACTAC | 1404 |
| TIMP2 | NM_003255.4 | ACCCGCAACAGGCGTTTTGCAATGCAGATGTAGTGATCAGG | 1405 |
| TIMP2 | NM_003255.4 | CTGAGCACCACCCAGAAGAAGAGCCTGAACCACAGGTACCAGAT | 1406 |
| TIMP2 | NM_003255.4 | TGGTCCAGCTCTGACATCCCTTCCTGGAAACAGCATGAATAAAAC | 1407 |
| TIMP3 | NM_000362.4 | GGCTTGCCCCAGAGCTGATCCTTGTCTTTGTCCACTTCTCAG | 1408 |
| TIMP3 | NM_000362.4 | TAACCCAGCATCCTGAACCGTGTTTGTTGAATGAATACAGAACCC | 1409 |
| TIMP3 | NM_000362.4 | TCTGTGCCTGCTCTCTCCAGAGAAACTGGAGGGGTAGCAGTTAG | 1410 |
| TIMP4 | NM_003256.2 | CTCCTTCCAGGCTTCCCTCTGCATCTTACTGAGTATGCAGGTCG | 1411 |
| TIMP4 | NM_003256.2 | CGCCTTTTGACTCTTCCCTCTGTGGTGTGAAACTAGAAGCCAACAG | 1412 |
| TIMP4 | NM_003256.2 | TTGACTGGTCAGGTCCTCAGTGATGGAAAAGTCTTCATCCATCTGTG | 1413 |
| TK1 | NM_003258.1 | CTTACTGCGGGACGGCCTTGGAGAGTACTCGGGTTCGTGAAC | 1414 |
| TK1 | NM_003258.1 | AGTTGATGAGACGCGTCCGTCGCTTCCAGATTGCTCAGTACAAG | 1415 |
| TK1 | NM_003258.1 | AGTACCACTCCGTGTGTCGGCTCTGCTACTTCAAGAAGGCCT | 1416 |
| TLK1 | NM_012290.3 | GGAGCTAAAGCCTCAACAAATAACGAAAGCTCTAATCACAGTTTTGGA | 1417 |
| TLK1 | NM_012290.3 | GGCATTTATAAGACGCTGTTTGGCATATCGAAAAGAAGATCGATTTG | 1418 |
| TLK1 | NM_012290.3 | CCTACACCCCCTTCTTCAAGCATAATTACTrACTGACTTTCCTCCAA | 1419 |
| TMEM8 | NM_021259.1 | CTCACAGGCCCCGCAGAGGCTGTCCTTCTACAGCTGGTATG | 1420 |
| TMEM8 | NM_021259.1 | GCTTGGCTCCCACCTGTGCCTACGTCTTCCAGCCTGAACT | 1421 |
| TMEM8 | NM_021259.1 | CAGCCCCTTCTGCAGAGCAGCCAAAACCAGAGCTTCAATGC | 1422 |
| TMPRSS2 | NM_005656.2 | GGTCACCACCAGCTATTGGACCTTACTATGAAAACCATGGATACCA | 1423 |
| TMPRSS2 | NM_005656.2 | CGGACCAAACTTCATCCTTCAGATGTACTCATCTCAGAGGAAGTCCT | 1424 |
| TMPRSS2 | NM_005656.2 | AATAGTGGATGACAGCGGATCCACCAGCTTTATGAAACTGAACACA | 1425 |
| TNF | NM_000594.2 | GCCATCAGAGGGCCTGTACCTCATCTACTCCCAGGTCCTCTTC | 1426 |
| TNF | NM_000594.2 | TCGACTTTGCCGAGTCTGGGCAGGTCTACTTTGGGATCATTG | 1427 |
| TNF | NM_000594.2 | CCTCCTTCAGACACCCTCAACCTCTTCTGGCTCAAAAAGAGAATT | 1428 |
| TNFRSF10B | NM_147187.1 | GGAGGATTGCGTTGACGAGACTCTTATTTATTGTCACCAACCTGTG | 1429 |
| TNFRSF10B | NM_147187.1 | CTTTAAGGGCTGAAACCCACGGGCCTGAGAGACTATAAGAGCGTTC | 1430 |
| TNFRSF10B | NM_147187.1 | GCTGGGAGAGAGACTTGCCAAGCAGAAGATTGAGGACCACTTGTT | 1431 |
| TNFRSF10D | NM_003840.3 | GCACGCGCACAAACTACGGGGACGATTTCTGATTGATTTTTG | 1432 |
| TNFRSF10D | NM_003840.3 | GCTTGCCTCTCCCTATCACTTACCTTATCATCATAGTGGTTTTAGTCATCA | 1433 |
| TNFRSF10D | NM_003840.3 | TACTTGACCCATGCCCCAACAAACTCTACTATCCAATATGGGGC | 1434 |
| TNFSF10 | NM_003810.2 | TGATCTTCACAGTGCTCCTGCAGTCTCTCTGTGTGGCTGTAACTTAC | 1435 |
| TNFSF10 | NM_003810.2 | TCCCCTAGTGAGAGAAAGAGGTCCTCAGAGAGTAGCAGCTCACATAAC | 1436 |
| TNFSF10 | NM_003810.2 | TGGTGAACTGGTCATCCATGAAAAAGGGTTTTACTACATCTATTCCC | 1437 |
| TNFSF11 | NM_003701.2 | TCAGAAGATGGCACTCACTGCATTTATAGAATTTTGAGACTCCATGA | 1438 |
| TNFSF11 | NM_003701.2 | GCACCAAGTATTGGTCAGGGAATTCTGAATTCCATTTTATTCCATAA | 1439 |
| TNFSF11 | NM_003701.2 | GATGCAACATACTTTGGGGCTTTTAAAGTTCGAGATATAGATTGAGCC | 1440 |
| TNFSF13 | NM_172087.1 | GGAAACAGGAAGTCCTGCTTGCCAATTTCAGCACAGGGAGTAGT | 1441 |
| TNFSF13 | NM_172087.1 | GCAGCCCTGTCCTTCCTAGAGGGACTGGAACCTAATTCTCCTGAG | 1442 |
| TNFSF13 | NM_172087.1 | CACGACGGAGTGCCAGGAGCACTAACAGTACCCTTAGCTTGCT | 1443 |
| TNFSF15 | NM_005118.2 | TGTGAGACAAACTCCCACACAGCACTTTAAAAATCAGTTCCCAGCT | 1444 |
| TNFSF15 | NM_005118.2 | GGCCTTCACCAAGAACCGAATGAACTATACCAACAAATTCCTGCT | 1445 |
| TNFSF15 | NM_005118.2 | GGGACAAGCTAATGGTGAACGTCAGTGACATCTCTTTGGTGGATTA | 1446 |
| TOP1 | NM_003286.2 | AACACAAAGATCGAGAACACCGGCACAAAGAACACAAGAAGGAGAAG | 1447 |
| TOP1 | NM_003286.2 | GCTATCCTGAAGGCATCAAGTGGAAATTCCTAGAACATAAAGGTCCA | 1448 |
| TOP1 | NM_003286.2 | GTCATGAAGCTGAGCCCCAAAGCAGAGGAAGTAGCTACGTTCTTTG | 1449 |
| TOP2A | NM_001067.2 | CTCAAGCCCTTCAATGGAGAAGATTATACATGTATCACCTTTCAGCC | 1450 |
| TOP2A | NM_001067.2 | TGGCATTTTACAGCCTTCCTGAATTTGAAGAGTGGAAGAGTTCTACTC | 1451 |
| TOP2A | NM_001067.2 | TCTAGAACCCATGTTGAATGGCACCGAGAAGACACCTCCTCTCATAAC | 1452 |
| TP53 | NM_000546.2 | GTGCTCAAGACTGGCGCTAAAAGTTTTGAGCTTCTCAAAAGTCTAGA | 1453 |
| TP53 | NM_000546.2 | CTGGCCCCTGTCATCTTCTGTCCCTTCCCAGAAAACCTACCAG | 1454 |
| TP53 | NM_000546.2 | CCGAGTGGAAGGAAATTTGCGTGTGGAGTATTTGGATGACAGAA | 1455 |
| TRIM29 | NM_012101.2 | ACCTATCCTGAACCCCAGCAAGCCTGAAACAGCTCAGCCAAG | 1456 |
| TRIM29 | NM_012101.2 | AGTCCGGGGACGACAAGAACTNCAACTACTTCAGCATGGACTCTA | 1457 |
| TRIM29 | NM_012101.2 | ATCGGCAACAAGCAGAAGGCGGTCAAGTCCTGCCTGGTGT | 1458 |
| TRIP13 | NM_004237.2 | GGAAAAACATCCCTGTGTAAAGCGTTAGCCCAGAAATTGACAATTAG | 1459 |
| TRIP13 | NM_004237.2 | GGCAAGCTGGTAACCAAGATGTTTCAGAAGATTCAGGATTTGATTGAT | 1460 |
| TRIP13 | NM_004237.2 | CATTCCAATGTTGTGATTCTGACCACTTCTAACATCACCGAGAAGATC | 1461 |
| TSC1 | NM_000368.3 | GGGACGACGTGACAGCTGTCTTTAAAGAGAACCTCAATTCTGACC | 1462 |
| TSC1 | NM_000368.3 | GAGCCACATGACkAGCACCTCTTGGACAGGATTAACGAATATGTGG | 1463 |
| TSC1 | NM_000368.3 | TCAAGCACCTCTTTTGCCTTCTTTACTAAAATGTCTCAAGATGGACA | 1464 |
| TSC22D1 | NM_183422.1 | ACCTCATGCAGCTTGGCAGATATCTGAGAAATGGTTTAATTCATG | 1465 |
| TSC22D1 | NM_183422.1 | CCCCCAGGAGGAACTTGAAAGGAGGGTAAAAAGACTAAAATGAGG | 1466 |
| TSC22D1 | NM_183422.1 | GACAAAATGGTGACAGGTAGCTGGGACCTAGGCTATCTTACCATGAAG | 1467 |
| TSPAN1 | NM_005727.2 | CTGACGTTGCTGGTAGTGCCTGCCATCAAGAAAGATTATGGTTCC | 1468 |
| TSPAN1 | NM_005727.2 | TCAAGTGCTGTGGCTTCACCAACTATACGGATTTTGAGGACTCA | 1469 |
| TSPAN1 | NM_005727.2 | GCCATGATTGTGTCCATGTATCTGTACTGCAATCTACAATAAGTCCAC | 1470 |
| TSPAN13 | NM_014399.3 | GTGGTCATTGCAGTGGGCATCTTCTTGTTCCTGATTGCTTTAGT | 1471 |
| TSPAN13 | NM_014399.3 | ACAATACGGCAAGTGCTCGAAATGACATCCAGAGAAATCTAAACTG | 1472 |
| TSPAN13 | NM_014399.3 | TTTGAGATTTGTGGTGGCATTGGCCTGTTCTTCAGTTTTACAGAGA | 1473 |
| TSPAN5 | NM_005723.2 | GGGAAGCACTACAAGGGTCCTGAAGTCAGTTGTTGCATCAAATACT | 1474 |
| TSPAN5 | NM_005723.2 | TTTTCTTCCTGGAGCTCACTGCCGGAGTTCTAGCATTTGTTTTCA | 1475 |
| TSPAN5 | NM_005723.2 | TTTTGGAGCTGATGATTGGAACCTAAATATTTACTTCAATTGCACAGA | 1476 |
| TUBG1 | NM_001070.3 | TCCCCCAGGACAGGGACCCTCATCTGCCTTACTGGTTG | 1477 |
| TUBG1 | NM_001070.3 | AGATCAGGGACCTCACGCATCTCTTTCTCATATACATGGACTCTCTG | 1478 |
| TUBG1 | NM_001070.3 | TCTTCGAGAGAACCTGTCGCCAGTATGACAAGCTGCGTAAGC | 1479 |
| TWIST1 | NM_000474.3 | GGGCCGGAGACCTAGATGTCATTGTTTCCAGAGAAGGAGAAAATG | 1480 |
| TWIST1 | NM_000474.3 | ATTCAAAGAAACAGGGCGTGGGGCGCACTTTTAAAAGAGAAAGC | 1481 |
| TWIST1 | NM_000474.3 | TGAGGACCCATGGTAAAATGCAAATAGATCCGGTGTCTAAATGC | 1482 |
| UBE2T | NM_014176.1 | CCTCCTCAGATCCGATTTCTCACTCCAATTTATCATCCAAACATTGAT | 1483 |
| UBE2T | NM_014176.1 | CTTGGAGACCATCCCTCAACATCGCAACTGTGTTGACCTCTATTCAG | 1484 |
| UBE2T | NM_014176.1 | AGGGGACTTGTCCTGGTTCATCTTAGTTAATGTGTTCTTTGCCAAG | 1485 |
| UCKL1 | NM_017859.2 | AGTCAGAGCCTCCCCTGCTGCGTACAAGCAAGCGTACCATCTA | 1486 |
| UCKL1 | NM_017859.2 | TTCAACTTCGACCACCCAGATGCCTTTGACTTCGACCTCATCAT | 1487 |
| UCKL1 | NM_017859.2 | CTGTTGGAGCTCCTGGACATGAAGATCTTTGTGGACACAGACTC | 1488 |
| UHRF1 | NM_013282.2 | ACCAAGGTGGAGGAGCTGAGGCGGAAGATCCAGGAGCTGTT | 1489 |
| UHRF1 | NM_013282.2 | TCTTCGACTACGAGGTCCGCCTGAATGACACCATCCAGCTC | 1490 |
| UHRF1 | NM_013282.2 | AGGACCTGGAGGTGGGCCAGGTGGTCATGCTCAACTACAAC | 1491 |
| USP22 | XM_042698.6 | GGCCCTGCAAACAGCTCCCGATTAGGGGGTGCTTTTG | 1492 |
| USP22 | XM_042698.6 | CGGGAGCGGGCTCTGTACCAGACGGACTATACTGAGAGCCTA | 1493 |
| USP22 | XM_042698.6 | CACCTGGGCAGCTTCAAGGTGGACAACTGGAAGCAGAACCT | 1494 |
| VCAM1 | NM_080682.1 | CCCATTTGACAGGCTGGAGATAGACTTACTGAAAGGAGATCATCTCA | 1495 |
| VCAM1 | NM_080682.1 | GAGGATGCAGACAGGAAGTCCCTGGAAACCAAGAGTTTGGAAGTAAC | 1496 |
| VCAM1 | NM_080682.1 | GGAAAAGTTCTTGTTTGCCGAGCTAAATTACACATTGATGAAATGGA | 1497 |
| VEGF | NM_001025366.1 | ACTCACCGGCCAGGGCGCTCGGTGCTGGAATTTGATAT | 1498 |
| VEGF | NM_001025366.1 | GGGAGATTGCTCTACTTCCCCAAATCACTGTGGATTTTGGAAAC | 1499 |
| VEGF | NM_001025366.1 | AGCAGCGAAAGCGACAGGGGCAAAGTGAGTGACCTGCTTTT | 1500 |
| VTCN1 | NM_024626.1 | AGGAAGGCAGCGGCAGCTCCACTCAGCCAGTACCCAGATAC | 1501 |
| VTCN1 | NM_024626.1 | GCAATGCCTCTTTGCGGCTGAAAAACGTGCAACTCACAGAT | 1502 |
| VTCN1 | NM_024626.1 | AGCATGCCGGAAGTGAATGTGGACTATAATGCCAGCTCAGAGAC | 1503 |
| VWF | NM_000552.2 | GGGGACTCCACAGCCCCTGGGCTACATAACAGCAAGACAGT | 1504 |
| VWF | NM_000552.2 | CTATGCCTCCAAAGGGCTGTATCTAGAAACTGAGGCTGGGTACTAC | 1505 |
| VWF | NM_000552.2 | GGGCTGTGTGGCAACTTTAACATCTTTGCTGAAGATGACTTTATGAC | 1506 |
| WNT1 | NM_005430.2 | TGAACGTAGCCTCCTCCACGAACCTGCTTACAGACTCCAAGAGTC | 1507 |
| WNT1 | NM_005430.2 | CTGTTGAGCCGCAAACAGCGGCGTCTGATACGCCAAAATC | 1508 |
| WNT1 | NM_005430.2 | AAACCGCCCTCCCCCCACGACCTCGTCTACTTCGAGAAATC | 1509 |
| WRN | NM_000553.2 | AGCAGCGGAAATGTCCTGAATGGATGAATGTGCAGAATAAAAGATG | 1510 |
| WRN | NM_000553.2 | GGTGGGATTTGACATGGAGTGGCCACCATTATACAATAGAGGGAAA | 1511 |
| WRN | NM_000553.2 | CCCCAGGGATTAAAAATGTTGCTTGAAAATAAAGCAGTTAAAAAGGC | 1512 |
| XBP1 | NM_005080.2 | GTTGGGCATTCTGGACAACTTGGACCCAGTCATGTTCTTCAAAT | 1513 |
| XBP1 | NM_005080.2 | TTGACCACATATATACCAAGCCCCTAGTCTTAGAGATACCCTCTGAGACA | 1514 |
| XBP1 | NM_005080.2 | AGGAAGCACCTCTCAGCCCCTCAGAGAATGATCACCCTGAATTC | 1515 |
| YWHAZ | NM_145690.1 | TCATCCATGCTGTCCCACAAATAGTTTTTTGTTTACGATTTATGACA | 1516 |
| YWHAZ | NM_145690.1 | TACATTGTGGCTTCAAAAGGGCCAGTGTAAAACTGCTTCCATGTCTA | 1517 |
| YWHAZ | NM_145690.1 | ACATACTGGTTTGTCCTGGCGGGGAATAAAAGGGATCATTGGTTC | 1518 |
| ZBTB20 | NM_015642.2 | GTAGGGGCGGGGGGAAGTTTAGGAGTTGAGGAAAGAAGATTAAAGA | 1519 |
| ZBTB20 | NM_015642.2 | GCCTTTGGGACTCTGAAGGCTGAAGAATTGATGAATTGCAAGTT | 1520 |
| ZBTB20 | NM_015642.2 | CCTGAAGAGTGACACCATTGATTTTGAAACTACTGAAGAAACCCAAGAC | 1521 |
| ZFP36L2 | NM_006887.3 | CGGGATCCAGAAACATGTCGACCACACTTCTGTCCGCCTTCTAC | 1522 |
| ZFP36L2 | NM_006887.3 | ATCCCTGGCCAACCTCAACCTGAACAACATGCTGGACAAGAAG | 1523 |
| ZFP36L2 | NM_006887.3 | ACAAGGAGAACAAATTCCGGGACCGCTCGTTTAGCGAGAACG | 1524 |
| ZNF217 | NM_006526.2 | CAGTGACACCATCACTGAGCTTCCTAAAAGTTCGAAGAAGTTAGAGGA | 1525 |
| ZNF217 | NM_006526.2 | ACTCCAGAAATTGCCCAACGGAACTTTGAGATTATATGCAATCGA | 1526 |
| ZNF217 | NM_006526.2 | GACAGGAAACATGCCAACTCAATCCCTCTTAATGTACATGGATGGG | 1527 |
| ZNF364 | NM_014455.1 | GCCATTTGGATCACACGATGTTTTTTCAAGATTTTAGACCCTTTCT | 1528 |
| ZNF364 | NM_014455.1 | CCCCAGCTGACAAGGAAAAGATCACATCTCTTCCAACAGTGACAGT | 1529 |
| ZNF364 | NM_014455.1 | TGGGTTTAGAGTGTCCAGTATGCAAAGAAGATTACACAGTTGAAGAGGA | 1530 |
| ZNF668 | NM_024706.3 | CTTCGTGAAACCCACTCCTTGCTATTAAAGGAAATGTTGTGGA | 1531 |
| ZNF668 | NM_024706.3 | GAAGACATTGCCGGTGACCTGGCCCCAGACTAACACAAGGC | 1532 |
| ZNF668 | NM_024706.3 | AGAGGTGGCCGAGGTGAAGCCAAAGCCAGAGACAGAAGCTAAG | 1533 |
| ZNFN1A1 | NM_006060.2 | GCCGAAGCTATAAACAGCGAAGCTCTTTAGAGGAACATAAAGAGCG | 1534 |
| ZNFN1A1 | NM_006060.2 | GGGCACACTGTACCCAGTCATTAAAGAAGAAACTAATCACAGTGAAATG | 1535 |
| ZNFN1A1 | NM_006060.2 | CCTACGACAGCAGCGCCAGCTACGAGAAGGAGAACGAAATG | 1536 |

The inventors have also identified a selection of 73 of the 512 genes listed in Table 2 that are biomarkers useful for classifying breast cancer tumor subtypes based on their ESR1-PGR-ERBB2 makeup. The inventors have further identified MPP7 as a useful breast cancer biomarker.

TABLE 2
Biomarkers that exhibit a 1.5 fold up or down regulation between triple
negative (ESR1-, PGR-, ERBB2-) (NNN) and other breast cancer subtypes

| | | | |
|---|---|---|---|
| Differentially Up-regulated Genes | LY6D | CTSL2 | PRAME |
| | FOXC1 | KRT6B | MFGE8 |
| | NTRK3 | CRYAB | MK167 |
| | KNTC2 | KRT5 | ORC6L |
| | KRT17 | CX3CL1 | GTSE1 |
| | FZD7 | DLG7 | CDH3 |
| | NDRG1 | CRABP1 | FOXM1 |
| | CH13L2 | CDC20 | BUB1 |
| | CXCL1 | CENPA | LAMC2 |
| | PLK1 | TRIP13 | MELK |
| | GPR56 | CCNB2 | PTDSS1 |
| | MMP7 | MMP1 | IL8 |
| | MMP9 | TERT | TGFA |
| | MYBL2 | EGFR | MYC |
| | SPP1 | IL1A | GSTP1 |
| | CHEK1 | | |
| Differentially Down-regulated Genes | ATP8B1 | MAPT | MUC1 |
| | DUSP4 | GSTM3 | PERLD1 |
| | TSPAN1 | GATA3 | AFF3 |
| | FOXA1 | IL20 | AREG |
| | XBP1 | RERG | TFF3 |
| | SLC39A6 | SCUBE2 | NPY1R |
| | NAT1 | MLPH | BCL2 |
| | TFF1 | MYB | ERBB2 |
| | PGR | ERBB4 | ESR1 |

Accordingly, one aspect of the invention is a method of prognosing or classifying breast cancer subtypes of a subject, comprising the steps of:

a) determining the expression of a biomarker in a test sample from the subject, wherein the biomarker comprises one or more biomarkers as shown in Table 1; and

b) comparing the expression of the biomarker with a control representative of a cancer subtype, wherein a difference in the expression of the biomarker between the control and the test sample is used to prognose or classify the breast cancer subtype.

The prognosis and classifying methods of the invention can be used to select treatment. For example, the methods can be used to select or identify subjects who might (or might not) benefit from particular forms of chemotherapy. More specifically differences in the expression or regulation pattern of the biomarkers in Table 2 can be used to determine a certain cancer treatment.

Another aspect of the invention is to use the 512-gene custom breast cancer panel to potentially identify genes and biomarkers in the genome that can be used prognostically to predict outcome (recurrence, survival) and to predict sensitivity or resistance to various breast cancer therapies.

The invention also provides for kits for the prognosis or classification of breast cancer subtype of subject with breast cancer into groups based on their ESR1-PGR-ERBB2 makeup that includes at least one detection agent that can detect the expression products of the biomarkers.

Other features and advantages of the present invention will become apparent from the following detailed description. It should be understood, however, that the detailed description and the specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

FIG. 1 shows DASL assay data for ESR1, PGR and ERBB2. ESR1, PGR and ERBB2 expression levels in the DASL assay using the 512-gene custom panel show excellent correlation with receptor expression as determined by immunohistochemical methods.

FIG. 2 shows an unsupervised clustering of breast tumor samples using the 512-gene custom breast cancer panel. All replicate samples clustered together whether or not they were run on the same or different SAMs. In addition, the tumor samples clustered into groups representative of breast cancer subtypes. A major group of triple negative samples (NNN) clustered together and away from the ESR+ERBB2− or ERBB2+samples. Other major clusters included an ESR1+PGR±ERBB2− group and an ER+PR±ERBB2+ group.

FIG. 3 statistically significant up and down regulated genes determined by Stanford's Statistical Analysis of Microarray software.

FIG. 4 is a Venn diagram showing differentially up-regulated genes in triple negative (ESR1−, PGR−, ERBB2−) samples with at least 1.5 fold change in the custom LA-DASL breast cancer panel (left) and the standard cancer panel (right).

FIG. 5 is a Venn diagram showing differentially down-regulated genes in triple negative (ESR1−, PGR−, ERBB2−) samples with at least 1.5 fold change in the custom breast cancer panel (left) and the standard cancer panel (right).

FIG. 6 shows a hierarchical clustering of DASL analysis of 175 samples from 87 subjects using the 73 biomarkers with significantly different regulation (1.5-fold change) between triple negative (ESR1−, PGR−, ERBB2−) (NNN) and other breast cancer subtypes.

FIG. 7 shows MMP7 mRNA signal levels by sample (technical replicates averaged) grouped by immunohistochemical (IHC) status.

FIG. 8 illustrates the number of significant genes detected when comparing each class.

### DETAILED DESCRIPTION OF THE INVENTION

This invention relates to a method for diagnosing, prognosing or classifying breast cancer subtypes in a subject, which comprises determining the expression of at least one gene chosen from the list of 512 genes of Table 1 in a subject sample.

The term “biomarker” as used herein refers to a gene that is differentially expressed in individuals with breast cancer and is predictive of different tumor types, tumor responsiveness or survival outcomes. In a preferred embodiment, the biomarkers are predictive of the ESR1, PGR and/or ERBB2 status of a sample taken from an individual with breast cancer. The term “biomarker” includes one or more of the genes listed in any of Tables 1 to 7.

Accordingly, one aspect of the invention is a method of prognosing or classifying breast cancer subtypes in a subject, comprising the steps of determining the expression of a biomarker in a test sample from the subject, wherein the biomarker comprises one or more biomarkers as shown in any of Tables 1 to 7 and comparing the expression of the biomarker with a control representative of various cancer subtypes, wherein a difference in the expression of the biomarker between the control and the test sample is used to prognose or classify the subject with a breast cancer subtype.

The phrase “prognosing or classifying” as used herein refers to a method or process of determining whether a subject has a specific tumor subtype based on biomarker expression profiles. In a preferred embodiment, the method is used to prognose or classify a tumor sample based on its ESR1, PGR or ERBB2 status.

The term “test sample” as used herein refers to any fluid, cell or tissue sample from a subject which can be assayed for biomarker expression products, particularly genes differentially expressed in subjects with different forms of breast cancer subtypes. In one embodiment, the test sample is a cell, cells or tissue from a tumor biopsy from the subject.

The preferred test sample to test using the cancer panel consists in obtaining FFPE tumor blocks in 5×5 μm sections by subject, each section being incorporated in a sterile 1.5 ml Eppendorf tube. Moreover, one 5 μm section of tumor sample on a slide by subject may be used for haematoxylin and eosin (H&E) staining.

As used herein, the term “control” refers to a specific value that one can use to prognose or classify the value obtained from the test sample. In one embodiment, a dataset may be obtained from samples from a group of subjects known to have a particular breast cancer type or subtype. In a preferred embodiment, the control dataset consists of tumor or subject samples for which the status of ESR1, PGR and/or ERBB2 has been determined. The expression data of the biomarkers in the dataset can be used to create a control value that is used in testing samples from new subjects. In such an embodiment, the “control” is a predetermined value for each biomarker or set of biomarkers obtained from subjects with breast cancer subjects whose biomarker expression values and tumor types are known.

In another embodiment, the control can be an actual sample from a subject with a known ESR1, PGR and/or ERBB2 breast cancer subtype.

The term “differentially expressed” or “differential expression” as used herein refers to a difference in the level of expression of the biomarkers that can be assayed by measuring the level of expression of the products of the biomarkers, such as the difference in level of messenger RNA transcript expressed or proteins expressed of the biomarkers. In a preferred embodiment, the difference is statistically significant. The term “difference in the level of expression” refers to an increase or decrease in the measurable expression level of a given biomarker as measured by the amount of messenger RNA transcript and/or the amount of protein in a sample as compared with the measurable expression level of a given biomarker in a control. In one embodiment, the differential expression can be compared using the ratio of the level of expression of a given biomarker or biomarkers as compared with the expression level of the given biomarker or biomarkers of a control, wherein the ratio is not equal to 1.0. For example, an RNA or protein is differentially expressed if the ratio of the level of expression in a first sample as compared with a second sample is greater than or less than 1.0. For example, a ratio of greater than 1, 1.2, 1.5, 1.7, 2, 3, 3, 5, 10, 15, 20 or more, or a ratio less than 1, 0.8, 0.6, 0.4, 0.2, 0.1, 0.05, 0.001 or less. In another embodiment the differential expression is measured using p-value. For instance, when using p-value, a biomarker is identified as being differentially expressed as between a first sample and a second sample when the p-value is less than 0.1, preferably less than 0.05, more preferably less than 0.01, even more preferably less than 0.005, the most preferably less than 0.001.

In another embodiment, expression data from multiple biomarkers is analyzed using cluster techniques. In one embodiment, clustering is based on correlation of average normalized signal intensities. In one embodiment, the biomarkers comprise the 512-gene custom breast cancer panel. In another embodiment, the biomarkers comprise the 73 biomarkers listed in Table 2. In another embodiment, the biomarkers comprise the ones listed in Tables 5, 6 and 7.

The phrase “determining the expression of biomarkers” as used herein refers to determining or quantifying RNA or proteins expressed by the biomarkers. The term “RNA” includes mRNA transcripts, and/or specific spliced variants of mRNA. The term “RNA product of the biomarker” as used herein refers to RNA transcripts transcribed from the biomarkers and/or specific spliced variants. In the case of “protein”, it refers to proteins translated from the RNA transcripts transcribed from the biomarkers. The term “protein product of the biomarker” refers to proteins translated from RNA products of the biomarkers.

A person skilled in the art will appreciate that a number of methods can be used to detect or quantify the level of RNA products of the biomarkers within a sample, including microarrays, RT-PCR (including quantitative RT-PCR), nuclease protection assays and Northern blot analyses. In one embodiment, the assay used is a DASL assay as shown in Example 1 which uses a bead-array format.

In addition, a person skilled in the art will appreciate that a number of methods can be used to determine the amount of a protein product of a biomarker of the invention, including immunoassays such as Western blots, ELISA, and immunoprecipitation followed by SDS-PAGE and immunocytochemistry.

Conventional techniques of molecular biology, microbiology and recombinant DNA techniques, are within the skill of the art. Such techniques are explained fully in the literature. See, e.g., Sambrook, Fritsch & Maniatis, 1989, Molecular Cloning: A Laboratory Manual, Second Edition; Oligonucleotide Synthesis (M. J. Gait, ed., 1984); Nucleic Acid Hybridization (B. D. Harnes & S. J. Higgins, eds., 1984); A Practical Guide to Molecular Cloning (B. Perbal, 1984); and a series, Methods in Enzymology (Academic Press, Inc.); Short Protocols In Molecular Biology, (Ausubel et al., ed., 1995).

A person skilled in the art will appreciate that a number of detection agents can be used to determine the expression of the biomarkers. For example, to detect RNA products of the biomarkers, probes, primers, complementary nucleotide sequences or nucleotide sequences that hybridize to the RNA products can be used. To detect protein products of the biomarkers, ligands or antibodies that specifically bind to the protein products can be used.

The term “nucleic acid” includes DNA and RNA and can be either double stranded or single stranded.

The term “hybridize” refers to the sequence specific non-covalent binding interaction with a complementary nucleic acid. In a preferred embodiment, the hybridization is under high stringency conditions. Appropriate stringency conditions which promote hybridization are known to those skilled in the art, or can be found in Current Protocols in Molecular Biology, John Wiley & Sons, N.Y. (1989), 6.3.1 6.3.6. For example, 6.0× sodium chloride/sodium citrate (SSC) at about 45° C., followed by a wash of 2.0×SSC at 50° C. may be employed.

The term “primer” as used herein refers to a nucleic acid sequence, whether occurring naturally as in a purified restriction digest or produced synthetically, which is capable of acting as a point of synthesis of when placed under conditions in which synthesis of a primer extension product, which is complementary to a nucleic acid strand is induced (e.g. in the presence of nucleotides and an inducing agent such as DNA polymerase and at a suitable temperature and pH). The primer must be sufficiently long to prime the synthesis of the desired extension product in the presence of the inducing agent. The exact length of the primer will depend upon factors, including temperature, sequences of the primer and the methods used. A primer typically contains 15-25 or more nucleotides, although it can contain less. The factors involved in determining the appropriate length of primer are readily known to one of ordinary skill in the art. The term “primer” as used herein refers a set of primers which can produce a double stranded nucleic acid product complementary to a portion of the RNA products of the biomarker or sequences complementary thereof.

The term “probe” as used herein refers to a nucleic acid sequence that will hybridize to a nucleic acid target sequence. In one example, the probe hybridizes to an RNA product of the biomarker or a nucleic acid sequence complementary thereof. The length of probe depends on the hybridize conditions and the sequences of the probe and nucleic acid target sequence. In one embodiment, the probe is at least 8, 10, 15, 20, 25, 50, 75, 100, 150, 200, 250, 400, 500 or more nucleotides in length. In a preferred embodiment, the assay used is a DASL assay and the probes used are those identified in Table 1. The probe sequences are the oligo sequence on the 5′ and 3′ end which is then extended and ligated to form the “probe” sequence.

The term “antibody” as used herein is intended to include monoclonal antibodies, polyclonal antibodies, and chimeric antibodies. The antibody may be from recombinant sources and/or produced in transgenic animals. The term “antibody fragment” as used herein is intended to include Fab, Fab′, F(ab′)2, scFv, dsFv, ds-scFv, dimers, minibodies, diabodies, and multimers thereof and bispecific antibody fragments. Antibodies can be fragmented using conventional techniques. For example, F(ab′)2 fragments can be generated by treating the antibody with pepsin. The resulting F(ab′)2 fragment can be treated to reduce disulfide bridges to produce Fab′ fragments. Papain digestion can lead to the formation of Fab fragments. Fab, Fab′ and F(ab′)2, scFv, dsFv, ds-scFv, dimers, minibodies, diabodies, bispecific antibody fragments and other fragments can also be synthesized by recombinant techniques.

Antibodies having specificity for a specific protein, such as the protein product of a biomarker, may be prepared by conventional methods. A mammal, (e.g. a mouse, hamster, or rabbit) can be immunized with an immunogenic form of the peptide which elicits an antibody response in the mammal. Techniques for conferring immunogenicity on a peptide include conjugation to carriers or other techniques well known in the art. For example, the peptide can be administered in the presence of adjuvant. The progress of immunization can be monitored by detection of antibody titers in plasma or serum. Standard ELISA or other immunoassay procedures can be used with the immunogen as antigen to assess the levels of antibodies. Following immunization, antisera can be obtained and, if desired, polyclonal antibodies isolated from the sera.

To produce monoclonal antibodies, antibody producing cells (lymphocytes) can be harvested from an immunized animal and fused with myeloma cells by standard somatic cell fusion procedures thus immortalizing these cells and yielding hybridoma cells. Such techniques are well known in the art, (e.g. the hybridoma technique originally developed by Kohler and Milstein (Nature 256:495-497 (1975)) as well as other techniques such as the human B-cell hybridoma technique (Kozbor et al. Immunol. Today 4:72 (1983)), the EBV-hybridoma technique to produce human monoclonal antibodies (Cole at al., Methods Enzymol, 121:140-67 (1986)), and screening of combinatorial antibody libraries (Huse et al., Science 246:1275 (1989)). Hybridoma cells can be screened immunochemically for production of antibodies specifically reactive with the peptide and the monoclonal antibodies can be isolated.

A person skilled in the art will appreciate that the detection agents can be labeled.

The label is preferably capable of producing, either directly or indirectly, a detectable signal. For example, the label may be radio-opaque or a radioisotope, such as ³H, ¹⁴C, ³²P, ³⁵S, ¹²³I, ¹²⁵I, ¹³¹I; a fluorescent (fluorophore) or chemiluminescent (chromophore) compound, such as fluorescein isothiocyanate, rhodamine or luciferin; an enzyme, such as alkaline phosphatase, beta-galactosidase or horseradish peroxidase; an imaging agent; or a metal ion.

Accordingly, the invention includes a kit for prognosing or classifying cancer subtypes in a subject with breast cancer, comprising at least one detection agent that can detect the expression products of biomarkers, wherein the biomarkers comprise at least one biomarker as shown in Table 1.

The kit can also include a control or reference standard and/or instructions for use thereof. In addition, the kit can include ancillary agents such as vessels for storing or transporting the detection agents and/or buffers or stabilizers.

The term “subject” as used herein refers to any member of the animal kingdom, preferably a human being that has breast cancer.

The above disclosure generally describes the present invention. A more complete understanding can be obtained by reference to the following specific examples. These examples are described solely for the purpose of illustration and are not intended to limit the scope of the invention. Changes in form and substitution of equivalents are contemplated as circumstances might suggest or render expedient. Although specific terms have been employed herein, such terms are intended in a descriptive sense and not for purposes of limitation.

The following non-limiting examples are illustrative of the present invention:

### Example 1

### DASL Assay for Biomarker Expression Profiling

The DASL Assay process allows expression profiling of biomarkers in a subject tissue sample. It involves random priming with biotinylated 9mers to generate cDNA. Transcripts are probed in solution using oligo probe sets. The DASL assay probe sets incorporates target specific sequences, universal primers and a short universal address sequence for use in reading out the assay products on Sentrix® universal arrays. In a preferred embodiment, three assays are used for each gene of interest, allowing a total of up to 512 genes to be profiled for each sample or replicate.

The cDNA-mediated annealing, selection, extension and ligation (DASL) assay has been specifically designed as a gene expression profiling system to generate reproducible data from degraded RNAs such as those derived from Frozen Fixed Paraffin Embedded (FFPE) tumor samples as old as 24 years. The assay is amenable to high-throughput screening of subject samples which can be accommodated on one of two array platforms that allow for either 16 or 96 samples to be processed on one slide or plate, respectively. In one embodiment of the invention, the DASL assay is used in conjunction with the 73-gene custom breast cancer panel as detailed above.

The DASL assay protocol only requires around 200 ng of total RNA that is converted to cDNA and processed in the DASL assay. In one embodiment, oligonucleotides targeting biomarkers are used at a density of three non-overlapping probes per gene. This results in a multiplex measurement for each sample. Using this number of probes per gene lends the assay the necessary sensitivity and reproducibility for quantitative detection of differential expression using RNA from FFPE tissues. In one embodiment, random priming is used for cDNA synthesis and, therefore, probes are designed such that they can target any unique region of the gene without limiting the selection of the optimal probe to the 3′ end of transcripts. In addition, due to the small size of the targeted gene sequence (50 nucleotides), along with the use of random primers in the cDNA synthesis, this allows for detection of RNAs that are otherwise too degraded for conventional microarray analysis.

The 5′-oligonucleotides consists of two parts: the gene specific sequence and a universal PCR primer sequence. The 3′-oligonucleotides consist of three parts: the gene specific sequence, a unique address sequence which is complementary to one of the capture sequences on the array and a universal PCR primer sequence at the 3′ end. A single address sequence is uniquely associated with a single target site. This address sequence allows the PCR-amplified products to hybridize to a universal microarray bearing the complementary address sequences.

### Example 2

### RNA Preparation Method and Quality Control of RNA Samples

Breast Cancer FFPE blocks were obtained from St. Mary's Hospital, Montreal, Quebec, and three 5 μm sections per block, placed into a 1.5 mL sterile microfuge tube were taken for each RNA isolation. The commercially available RNA High Pure Kit (Roche, Mannheim, Germany) was used for RNA extraction from FFPE tissues that were used in this experiment. The manufacturer's instructions were followed for each kit, with two exceptions. First, an additional ethanol wash was added to all kits after the deparaffinization step to ensure that all the xylene was completely removed. Second, Proteinase K digestion times were changed slightly to an overnight Proteinase K digestion.

Concentration and Å260/Å280 ratio were determined using the NanoDrop spectrophotometer (NanoDrop, Wilmington, Del.). RNA quality was initially tested using the 2100 Bioanalyzer (Agilent Technologies, Waldbronn, Germany). In addition, TaqMan (Applied Biosystems, Foster City, Calif.) assays were performed on the RPL13a gene in triplicate using 20 ng of cDNA to determine how many copies of usable RNA molecules were available in each sample. The quantitative RT-PCR reactions were run on the HT7900 real-time PCR instrument (Applied Biosystems, Foster City, Calif.).

### Example 3

### DASL Assay Data Analysis

The DASL assay was performed using a maximum of 200 ng of input RNA on the custom 512-gene human breast cancer panel of the present invention and a standard IIlumina 502-gene Human Standard Cancer panel. In cases where RNA concentrations were below 40 ng/μL but not less than 20 ng/μL, the maximum allowable volume of RNA (5 μl) was used. The manufacturer's instructions were followed without any changes. The hybridized Sentrix Array Matrix (SAM) was scanned using the BeadStation 500 Instrument (Illumina, Inc., San Diego, Calif.). The data was analyzed using the BeadStudio v3.0 software package (Illumina, Inc., San Diego, Calif.) and Spotfire DecisionSite 9.0 for Functional Genomics (Spotfire Inc, Somerville, Mass.).

Data from Illumina DASL experiments were scanned and interpreted using IIlumina's BeadStudio. Prior to analysis, samples which failed (criteria being a detection p-value <0.05 in less than 40% of the samples) were removed from the data sets. Reference RNA, and samples with no immunohistochemical data (i.e. ESR1, PGR, ERBB2 status) were also removed. Therefore, with removal of these samples from further analysis, we performed DASL analysis on 175 samples from 87 subjects in six major breast cancer subtypes. Non-normalized signal intensity data was exported from BeadStudio and analyzed for correlations in Microsoft Excel and Access.

### Example 4

### DASL Data Plotted According to IHC Receptor Subtype

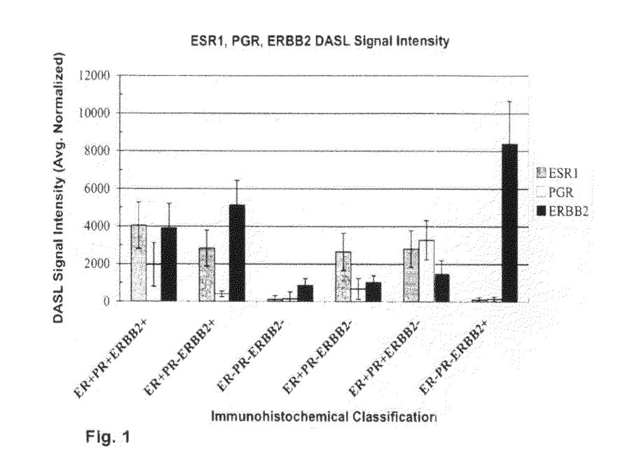

DASL assay data was plotted for expression of ESR, PGR, and ERBB2 receptors according to receptor subtype as determined by Immunohistochemistry (i.e. ESR1+PGR+ERBB2+, ESR1+PGR−ERBB2+, ESR1−PGR−ERBB2−, ESR1+PGR−ERBB2−, ESR1+PGR+ERBB2−, ESR1−PGR−ERBB2+) on 87 subjects. An excellent correlation between DASL data and IHC data was observed as shown in FIG. 1 and confirms the use of the custom panel in the DASL assay.

### Example 6

### Validation of Selected Genes in the 512-Gene Custom Panel

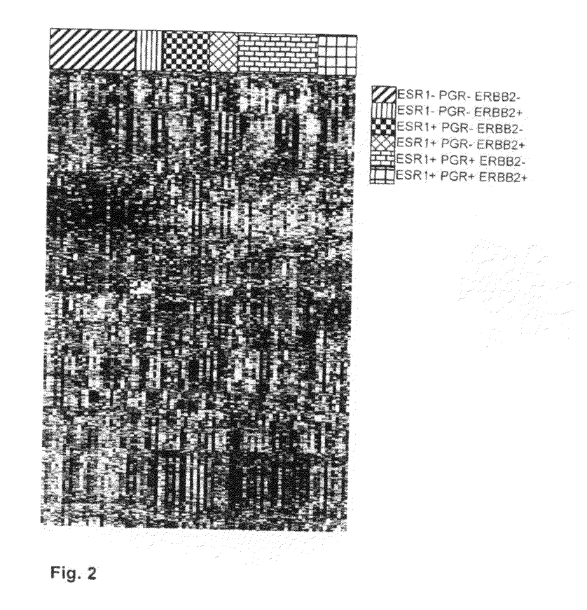

To validate the relevance of the genes selected for our custom cancer panel, we conducted an unsupervised clustering of all non-failed samples. Clustering is based on correlation of average normalized signal intensities. Typically, data protocols call for normalizations to be done per experiment (e.g. one SAM normalized within itself, and compared to another SAM normalized within itself), but because the data is being looked at as a whole, average normalization was conducted on both custom cancer panel SAMs (1842787020 & 1892661005) together. FIG. 2 shows a heatmap that illustrates the clustering of breast cancer subtypes and further authenticates the relevance of the genes selected for the custom cancer panel. For example, triple negative (NNN; ESR1−PGR−ERBB2−) breast cancer samples cluster together as seen on the right side of FIG. 2.

### Example 7

### Identification of a Subset of 73 Biomarkers for Cancer Subtype

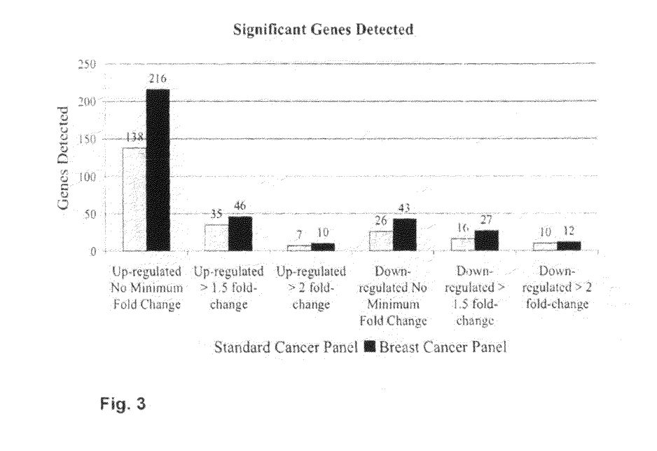

To further elucidate genes significantly up-regulated and down-regulated in both the custom and standard cancer panels, a significance analysis of microarrays was conducted using Stanford's significance analysis of microarrays software. To summarize the number of genes detected, we first looked at raw counts of significant genes detected at no minimum fold change, a minimum of 1.5-fold change, and a minimum of 2-fold change. FIG. 3 shows that in all fold change categories and in both up-regulation and down-regulation, the 512-gene custom cancer panel detected more significant genes than the standard cancer panel.

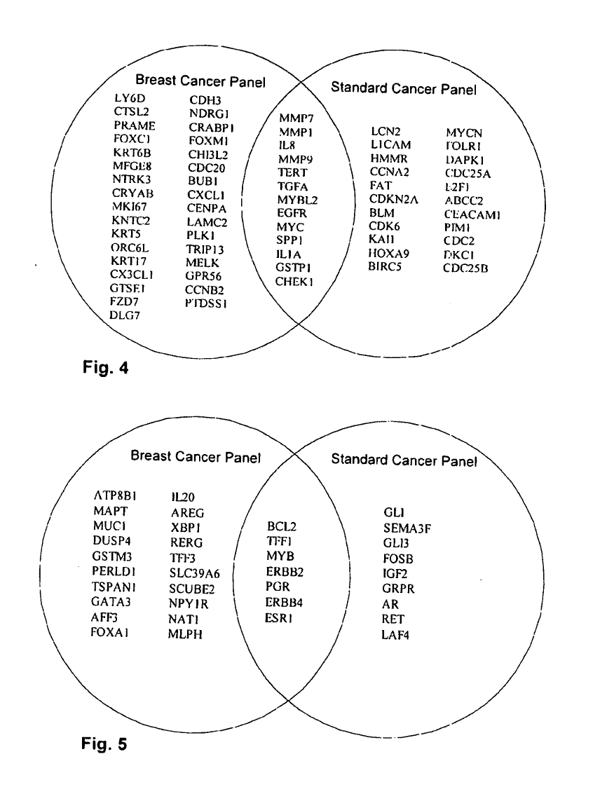

To further investigate the sets of genes detected by each panel, data was loaded in Microsoft Access and queries were run against the data sets to generate data for a Venn diagram. Differentially up-regulated genes in NNN samples, with at least 1.5 fold change, are shown in FIG. 4 for both the custom 512-gene and standard cancer panels. Differentially down-regulated genes in NNN samples, with at least 1.5 fold change, are shown in FIG. 5 for both the custom 512-gene and standard cancer panels.

Thus, we identified a subset of 73 genes (46 up-regulated 1.5-fold; 27 down-regulated 1.5-fold) from our custom 512-gene panel that were significantly different between the NNN subtype and other breast cancer subtypes. Among the significantly decreased genes were ESR1, PGR, ERBB2, and among the increased genes were EGFR, MMP7, FZD7, and MYC. The four aforementioned up-regulated genes, EGFR, MMP7, FZD7, and MYC, are all components or targets of the Wnt signaling pathway as identified by Ingenuity Pathway Analysis (IPA). Correlation of expression of EGFR, MMP7, and MYC with FZD7 expression across the 175 samples was highly significant (Table 3), suggesting a functional link with Wnt signaling, and, therefore, these genes may play an important role in the tumorigenic process.

TABLE 3
Correlation of expression of Wnt target genes with FZD7
expression across 174 FFPE DASL samples

| GENE | Correlation | p-value |
|---|---|---|
| MMP7 | 0.57 | 3.91E−17 |
| EGFR | 0.57 | 1.14E−16 |
| MYC | 0.35 | 1.47E−06 |

IPA identified several other significantly altered pathways as expected including estrogen signaling (p=1E-7), neuregulin signaling (p=1E-5), p53 signaling (p=1E-4), and cell cycle checkpoints (p=1E-3).

### Example 8

### Biomarkers of Table 2 Effectively Identify NNN Samples

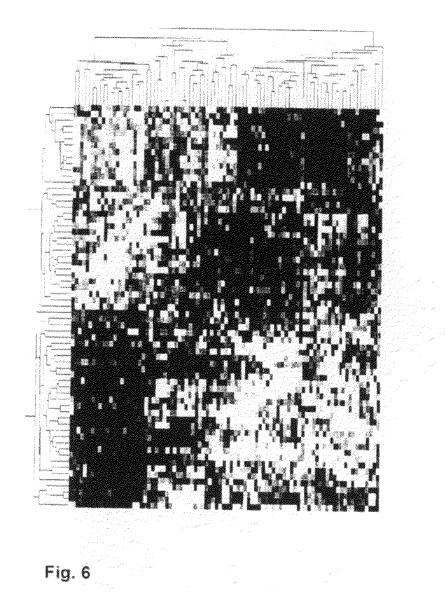

The 73 biomarkers identified in Example 7 and listed in Table 2 were used to perform a hierarchical clustering of all samples. As shown in FIG. 6, this set of differentially expressed NNN genes effectively separated all NNN samples from the other breast cancer subtypes.

### Example 9

### Identification of MMP7 as a Breast Cancer Biomarker

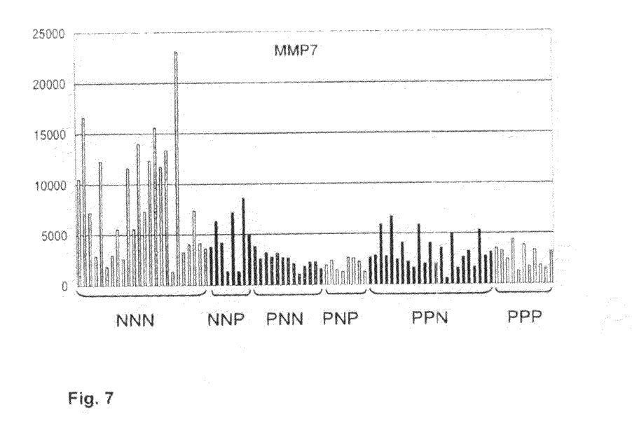

MMP7 was identified as a biomarker of breast cancer in general and of hormone-negative, ERBB2-positive and NNN breast cancer in particular and especially NNN breast cancer. As shown in FIG. 7, MMP7 is expressed in most breast cancer samples but is highly up-regulated in certain samples, mainly hormone-negative, ERBB2-positive and NNN and especially NNN breast cancer.

### Example 10

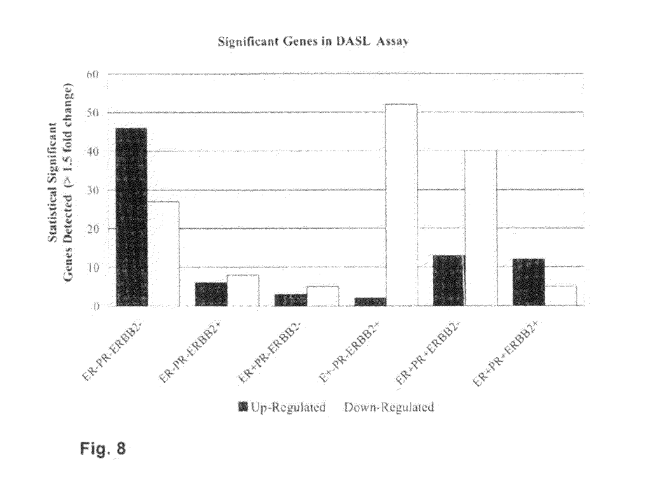

In further analysis of gene expression signatures in breast cancer tissue samples, each IHC class was examined separately and compared to all other samples not in the specified IHC class (e.g. ESR1+PGR+ERBB2+ compared with all none ESR1+PGR+ERBB2+samples). FIG. 8 illustrates the number of significant genes detected when comparing each class. Number of significantly regulated genes found when comparing each IHC determined tissue type to all other tissue types. Only genes with a fold change of at least 1.5 were considered.

TABLE 4
Common Genes between Standard Cancer Panel & Custom
Breast Cancer Panel

| targetid [symbol] | name [symbol] | |
|---|---|---|
| GI_10834981-S [symbol] | IGFBP5 [symbol] | |
| GI_10834983-S [symbol] | IL6 [symbol] | |
| GI_10835001-S [symbol] | ARHGDIB [symbol] | |
| GI_10835156-S [symbol] | IGFBP2 [symbol] | |
| GI_10835158-S [symbol] | SERPINE1 | |
| GI_10835170-S [symbol] | IFNG [symbol] | |
| GI_10863872-S [symbol] | TGFB1 [symbol] | |
| GI_11068002-S [symbol] | IGFIR [symbol] | |
| GI_11321596-S [symbol] | KDR [symbol] | |
| GI_11342665-S [symbol] | MMP2 [symbol] | |
| GI_11496979-S [symbol] | PMSI [symbol] | |
| GI_11641410-A [symbol] | CDC25B [symbol] | |
| GI_12669910-S [symbol] | E2F1 [symbol] | |
| GI_13027798-S [symbol] | MMP1 [symbol] | |
| GI_13027803-S [symbol] | MMP3 [symbol] | |
| GI_13027804-S [symbol] | MMP7 [symbol] | |
| GI_13112049-A [symbol] | FGFR4 [symbol] | |
| GI_13128859-S [symbol] | HDAC1 [symbol] | |
| GI_13186246-A [symbol] | FGFR1 [symbol] | |
| GI_13186266-A [symbol] | FGFR2 [symbol] | |
| GI_13435352-A [symbol] | LICAM [symbol] | |
| GI_14589887-S [symbol] | CDH1 [symbol] | |
| GI_14589947-S [symbol] | ETV6 [symbol] | |
| GI_14670387-A [symbol] | BAD [symbol] | |
| GI_14702166-A [symbol] | PLAT [symbol] | |
| GI_14790114-A [symbol] | CASP3 [symbol] | |
| GI_14790185-A [symbol] | CASP2 [symbol] | |
| GI_15011927-A [symbol] | PCTK1 [symbol] | |
| GI_15055544-A [symbol] | FGF1 [symbol] | |
| GI_15208655-A [symbol] | PDGFA [symbol] | |
| GI_15451785-A [symbol] | PDGFB [symbol] | |
| GI_15451897-S [symbol] | FGF2 [symbol] | |
| GI_15718711-A [symbol] | CASP8 [symbol] | |
| GI_16936523-S [symbol] | WNT1 [symbol] | |
| GI_16936532-A [symbol] | CDK4 [symbol] | |
| GI_16950654-S [symbol] | CCND1 [symbol] | |
| GI_16950656-S [symbol] | CCND2 [symbol] | |
| GI_17318560-A [symbol] | CCNE1 [symbol] | |
| [symbol] 1_17738295-A [symbol] | CDKN2A [symbol] | |
| [symbol] 1_17978496-A [symbol] | CDKN1A [symbol] | |
| [symbol] 1_17978497-S [symbol] | CDKN1B [symbol] | |
| [symbol] 1_17981693-A [symbol] | CDKN2B [symbol] | |
| [symbol] 1_18765747-A [symbol] | COL18A1 [symbol] | |
| [symbol] 1_19913404-S [symbol] | TOP1 [symbol] | |
| [symbol] 1_19913405-S [symbol] | TOP2A [symbol] | |
| [symbol] 1_19923110-S [symbol] | IGFBP3 [symbol] | |
| [symbol] 1_19923111-S [symbol] | IGF1 [symbol] | |
| [symbol] 1_19923162-S [symbol] | TFAP2C [symbol] | |
| [symbol] 1_19924171-S [symbol] | WRN [symbol] | |
| [symbol] 1_19924298-S [symbol] | FRAP1 [symbol] | |
| [symbol] 1_20127419-S [symbol] | CHEK1 [symbol] | |
| [symbol] 1_20336333-A [symbol] | BCL2L1 [symbol] | |
| [symbol] 1_20986513-A [symbol] | MAPK14 [symbol] | |
| [symbol] 1_21071055-S [symbol] | SMARCA4 | |
| [symbol] 1_21361192-S [symbol] | CD44 [symbol] | |
| [symbol] 1_21361613-S [symbol] | STK11 [symbol] | |
| [symbol] 1_21536431-S [symbol] | TIMP3 [symbol] | |
| [symbol] 1_22035683-S [symbol] | AREG [symbol] | |
| [symbol] 1_22547118-A [symbol] | TNFRSF10 [symbol] | |
| [symbol] 1_23510439-S [symbol] | TNFSF10 [symbol] | |
| [symbol] 1_24041034-S [symbol] | NOTCH2 [symbol] | |
| [symbol] 1_24430217-S [symbol] | IL11 [symbol] | |
| [symbol] 1_24430218-S [symbol] | IL12A [symbol] | |
| [symbol] 1_24475626-S [symbol] | TSC1 [symbol] | |
| [symbol] 1_25952110-S [symbol] | TNF [symbol] | |
| [symbol] 1_27437048-A [symbol] | CSF3 [symbol] | |
| [symbol] 1_27886643-A [symbol] | CDC2 [symbol] | |
| [symbol] 1_27894305-S [symbol] | IL1B [symbol] | |
| [symbol] 1_27894329-S [symbol] | IL1A [symbol] | |
| [symbol] 1_27894369-S [symbol] | NOTCH4 [symbol] | |
| [symbol] 1_28559089-S [symbol] | MLH1 [symbol] | |
| [symbol] 1_28610153-S [symbol] | IL8 [symbol] | |
| [symbol] 1_28916690-A [symbol] | MUC1 [symbol] | |
| [symbol] 1_29725608-S [symbol] | EGFR [symbol] | |
| [symbol] 1_30172563-S [symbol] | VEGF [symbol] | |
| [symbol] 1_31077210-A [symbol] | HIF1A [symbol] | |
| [symbol] 1_31317226-S [symbol] | EGR1 [symbol] | |
| [symbol] _31377801-S [symbol] | SEMA3F [symbol] | |
| [symbol] _31543215-S [symbol] | MYC [symbol] | |
| [symbol] _31652260-S [symbol] | MYBL2 [symbol] | |
| [symbol] _31657112-S [symbol] | ZNFN1A1 [symbol] | |
| [symbol] _31742533-S [symbol] | ETV1 [symbol] | |
| [symbol] 1_31981491-S [symbol] | PGR [symbol] | |
| [symbol] 1_32306519-S [symbol] | FLT1 [symbol] | |
| [symbol] 1_33188458-S [symbol] | BRAF [symbol] | |
| [symbol] 1_33239450-A [symbol] | PCNA [symbol] | |
| [symbol] 1_33457353-S [symbol] | BAK1 [symbol] | |
| [symbol] 1_33519457-A [symbol] | MCL1 [symbol] | |
| [symbol] 1_34147567-S [symbol] | RAP1GDS | |
| [symbol] 1_34485718-S [symbol] | E2F2 [symbol] | |
| [symbol] 1_38146097-S [symbol] | SPP1 [symbol] | |
| [symbol] 1_38201699-A [symbol] | TERT [symbol] | |
| [symbol] _4502144-S [symbol] | BIRC5 [symbol] | |
| [symbol] 1_4502450-S [symbol] | BRCA2 [symbol] | |
| [symbol] 1_4503122-S [symbol] | CTGF [symbol] | |
| [symbol] 1_4503126-S [symbol] | CTNNA1 [symbol] | |
| [symbol] 1_4503130-S [symbol] | CTNNB1 [symbol] | |
| [symbol] _4503588-S [symbol] | EPO [symbol] | |
| [symbol] _4503596-S [symbol] | ERBB3 [symbol] | |
| [symbol] 1_4503602-S [symbol] | ESR1 [symbol] | |
| [symbol] 1_4503718-S [symbol] | FHIT [symbol] | |
| [symbol] 1_4503752-A [symbol] | FLT4 [symbol] | |
| [symbol] 1_4503832-S [symbol] | FZD7 [symbol] | |
| [symbol] 1_4504190-S [symbol] | MSH6 [symbol] | |
| [symbol] 1_4504720-S [symbol] | IRF1 [symbol] | |
| [symbol] 1_4505392-S [symbol] | NGFR [symbol] | |
| [symbol] 1_4505474-S [symbol] | NTRK3 [symbol] | |
| [symbol] 1_4505864-S [symbol] | PLAUR [symbol] | |
| [symbol] 1_4506102-S [symbol] | EIF2AK2 [symbol] | |
| [symbol] 1_4506248-S [symbol] | PTEN [symbol] | |
| [symbol] 1_4506264-S [symbol] | PTGS2 [symbol] | |
| [symbol] 1_4506418-S [symbol] | RARA [symbol] | |
| [symbol] 1_4506434-S [symbol] | RB1 [symbol] | |
| [symbol] 1_4507424-S [symbol] | TDGF1 [symbol] | |
| [symbol] 1_4507450-S [symbol] | TFF1 [symbol] | |
| [symbol] 1_4507456-S [symbol] | TFRC [symbol] | |
| [symbol] 1_4507460-S [symbol] | TGFA [symbol] | t |
| [symbol] 1_4507464-S [symbol] | TGFB3 [symbol] | t |
| [symbol] 1_4507508-S [symbol] | TIMP1 [symbol] | t |
| [symbol] 1_4507518-S [symbol] | TK1 [symbol] | t |
| [symbol] 1_4557356-A [symbol] | BCL2 [symbol] | t |
| [symbol] 1_4557364-S [symbol] | BLM [symbol] | t |
| [symbol] 1_4557480-S [symbol] | ABCC2 [symbol] | t |
| [symbol] 1_4557570-S [symbol] | EXT1 [symbol] | t |
| [symbol] 1_4557694-S [symbol] | KIT [symbol] | t |
| [symbol] 1_4557760-S [symbol] | MSH2 [symbol] | t |
| [symbol] 1_4757849-S [symbol] | ABCG2 [symbol] | t |
| [symbol] 1_4758297-S [symbol] | ERBB2 [symbol] | t |
| [symbol] 1_4758395-S [symbol] | FLT3 [symbol] | t |
| [symbol] 1_4758605-S [symbol] | ILK [symbol] | t |
| [symbol] 1_4826835-S [symbol] | MMP9 [symbol] | t |
| [symbol] 1_4885060-S [symbol] | AKT1 [symbol] | t |
| [symbol] 1_4885214-S [symbol] | ERBB4 [symbol] | t |
| [symbol] 1_4885218-S [symbol] | ETS1 [symbol] | t |
| [symbol] 1_4885354-S [symbol] | GRB7 [symbol] | t |
| [symbol] 1_4885424-A [symbol] | HRAS [symbol] | t |
| [symbol] 1_4885496-S [symbol] | MYB [symbol] | t |
| [symbol] 1_5453891-S [symbol] | PIK3CA [symbol] | t |
| [symbol] 1_6006027-S [symbol] | NRAS [symbol] | t |
| [symbol] 1_6031163-S [symbol] | EGF [symbol] | t |
| [symbol] 1_6042206-S [symbol] | RAN [symbol] | t |
| [symbol] 1_6382057-A [symbol] | ABL1 [symbol] | t |
| [symbol] 1_6552306-A [symbol] | BRCA1 [symbol] | t |
| [symbol] 1_6552334-S [symbol] | GSTP1 [symbol] | t |
| [symbol] 1_6715585-S [symbol] | AKT2 [symbol] | t |
| [symbol] 1_6806892-S [symbol] | LTA [symbol] | t |
| [symbol] 1_7549801-S [symbol] | BAG1 [symbol] | t |
| [symbol] 1_7657065-A [symbol] | ERG [symbol] | t |
| [symbol] 1_7669470-S [symbol] | ABCB1 [symbol] | t |
| [symbol] 1_8400737-S [symbol] | TP53 [symbol] | t |
| [symbol] 1_9257247-S [symbol] | TIMP2 [symbol] | t |
| [symbol] 1_9790904-S [symbol] | GADD45A [symbol] | t |
| [symbol] 1_9845515-A [symbol] | S100A4 [symbol] | t |

[symbol]

indicates data missing or illegible when filed

The panel of the present invention detected the most significantly up and down regulated genes in NNN (ESR1−PGR−ERBB2) cancer tissue. A complete listing of all up and down regulated genes in each IHC category (compared independently to all other categories) can be found in Tables 5 and 6, respectively.

TABLE 5
Up-Regulated Genes for each IHC category compared to all other
categories

| ESR1− | ESR1− | ESR1+ | ESR1+ | ESR1+ | ESR1+ |
|---|---|---|---|---|---|
| PGR− | PGR− | PGR− | PGR− | PGR+ | PGR+ |
| ERBB2− | ERBB2+ | ERBB2− | ERBB2+ | ERBB2− | ERBB2+ |
| MMP7 | ERBB2 | NDP | TSPAN1 | PGR | ESR1 |
| CRYAB | THRAP4 | IL11 | | NPY1R | SNCG |
| LY6D | PPARBP | NAT1 | | NAT1 | TSPAN13 |
| FOXC1 | PERLD1 | | | CXCL14 | PERLD1 |
| CDH3 | CACNG4 | | | MAPT | RAB31 |
| TGFA | EPO | | | SCUBE2 | SLC39A6 |
| NDRG1 | | | | LRP2 | BCL2 |
| FOXM1 | | | | ERBB4 | AFF3 |
| EGFR | | | | AFF3 | IL20 |
| CTSL2 | | | | AREG | RERG |
| GSTP1 | | | | PTN | FOXA1 |
| PTDSS1 | | | | ESR1 | ERBB2 |
| CDC20 | | | | THRSP | |
| ORC6L | | | | | |
| MFGE8 | | | | | |
| MMP9 | | | | | |
| MYBL2 | | | | | |
| PLK1 | | | | | |
| MMP1 | | | | | |
| GPR56 | | | | | |
| BUB1 | | | | | |
| MELK | | | | | |
| CHI3L2 | | | | | |
| CXCL1 | | | | | |
| TRIP13 | | | | | |
| CRABP1 | | | | | |
| MYC | | | | | |
| FZD7 | | | | | |
| CX3CL1 | | | | | |
| SPP1 | | | | | |
| KRT6B | | | | | |
| CENPA | | | | | |
| KNTC2 | | | | | |
| MKI67 | | | | | |
| CCNB2 | | | | | |
| PRAME | | | | | |
| LAPTM4B | | | | | |
| CHEK1 | | | | | |
| IL8 | | | | | |
| NTRK3 | | | | | |
| KRT17 | | | | | |
| KRT5 | | | | | |
| TERT | | | | | |
| IL1A | | | | | |
| LAMC2 | | | | | |

TABLE 6
Down-Regulated Genes for each IHC category compared to all other categories

| ESR1− | ESR1− | ESR1+ | | | |
|---|---|---|---|---|---|
| PGR− | PGR− | PGR− | ESR1+ PGR− | ESR1+ PGR+ | ESR1+ PGR+ |
| ERBB2− | ERBB2+ | ERBB2− | ERBB2+ | ERBB2− | ERBB2+ |
| TFF3 | IGF1R | MMP7 | SFRP1 | ORC6L | LY6D |
| GATA3 | ESR1 | ERBB2 | CXCL1 | E2F1 | KRT6B |
| MYB | SERPINA3 | CDH3 | GSTP1 | MYBL2 | KRT5 |
| FOXA1 | BCL2 | PERLD1 | SLC2A3 | MELK | MMP7 |
| MLPH | FGFR2 | PGR | TP53 | PLK1 | LAMC2 |
| ESR1 | AFF3 | | ANK3 | BIRC5 | |
| XBP1 | RERG | | F3 | NM_018455 | |
| TFF1 | SLC39A6 | | SPP1 | FOXM1 | |
| NAT1 | | | CXCL14 | CCNE2 | |
| AFF3 | | | IL11 | CCNE1 | |
| SLC39A6 | | | CRYAB | CDC6 | |
| ERBB4 | | | NRP1 | GTSE1 | |
| DUSP4 | | | TNF | TACSTD1 | |
| PGR | | | SERPINA3 | GPR56 | |
| TSPAN1 | | | PTGS2 | MMP9 | |
| ERBB2 | | | EGFR | CENPA | |
| MUC1 | | | MMP7 | KPNA2 | |
| MAPT | | | LTBP1 | CDC20 | |
| GSTM3 | | | EMP1 | TRIP13 | |
| SCUBE2 | | | MMP3 | KNTC2 | |
| BCL2 | | | FZD7 | MMP1 | |
| PERLD1 | | | ETS1 | MKI67 | |
| RERG | | | VEGF | BUB1 | |
| NPY1R | | | OXCT1 | CTSL2 | |
| AREG | | | LAPTM4B | DLG7 | |
| IL20 | | | C3 | PRAME | |
| LRP2 | | | AKT3 | CCNB2 | |
| CGA | | | KRT6B | LAPTM4B | |
| | | | MYC | NDRG1 | |
| | | | PDPN | IL8 | |
| | | | KRT5 | LY6D | |
| | | | LAMC2 | ERBB2 | |
| | | | CDC20 | FOXC1 | |
| | | | HOXA5 | IL6 | |
| | | | FGFR2 | PERLD1 | |
| | | | IL8 | CDH3 | |
| | | | PGR | TERT | |
| | | | LY6D | CHI3L2 | |
| | | | IL1B | MMP7 | |
| | | | FOXC1 | CRABP1 | |
| | | | MFGE8 | | |
| | | | IL6 | | |
| | | | PRAME | | |
| | | | NDRG1 | | |
| | | | KRT17 | | |
| | | | SCUBE2 | | |
| | | | CDH3 | | |
| | | | NTRK3 | | |
| | | | CTSL2 | | |
| | | | MMP1 | | |
| | | | CRABP1 | | |
| | | | NPY1R | | |

To visually explicate results, heat maps of IHC tumor tissue types have been analyzed to inspect the unsupervised clustering of samples. IHC similarly categorized tissues tend to group together in unsupervised clustering indicating the panel has at least the ability to differentiate steroid receptor type in FFPE cancer tissue.

To comprehensively analyze the multiple IHC subtypes a multiclass analysis has been conducted using Stanford's (©Trustees of Leland Standford University) software. This further supports the design of the DASL custom cancer panel by validating 286 of 512 genes on the panel are statistically significant in identifying receptor type (i.e. ESR1, PGR, ERBB2) defined by IHC results (see Table 7 for a list of genes). Of these 286 genes 220 have a local false discovery rate of less than 1%. A z-score normalized heatmap showed significantly regulated genes between all receptor subtypes. This heatmap provided evidence of the z-score normalized gene expression signatures across the 286 genes defined as statistically significant and differentially regulated between receptor subtypes.

TABLE 7
Statistically significant genes regulated differentially between receptor
subtype (ESR1, PGR, ERBB2)

| | Gene | Local |
|---|---|---|
| Gene ID | Name | fdr (%) |
| GI_4758297-S | ERBB2 | 0 |
| GI_50541958-A | GATA3 | 0.000101504 |
| GI_4503602-S | ESR1 | 9.28199E−05 |
| GI_4885496-S | MYB | 0 |
| GI_31981491-S | PGR | 0 |
| GI_48928026-S | TFF3 | 0 |
| GI_13027804-S | MMP7 | 0 |
| GI_42741670-S | NAT1 | 0 |
| GI_4503056-S | CRYAB | 0 |
| GI_45505179-S | PERLD1 | 0 |
| GI_49574517-S | LY6D | 0 |
| GI_24497500-S | FOXA1 | 0 |
| GI_68348713-A | AFF3 | 0 |
| GI_14110394-S | XBP1 | 0 |
| GI_32454755-S | ORC6L | 0.000545757 |
| GI_4503734-S | FOXC1 | 0.001968443 |
| GI_12751474-S | SLC39A6 | 0.002497847 |
| GI_34222365-S | MLPH | 0.008805337 |
| GI_28559038-S | PPARBP | 0.016758705 |
| GI_41281495-S | THRAP4 | 0.025690204 |
| GI_45269142-S | CDH3 | 0.026358109 |
| GI_42544166-A | FOXM1 | 0.028334976 |
| GI_29725608-S | EGFR | 0.032623661 |
| GI_58331238-A | DUSP4 | 0.034158374 |
| GI_6552334-S | GSTP1 | 0.034689965 |
| GI_4885214-S | ERBB4 | 0.035297793 |
| GI_37655182-S | NDRG1 | 0.036157455 |
| GI_41350310-S | NPY1R | 0.038402757 |
| GI_4507460-S | TGFA | 0.041178148 |
| GI_4507450-S | TFF1 | 0.042800522 |
| GI_23110959-S | CTSL2 | 0.044293731 |
| GI_7662646-S | PTDSS1 | 0.044832054 |
| GI_4885354-S | GRB7 | 0.052760763 |
| GI_4826835-S | MMP9 | 0.056575389 |
| GI_4557436-S | CDC20 | 0.060010098 |
| GI_82533197-A | MAPT | 0.06047183 |
| GI_4504152-S | CXCL1 | 0.059829475 |
| GI_13259547-A | NM_002038 | 0.059594028 |
| GI_41584201-A | GPR56 | 0.059476465 |
| GI_34147632-S | PLK1 | 0.059213324 |
| GI_74271830-S | LAPTM4B | 0.058886209 |
| GI_41352062-S | PFKP | 0.054751139 |
| GI_31652260-S | MYBL2 | 0.054035098 |
| GI_10190747-S | SCUBE2 | 0.051580699 |
| GI_41281490-S | MELK | 0.033525991 |
| GI_12669910-S | E2F1 | 0.024116348 |
| GI_62422581-S | TSPAN13 | 0.01744636 |
| GI_4557356-A | BCL2 | 0.014810949 |
| GI_20149561-S | TRIP13 | 0.01271771 |
| GI_56117837-S | SFRP1 | 0 |
| GI_13027798-S | MMP1 | 0 |
| GI_21264577-S | TSPAN1 | 0 |
| GI_48762938-S | APOE | 0 |
| GI_46249368-A | PRAME | 0 |
| GI_21618341-S | STAT5A | 0 |
| GI_5174456-S | KNTC2 | 0 |
| GI_17402908-A | TRIM29 | 0 |
| GI_56118215-S | BUB1 | 0 |
| GI_51317385-S | GTSE1 | 0 |
| GI_38146097-S | SPP1 | 0 |
| GI_23199988-S | CXCL14 | 0 |
| GI_4585861-S | CENPA | 0 |
| GI_39725678-S | NM_018455 | 0 |
| GI_5174556-S | MFGE8 | 0 |
| GI_14249703-S | RERG | 0 |
| GI_19923216-S | MKI67 | 0 |
| GI_30172563-S | VEGF | 0 |
| GI_4506418-S | RARA | 0 |
| GI_4507456-S | TFRC | 0 |
| GI_4885218-S | ETS1 | 0 |
| GI_17505187-S | KRT6B | 0 |
| GI_11641410-A | CDC25B | 0 |
| GI_51944959-S | CDC6 | 0 |
| GI_19913405-S | TOP2A | 0 |
| GI_31543215-S | MYC | 0 |
| GI_21735624-A | YWHAZ | 0 |
| GI_47458829-S | OXCT1 | 0 |
| GI_31881686-A | RFC4 | 0 |
| GI_4557788-S | NDP | 0 |
| GI_21361644-S | DLG7 | 0 |
| GI_73858562-S | SERPINA3 | 0 |
| GI_11068002-S | IGF1R | 0 |
| GI_10938017-S | CCNB2 | 0 |
| GI_25777601-S | PSMD2 | 0 |
| GI_34335230-S | CDC45L | 0 |
| GI_14589947-S | ETV6 | 0 |
| GI_46249413-A | LTBP1 | 0 |
| GI_17318564-A | CCNE2 | 0 |
| GI_39995110-S | GSTM3 | 0 |
| GI_13699832-S | KIF2C | 0 |
| GI_17318560-A | CCNE1 | 0 |
| GI_24234746-S | ILF2 | 0 |
| GI_28610153-S | IL8 | 0 |
| GI_4503832-S | FZD7 | 0 |
| GI_16507965-S | ENO1 | 0 |
| GI_33469920-S | MCM6 | 0 |
| GI_54111253-S | CX3CL1 | 0 |
| GI_4502144-S | BIRC5 | 0 |
| GI_17738295-A | CDKN2A | 0 |
| GI_5454093-S | STK3 | 0 |
| GI_53759143-S | GMPS | 0 |
| GI_4507112-S | SNCG | 0 |
| GI_4557570-S | EXT1 | 0 |
| GI_68533254-A | CHI3L2 | 0 |
| GI_4503746-S | FLNB | 0 |
| GI_34335279-S | PSMD7 | 0 |
| GI_33589860-S | RAB31 | 0 |
| GI_14589887-S | CDH1 | 0 |
| GI_4503298-S | BHLHB2 | 0 |
| GI_4505058-S | TACSTD1 | 0 |
| GI_4758051-S | CRABP1 | 0 |
| GI_62388891-S | KPNA2 | 0 |
| GI_50845426-S | IL20 | 0 |
| GI_42716309-S | RHOB | 0 |
| GI_6806918-S | LRP2 | 0 |
| GI_4557640-S | HDAC2 | 0 |
| GI_14602458-S | TMPRSS2 | 0 |
| GI_40807441-A | PRC1 | 0 |
| GI_4504190-S | MSH6 | 0 |
| GI_9955955-A | ABCC1 | 0 |
| GI_4506760-S | S100A10 | 0 |
| GI_15011927-A | PCTK1 | 0 |
| GI_20127419-S | CHEK1 | 0 |
| GI_8051633-S | RARRES3 | 0 |
| GI_20143965-A | KIF23 | 0 |
| GI_18201908-A | VCAM1 | 0 |
| GI_28916690-A | MUC1 | 0 |
| GI_4507518-S | TK1 | 0 |
| GI_17986276-S | COL4A2 | 0 |
| GI_4557364-S | BLM | 0 |
| GI_54792128-S | DCBLD2 | 0 |
| GI_31377801-S | SEMA3F | 0 |
| GI_19718773-A | ASNS | 0 |
| GI_13186266-A | FGFR2 | 0 |
| GI_55774982-S | ATP8B1 | 0 |
| GI_21614500-A | DEGS1 | 0 |
| GI_4503986-S | GGH | 0 |
| GI_5453993-S | RAD21 | 0 |
| GI_17318577-S | KRT5 | 0 |
| GI_5921996-S | CALR | 0 |
| GI_13435352-A | L1CAM | 0 |
| GI_24430217-S | IL11 | 0 |
| GI_38455407-S | HRASLS | 0 |
| GI_34222309-S | MYST2 | 0 |
| GI_59710089-A | NUSAP1 | 0 |
| GI_21361242-S | HSPA5 | 0 |
| GI_22035683-S | AREG | 0 |
| GI_6138970-S | ACP5 | 0 |
| GI_16904380-S | LRBA | 0 |
| GI_4557434-S | CD68 | 0 |
| GI_22027547-S | CACNG4 | 0 |
| GI_4506026-S | PPP4C | 0 |
| GI_31077210-A | HIF1A | 0 |
| GI_83641890-S | GAPDH | 0 |
| GI_5032012-S | KIF20A | 0 |
| GI_62865634-S | SQLE | 0 |
| GI_38045911-A | NME1 | 0 |
| GI_21361396-S | RACGAP1 | 0 |
| GI_28872718-S | BTG2 | 0 |
| GI_42476152-S | PTN | 0 |
| GI_31377721-S | PERP | 0 |
| GI_23510382-A | EZH2 | 0 |
| GI_27436947-A | LMNA | 0 |
| GI_4505864-S | PLAUR | 0 |
| GI_6466452-S | MAD2L1 | 0 |
| GI_40807454-S | ZNF217 | 0 |
| GI_4507508-S | TIMP1 | 0 |
| GI_10834983-S | IL6 | 0 |
| GI_76881816-S | POLQ | 0 |
| GI_4505474-S | NTRK3 | 0 |
| GI_16306549-S | SELENBP1 | 0 |
| GI_6806892-S | LTA | 0 |
| GI_20336333-A | BCL2L1 | 0 |
| GI_75709178-A | MAPK1 | 0 |
| GI_13027803-S | MMP3 | 0 |
| GI_53729348-S | PLAU | 0 |
| GI_4502450-S | BRCA2 | 0 |
| GI_73623396-S | CD24 | 0 |
| GI_32307164-A | AKT3 | 0 |
| GI_5902089-S | SLC2A3 | 0 |
| GI_34147567-S | RAP1GDS1 | 0 |
| GI_4557700-S | KRT17 | 0 |
| GI_32307125-A | NCOA3 | 0 |
| GI_27886643-A | CDC2 | 0 |
| GI_31340617-S | PRKDC | 0 |
| GI_4506264-S | PTGS2 | 0 |
| GI_5016088-S | ACTB | 0 |
| GI_17149835-A | FKBP1A | 0 |
| GI_7019408-S | HIG2 | 0 |
| GI_33457353-S | BAK1 | 0 |
| GI_9845499-A | LAMC2 | 0 |
| GI_56790928-A | CXCR4 | 0 |
| GI_75709199-S | GPX4 | 0 |
| GI_61676085-S | STC2 | 0 |
| GI_27437028-A | CSF2RA | 0 |
| GI_4557554-S | ENG | 0 |
| GI_9845515-A | S100A4 | 0 |
| GI_72534651-A | RUNX3 | 0 |
| GI_19923110-S | IGFBP3 | 0 |
| GI_4507446-S | TFAP4 | 0 |
| GI_37574727-A | BID | 0 |
| GI_4504700-S | CXCL10 | 0 |
| GI_40217850-S | KRT19 | 0 |
| GI_4503718-S | FHIT | 0 |
| GI_16950654-S | CCND1 | 0.147637767 |
| GI_15451897-S | FGF2 | 0.20529995 |
| GI_11496990-S | PARP4 | 0.335501946 |
| GI-38016934-S | MLF1IP | 0.36648423 |
| GI_22001414-S | RIS1 | 0.428344619 |
| GI_54112405-A | CHEK2 | 0.482796778 |
| GI_25952110-S | TNF | 0.529235646 |
| GI_23238213-A | ACE | 0.537365236 |
| GI_14702166-A | PLAT | 0.600245478 |
| GI_32455251-A | PIK3R1 | 0.668201464 |
| GI_4506102-S | EIF2AK2 | 0.711475972 |
| GI_4885060-S | AKT1 | 0.716782955 |
| GI_4826991-S | SCO2 | 0.80189746 |
| GI_33356546-S | MCM2 | 0.817771887 |
| GI_57863311-S | UCKL1 | 0.870115021 |
| GI_27886525-A | NFAT5 | 0.919287652 |
| GI_30410729-A | FUT8 | 1.00365513 |
| GI_13112049-A | FGFR4 | 1.051450684 |
| GI_38201699-A | TERT | 1.053198413 |
| GI_31317226-S | EGR1 | 1.058526025 |
| GI_39725704-S | ZNF668 | 1.077588291 |
| GI_27502389-S | IL18 | 1.079737528 |
| GI_4507464-S | TGFB3 | 1.534775388 |
| GI_19923162-S | TFAP2C | 1.536930989 |
| GI_20070268-S | CD274 | 1.723109419 |
| GI_10518499-S | F3 | 1.803578136 |
| GI_45580725-S | GNAZ | 1.998716877 |
| GI_42544227-S | TNFRSF10D | 2.071637794 |
| GI_40807361-S | RAB7 | 2.202344832 |
| GI_38327565-A | NM_198433 | 2.270498795 |
| GI_40316920-S | PPAPDC18 | 2.360038003 |
| GI_66912177-A | NRP1 | 2.433911225 |
| GI_8400737-S | TP53 | 2.472946866 |
| GI_34304372-S | CCNB1 | 2.544760434 |
| GI_26787971-S | CSNK2B | 2.66330117 |
| GI_12597624-S | ATF5 | 2.802040471 |
| GI_24430216-S | IL10 | 3.06654912 |
| GI_4503558-S | EMP1 | 3.258585753 |
| GI_22035640-S | MGST3 | 3.465269056 |
| GI_40217844-S | ITGAV | 3.68670836 |
| GI_17149846-S | FKBP4 | 3.7884073 |
| GI_19718776-S | FEN1 | 4.015700025 |
| GI_29550837-A | GOLPH2 | 4.136393992 |
| GI_19924298-S | FRAP1 | 4.248355683 |
| GI_7549801-S | BAG1 | 4.320119002 |
| GI_21359902-S | HDGFRP3 | 4.430687556 |
| GI_4503126-S | CTNNA1 | 4.46039401 |
| GI_19923111-S | IGF1 | 4.638123112 |
| GI_39652623-S | ESPL1 | 4.642587113 |
| GI_21536403-A | BIN1 | 4.644231925 |
| GI_31317298-A | ID1 | 4.884165949 |
| GI_27894305-S | IL1B | 4.89545774 |
| GI_50345996-S | EP300 | 5.033232076 |
| GI_16507203-S | UHRF1 | 5.092195459 |
| GI_10834981-S | IGFBP5 | 5.094100257 |
| GI_13435358-S | DDB1 | 5.130688959 |
| GI_6006027-S | NRAS | 5.289314087 |
| GI_50345985-S | ATP5B | 5.291901019 |
| GI_4557480-S | ABCC2 | 5.335823592 |
| GI_47132548-A | FN1 | 5.354140443 |
| GI_27894329-S | IL1A | 5.38938265 |
| GI_24497617-S | ATAD2 | 5.400827814 |
| GI_42476332-S | SCNN1G | 5.441568371 |
| GI_4504504-S | HSD17B4 | 5.518637139 |
| GI_22547118-A | TNFRSF10B | 5.742856511 |
| GI_5730050-S | SLC2A1 | 6.063403307 |
| GI_40317625-S | THBS1 | 6.263131236 |
| GI_19923365-S | HPSE | 6.281563973 |
| GI_10835158-S | SERPINE1 | 6.423147048 |
| GI_11056055-A | MRPS12 | 6.604313658 |
| GI_22208974-A | HMGA1 | 6.649535872 |
| GI_41327154-S | EPAS1 | 6.66797078 |
| GI_62243289-S | IGFBP4 | 7.094371605 |
| GI_5453548-S | PRDX4 | 7.164920126 |
| GI_15812177-S | ZFP36L2 | 7.361391221 |
| GI_16418454-S | RBP7 | 7.423199334 |
| GI_4504618-S | IGFBP7 | 7.437581121 |
| GI_5031856-S | LDHA | 7.629216041 |
| GI_19923436-S | AK3 | 7.691683851 |
| GI_45827754-A | TACC2 | 8.068529617 |
| GI_18765740-S | SNAI1 | 8.304235546 |
| GI_22547155-S | FLII | 8.312575741 |

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claims.

1. A method of prognosing or classifying breast cancer subtype in a subject with breast cancer, comprising the steps of:
(a) determining the expression level of all the biomarkers of a gene array of Table 1 in a test sample from the subject.
(b) comparing the expression level of the biomarkers with a control value of expression level of said biomarkers of said gene array representative of a cancer subtype,
wherein a difference in the expression level of the biomarkers between the control value and the test sample is used to prognose or classify the subject with a breast cancer subtype chosen from estrogen receptor 1 (ESR1), progesterone receptor (PGR) and human epidermal growth factor receptor-2 (ERBB2) expression.

2. The method according to claim 1, wherein the difference in the expression of the biomarkers between the control and test sample is used to prognose or classify a breast cancer subtype as positive or negative for ESR1, as positive or negative for PGR and as positive or negative for ERBB2.

3. The method according to claim 2, wherein the subject is classified as negative for ESR1, PGR and ERBB2 breast cancer subtype.

4. The method of claim 1, wherein the test sample is a frozen fixed paraffin embedded (FFPE) tumor sample.

5. The method according to claim 1, wherein the test sample is tested using a high-throughput array.

6. The method according to claim 1, wherein a difference in the expression pattern of the biomarkers of Table 1 is used to determine a certain cancer treatment.

7. The method according to claim 1, wherein the up-regulation and down-regulation pattern of the biomarkers of Table 2 is used to determine a certain cancer treatment.

8. The method according to claim 2, wherein the difference in the expression of the biomarkers comprises up-regulation of the biomarkers listed in Table 5 and down-regulation of the biomarkers listed in Table 6.

9. The method according to claim 1, wherein the difference in the expression of the biomarkers between the control and test sample is used to prognose or classify a breast cancer subtype as negative for ESR1, PGR and ERBB2.

10. The method according to claim 9, wherein the difference in the expression of the biomarkers comprises up-regulation or down-regulation.

11. A kit for prognosing or classifying cancer subtypes in a subject with breast cancer, comprising detection agents that can detect the expression products of all the biomarkers listed in Table 1, and instructions for using said detection agents; and wherein said cancer subtype is chosen from estrogen receptor 1 (ESR1), progesterone receptor (PGR) and human epidermal growth factor receptor-2 (ERBB2) expression.

12. A breast cancer subtype gene array, which is consisting of the genes listed in Table 1, wherein said breast cancer subtype is according to estrogen receptor 1 (ESR 1), progesterone receptor (PGR) and human epidermal growth factor receptor-2 (ERBB2) expression.


SEQUENCE LISTING (1536 sequences)

SEQ ID NO: 1 - DNA, 46 bp, Artificial Sequence
  Probe
tcgctattcaaattggcttgacaagttgtatatggtggtgggaact

SEQ ID NO: 2 - DNA, 47 bp, Artificial Sequence
  Probe
tcctctcatgatgctggtgtttggagaaatgacagatatctttgcaa

SEQ ID NO: 3 - DNA, 44 bp, Artificial Sequence
  Probe
attggtgctggggtgctggttgctgcttacattcaggtttcatt

SEQ ID NO: 4 - DNA, 46 bp, Artificial Sequence
  Probe
gccttgtttttacctctgggcctgtttccccttctacttcctctat

SEQ ID NO: 5 - DNA, 44 bp, Artificial Sequence
  Probe
ctcttgggcatcaccacgctgcttgctacctttttaattcagct

SEQ ID NO: 6 - DNA, 44 bp, Artificial Sequence
  Probe
agactaggaagcagccggtgaaggttgtgtactcctccaaggat

SEQ ID NO: 7 - DNA, 47 bp, Artificial Sequence
  Probe
ggttttgctgatccaatacagcagacaatggtgtgtacagaaaaact

SEQ ID NO: 8 - DNA, 44 bp, Artificial Sequence
  Probe
caagcgtcctctgacactcgaggatgtctgggaagttgatgaag

SEQ ID NO: 9 - DNA, 45 bp, Artificial Sequence
  Probe
attcactgcggctctcattcagtctttctgccttcagtgttattt

SEQ ID NO: 10 - DNA, 45 bp, Artificial Sequence
  Probe
tggaaggtccgggtgactcatcccaacatttacatccttaattgt

SEQ ID NO: 11 - DNA, 46 bp, Artificial Sequence
  Probe
tcctgagatcctgagcctttggttaagaccgagctctattaagctg

SEQ ID NO: 12 - DNA, 49 bp, Artificial Sequence
  Probe
ccttgtcgaaaaccagttgagaaagaaatattatcgaatatcaatggga

SEQ ID NO: 13 - DNA, 41 bp, Artificial Sequence
  Probe
aagcccttcagcggccagtagcatctgactttgagcctcag

SEQ ID NO: 14 - DNA, 41 bp, Artificial Sequence
  Probe
gtctgcacccgggagcccccgttctatatcatcactgagtt

SEQ ID NO: 15 - DNA, 43 bp, Artificial Sequence
  Probe
gacgaggacctccaggagagctgcagagcacagagacaccact

SEQ ID NO: 16 - DNA, 44 bp, Artificial Sequence
  Probe
ctctgtcctagggcctggcggcagttacacaccatctaccagtc

SEQ ID NO: 17 - DNA, 42 bp, Artificial Sequence
  Probe
cagacatgccgggactttgccgagaaggagttgtttcccatt

SEQ ID NO: 18 - DNA, 45 bp, Artificial Sequence
  Probe
aacaactctctctacctggggcccatcttgaagtttggctccaag

SEQ ID NO: 19 - DNA, 47 bp, Artificial Sequence
  Probe
gcagaacaccactatcaagcggatcataaagaaggttcaggacctag

SEQ ID NO: 20 - DNA, 47 bp, Artificial Sequence
  Probe
ggagagccatcctccagttttacccgaaatacgtggaactcatcaac

SEQ ID NO: 21 - DNA, 45 bp, Artificial Sequence
  Probe
gtagatgcaggggactcgtggaggtctatgtacgagacaccatcc

SEQ ID NO: 22 - DNA, 41 bp, Artificial Sequence
  Probe
gtggcctcggaggacctgtgctctgagaagcagtggaatgt

SEQ ID NO: 23 - DNA, 42 bp, Artificial Sequence
  Probe
ctgaagcagatcacgccgcggacagaagaggagaagatggag

SEQ ID NO: 24 - DNA, 41 bp, Artificial Sequence
  Probe
gtgcccaccctacgctgaaggccattgaaatgttccacttc

SEQ ID NO: 25 - DNA, 44 bp, Artificial Sequence
  Probe
ggactgtgcagatcctgggtgcagacttcatcctgtctctaggg

SEQ ID NO: 26 - DNA, 46 bp, Artificial Sequence
  Probe
gctggacacagtgacactatgtggcaactcagatgacttcctcagc

SEQ ID NO: 27 - DNA, 44 bp, Artificial Sequence
  Probe
aggtccccaacggctatctgcgcttccactatgggactgaagac

SEQ ID NO: 28 - DNA, 44 bp, Artificial Sequence
  Probe
ggaagtcccttgccatcctaaaagccaccccacttctctctaag

SEQ ID NO: 29 - DNA, 47 bp, Artificial Sequence
  Probe
tccacacaggggaggtgatagcattgctttcgtgtaaattatgtaat

SEQ ID NO: 30 - DNA, 37 bp, Artificial Sequence
  Probe
caatgagcggttccgctgccctgaggcactcttccag

SEQ ID NO: 31 - DNA, 42 bp, Artificial Sequence
  Probe
atccgagtcaagcgctaccgccagagcatgaacaacttccag

SEQ ID NO: 32 - DNA, 43 bp, Artificial Sequence
  Probe
acggtgcagaagctggcacaccagatctaccagttcacagata

SEQ ID NO: 33 - DNA, 47 bp, Artificial Sequence
  Probe
tccccactttctttaggatttaggcgcccatggtacaaggaatagtc

SEQ ID NO: 34 - DNA, 49 bp, Artificial Sequence
  Probe
ccagatagaaatgcattacggaggaaagaacgagaaagaagaaatcaag

SEQ ID NO: 35 - DNA, 48 bp, Artificial Sequence
  Probe
acaggatgatggcacgtttaattctagttactctctcttcagtgagcc

SEQ ID NO: 36 - DNA, 43 bp, Artificial Sequence
  Probe
ccaagatcaggcccctgatgagtctcctaagctgaagtcgtct

SEQ ID NO: 37 - DNA, 45 bp, Artificial Sequence
  Probe
acatacaccccttccacctcgtcatccacaatgagagtacctgtg

SEQ ID NO: 38 - DNA, 44 bp, Artificial Sequence
  Probe
ctggccaacttcttgggcttccgtatatatggcatgcacagtga

SEQ ID NO: 39 - DNA, 45 bp, Artificial Sequence
  Probe
tatacccctgtggtcctcccacgctctctggacttcacagaactg

SEQ ID NO: 40 - DNA, 39 bp, Artificial Sequence
  Probe
accgtgtcgtcgcgcatcactacacacttcgagctgaag

SEQ ID NO: 41 - DNA, 46 bp, Artificial Sequence
  Probe
acttccacaggcagaagccctagatagagcttatcagatcgacaca

SEQ ID NO: 42 - DNA, 47 bp, Artificial Sequence
  Probe
taaggatgtgccaaatgattcggatactaagatgcatcgtttgaaat

SEQ ID NO: 43 - DNA, 43 bp, Artificial Sequence
  Probe
ctcacccagtgacaactcaggggctgaagagatggaggtgtcc

SEQ ID NO: 44 - DNA, 42 bp, Artificial Sequence
  Probe
gccctgggctgtctgtcaccagctatctgtcatctctctggg

SEQ ID NO: 45 - DNA, 40 bp, Artificial Sequence
  Probe
agccccccagcactaaggccgtgtctctgaggacgtcatc

SEQ ID NO: 46 - DNA, 43 bp, Artificial Sequence
  Probe
ccaaggaggtcatggagcacaggttcttcctcagcatcaactg

SEQ ID NO: 47 - DNA, 43 bp, Artificial Sequence
  Probe
gcccggttttatggtgcagagattgtctcggctcttgagtact

SEQ ID NO: 48 - DNA, 43 bp, Artificial Sequence
  Probe
aggtcacgtccgaggtcgacacaaggtacttcgatgatgaatt

SEQ ID NO: 49 - DNA, 46 bp, Artificial Sequence
  Probe
agaacgaccaaagccaaacacatttataatcagatgtctccagtgg

SEQ ID NO: 50 - DNA, 46 bp, Artificial Sequence
  Probe
ggctgtagcagacagactgcagaggcaagaagaggagagaatgaat

SEQ ID NO: 51 - DNA, 49 bp, Artificial Sequence
  Probe
ggaggaccagatgatgcaaaagaaattatgagacacagtttcttctctg

SEQ ID NO: 52 - DNA, 44 bp, Artificial Sequence
  Probe
agaggcagcttacacacgccttccagtccctctactcagagcag

SEQ ID NO: 53 - DNA, 48 bp, Artificial Sequence
  Probe
tgtgcagtacgacgatgtaccagaatacaaagacagattgaacctctc

SEQ ID NO: 54 - DNA, 47 bp, Artificial Sequence
  Probe
tgcaaggatcagtgatgaaaagagatttgtgtgcatgctagtaactg

SEQ ID NO: 55 - DNA, 45 bp, Artificial Sequence
  Probe
ggtgggaaattcgttgaatccaaaagtgacaaatggatcgatatc

SEQ ID NO: 56 - DNA, 46 bp, Artificial Sequence
  Probe
ttggaacaagggaagaccctagctgatgctgaaggagatgtatttc

SEQ ID NO: 57 - DNA, 45 bp, Artificial Sequence
  Probe
atggccatggtgtgtggaaataccttcctaatgaaaccatctgag

SEQ ID NO: 58 - DNA, 45 bp, Artificial Sequence
  Probe
ctatgatgccaaaccacagggccgggatgacagatactgtgaaag

SEQ ID NO: 59 - DNA, 47 bp, Artificial Sequence
  Probe
tggaaaccctcacagagaaaacctaagaataagcaagtcttctttcc

SEQ ID NO: 60 - DNA, 48 bp, Artificial Sequence
  Probe
gcccaaagaaagagctacctggaccttttgttttctgtttgacaacat

SEQ ID NO: 61 - DNA, 47 bp, Artificial Sequence
  Probe
aactttcggaagagcatggacagcataggaaagaagcaatatcaggt

SEQ ID NO: 62 - DNA, 48 bp, Artificial Sequence
  Probe
catggaaaacaacactcagtggctaatgaagcttgagaattatatcca

SEQ ID NO: 63 - DNA, 47 bp, Artificial Sequence
  Probe
aatgcagtacagaaccagacggctgtgatgatagaaatagggacaaa

SEQ ID NO: 64 - DNA, 46 bp, Artificial Sequence
  Probe
ctccgctccttcagttcggataggtcttacaccttgaacagaagct

SEQ ID NO: 65 - DNA, 46 bp, Artificial Sequence
  Probe
atccctcactttgggtccatgagaggaaaagagagagaactcattg

SEQ ID NO: 66 - DNA, 47 bp, Artificial Sequence
  Probe
tggaaggagcatcagtttgacagcaaaaatgaagatttaaccgagtt

SEQ ID NO: 67 - DNA, 42 bp, Artificial Sequence
  Probe
ttgagtcctactcagccccagcggaggtgaaggacgtccttc

SEQ ID NO: 68 - DNA, 40 bp, Artificial Sequence
  Probe
ggattacctgcgctgggtgcagacactgtctgagcaggtg

SEQ ID NO: 69 - DNA, 42 bp, Artificial Sequence
  Probe
gaactgagggcgctgatggacgagaccatgaaggagttgaag

SEQ ID NO: 70 - DNA, 39 bp, Artificial Sequence
  Probe
ctaccgccggcgccggtggtgctgtcgctcttgatactc

SEQ ID NO: 71 - DNA, 46 bp, Artificial Sequence
  Probe
cctcgggagccgactatgactactcagaagagtatgataacgaacc

SEQ ID NO: 72 - DNA, 47 bp, Artificial Sequence
  Probe
ttcaaaatttctgcattcacggagaatgcaaatatatagagcacctg

SEQ ID NO: 73 - DNA, 46 bp, Artificial Sequence
  Probe
ggagatctggaagccctcaaaaaggaaaccattgtgttaaaggaag

SEQ ID NO: 74 - DNA, 44 bp, Artificial Sequence
  Probe
atggttggcagctatggacctcggcctgaggagtatgagttcct

SEQ ID NO: 75 - DNA, 46 bp, Artificial Sequence
  Probe
ctcagctgggagtggaacctgtcgattaagaaggagtggacagaat

SEQ ID NO: 76 - DNA, 41 bp, Artificial Sequence
  Probe
ggcatttgggcgctgtttggcagtgatgattgcctttctgt

SEQ ID NO: 77 - DNA, 46 bp, Artificial Sequence
  Probe
gattgcacacagaggtccagatgcattccgttttgagaatgtcaat

SEQ ID NO: 78 - DNA, 49 bp, Artificial Sequence
  Probe
tgccaataagaaagtgttcctgggtagagatacatatggagtcagacct

SEQ ID NO: 79 - DNA, 48 bp, Artificial Sequence
  Probe
aagttgaaacctaccaccggacacgtgctttaagatctttgagaaaag

SEQ ID NO: 80 - DNA, 48 bp, Artificial Sequence
  Probe
tccagttactcggtcattgagggctagaaacatcgttcaaagtacaga

SEQ ID NO: 81 - DNA, 49 bp, Artificial Sequence
  Probe
gatgttgaagtgcgtcgaagttgtaggattagaagtcgttatagtggtg

SEQ ID NO: 82 - DNA, 45 bp, Artificial Sequence
  Probe
tcattccctgtcctcggatcacagtctcttctcactacagtgtcg

SEQ ID NO: 83 - DNA, 41 bp, Artificial Sequence
  Probe
catcagtgcccagcacctgtgctacagccatgtcactcctg

SEQ ID NO: 84 - DNA, 43 bp, Artificial Sequence
  Probe
ccagctagtgggctgggatggctcgtagactatgggaaactcc

SEQ ID NO: 85 - DNA, 47 bp, Artificial Sequence
  Probe
gcatttgggtgagagcacagtaaggactattgctatggatggtacag

SEQ ID NO: 86 - DNA, 46 bp, Artificial Sequence
  Probe
catggaaatgagtgttgagcaggaaattctggtgactggtatcaag

SEQ ID NO: 87 - DNA, 45 bp, Artificial Sequence
  Probe
aattgggctttttggtggtgctggagttggcaagactgtactgat

SEQ ID NO: 88 - DNA, 50 bp, Artificial Sequence
  Probe
ccacgaacaacctcactttatgaacacaaaattcttgtgtattaaggaga

SEQ ID NO: 89 - DNA, 45 bp, Artificial Sequence
  Probe
aggatggcaggttcaaagttgctaagtggaaagaaattcaagttg

SEQ ID NO: 90 - DNA, 46 bp, Artificial Sequence
  Probe
ttgttccagctgacattctcctgctgtctagctctgagcctaacag

SEQ ID NO: 91 - DNA, 44 bp, Artificial Sequence
  Probe
gagacttctgcggattgcagcaactccctcctgtcatttgttac

SEQ ID NO: 92 - DNA, 46 bp, Artificial Sequence
  Probe
ccagtggtcatgagccgatttttaagtcaattagatgaacacatgg

SEQ ID NO: 93 - DNA, 49 bp, Artificial Sequence
  Probe
tgcaattgtgttttttagaaggcaagaactcttactttggcagataggt

SEQ ID NO: 94 - DNA, 45 bp, Artificial Sequence
  Probe
cccctttctctctaaggatggcccagaaggagaactcctacccct

SEQ ID NO: 95 - DNA, 39 bp, Artificial Sequence
  Probe
tgcccctggccagaaggtgatggagaatagcagtgggac

SEQ ID NO: 96 - DNA, 42 bp, Artificial Sequence
  Probe
aacgagacctatcgccgcatcgtcaaggtggacctaaagttc

SEQ ID NO: 97 - DNA, 43 bp, Artificial Sequence
  Probe
tccagatcccagagtttgagccgagtgagcaggaagactccag

SEQ ID NO: 98 - DNA, 39 bp, Artificial Sequence
  Probe
gccctgggcagccatcttgaatatgggcggaagtacttc

SEQ ID NO: 99 - DNA, 41 bp, Artificial Sequence
  Probe
aagccacggaaggcttggtcccatcggaagttttgggtttt

SEQ ID NO: 100 - DNA, 43 bp, Artificial Sequence
  Probe
accagttgtccaagacctggcccaggttgttgaagaggtcata

SEQ ID NO: 101 - DNA, 50 bp, Artificial Sequence
  Probe
ggttccacagtcttttcagaaactcatatttaagggaaaatctctgaagg

SEQ ID NO: 102 - DNA, 46 bp, Artificial Sequence
  Probe
atacaagatggttgccgggtcatgttaattgggaaaaagaacagtc

SEQ ID NO: 103 - DNA, 41 bp, Artificial Sequence
  Probe
gtccctcgggctgcacagggacaagtaaaggctacatccag

SEQ ID NO: 104 - DNA, 41 bp, Artificial Sequence
  Probe
ccatcatcggggacgacatcaaccgacgctatgactcagag

SEQ ID NO: 105 - DNA, 41 bp, Artificial Sequence
  Probe
gcttcctaggccaggtgacccgcttcgtggtcgacttcatg

SEQ ID NO: 106 - DNA, 42 bp, Artificial Sequence
  Probe
ccctcaccctggagggtcctgtacaatctcatcatgggactc

SEQ ID NO: 107 - DNA, 38 bp, Artificial Sequence
  Probe
aggggccacagagcccccgagatggagcccaattaggt

SEQ ID NO: 108 - DNA, 42 bp, Artificial Sequence
  Probe
agcgcgggggactttctctgcaccatgtagcatactggactc

SEQ ID NO: 109 - DNA, 41 bp, Artificial Sequence
  Probe
gcagacgcagaaaacgcaggcaaacctgaggtcctcagaat

SEQ ID NO: 110 - DNA, 44 bp, Artificial Sequence
  Probe
agaggttgtggtggatgcgctgccgtattttgatcaaggttatg

SEQ ID NO: 111 - DNA, 45 bp, Artificial Sequence
  Probe
gtggaggaggaaactcgcagataccgacctactaagaactacctg

SEQ ID NO: 112 - DNA, 45 bp, Artificial Sequence
  Probe
gcgactcctgattcattgggaagtttcaaatcagctataactgga

SEQ ID NO: 113 - DNA, 46 bp, Artificial Sequence
  Probe
tgaagattgatgggatcgttgccttatgcatttgttttggttttac

SEQ ID NO: 114 - DNA, 48 bp, Artificial Sequence
  Probe
cgtgcctcatgaaataaagatccgaaaggaattggaataaaaatttcc

SEQ ID NO: 115 - DNA, 47 bp, Artificial Sequence
  Probe
ggtgttttggacaatggactggttgagcccatccctattataaaaat

SEQ ID NO: 116 - DNA, 48 bp, Artificial Sequence
  Probe
tcctacaagctttcccagaaaggatacagctggagtcagtttagtgat

SEQ ID NO: 117 - DNA, 43 bp, Artificial Sequence
  Probe
ccagctccacatcaccccagggacagcatatcagagctttgaa

SEQ ID NO: 118 - DNA, 48 bp, Artificial Sequence
  Probe
accatagaattcaaaatcctcgcctactacaccagacatcatgtcttc

SEQ ID NO: 119 - DNA, 46 bp, Artificial Sequence
  Probe
gcaggaggcttcaagtccaaagagatttttgtaactgagggtctct

SEQ ID NO: 120 - DNA, 46 bp, Artificial Sequence
  Probe
gccaaaattgttgagctgctgaaatattcaggagatcagttggaaa

SEQ ID NO: 121 - DNA, 42 bp, Artificial Sequence
  Probe
acctacaaattgccgcaccggctcatcgagaaaaagagacgt

SEQ ID NO: 122 - DNA, 46 bp, Artificial Sequence
  Probe
gggtcacttggaaaaagcagtggttcttgaacttaccttgaagcat

SEQ ID NO: 123 - DNA, 46 bp, Artificial Sequence
  Probe
cagggagaaatgtcgaaacaggtcaagagatgttctgctcaggttt

SEQ ID NO: 124 - DNA, 45 bp, Artificial Sequence
  Probe
gttccagcctcagggatgagtgcatcacaaacctactggtgtttg

SEQ ID NO: 125 - DNA, 45 bp, Artificial Sequence
  Probe
cctggcatgtcaacagcgttcctagagaagacaggctggaagata

SEQ ID NO: 126 - DNA, 48 bp, Artificial Sequence
  Probe
tgaatggccttcatatcatccacacatgaatctgcacatctgtaaatc

SEQ ID NO: 127 - DNA, 45 bp, Artificial Sequence
  Probe
tgactctgaagaggacctggaccctatggaggacttcgattcttt

SEQ ID NO: 128 - DNA, 46 bp, Artificial Sequence
  Probe
gaccagactgaggacatcagggatgttcttagaagtttcatggacg

SEQ ID NO: 129 - DNA, 46 bp, Artificial Sequence
  Probe
tggaatagattccgaggagcaggagtgctcaataaaatgttggttt

SEQ ID NO: 130 - DNA, 42 bp, Artificial Sequence
  Probe
cagaagctggggaaggcagatgagaccaaggatgagcagttt

SEQ ID NO: 131 - DNA, 44 bp, Artificial Sequence
  Probe
acgaggcttccaagaagctgaatgagtgtctgcaggaggtgtat

SEQ ID NO: 132 - DNA, 45 bp, Artificial Sequence
  Probe
gaggaggagctcatcaaagcccagaaggtgtttgaggagatgaat

SEQ ID NO: 133 - DNA, 46 bp, Artificial Sequence
  Probe
ggaaacggggtgaacttcaggtggatgaggagacagaatagagtga

SEQ ID NO: 134 - DNA, 47 bp, Artificial Sequence
  Probe
ctccctcagaaaaaggcagtggcctaaatcctttttaaatgacttgg

SEQ ID NO: 135 - DNA, 46 bp, Artificial Sequence
  Probe
gctgtggaccctactgggtttttaaaatattgtcagtttttcatcg

SEQ ID NO: 136 - DNA, 48 bp, Artificial Sequence
  Probe
ccaactgtaaagaaatcccgggatactgctctcaagaaattagaattt

SEQ ID NO: 137 - DNA, 48 bp, Artificial Sequence
  Probe
tgttacaccaccccaaagtcactttgtaagagtaagcactgctcagaa

SEQ ID NO: 138 - DNA, 44 bp, Artificial Sequence
  Probe
gatggccccattgctgaagtgcatataaatgaagatgctcagga

SEQ ID NO: 139 - DNA, 47 bp, Artificial Sequence
  Probe
tcaaacactgttgaaggagaggctgatgtgtctgtgatggtgagaat

SEQ ID NO: 140 - DNA, 45 bp, Artificial Sequence
  Probe
accagttgtcgaagatgatccgttagtgatgttctctgggaagtg

SEQ ID NO: 141 - DNA, 48 bp, Artificial Sequence
  Probe
tgtggtttttccagaggaactcagttaagaaatcgagagtggattaga

SEQ ID NO: 142 - DNA, 41 bp, Artificial Sequence
  Probe
aataatgggaacgggggcagcgttccagcctcggtttctat

SEQ ID NO: 143 - DNA, 46 bp, Artificial Sequence
  Probe
caccacaagataccaacagggcttctgaaacagatacccatagcat

SEQ ID NO: 144 - DNA, 53 bp, Artificial Sequence
  Probe
tcatgttgatctataattacacctatgggatcaataagcatgtcagactgatt

SEQ ID NO: 145 - DNA, 46 bp, Artificial Sequence
  Probe
ccagcaagctagatgcactccaacaaagagaacaacagttattgga

SEQ ID NO: 146 - DNA, 47 bp, Artificial Sequence
  Probe
caaggtgtggagttacagtccgagacagtctaaagaaagcactgatg

SEQ ID NO: 147 - DNA, 46 bp, Artificial Sequence
  Probe
gagaagaaaccaattggttgggacactgatatttcctggcttactg

SEQ ID NO: 148 - DNA, 45 bp, Artificial Sequence
  Probe
aagcagcatctgggtgtgagagtgaaacaagcgtctctgaagact

SEQ ID NO: 149 - DNA, 47 bp, Artificial Sequence
  Probe
ccactcagcagagggataccatgcaacataacctgataaagctccag

SEQ ID NO: 150 - DNA, 46 bp, Artificial Sequence
  Probe
catgggagccagccttctaacagctacccttccatcataagtgact

SEQ ID NO: 151 - DNA, 46 bp, Artificial Sequence
  Probe
ataatcagctggcttcaactccaataatattcaaagagcaagggct

SEQ ID NO: 152 - DNA, 51 bp, Artificial Sequence
  Probe
ttccaatcatgatgaaagtctgaagaaaaatgatagatttatcgcttctgt

SEQ ID NO: 153 - DNA, 49 bp, Artificial Sequence
  Probe
tttggaaaaacatcagggaattcatttaaagtaaatagctgcaaagacc

SEQ ID NO: 154 - DNA, 42 bp, Artificial Sequence
  Probe
agcgagctgaccctgtgggtggacccctatgaggtgtcctac

SEQ ID NO: 155 - DNA, 46 bp, Artificial Sequence
  Probe
tgacaacaggccaccacatacctcaacctggggaactgtattttta

SEQ ID NO: 156 - DNA, 45 bp, Artificial Sequence
  Probe
ataggagggggagctgttagggggtagacctagccaaggagaagt

SEQ ID NO: 157 - DNA, 44 bp, Artificial Sequence
  Probe
agagctacaagggcaatgaccctcttggtgaatgggaaagatac

SEQ ID NO: 158 - DNA, 46 bp, Artificial Sequence
  Probe
caggctgaacccagagagttcctgcaacaacaatacaggttatttc

SEQ ID NO: 159 - DNA, 49 bp, Artificial Sequence
  Probe
tggaacgaagagtgatcacgatttctaaatcagaatattctgtgcactc

SEQ ID NO: 160 - DNA, 37 bp, Artificial Sequence
  Probe
ggtccttgcccgggaggcgccccacctagagaaacag

SEQ ID NO: 161 - DNA, 47 bp, Artificial Sequence
  Probe
aaagacatcccttggtcctggaggcagctatcaaatatcagagcatg

SEQ ID NO: 162 - DNA, 52 bp, Artificial Sequence
  Probe
ctgagaacatctctaaggacctctacatagaagtatatccagggacctattc

SEQ ID NO: 163 - DNA, 46 bp, Artificial Sequence
  Probe
tctggatctcagcagggatgaatgcaaaagaattcttcgaaaattg

SEQ ID NO: 164 - DNA, 49 bp, Artificial Sequence
  Probe
tgaacggttaacaacaattgcacataatatgtctggacctaatagctct

SEQ ID NO: 165 - DNA, 44 bp, Artificial Sequence
  Probe
aatgcatctcttccagtgcctgcagaaacaggaagcaaggaagt

SEQ ID NO: 166 - DNA, 47 bp, Artificial Sequence
  Probe
tgagggagctcaacagaatgacacctaagaaagggaaagtctttgac

SEQ ID NO: 167 - DNA, 47 bp, Artificial Sequence
  Probe
tctggaagcaaaggcagctactctgccaaagcctatgagtctattag

SEQ ID NO: 168 - DNA, 47 bp, Artificial Sequence
  Probe
tgaattgccagagagtgttcaggatgtagaaattccaccaaacatac

SEQ ID NO: 169 - DNA, 45 bp, Artificial Sequence
  Probe
ttactgtccacgacttcccaggcaaaaaactagtgctgtccagtg

SEQ ID NO: 170 - DNA, 44 bp, Artificial Sequence
  Probe
gggccagtggaagatccgagcctactatgaaaactcaccacagc

SEQ ID NO: 171 - DNA, 45 bp, Artificial Sequence
  Probe
tgcccagtttcgaggtcatagtggagcctacagagaaattctact

SEQ ID NO: 172 - DNA, 42 bp, Artificial Sequence
  Probe
gctggcaggatctacagccgcaagaacaacatcgtcctcagt

SEQ ID NO: 173 - DNA, 47 bp, Artificial Sequence
  Probe
ggcgtcctggctgtaaacatttacattgagaaaaataaagagttgag

SEQ ID NO: 174 - DNA, 45 bp, Artificial Sequence
  Probe
acaggatggcatgtgatcctcaagacgacgaacaatgaactaaag

SEQ ID NO: 175 - DNA, 43 bp, Artificial Sequence
  Probe
gccctggcaccaagaaggttcatgtcatcttcaactacaaggg

SEQ ID NO: 176 - DNA, 45 bp, Artificial Sequence
  Probe
ctgtacacactgattgtgcggccagacaacacctatgaggtgaag

SEQ ID NO: 177 - DNA, 44 bp, Artificial Sequence
  Probe
ggaagacgattgggacttcctgccacccaagaagataaaggatc

SEQ ID NO: 178 - DNA, 45 bp, Artificial Sequence
  Probe
tgtgtggcatgcatcctcatcatcaggaaactctaaaaaagaacc

SEQ ID NO: 179 - DNA, 46 bp, Artificial Sequence
  Probe
aatttcgctctggaggggatgtggaccacagtactctagtcaccct

SEQ ID NO: 180 - DNA, 44 bp, Artificial Sequence
  Probe
cgaggttcctggtacatcgaggctcttgctcaagtgttttctga

SEQ ID NO: 181 - DNA, 48 bp, Artificial Sequence
  Probe
tggaagcgaatcaatggactctggaatatccctggacaacagttataa

SEQ ID NO: 182 - DNA, 47 bp, Artificial Sequence
  Probe
gaaattgtggaattgatgcgtgatgtttctaaagaagatcacagcaa

SEQ ID NO: 183 - DNA, 46 bp, Artificial Sequence
  Probe
ttgtgtgcttctgagccatggtgaagaaggaataatttttggaaca

SEQ ID NO: 184 - DNA, 47 bp, Artificial Sequence
  Probe
ggtcatcctgggagaaggaaagttggacatcctgaaaagagtctgtg

SEQ ID NO: 185 - DNA, 46 bp, Artificial Sequence
  Probe
aaatgaaaagcaaacctcggggatactgtctgatcatcaacaatca

SEQ ID NO: 186 - DNA, 43 bp, Artificial Sequence
  Probe
aaaagcacgggagaaagtgcccaaacttcacagcattagggac

SEQ ID NO: 187 - DNA, 45 bp, Artificial Sequence
  Probe
aggccaagaacagctcttggggacattggtaacaaagtcagtgaa

SEQ ID NO: 188 - DNA, 50 bp, Artificial Sequence
  Probe
gcaaaaccttcagctactggaaaagtcattgataaaaaactaccaaaacc

SEQ ID NO: 189 - DNA, 48 bp, Artificial Sequence
  Probe
tcaaatgaaattcaggttgttgcaggagaccatgtacatgactgtctc

SEQ ID NO: 190 - DNA, 46 bp, Artificial Sequence
  Probe
ccagttcaacccaccaaaacaacaaatgtcaacaaacaactgaaac

SEQ ID NO: 191 - DNA, 45 bp, Artificial Sequence
  Probe
gtccttctcccacacctgaggatgtctccatgaaggaagagaatc

SEQ ID NO: 192 - DNA, 49 bp, Artificial Sequence
  Probe
tgcttataccagttcccaaatccgagaaatggaaactctaattttgaaa

SEQ ID NO: 193 - DNA, 44 bp, Artificial Sequence
  Probe
ttcctctccaaaatgccagaggcggaggagaacaaacagatcat

SEQ ID NO: 194 - DNA, 44 bp, Artificial Sequence
  Probe
caaggcctgaacctgaggagccccaacaacttcctgtcctacta

SEQ ID NO: 195 - DNA, 46 bp, Artificial Sequence
  Probe
cggagcattttgataccagaagggaaagcttcattctccttgttgt

SEQ ID NO: 196 - DNA, 45 bp, Artificial Sequence
  Probe
agttgaagtggaacctggcagctgtcactcctcatgacttcattg

SEQ ID NO: 197 - DNA, 43 bp, Artificial Sequence
  Probe
agtttgccatgtacccaccgtcgatgatcgcaactggaagtgt

SEQ ID NO: 198 - DNA, 42 bp, Artificial Sequence
  Probe
gagcagattgaggcggtgctcctcaatagcctgcagcagtac

SEQ ID NO: 199 - DNA, 49 bp, Artificial Sequence
  Probe
tgggcaaatagagaggaagtctggaaaatcatgttaaacaaggaaaaga

SEQ ID NO: 200 - DNA, 48 bp, Artificial Sequence
  Probe
tcacagggagaccttttacttggcacaagatttctttgaccggtatat

SEQ ID NO: 201 - DNA, 46 bp, Artificial Sequence
  Probe
ttgcgtatgtgacagatggagcttgttcaggagatgaaattctcac

SEQ ID NO: 202 - DNA, 46 bp, Artificial Sequence
  Probe
tatctggggggatcagtccttgcattatcattgaaacacctcacaa

SEQ ID NO: 203 - DNA, 47 bp, Artificial Sequence
  Probe
accaccgaagagcactgaaaaaccaccaggaaaacactaaagaagat

SEQ ID NO: 204 - DNA, 48 bp, Artificial Sequence
  Probe
ttgccctagccaattcacaagttacactgccattctgattttaaaact

SEQ ID NO: 205 - DNA, 42 bp, Artificial Sequence
  Probe
gagagaccgtgttgcaatgttccgttcagcttggtgtcaatg

SEQ ID NO: 206 - DNA, 46 bp, Artificial Sequence
  Probe
ctcatgggtagcctctgagggtaagtgactaagacttctcctctgc

SEQ ID NO: 207 - DNA, 41 bp, Artificial Sequence
  Probe
acccaagcgggctttggtccctcttccaagtggactccttc

SEQ ID NO: 208 - DNA, 47 bp, Artificial Sequence
  Probe
tctgttttgaaggcaaaattgcaaatcttgaaattaagaaggcaaaa

SEQ ID NO: 209 - DNA, 51 bp, Artificial Sequence
  Probe
caactatggatcagaatagccacatttagaacactttttgttatcagtcaa

SEQ ID NO: 210 - DNA, 51 bp, Artificial Sequence
  Probe
tgaatgaacactcttgctttattccagaatgctgtacatctattttggatt

SEQ ID NO: 211 - DNA, 46 bp, Artificial Sequence
  Probe
tgtcacggttcccaaggacctatatgtggtagagtatggtagcaat

SEQ ID NO: 212 - DNA, 49 bp, Artificial Sequence
  Probe
tggctgcactaattgtctattgggaaatggaggataagaacattattca

SEQ ID NO: 213 - DNA, 47 bp, Artificial Sequence
  Probe
cacatttggaggagacgtaatccagcattggaacttctgatcttcaa

SEQ ID NO: 214 - DNA, 46 bp, Artificial Sequence
  Probe
ccctccctccgtcttaggtcactgttttcaacctcgaataaaaact

SEQ ID NO: 215 - DNA, 46 bp, Artificial Sequence
  Probe
aacagtcgaagaaggtgtgggcagaagaaaaagctagtgatcaaca

SEQ ID NO: 216 - DNA, 46 bp, Artificial Sequence
  Probe
ggagtcgtcagaaactccagaccagtttatgacagctgatgagaca

SEQ ID NO: 217 - DNA, 45 bp, Artificial Sequence
  Probe
caggggacagggaatgactgtcctcacaaaaaatcagctactttg

SEQ ID NO: 218 - DNA, 43 bp, Artificial Sequence
  Probe
gcactggaacaaccagccacaggactaccaagagccacaaaac

SEQ ID NO: 219 - DNA, 43 bp, Artificial Sequence
  Probe
accaccagccatggaaacgtcacagttcatccaacaagcaata

SEQ ID NO: 220 - DNA, 47 bp, Artificial Sequence
  Probe
cttcaggatgtgcttatgcaggattccaggttatatctcatctttga

SEQ ID NO: 221 - DNA, 48 bp, Artificial Sequence
  Probe
gcactcccaataatgaagtgtggccagaagtggaatctttacaggact

SEQ ID NO: 222 - DNA, 45 bp, Artificial Sequence
  Probe
aaaccaggaagcctagcatcccatgtcaaaaacttggatgaaaat

SEQ ID NO: 223 - DNA, 44 bp, Artificial Sequence
  Probe
cgaactcctggcaaatccagttccaaggttcagaccactcctag

SEQ ID NO: 224 - DNA, 45 bp, Artificial Sequence
  Probe
agaaagcctgggctttgaacctgaacggttttgatgtagaggaag

SEQ ID NO: 225 - DNA, 47 bp, Artificial Sequence
  Probe
cgccagagggttatcagaacagactgaaagtactctacagccaaaag

SEQ ID NO: 226 - DNA, 42 bp, Artificial Sequence
  Probe
ccaaccgcgtgaccttgattgagttaatgaacttcacgcctc

SEQ ID NO: 227 - DNA, 41 bp, Artificial Sequence
  Probe
agggggatgtgcgagggtgtgggataaatcttaattcctcc

SEQ ID NO: 228 - DNA, 44 bp, Artificial Sequence
  Probe
gcggctgctgttatttttcgaatatataaggaggtggaagtggc

SEQ ID NO: 229 - DNA, 46 bp, Artificial Sequence
  Probe
gggaagtgaattgctgatgcaaatcggactttattcattaatgatg

SEQ ID NO: 230 - DNA, 47 bp, Artificial Sequence
  Probe
tgggtgaaattgaagacgcttcagttaagtgaggttactggtgtgtt

SEQ ID NO: 231 - DNA, 46 bp, Artificial Sequence
  Probe
aattcagcaccagcattgcatgacagttgtttgaataacaagtggt

SEQ ID NO: 232 - DNA, 43 bp, Artificial Sequence
  Probe
ggcgagtccttggacgaacagccctcttcttcatcttccaaac

SEQ ID NO: 233 - DNA, 42 bp, Artificial Sequence
  Probe
ctcgatgagcaggcctttggggatctgacagatctgcctgtc

SEQ ID NO: 234 - DNA, 40 bp, Artificial Sequence
  Probe
gtacgggctgaagcatgcggagtccatcatgtccttccac

SEQ ID NO: 235 - DNA, 44 bp, Artificial Sequence
  Probe
tgttccagtgtgaccacgtgcaatatacgctggttccagtttct

SEQ ID NO: 236 - DNA, 44 bp, Artificial Sequence
  Probe
tgaccttgaagttcccgcctatgaagacatcttcagggatgaag

SEQ ID NO: 237 - DNA, 42 bp, Artificial Sequence
  Probe
ggagagccccgagaaggatggctcagggacagatcacttcat

SEQ ID NO: 238 - DNA, 47 bp, Artificial Sequence
  Probe
aagctaaaaactccagtgatgccaaactagaaccaacaaatgtccaa

SEQ ID NO: 239 - DNA, 46 bp, Artificial Sequence
  Probe
agagaatggtccccctcactcacatacacttaagggacgaagattg

SEQ ID NO: 240 - DNA, 47 bp, Artificial Sequence
  Probe
ggaaagggagatggatgtcatcaggaatttcttgagggaacacatct

SEQ ID NO: 241 - DNA, 47 bp, Artificial Sequence
  Probe
acagtcaaaaggcctctacggtttcataacccacagatccatttctt

SEQ ID NO: 242 - DNA, 47 bp, Artificial Sequence
  Probe
aagagaaacaggatggctgaaggtgacagagcctctggatagagaac

SEQ ID NO: 243 - DNA, 44 bp, Artificial Sequence
  Probe
gggaatgcagttgaggatccaatggagattttgatcacggtaac

SEQ ID NO: 244 - DNA, 46 bp, Artificial Sequence
  Probe
tggtgaaatcgcattatgcaagactggatttcctgaagatgtttac

SEQ ID NO: 245 - DNA, 46 bp, Artificial Sequence
  Probe
caatatgagagcagtgagcctgcagattttaaggtggatgaagatg

SEQ ID NO: 246 - DNA, 47 bp, Artificial Sequence
  Probe
tcttctgagcatgccaagttcctgatatatgcccaagacaaagagac

SEQ ID NO: 247 - DNA, 44 bp, Artificial Sequence
  Probe
gctgaggagtgcactgggtgttcttttctcctctaacccagaac

SEQ ID NO: 248 - DNA, 46 bp, Artificial Sequence
  Probe
gggcaagagccagctctgtttagcactgataatgatgacttcactg

SEQ ID NO: 249 - DNA, 47 bp, Artificial Sequence
  Probe
tccattgaagatcttcccatccaaacgtatcttacgaagacacaaga

SEQ ID NO: 250 - DNA, 45 bp, Artificial Sequence
  Probe
ggtctcccttgatctgagaatggctacctctcgatatgagccagt

SEQ ID NO: 251 - DNA, 43 bp, Artificial Sequence
  Probe
atcccgaactgaccgggagatcaaggtaaccctggtgtttgag

SEQ ID NO: 252 - DNA, 47 bp, Artificial Sequence
  Probe
ttacactctggtaccgagctcccgaagttcttctgcagtccacatat

SEQ ID NO: 253 - DNA, 45 bp, Artificial Sequence
  Probe
gcagaggaagaccatgtggacctgtcactgtcttgtacccttgtg

SEQ ID NO: 254 - DNA, 47 bp, Artificial Sequence
  Probe
caaaggcccgctctacatcttctgccttagtctcagtttgtgtgtct

SEQ ID NO: 255 - DNA, 45 bp, Artificial Sequence
  Probe
ccccagcctctggcattagaattatttaaacaaaaactaggcggt

SEQ ID NO: 256 - DNA, 41 bp, Artificial Sequence
  Probe
gcagacccgggagaaagatgtcaaacgtgcgagtgtctaac

SEQ ID NO: 257 - DNA, 44 bp, Artificial Sequence
  Probe
cacgaagagttaacccgggacttggagaagcactgcagagacat

SEQ ID NO: 258 - DNA, 44 bp, Artificial Sequence
  Probe
agcgcaagtggaatttcgattttcagaatcacaaacccctagag

SEQ ID NO: 259 - DNA, 40 bp, Artificial Sequence
  Probe
gagcgtcttgtcgcccgtgggaccttcccagtactagtgc

SEQ ID NO: 260 - DNA, 36 bp, Artificial Sequence
  Probe
cagcgactcggtgcccgcgttctaccgcgagacggt

SEQ ID NO: 261 - DNA, 40 bp, Artificial Sequence
  Probe
gatttcttcgccaagcgcaagagatcagcgcctgagaagt

SEQ ID NO: 262 - DNA, 46 bp, Artificial Sequence
  Probe
agagaggctctgagaaacctcgggaaacttagatcatcagtcaccg

SEQ ID NO: 263 - DNA, 41 bp, Artificial Sequence
  Probe
gcagcctccggaagctgtcgacttcatgacaagcattttgt

SEQ ID NO: 264 - DNA, 44 bp, Artificial Sequence
  Probe
tagggaagctcaggggggttactggcttctcttgagtcacactg

SEQ ID NO: 265 - DNA, 45 bp, Artificial Sequence
  Probe
gagggtaatgaagctgagcccaggtctcctaggaaggagagagtg

SEQ ID NO: 266 - DNA, 42 bp, Artificial Sequence
  Probe
ctcgacactcaccatgaagcgaaacacagagaagcggatttc

SEQ ID NO: 267 - DNA, 44 bp, Artificial Sequence
  Probe
aggggtcgtttgcttttcagggttttctgagggaaagtgcatat

SEQ ID NO: 268 - DNA, 42 bp, Artificial Sequence
  Probe
agtcggcggagacaaggttggctaaaggagatccgaaagctt

SEQ ID NO: 269 - DNA, 45 bp, Artificial Sequence
  Probe
tgataccggggactctccagagccatgactagatccaatggattc

SEQ ID NO: 270 - DNA, 50 bp, Artificial Sequence
  Probe
tgcatgactttcctctgtaacagaggtaatatatgagacaatcaacaccg

SEQ ID NO: 271 - DNA, 45 bp, Artificial Sequence
  Probe
tctctggacttacagggagaccccagagagagtcaaccccttctg

SEQ ID NO: 272 - DNA, 42 bp, Artificial Sequence
  Probe
cagggctggacagcacagtccctctgaactgcacagagacct

SEQ ID NO: 273 - DNA, 45 bp, Artificial Sequence
  Probe
agaaaggtgatgtcaagcccttggctgagcaaattgctatcactg

SEQ ID NO: 274 - DNA, 46 bp, Artificial Sequence
  Probe
agcgccatggattactacagaaaatatgcagctatctttctggtca

SEQ ID NO: 275 - DNA, 47 bp, Artificial Sequence
  Probe
tccaaaagaacgtcacctcagagtccacttgctgtgtagctaaatca

SEQ ID NO: 276 - DNA, 46 bp, Artificial Sequence
  Probe
aagtggagaaccacacggcgtgccactgcagtacttgttattatca

SEQ ID NO: 277 - DNA, 48 bp, Artificial Sequence
  Probe
tggtcacaggagagaaggcaatatccaatatttatttctggagtactg

SEQ ID NO: 278 - DNA, 46 bp, Artificial Sequence
  Probe
cgagtcacttcaggtggtgtgtcagagtctcccagtggattttcta

SEQ ID NO: 279 - DNA, 44 bp, Artificial Sequence
  Probe
cagttctcagccagaaccccgcacaggtctttccttatgggata

SEQ ID NO: 280 - DNA, 47 bp, Artificial Sequence
  Probe
cagtcctctcactccagctctgggacactgagctccttagagacagt

SEQ ID NO: 281 - DNA, 47 bp, Artificial Sequence
  Probe
ttgctttgatgaaccactgctgaaaagaacagataaataccgaacat

SEQ ID NO: 282 - DNA, 48 bp, Artificial Sequence
  Probe
ggaaaacgccgtcctttgaataacaattctgaaattgcactgtcacta

SEQ ID NO: 283 - DNA, 45 bp, Artificial Sequence
  Probe
ttggttccaaagggttccaccctatggtggattcttctacatcac

SEQ ID NO: 284 - DNA, 49 bp, Artificial Sequence
  Probe
tccataatcctgtttctgaggaaccataactttgatggactggatgtaa

SEQ ID NO: 285 - DNA, 46 bp, Artificial Sequence
  Probe
tgtggaatatgctgtggggtactggatacataagggaatgccatca

SEQ ID NO: 286 - DNA, 50 bp, Artificial Sequence
  Probe
cccagagaactttccaaacaagtacctaaaactcatctgatgtctgaaga

SEQ ID NO: 287 - DNA, 46 bp, Artificial Sequence
  Probe
ttcatccatacctgtgcatgagctgtattcttcacagcaacagagc

SEQ ID NO: 288 - DNA, 51 bp, Artificial Sequence
  Probe
tgtttaagataaaagttcttccagtcagtttttctcttaagtgcctgtttg

SEQ ID NO: 289 - DNA, 39 bp, Artificial Sequence
  Probe
atcgttcgtccgaccggagggtgtatgaccggcgatact

SEQ ID NO: 290 - DNA, 45 bp, Artificial Sequence
  Probe
tatagccgggatcggggagatgcctactatgacacagactatcgg

SEQ ID NO: 291 - DNA, 48 bp, Artificial Sequence
  Probe
tgccttgtacataatactattccatccacacagtttccaccctcacct

SEQ ID NO: 292 - DNA, 41 bp, Artificial Sequence
  Probe
gggggactgtgccaagacccctattgatgtcctctgtgcag

SEQ ID NO: 293 - DNA, 43 bp, Artificial Sequence
  Probe
tctcagcatgccaggagatccgagacttgttggaggagctgag

SEQ ID NO: 294 - DNA, 43 bp, Artificial Sequence
  Probe
gccccatctgaagacgtctttgcctttgacctgtcttcaaacc

SEQ ID NO: 295 - DNA, 41 bp, Artificial Sequence
  Probe
cccagcctcttcttccgtgacttctcactgctgttccacat

SEQ ID NO: 296 - DNA, 38 bp, Artificial Sequence
  Probe
aggccatggtcttgctgggcgtgaagctctctggggtg

SEQ ID NO: 297 - DNA, 39 bp, Artificial Sequence
  Probe
gccttcgtcggccagtggacacacttagccctcagtgtg

SEQ ID NO: 298 - DNA, 43 bp, Artificial Sequence
  Probe
tgtgaagaagtttgatgtgccgtgtggaggaagagattgcagt

SEQ ID NO: 299 - DNA, 40 bp, Artificial Sequence
  Probe
ccccaggggtacaatgggccaccaggattacaaggattcc

SEQ ID NO: 300 - DNA, 44 bp, Artificial Sequence
  Probe
gaccaaaagggcagaaaggtgagccttatgcactgcctaaagag

SEQ ID NO: 301 - DNA, 39 bp, Artificial Sequence
  Probe
ctggccaggcaatcaacggcaaggatggagatcgagggt

SEQ ID NO: 302 - DNA, 39 bp, Artificial Sequence
  Probe
gatccatcaaggggccttgagcatcaggcccagacagag

SEQ ID NO: 303 - DNA, 39 bp, Artificial Sequence
  Probe
gggtggacatgcacccatccccagtccaggaaaccatct

SEQ ID NO: 304 - DNA, 42 bp, Artificial Sequence
  Probe
cgatgacgtggtctgcaccagaatttatgtccgggaatgaag

SEQ ID NO: 305 - DNA, 44 bp, Artificial Sequence
  Probe
tcaggaagggatgcaggtccccgaggaatatgtcatagttctga

SEQ ID NO: 306 - DNA, 41 bp, Artificial Sequence
  Probe
ccctggccttggtgcctcttgtatccctagtgctgcatagc

SEQ ID NO: 307 - DNA, 44 bp, Artificial Sequence
  Probe
gttccacaggaaataccggatcccagctgatgtagaccctctca

SEQ ID NO: 308 - DNA, 44 bp, Artificial Sequence
  Probe
ctgatggggtcctcactgtgaatggaccaaggaaacaggtctct

SEQ ID NO: 309 - DNA, 47 bp, Artificial Sequence
  Probe
acaagaaagtttccccaccagtgaatgaaagtcttgtgactagtgct

SEQ ID NO: 310 - DNA, 45 bp, Artificial Sequence
  Probe
ccatgcttctcctggtgacaagccttctgctctgtgagttaccac

SEQ ID NO: 311 - DNA, 44 bp, Artificial Sequence
  Probe
ggagggtaccgctgctcagaatttctcctgtttcatctacaatg

SEQ ID NO: 312 - DNA, 45 bp, Artificial Sequence
  Probe
ggagggagatccggtgtccttattacatacaagactcaggaaccc

SEQ ID NO: 313 - DNA, 41 bp, Artificial Sequence
  Probe
caggctgcttgagccaactccatagcggccttttcctctac

SEQ ID NO: 314 - DNA, 44 bp, Artificial Sequence
  Probe
aggcctctgtgtccttccctgcatttctgagtttcattctcctg

SEQ ID NO: 315 - DNA, 45 bp, Artificial Sequence
  Probe
gtcctcccatcccctggactgggaggtagataggtaaataccaag

SEQ ID NO: 316 - DNA, 47 bp, Artificial Sequence
  Probe
cctgggattggtagttcgctttctctcatttagccagtttctttctc

SEQ ID NO: 317 - DNA, 50 bp, Artificial Sequence
  Probe
ggatgaagactacatccaggacaaatttaatcttactggactcaatgagc

SEQ ID NO: 318 - DNA, 48 bp, Artificial Sequence
  Probe
tggaaaagtaccagcaaggagactttggttactgtcctcgtgtgtact

SEQ ID NO: 319 - DNA, 43 bp, Artificial Sequence
  Probe
cctctgaggagaccatggcccagtatctgagtaccctgctgct

SEQ ID NO: 320 - DNA, 45 bp, Artificial Sequence
  Probe
agcgagtataacaaggccaccaaagatgactactacagacgtccg

SEQ ID NO: 321 - DNA, 45 bp, Artificial Sequence
  Probe
aaggtccctggtgaaatccaggtgtcaagaatcctagggatctgt

SEQ ID NO: 322 - DNA, 46 bp, Artificial Sequence
  Probe
tgcatccgtactcccaaaatctccaagcctatcaagtttgagcttt

SEQ ID NO: 323 - DNA, 44 bp, Artificial Sequence
  Probe
tgacggcgaggtcatgaagaagaacatgatgttcatcaagacct

SEQ ID NO: 324 - DNA, 46 bp, Artificial Sequence
  Probe
acaactgtcccggagacaatgacatctttgaatcgctgtactacag

SEQ ID NO: 325 - DNA, 47 bp, Artificial Sequence
  Probe
tgtccatgcaggcaacataaacttcaagtgggatcctaaaagtctag

SEQ ID NO: 326 - DNA, 48 bp, Artificial Sequence
  Probe
cttgttcagctgaaagttgtggaagatggtatcttgaagttgaggaat

SEQ ID NO: 327 - DNA, 47 bp, Artificial Sequence
  Probe
ggagaactggcatatgcactcaataactttgacaaacaaatcattgt

SEQ ID NO: 328 - DNA, 45 bp, Artificial Sequence
  Probe
ctcgagctcagagggtacgagctgctatgttccctgagacattag

SEQ ID NO: 329 - DNA, 47 bp, Artificial Sequence
  Probe
cgttctcctcagatggtgtctgctattgtacgtaccatgcagaatac

SEQ ID NO: 330 - DNA, 46 bp, Artificial Sequence
  Probe
aacctttcccatcatcgtgagggcttactggccatctttaagtctg

SEQ ID NO: 331 - DNA, 45 bp, Artificial Sequence
  Probe
aggacagcatgtctggggaaattttatcttgaaactgaccaaacg

SEQ ID NO: 332 - DNA, 52 bp, Artificial Sequence
  Probe
ccaagttgagattttaattctgtgacatttttacaagggtaaaatgttacca

SEQ ID NO: 333 - DNA, 46 bp, Artificial Sequence
  Probe
cctccgctgttccaaaatttgaccaaaatttggatacaaagtggta

SEQ ID NO: 334 - DNA, 39 bp, Artificial Sequence
  Probe
gtggctgctccgcttggccaccttctgccatctgactgt

SEQ ID NO: 335 - DNA, 46 bp, Artificial Sequence
  Probe
caacatcacgtgcagcaagatgacatcaaagatacctgtagctttg

SEQ ID NO: 336 - DNA, 40 bp, Artificial Sequence
  Probe
tgccctaactcgaaatggcggcaccttcgagaagcagatc

SEQ ID NO: 337 - DNA, 49 bp, Artificial Sequence
  Probe
ttctggcttagaacaaaggggcttaattattgatgttttcatagagaat

SEQ ID NO: 338 - DNA, 52 bp, Artificial Sequence
  Probe
agggtatgattaactctacctgcacactgtcctattatattcattctttttg

SEQ ID NO: 339 - DNA, 44 bp, Artificial Sequence
  Probe
ccaatgagatcattgtgaaggcaggggaatgtatgtgcacatct

SEQ ID NO: 340 - DNA, 46 bp, Artificial Sequence
  Probe
tgcctctcccatcacttccctacatggagtatatgtcaagccataa

SEQ ID NO: 341 - DNA, 47 bp, Artificial Sequence
  Probe
ccaatgatggtcaccaaatcagctgctactactcctgtaggaaggtt

SEQ ID NO: 342 - DNA, 46 bp, Artificial Sequence
  Probe
ggcccaaattctttcagtggctacctacatacaattccaaacacat

SEQ ID NO: 343 - DNA, 44 bp, Artificial Sequence
  Probe
aggtctcctcccctcaccacattgagaaatctcagtgagtcacc

SEQ ID NO: 344 - DNA, 42 bp, Artificial Sequence
  Probe
acccaagatccgctacagcgacgtgaagaagctggaaatgaa

SEQ ID NO: 345 - DNA, 45 bp, Artificial Sequence
  Probe
aaaggcttccagatgggagacccatctctcttgtgctccagactt

SEQ ID NO: 346 - DNA, 46 bp, Artificial Sequence
  Probe
tggattggtcatcctggtcatgggttaccagaagaaactgagaagc

SEQ ID NO: 347 - DNA, 47 bp, Artificial Sequence
  Probe
ttcctatgcaaggcagtccatgtcatctacacagtcaacctctacag

SEQ ID NO: 348 - DNA, 48 bp, Artificial Sequence
  Probe
ttcatctttgccaacgtcagtgaggcagatgacagatatatctgtgac

SEQ ID NO: 349 - DNA, 51 bp, Artificial Sequence
  Probe
agaactgaatgagaaccaacaagtaaatatttttggtcattgtaatcactg

SEQ ID NO: 350 - DNA, 46 bp, Artificial Sequence
  Probe
tgttttcagcccatctcctttcatatttctgggagacagaaaacat

SEQ ID NO: 351 - DNA, 47 bp, Artificial Sequence
  Probe
cctcaacacccaactgtctcgatgcaatgaacacttaataaaaaaca

SEQ ID NO: 352 - DNA, 47 bp, Artificial Sequence
  Probe
tggagcctcgcatcctatacaaccctttacaaggccagaaatgtatt

SEQ ID NO: 353 - DNA, 45 bp, Artificial Sequence
  Probe
ccagtgctcaaagacctgtggaactggtatctccacacgagttac

SEQ ID NO: 354 - DNA, 45 bp, Artificial Sequence
  Probe
tgcagcaagaccaagaaatcccccgaaccagtcaggtttacttac

SEQ ID NO: 355 - DNA, 47 bp, Artificial Sequence
  Probe
agtgtctgtcatttcgcggttcttagaagagtacttgagctccactc

SEQ ID NO: 356 - DNA, 44 bp, Artificial Sequence
  Probe
ctctttgccagcaccatcctgcaccttgttgtcatgaactttgt

SEQ ID NO: 357 - DNA, 46 bp, Artificial Sequence
  Probe
tctggagatggcagcttattggacacatggattttcttcagatttg

SEQ ID NO: 358 - DNA, 43 bp, Artificial Sequence
  Probe
ctggagcccagcaaggtgatggatgtggacacactgtactagg

SEQ ID NO: 359 - DNA, 47 bp, Artificial Sequence
  Probe
cgcatcaaatttggtgactttgacattgaagattctgattcttgtca

SEQ ID NO: 360 - DNA, 45 bp, Artificial Sequence
  Probe
ggcaatgaaatcacattgctgttcatgagtggaatccatgtttct

SEQ ID NO: 361 - DNA, 45 bp, Artificial Sequence
  Probe
ttgcctctctgaatggcaagctcaaagatgcagagaaacctgtat

SEQ ID NO: 362 - DNA, 46 bp, Artificial Sequence
  Probe
taaccaatttggccaaagccttgaattggatggaatcatttatctt

SEQ ID NO: 363 - DNA, 47 bp, Artificial Sequence
  Probe
acggggaagaaatgaagagcaaggcattcctcttgaatatttagaga

SEQ ID NO: 364 - DNA, 44 bp, Artificial Sequence
  Probe
gggagagcaaggacctgctgtttatcttgacagcgaagtacaat

SEQ ID NO: 365 - DNA, 45 bp, Artificial Sequence
  Probe
cctggaggagctgcatgtcattgatgtcaagttcctatatggttg

SEQ ID NO: 366 - DNA, 48 bp, Artificial Sequence
  Probe
tcatcattggacaggagtcaatcacctatcacaatggtgacaaatacc

SEQ ID NO: 367 - DNA, 45 bp, Artificial Sequence
  Probe
tacagcatgcatcagctccagggcaataaggaatatggcagtgaa

SEQ ID NO: 368 - DNA, 46 bp, Artificial Sequence
  Probe
ccaagttgaaccttctcacctgccaagtaaaacctaatgccgaaga

SEQ ID NO: 369 - DNA, 47 bp, Artificial Sequence
  Probe
ctggctttcaaccaacttgggtattttgacctgtatagaatgttctg

SEQ ID NO: 370 - DNA, 47 bp, Artificial Sequence
  Probe
tcacccagttgggtgcattttacatagtaaaagacttggactggaaa

SEQ ID NO: 371 - DNA, 46 bp, Artificial Sequence
  Probe
aagcaatgtggaatcgctggtttggaatgtttgctaatcttcctat

SEQ ID NO: 372 - DNA, 45 bp, Artificial Sequence
  Probe
cctgggtttgcacccaatttctggacattttatagctgagcatta

SEQ ID NO: 373 - DNA, 46 bp, Artificial Sequence
  Probe
tgcttgaagcagctctggatcataataccatcgtctgtttaaacac

SEQ ID NO: 374 - DNA, 47 bp, Artificial Sequence
  Probe
accaggttgctcaacaagtgtcagctgtcagaactcattcagatctc

SEQ ID NO: 375 - DNA, 47 bp, Artificial Sequence
  Probe
tccatcatgtcctcgcattttgggactaactgcttccattttaaatg

SEQ ID NO: 376 - DNA, 45 bp, Artificial Sequence
  Probe
ggtcgtccagaccgagtgttctttactttttgtttggttgaggtt

SEQ ID NO: 377 - DNA, 45 bp, Artificial Sequence
  Probe
gttcgagcaatccgacctggtccaagacaaacttctgaaaagaaa

SEQ ID NO: 378 - DNA, 45 bp, Artificial Sequence
  Probe
ctgtaatgcccacgtcgttgagaatgactcgatcagctactcaag

SEQ ID NO: 379 - DNA, 47 bp, Artificial Sequence
  Probe
ccggcagtagaagatggtgaaagaaacaacttactacgatgttttgg

SEQ ID NO: 380 - DNA, 48 bp, Artificial Sequence
  Probe
tggaagagactgatgagatggaccaagtagaactggtggactttgatc

SEQ ID NO: 381 - DNA, 47 bp, Artificial Sequence
  Probe
cactgctggcatttaatgtgcagtagtgaatgagtgaaggactgtaa

SEQ ID NO: 382 - DNA, 47 bp, Artificial Sequence
  Probe
gcggctatgagaggttttcctccgagtacccagaattctgttctaaa

SEQ ID NO: 383 - DNA, 43 bp, Artificial Sequence
  Probe
acgacgaggccagccagaatggcaataaggactccgaatacat

SEQ ID NO: 384 - DNA, 44 bp, Artificial Sequence
  Probe
aggaagggagggcaaagggatgagaagacaagtttcccagaagt

SEQ ID NO: 385 - DNA, 41 bp, Artificial Sequence
  Probe
tgaagcggaggctggacctggaaactgaccatcagtacctg

SEQ ID NO: 386 - DNA, 44 bp, Artificial Sequence
  Probe
atccccgggggagaagtcacgctatgagacctcactgaatctga

SEQ ID NO: 387 - DNA, 41 bp, Artificial Sequence
  Probe
ggaagaccccatcccaggaggtcacttctgaggaggagaac

SEQ ID NO: 388 - DNA, 41 bp, Artificial Sequence
  Probe
gactagagagcgagccgcaaggaagtcggtgcagtcgagac

SEQ ID NO: 389 - DNA, 38 bp, Artificial Sequence
  Probe
ctcagcagcccccagctctgcccagctactgctaccta

SEQ ID NO: 390 - DNA, 45 bp, Artificial Sequence
  Probe
gtatgacacttcgctggggctgctcaccaagaagttcatttacct

SEQ ID NO: 391 - DNA, 47 bp, Artificial Sequence
  Probe
cctttggtcaacaccgagacatttaggtgaaagacatctaattctgg

SEQ ID NO: 392 - DNA, 47 bp, Artificial Sequence
  Probe
gggttaaaatgactgggcagtgaaagttgactatttgccatgacata

SEQ ID NO: 393 - DNA, 47 bp, Artificial Sequence
  Probe
ccctatgagtggaagggtccattttgaagtcagtggagtaagcttta

SEQ ID NO: 394 - DNA, 47 bp, Artificial Sequence
  Probe
ggactacaccatacatgtgcagctgaatgactacgtggacatcatct

SEQ ID NO: 395 - DNA, 43 bp, Artificial Sequence
  Probe
cttcacacctttcaccctgggcaaggagttcaaagaaggacac

SEQ ID NO: 396 - DNA, 45 bp, Artificial Sequence
  Probe
tcacctagcagcctcaaaacgggtcagtattaaggttttcaaccg

SEQ ID NO: 397 - DNA, 48 bp, Artificial Sequence
  Probe
cagaactgcgatttccaaatcgatagttttagagcctatctattggaa

SEQ ID NO: 398 - DNA, 46 bp, Artificial Sequence
  Probe
tacccctctcctcaactgtgccaaaccagaccaagatatcaaattc

SEQ ID NO: 399 - DNA, 48 bp, Artificial Sequence
  Probe
agaattcagccctaacctctggggtctagaatttcagaagaacaaaga

SEQ ID NO: 400 - DNA, 45 bp, Artificial Sequence
  Probe
cttggcaggctgcattcagaaggtctctcagttgaagaaagagct

SEQ ID NO: 401 - DNA, 47 bp, Artificial Sequence
  Probe
tgctccagcaaaatcaagctgttttcttttgaaagttcaaactcatc

SEQ ID NO: 402 - DNA, 47 bp, Artificial Sequence
  Probe
ggtggatgctggtgtctcagtgatcatggattttcattataatgaga

SEQ ID NO: 403 - DNA, 47 bp, Artificial Sequence
  Probe
agtaacaagctcacgcagttgggcacttttgaagatcattttctcag

SEQ ID NO: 404 - DNA, 46 bp, Artificial Sequence
  Probe
tgaggtggtccttgggaatttggaaattacctatgtgcagaggaat

SEQ ID NO: 405 - DNA, 44 bp, Artificial Sequence
  Probe
ccagtggcgggacatagtcagcagtgactttctcagcaacatgt

SEQ ID NO: 406 - DNA, 42 bp, Artificial Sequence
  Probe
tcggatcctttcctcactcgcccaccatggacaactacccta

SEQ ID NO: 407 - DNA, 43 bp, Artificial Sequence
  Probe
ccctcttcagcttggtcagtggcctagtgagcatgaccaaccc

SEQ ID NO: 408 - DNA, 43 bp, Artificial Sequence
  Probe
cttccaggttcccatgatccccgactacctgtttccacagcag

SEQ ID NO: 409 - DNA, 46 bp, Artificial Sequence
  Probe
catgtttcagccaagcccagagccctaagattacaaacaactatgg

SEQ ID NO: 410 - DNA, 45 bp, Artificial Sequence
  Probe
atggggtaaggcagaagcaccagctgtactactagaagggagctt

SEQ ID NO: 411 - DNA, 46 bp, Artificial Sequence
  Probe
ttgccacaaaggtctgttcgaccagacatatcctagctaagggatg

SEQ ID NO: 412 - DNA, 46 bp, Artificial Sequence
  Probe
ggctggtgatctttcagcaggtttcttcatggaggaacttaataca

SEQ ID NO: 413 - DNA, 46 bp, Artificial Sequence
  Probe
gcggagcgtgaagtaaaagcattggcaaaacttgatcatgtaaata

SEQ ID NO: 414 - DNA, 46 bp, Artificial Sequence
  Probe
caatggctgttgggatggatttgattatgatcctgagaccagtgat

SEQ ID NO: 415 - DNA, 47 bp, Artificial Sequence
  Probe
ccaaataatttttaccgccacgcaagatttagccctgaggtcttaat

SEQ ID NO: 416 - DNA, 45 bp, Artificial Sequence
  Probe
gcctaaacgactctgcatcgccgcctctttttgaaactaagagaa

SEQ ID NO: 417 - DNA, 45 bp, Artificial Sequence
  Probe
aggcaacttgtcctgggacctcaactaagcaaatgaagccttatt

SEQ ID NO: 418 - DNA, 45 bp, Artificial Sequence
  Probe
acattgatcttgatgccttggctgcagaaatagaaggagctggtg

SEQ ID NO: 419 - DNA, 48 bp, Artificial Sequence
  Probe
gaaaggacagaagggcaaaaaacagagttttgatgataatgatagcga

SEQ ID NO: 420 - DNA, 48 bp, Artificial Sequence
  Probe
aatcagaaaaacaagccaggtcctaacatagaaagtgggaatgaagat

SEQ ID NO: 421 - DNA, 45 bp, Artificial Sequence
  Probe
accgcaaaattacacaccccagtacaccagcagaggaaacttata

SEQ ID NO: 422 - DNA, 46 bp, Artificial Sequence
  Probe
aagatgccctcaagacagtgcaggccttcatgattctctctatcat

SEQ ID NO: 423 - DNA, 46 bp, Artificial Sequence
  Probe
ttctgggtcatgcactgaggtccacagacctactgcactgagttaa

SEQ ID NO: 424 - DNA, 38 bp, Artificial Sequence
  Probe
cgggagctccctgctgccggtcataccacagccttcat

SEQ ID NO: 425 - DNA, 41 bp, Artificial Sequence
  Probe
ctcaggcccccaatgccatccttgaagtccatgtcctcttc

SEQ ID NO: 426 - DNA, 47 bp, Artificial Sequence
  Probe
ccactggagaatactccttcaagatctttccagagaaaaacattcgt

SEQ ID NO: 427 - DNA, 42 bp, Artificial Sequence
  Probe
ctggagccctgttggcagctctagctttgcagtcgtgtaatt

SEQ ID NO: 428 - DNA, 42 bp, Artificial Sequence
  Probe
gcctcactttccaccaagtgtctagagtcatgtgagcctcgt

SEQ ID NO: 429 - DNA, 40 bp, Artificial Sequence
  Probe
aggcccccgaccaacacttgcaggggtccctgctagttag

SEQ ID NO: 430 - DNA, 42 bp, Artificial Sequence
  Probe
ccgggccgaagaagagatttcctgaggattctggttttcctc

SEQ ID NO: 431 - DNA, 42 bp, Artificial Sequence
  Probe
gccagcgatggcacagattttggctctctatttgacttggag

SEQ ID NO: 432 - DNA, 47 bp, Artificial Sequence
  Probe
ggcatggtacaagatgcagcttctaaacataaacagctgtcagaatt

SEQ ID NO: 433 - DNA, 45 bp, Artificial Sequence
  Probe
ggcaccccagtctcccagttatcaaatacagcagctgatgaatag

SEQ ID NO: 434 - DNA, 41 bp, Artificial Sequence
  Probe
caggcgatgccctccacaggtatggcagagcagtctaagag

SEQ ID NO: 435 - DNA, 41 bp, Artificial Sequence
  Probe
agcagccgcaagtggtagaggcccagacacagctccaaatc

SEQ ID NO: 436 - DNA, 43 bp, Artificial Sequence
  Probe
gaagccgaagctgaccagcagatggacaacttgtacctgaaag

SEQ ID NO: 437 - DNA, 46 bp, Artificial Sequence
  Probe
ccaagatggcgacatgatctttctgtcagaaaacatcagcaagttc

SEQ ID NO: 438 - DNA, 44 bp, Artificial Sequence
  Probe
ttgacttcactcatccctgcgaccatgaggagattcgtgagaac

SEQ ID NO: 439 - DNA, 44 bp, Artificial Sequence
  Probe
ctggagaggtacctcttggaggccaaggaggccgagaatatcac

SEQ ID NO: 440 - DNA, 49 bp, Artificial Sequence
  Probe
tgagaatatcactgtcccagacaccaaagttaatttctatgcctggaag

SEQ ID NO: 441 - DNA, 46 bp, Artificial Sequence
  Probe
cgagtctactccaatttcctccggggaaagctgaagctgtacacag

SEQ ID NO: 442 - DNA, 42 bp, Artificial Sequence
  Probe
aagagcttctgtgcttcaccgagcggttggaggacttggtgt

SEQ ID NO: 443 - DNA, 39 bp, Artificial Sequence
  Probe
ccgcctgagacacccatgacgtctcacatccgctacgag

SEQ ID NO: 444 - DNA, 40 bp, Artificial Sequence
  Probe
agatcctggagggccgcaccgagtgtgtgctgagcaacct

SEQ ID NO: 445 - DNA, 47 bp, Artificial Sequence
  Probe
ttggaaggtgatcagcacacaataggcattcaataaatgttgaaata

SEQ ID NO: 446 - DNA, 43 bp, Artificial Sequence
  Probe
aggaccacgaccccaccatccaggattcctactggaaggagtt

SEQ ID NO: 447 - DNA, 40 bp, Artificial Sequence
  Probe
cttgtcctcgtgggcaacaagtgtgaccttgtgaccactg

SEQ ID NO: 448 - DNA, 41 bp, Artificial Sequence
  Probe
gcggattgtgcgaggcacccagctctttgaggacaactatg

SEQ ID NO: 449 - DNA, 45 bp, Artificial Sequence
  Probe
ttccacaagaacaaccagctggctctcacactgatagacaccaac

SEQ ID NO: 450 - DNA, 42 bp, Artificial Sequence
  Probe
gtaagggctcccgctgctggggagagagttctgaggattgtc

SEQ ID NO: 451 - DNA, 43 bp, Artificial Sequence
  Probe
gaccggcgatgctgagaaccaataccagacactgtacaagctc

SEQ ID NO: 452 - DNA, 44 bp, Artificial Sequence
  Probe
gagaggtgtgaggtggtgatggggaaccttgagattgtgctcac

SEQ ID NO: 453 - DNA, 41 bp, Artificial Sequence
  Probe
gtgcgagggacccaggtctacgatgggaagtttgccatctt

SEQ ID NO: 454 - DNA, 46 bp, Artificial Sequence
  Probe
agtaccgagccttgcgcaagtactatgaaaactgtgaggttgtcat

SEQ ID NO: 455 - DNA, 45 bp, Artificial Sequence
  Probe
cagttcttgtgtgcgtgcctgccctagttccaagatggaagtaga

SEQ ID NO: 456 - DNA, 46 bp, Artificial Sequence
  Probe
tgcttatcctcaagcaacagggcatcacctctctacagttccagtc

SEQ ID NO: 457 - DNA, 48 bp, Artificial Sequence
  Probe
ccatactggaattcaccaactgggggtatataccccaacactaggctc

SEQ ID NO: 458 - DNA, 45 bp, Artificial Sequence
  Probe
gccatatgccttctcatctgggcacttactactaaagacctggcg

SEQ ID NO: 459 - DNA, 48 bp, Artificial Sequence
  Probe
aggaggatgctaaaaatgtcacgaatatggacatatcatctgtggact

SEQ ID NO: 460 - DNA, 44 bp, Artificial Sequence
  Probe
atgctgctactgttcctgtccgagctgcagtattacctcaccac

SEQ ID NO: 461 - DNA, 46 bp, Artificial Sequence
  Probe
gacaagtcgcggggagataaactgaagatcaacatcgatgtacttt

SEQ ID NO: 462 - DNA, 42 bp, Artificial Sequence
  Probe
cagcacctgtcatttggggaggactatccaggcattgtgaac

SEQ ID NO: 463 - DNA, 43 bp, Artificial Sequence
  Probe
atcctgagggcttgcaaccagcagctgactgctaagctagctt

SEQ ID NO: 464 - DNA, 43 bp, Artificial Sequence
  Probe
gcagagctggcctgtgatggctacttagtgtctaccccacagc

SEQ ID NO: 465 - DNA, 45 bp, Artificial Sequence
  Probe
tggccatggtctaaatgaagcagatgctgatttcctagatgacct

SEQ ID NO: 466 - DNA, 47 bp, Artificial Sequence
  Probe
ccagcacctttgtaatgcatatgagctcgggagaccagtacttaaag

SEQ ID NO: 467 - DNA, 39 bp, Artificial Sequence
  Probe
ctggacagcagcaagcccgccgtgtacaactaccccgag

SEQ ID NO: 468 - DNA, 39 bp, Artificial Sequence
  Probe
cccacggccagcaggtgccctactacctggagaacgagc

SEQ ID NO: 469 - DNA, 44 bp, Artificial Sequence
  Probe
ggaaagaaaggcagcgggaatttgagatttttgggaagaaagtc

SEQ ID NO: 470 - DNA, 51 bp, Artificial Sequence
  Probe
ccttccccctgttactaatcctcattaaaaagaaaaacaacagtaactgca

SEQ ID NO: 471 - DNA, 46 bp, Artificial Sequence
  Probe
caccttgcagaatgactactttgctatcaaacaagaagtcgtcacc

SEQ ID NO: 472 - DNA, 45 bp, Artificial Sequence
  Probe
aagtttggcttttcatggcctgccactgaaaatcaagaaagaacc

SEQ ID NO: 473 - DNA, 46 bp, Artificial Sequence
  Probe
cctgcagtcaagaacagccctttaaattcagctatggagaaaagtg

SEQ ID NO: 474 - DNA, 46 bp, Artificial Sequence
  Probe
tatgtttgaaaagggccccaggcagttttatgatgacacctgtgtt

SEQ ID NO: 475 - DNA, 47 bp, Artificial Sequence
  Probe
tgagaacttcctgatctctctcgctgtgagacatgtctgagactcct

SEQ ID NO: 476 - DNA, 46 bp, Artificial Sequence
  Probe
tgtgctctatgaactccttcagcatattctgaagcagaggaaacct

SEQ ID NO: 477 - DNA, 46 bp, Artificial Sequence
  Probe
ccaccaggagtcctaccctctgtcagtgtctcccatggagaataat

SEQ ID NO: 478 - DNA, 42 bp, Artificial Sequence
  Probe
cggagtcttggagccgctgcagaagggaataaagagagatgc

SEQ ID NO: 479 - DNA, 45 bp, Artificial Sequence
  Probe
tcttttcctccgtcttgttgcatgcaagaaaattacagtccgctg

SEQ ID NO: 480 - DNA, 43 bp, Artificial Sequence
  Probe
ggaagatggcggactggagctgaaagtgttgattgggaaactt

SEQ ID NO: 481 - DNA, 45 bp, Artificial Sequence
  Probe
cccacctcggaaatttccttctgataaaatttttgaagccatttc

SEQ ID NO: 482 - DNA, 46 bp, Artificial Sequence
  Probe
ccccaccattaatgtgctggaatcaaaggatacagacagtgatagg

SEQ ID NO: 483 - DNA, 47 bp, Artificial Sequence
  Probe
gtggtgctgaagcctcaatgtttagagtcctcattggcacttactat

SEQ ID NO: 484 - DNA, 43 bp, Artificial Sequence
  Probe
ctgtagcgatgactccacgctccgaaggctccagtgtgaatct

SEQ ID NO: 485 - DNA, 43 bp, Artificial Sequence
  Probe
tgttcgagaagaagtcgctggaggacaaaaccgaaagagagct

SEQ ID NO: 486 - DNA, 40 bp, Artificial Sequence
  Probe
cctgtacccgccctgggacaagaacttcaccgagaatgac

SEQ ID NO: 487 - DNA, 46 bp, Artificial Sequence
  Probe
gatccccggtcatttcttctcaggaaccccaatgataaatatgaac

SEQ ID NO: 488 - DNA, 50 bp, Artificial Sequence
  Probe
gggaggatgaggagaaaaatgaaagtgggttaactgaatacagattagtc

SEQ ID NO: 489 - DNA, 46 bp, Artificial Sequence
  Probe
ctgtttgtgtctgtgctcccctttaagatcagctattacttttccg

SEQ ID NO: 490 - DNA, 48 bp, Artificial Sequence
  Probe
caggagattggaaaagcaaatgcttttacacaacagacacagagtgtg

SEQ ID NO: 491 - DNA, 45 bp, Artificial Sequence
  Probe
acactttcctaagcctccgggatgtttttggcaaggacttaattt

SEQ ID NO: 492 - DNA, 44 bp, Artificial Sequence
  Probe
agcagtgattccctcccgaacagttaaccggaagagtacagaca

SEQ ID NO: 493 - DNA, 45 bp, Artificial Sequence
  Probe
tcgtccaaaagtgttaatgcccaagtgactgacatcaactccaag

SEQ ID NO: 494 - DNA, 49 bp, Artificial Sequence
  Probe
tcaccactattgctggagtcatgacactaagtcaagttaaaggctttgt

SEQ ID NO: 495 - DNA, 48 bp, Artificial Sequence
  Probe
agaatggtgtcaatgaagccaaaatagatgagatcaagaatgacaatg

SEQ ID NO: 496 - DNA, 43 bp, Artificial Sequence
  Probe
ggagaagggtacgccagggtcgctgagagactctgttctccct

SEQ ID NO: 497 - DNA, 39 bp, Artificial Sequence
  Probe
gaacgtcaggccacccgccgctaagctgagaagggagag

SEQ ID NO: 498 - DNA, 41 bp, Artificial Sequence
  Probe
atgggaattcaaggcctggccaaactaattgctgatgtggc

SEQ ID NO: 499 - DNA, 46 bp, Artificial Sequence
  Probe
cctccagggaattacaagaagcccaaactcctctactgtagcaacg

SEQ ID NO: 500 - DNA, 46 bp, Artificial Sequence
  Probe
tgtttgttcctggaaaggctggaggagaaccattacaacacctata

SEQ ID NO: 501 - DNA, 47 bp, Artificial Sequence
  Probe
gaaagcaatcttgtttctccccctgccagtctcttctgattaaagag

SEQ ID NO: 502 - DNA, 49 bp, Artificial Sequence
  Probe
tcaagcagaagagagaggagttgtgtctatcaaaggagtgtgtgctaac

SEQ ID NO: 503 - DNA, 46 bp, Artificial Sequence
  Probe
atgtggcactgaaacgaactgggcagtataaacttggatccaaaac

SEQ ID NO: 504 - DNA, 48 bp, Artificial Sequence
  Probe
tcttccaatgtctgctaagagctgattttaatggccacatctaatctc

SEQ ID NO: 505 - DNA, 44 bp, Artificial Sequence
  Probe
ccgatgagtgcacgttcaaggagattctccttcccaacaactac

SEQ ID NO: 506 - DNA, 42 bp, Artificial Sequence
  Probe
ggcatgttcatcgccctgagcaagaatgggaagaccaagaag

SEQ ID NO: 507 - DNA, 40 bp, Artificial Sequence
  Probe
gtcacccacttcctccccaggctgtgaccctccagaggac

SEQ ID NO: 508 - DNA, 45 bp, Artificial Sequence
  Probe
ttgaaaaggaggatcgagctcactgtggagtatccatggagatgt

SEQ ID NO: 509 - DNA, 43 bp, Artificial Sequence
  Probe
aactgcagaactgggatgtggagctggaagtgcctcctcttct

SEQ ID NO: 510 - DNA, 45 bp, Artificial Sequence
  Probe
gctccatattggacatccccagaaaagatggaaaagaaattgcat

SEQ ID NO: 511 - DNA, 43 bp, Artificial Sequence
  Probe
tccatgcccgtagaggaagtgtncagatgggattaacgtccac

SEQ ID NO: 512 - DNA, 40 bp, Artificial Sequence
  Probe
ggaagaggaccggggattggtaccgtaaccatggtcagct

SEQ ID NO: 513 - DNA, 41 bp, Artificial Sequence
  Probe
aatgccaaccatgcggtggctgaaaaacgggaaggagttta

SEQ ID NO: 514 - DNA, 40 bp, Artificial Sequence
  Probe
gctcccagcctggagcagcaagagcaggagctgacagtag

SEQ ID NO: 515 - DNA, 41 bp, Artificial Sequence
  Probe
gacacacccccagcgcatggagaagaaactgcatgcagtac

SEQ ID NO: 516 - DNA, 42 bp, Artificial Sequence
  Probe
cgccggcctcgtgagtctagatctacctctcgacccactatg

SEQ ID NO: 517 - DNA, 45 bp, Artificial Sequence
  Probe
catgtcgttcagatttggccaacatctcatcaagccctctgtagt

SEQ ID NO: 518 - DNA, 44 bp, Artificial Sequence
  Probe
catgacaaggaggactttcctgcctcttggagatcagaggagga

SEQ ID NO: 519 - DNA, 45 bp, Artificial Sequence
  Probe
cctcggtcactccaactcccttaaaatacctagacctaaacggct

SEQ ID NO: 520 - DNA, 47 bp, Artificial Sequence
  Probe
ttgctaacaaccgctttgagacagggaagaaaaaactgcagtatctg

SEQ ID NO: 521 - DNA, 41 bp, Artificial Sequence
  Probe
cgccaagctgacccacaataaagatgtcagagacctgtttg

SEQ ID NO: 522 - DNA, 43 bp, Artificial Sequence
  Probe
actggccactcagcgacgtgcggttcttcctgaatcagtattc

SEQ ID NO: 523 - DNA, 46 bp, Artificial Sequence
  Probe
gaaatttgattcctcccgggacagaaacaagccctttaagtttatg

SEQ ID NO: 524 - DNA, 47 bp, Artificial Sequence
  Probe
gtgggtcagagagccaaactgactatatctccagattatgcctatgg

SEQ ID NO: 525 - DNA, 45 bp, Artificial Sequence
  Probe
ccactctcgtcttcgatgtggagcttctaaaactggaatgacagg

SEQ ID NO: 526 - DNA, 41 bp, Artificial Sequence
  Probe
atcggggtcaagaagcgggtggaccactgtcccatcaaatc

SEQ ID NO: 527 - DNA, 46 bp, Artificial Sequence
  Probe
tggagctgctcaaaatagagcgacgaactgagctgtaaccagactg

SEQ ID NO: 528 - DNA, 46 bp, Artificial Sequence
  Probe
agtaagcctgtgtgtttgtgggccctgagagactcagagacctcag

SEQ ID NO: 529 - DNA, 48 bp, Artificial Sequence
  Probe
cttcctccattgcacatgaacatatgtccatccatatatattcatcag

SEQ ID NO: 530 - DNA, 48 bp, Artificial Sequence
  Probe
ttctaagggtagaagaggcaagtggtagggatgaggtctgataagaac

SEQ ID NO: 531 - DNA, 42 bp, Artificial Sequence
  Probe
ttgtgtcccaaaatcccctcagcctcttctctgcacgttgct

SEQ ID NO: 532 - DNA, 47 bp, Artificial Sequence
  Probe
agtctgaagaattccggagtccccgatgacatcttcaagctagatga

SEQ ID NO: 533 - DNA, 47 bp, Artificial Sequence
  Probe
ccaaccagctcttcatcaacctcactgacctactatacctggacctc

SEQ ID NO: 534 - DNA, 44 bp, Artificial Sequence
  Probe
agccatttgcaagctgagcaagctgaagaagctgtacctgaatt

SEQ ID NO: 535 - DNA, 45 bp, Artificial Sequence
  Probe
acaagtgacccctgacagcgacaagaacaagacatactctgtgga

SEQ ID NO: 536 - DNA, 46 bp, Artificial Sequence
  Probe
caggacagcacatctccaagagcccatttgaagtgagtgttgacaa

SEQ ID NO: 537 - DNA, 43 bp, Artificial Sequence
  Probe
cattgaaggcccctctcaggcaaagattgagtacaacgaccag

SEQ ID NO: 538 - DNA, 46 bp, Artificial Sequence
  Probe
cctgtggaagaaatggcaaacaattctgcagtactttaaccttgaa

SEQ ID NO: 539 - DNA, 47 bp, Artificial Sequence
  Probe
gatggaaaacgcataatctgggacagtagaaagggcttcatcatatc

SEQ ID NO: 540 - DNA, 45 bp, Artificial Sequence
  Probe
gggcttctgacctgtgaagcaacagtcaatgggcatttgtataag

SEQ ID NO: 541 - DNA, 49 bp, Artificial Sequence
  Probe
tgacagaaacccaagctggagaatacctactttttattcagagtgaagc

SEQ ID NO: 542 - DNA, 47 bp, Artificial Sequence
  Probe
aagcactcgaggagggcaactactttgagatgagtacctattcaaca

SEQ ID NO: 543 - DNA, 46 bp, Artificial Sequence
  Probe
tcatcagtggcaagaaacgacaccggatactacacttgttcctctt

SEQ ID NO: 544 - DNA, 46 bp, Artificial Sequence
  Probe
caacgacacaggcagctacgtctgctactacaagtacatcaaggca

SEQ ID NO: 545 - DNA, 44 bp, Artificial Sequence
  Probe
cattcatcaacaagcctgacacgctcttggtcaacaggaaggac

SEQ ID NO: 546 - DNA, 42 bp, Artificial Sequence
  Probe
gagcgacgctcccaacagacccacacagaactctccagcatc

SEQ ID NO: 547 - DNA, 45 bp, Artificial Sequence
  Probe
cactgggaacacttaccgagtgggtgacacttatgagcgtcctaa

SEQ ID NO: 548 - DNA, 41 bp, Artificial Sequence
  Probe
tgccatgaagggggtcagtcctacaagattggtgacacctg

SEQ ID NO: 549 - DNA, 46 bp, Artificial Sequence
  Probe
atgcaacgatcaggacacaaggacatcctatagaattggagacacc

SEQ ID NO: 550 - DNA, 44 bp, Artificial Sequence
  Probe
gatggttgtattgggcagggtggctccaggatgttaggaactgt

SEQ ID NO: 551 - DNA, 44 bp, Artificial Sequence
  Probe
acatgaactcaggcctgggctccatgaactccatgaacacctac

SEQ ID NO: 552 - DNA, 40 bp, Artificial Sequence
  Probe
caacatgaccccggcgtccttcaacatgtcctatgccaac

SEQ ID NO: 553 - DNA, 38 bp, Artificial Sequence
  Probe
gccgtggacaaccccctgcccgactactctctgcctcc

SEQ ID NO: 554 - DNA, 43 bp, Artificial Sequence
  Probe
agaacttccactcggtgcgggagatgttcgagtcacagaggat

SEQ ID NO: 555 - DNA, 43 bp, Artificial Sequence
  Probe
gcgcttcaagaagaaggacgcggtgaaggacaaggaggagaag

SEQ ID NO: 556 - DNA, 46 bp, Artificial Sequence
  Probe
gtagtggccatccccaacaatgctaatattcacagcatcatcacag

SEQ ID NO: 557 - DNA, 45 bp, Artificial Sequence
  Probe
tgggaccaaaacctgcagctagggatgtgaatcttcctagaccac

SEQ ID NO: 558 - DNA, 44 bp, Artificial Sequence
  Probe
agatggtgaggcagcaggctgcactatcaacaatagcctatcca

SEQ ID NO: 559 - DNA, 45 bp, Artificial Sequence
  Probe
ctccgaggacttcaccatccacgaaaatgctttcattgtgttcat

SEQ ID NO: 560 - DNA, 46 bp, Artificial Sequence
  Probe
gcacacagtaagtcaggaggatcgcaagtcctacagctggaaacag

SEQ ID NO: 561 - DNA, 47 bp, Artificial Sequence
  Probe
tggagtgtacaccatctttgccatcctggagtacactgttgtcttaa

SEQ ID NO: 562 - DNA, 42 bp, Artificial Sequence
  Probe
gtgggaatgccacccgaattggcagatttgccaactatcttc

SEQ ID NO: 563 - DNA, 42 bp, Artificial Sequence
  Probe
tcttccagcaagtgcaacccttctttgacaacatttttgtgg

SEQ ID NO: 564 - DNA, 46 bp, Artificial Sequence
  Probe
actgcaaagatctcatgggcttcggaacaaaacctcgtcacattac

SEQ ID NO: 565 - DNA, 47 bp, Artificial Sequence
  Probe
ggacgggcctatatccctcctacaaagttcgagagaagatagaaacg

SEQ ID NO: 566 - DNA, 46 bp, Artificial Sequence
  Probe
ccccacatatcctgaggctgagaaataaagctcagatggaagagat

SEQ ID NO: 567 - DNA, 45 bp, Artificial Sequence
  Probe
taacaagggctgcaatgccctcatacccatgcacagtacaataat

SEQ ID NO: 568 - DNA, 44 bp, Artificial Sequence
  Probe
gaaaagaactgctgggtgggggcctgtttctgtaactttctccc

SEQ ID NO: 569 - DNA, 47 bp, Artificial Sequence
  Probe
ttggatgaaaagatttcaggcaaagacttgcaggaagatgatgataa

SEQ ID NO: 570 - DNA, 44 bp, Artificial Sequence
  Probe
aaaggtacgggccagcttgtgcctaatagaaggttgagaccagc

SEQ ID NO: 571 - DNA, 44 bp, Artificial Sequence
  Probe
gccaccccactctcagcctaccagatccctaggacattcactct

SEQ ID NO: 572 - DNA, 44 bp, Artificial Sequence
  Probe
attgtgggccgatcggacagcaccaattctgaagacaactatgt

SEQ ID NO: 573 - DNA, 42 bp, Artificial Sequence
  Probe
ggccatggaacgagcaggtgataattcccagagcgtctacat

SEQ ID NO: 574 - DNA, 48 bp, Artificial Sequence
  Probe
tcatctcaatggaaggatcctgccttaagtcaacttatttgtttttgc

SEQ ID NO: 575 - DNA, 45 bp, Artificial Sequence
  Probe
gaaactgatgccaaggggctgagtgagttcaactacatgttctgg

SEQ ID NO: 576 - DNA, 50 bp, Artificial Sequence
  Probe
tgaagaaggaagctgtgttgaaacagaaaaataagtcaaaaggaacaaaa

SEQ ID NO: 577 - DNA, 40 bp, Artificial Sequence
  Probe
ctctgctcctcctgttcgacagtcagccgcatcttctttt

SEQ ID NO: 578 - DNA, 41 bp, Artificial Sequence
  Probe
agccccagcaagagcacaagaggaagagagagaccctcact

SEQ ID NO: 579 - DNA, 43 bp, Artificial Sequence
  Probe
ctcctctgacttcaacagcgacacccactcctccacctttgac

SEQ ID NO: 580 - DNA, 46 bp, Artificial Sequence
  Probe
tggctagccagcagacatgaagctaatttgctaccaatgaaagaag

SEQ ID NO: 581 - DNA, 45 bp, Artificial Sequence
  Probe
ctggtgccgagatttaggggtggatgaaacgtgtctatttgaatc

SEQ ID NO: 582 - DNA, 46 bp, Artificial Sequence
  Probe
tatggtgtggagcctcctggtttgataaagctggaaaaagagattg

SEQ ID NO: 583 - DNA, 43 bp, Artificial Sequence
  Probe
cagagtcgtcgcccctttttacaacctggtcccgttttattct

SEQ ID NO: 584 - DNA, 41 bp, Artificial Sequence
  Probe
gccggaggaggtggatgtgctttttaacatcgacggtcaag

SEQ ID NO: 585 - DNA, 38 bp, Artificial Sequence
  Probe
gcccggcaggacgagaaagagtgcctcaagtaccaggt

SEQ ID NO: 586 - DNA, 47 bp, Artificial Sequence
  Probe
ggttggaatccattttcgtacccatacaaaaaactggattatggaaa

SEQ ID NO: 587 - DNA, 46 bp, Artificial Sequence
  Probe
agaccaaagaagccacggagtctaagaatttatgaatctcatgtgg

SEQ ID NO: 588 - DNA, 45 bp, Artificial Sequence
  Probe
gttgatggcaatcatggagcatgcttactatgccagctttggtta

SEQ ID NO: 589 - DNA, 42 bp, Artificial Sequence
  Probe
gtccgagggcaagggaaagacgagtcaaaggtggaagacgac

SEQ ID NO: 590 - DNA, 42 bp, Artificial Sequence
  Probe
tctcgctggagagcgatgtggactacagctcggatgacaatc

SEQ ID NO: 591 - DNA, 42 bp, Artificial Sequence
  Probe
aaagtcacagcccagctgtggccatcccaagcaaattgagaa

SEQ ID NO: 592 - DNA, 46 bp, Artificial Sequence
  Probe
tccctggaggaagtgttgacctcagacgctcagattatgctaaagt

SEQ ID NO: 593 - DNA, 47 bp, Artificial Sequence
  Probe
caattgcacagcagaatgttccagaattttcctactgagttgttgct

SEQ ID NO: 594 - DNA, 45 bp, Artificial Sequence
  Probe
tgtccagtggcatccagagaaagcaccttatgagtggaagaattt

SEQ ID NO: 595 - DNA, 45 bp, Artificial Sequence
  Probe
ctggatgctggtgctcagtacgggaaagtcatagaccgaagagtg

SEQ ID NO: 596 - DNA, 47 bp, Artificial Sequence
  Probe
aattttccccttggaaacaccagcatttgctataaaggaacaaggat

SEQ ID NO: 597 - DNA, 47 bp, Artificial Sequence
  Probe
gcaagcctgttcttggaatttgctatggtatgcagatgatgaataag

SEQ ID NO: 598 - DNA, 39 bp, Artificial Sequence
  Probe
caccgtcgccgaggacagggaatgactacggcaaatcag

SEQ ID NO: 599 - DNA, 42 bp, Artificial Sequence
  Probe
gccagaccatgggatgtcggcaaagctcagaggaaaaagaag

SEQ ID NO: 600 - DNA, 44 bp, Artificial Sequence
  Probe
aggcctgcaaggagtacaagcccctcatcatctacaatgccatc

SEQ ID NO: 601 - DNA, 42 bp, Artificial Sequence
  Probe
ggcctgcatcatcgtcttgggcttcaactactggattgcgag

SEQ ID NO: 602 - DNA, 42 bp, Artificial Sequence
  Probe
attacggcaggctgcagcaggatgtcctccagtttcagaaga

SEQ ID NO: 603 - DNA, 47 bp, Artificial Sequence
  Probe
caatcagatgaaggaggtgaaggaacagtgtgaggagcgaatagaag

SEQ ID NO: 604 - DNA, 43 bp, Artificial Sequence
  Probe
atccttccctgaccccaggggcctctaccacttctgcctctac

SEQ ID NO: 605 - DNA, 44 bp, Artificial Sequence
  Probe
tatggcaagcgtgacttcttgctgagtgacaaagcctctagcct

SEQ ID NO: 606 - DNA, 43 bp, Artificial Sequence
  Probe
catggagtactcggtgctgctgcctcgaacactcttccagagg

SEQ ID NO: 607 - DNA, 44 bp, Artificial Sequence
  Probe
ctcccagtgaggcaagaccgaagtaaactacactcagctcgtcg

SEQ ID NO: 608 - DNA, 44 bp, Artificial Sequence
  Probe
taaccagttcgggaagcaggagccagggagtaacgaagagatca

SEQ ID NO: 609 - DNA, 43 bp, Artificial Sequence
  Probe
cgcgggctacaacgtcaaattcgatatgttcagcaagatctgc

SEQ ID NO: 610 - DNA, 43 bp, Artificial Sequence
  Probe
cggagatagccgcttcgtcttccggaaaaacttcgccaagtac

SEQ ID NO: 611 - DNA, 43 bp, Artificial Sequence
  Probe
tcaagagctccccacactccctgttcccagaaaaaatggtctc

SEQ ID NO: 612 - DNA, 44 bp, Artificial Sequence
  Probe
cgctttttctgcttcttgcgccgatctggcctctattactccac

SEQ ID NO: 613 - DNA, 45 bp, Artificial Sequence
  Probe
ctgaagacagtgcagctgaggaacggaaatctgcagtatgacctc

SEQ ID NO: 614 - DNA, 42 bp, Artificial Sequence
  Probe
gtccagggcttcgagtcggccaccttcctaggctacttcaag

SEQ ID NO: 615 - DNA, 41 bp, Artificial Sequence
  Probe
agggcggtgagaccccactgttcaagcagttcttcaagaac

SEQ ID NO: 616 - DNA, 46 bp, Artificial Sequence
  Probe
ttttcccaagattcctgtccctagccctcacttcaaactctgcttc

SEQ ID NO: 617 - DNA, 45 bp, Artificial Sequence
  Probe
tgcagaagcctacttcacaccgccttctcttattttctgcccatt

SEQ ID NO: 618 - DNA, 47 bp, Artificial Sequence
  Probe
catgaaatgatggaggaggaagaggaaatcccaaaacctaagtctgt

SEQ ID NO: 619 - DNA, 45 bp, Artificial Sequence
  Probe
gctgtccactctgaattcatgcatgatcatgctgattatggcttt

SEQ ID NO: 620 - DNA, 45 bp, Artificial Sequence
  Probe
tgtgagggtaaattcaattggcgtgttattaaggaaaagcgggat

SEQ ID NO: 621 - DNA, 43 bp, Artificial Sequence
  Probe
agatccccggtgccagcttaggaataaccagcgatggattttt

SEQ ID NO: 622 - DNA, 45 bp, Artificial Sequence
  Probe
gctcctggagttcacggatacctcttatgaggagaaacggtacac

SEQ ID NO: 623 - DNA, 51 bp, Artificial Sequence
  Probe
tgaagaagaaaagattcgagtggacatcatagagaaccaagtaatggattt

SEQ ID NO: 624 - DNA, 49 bp, Artificial Sequence
  Probe
tcacctttgtggattttctcacctatgatatcttggatcagaaccgtat

SEQ ID NO: 625 - DNA, 44 bp, Artificial Sequence
  Probe
agttccaggacggagacctcaccctgtaccagtccaataccatc

SEQ ID NO: 626 - DNA, 40 bp, Artificial Sequence
  Probe
aaggaccagcaggaggcagccctggtggacatggtgaatg

SEQ ID NO: 627 - DNA, 44 bp, Artificial Sequence
  Probe
tgactacaacctgctggacttgctgctgatccatgaggtcctag

SEQ ID NO: 628 - DNA, 47 bp, Artificial Sequence
  Probe
gcagaagacagtgcgttgcagtatatgaacttcatgaatgtcatctt

SEQ ID NO: 629 - DNA, 46 bp, Artificial Sequence
  Probe
gggtgtttcttcccgatcaagatcagagatctcagttaatcctccc

SEQ ID NO: 630 - DNA, 47 bp, Artificial Sequence
  Probe
ggtcctcattgtgaaatgcatgccatacgaaatttgaacgtagcttt

SEQ ID NO: 631 - DNA, 46 bp, Artificial Sequence
  Probe
ggacgtgaacatggatgaccctaagaaggaagacattcttcttttg

SEQ ID NO: 632 - DNA, 49 bp, Artificial Sequence
  Probe
tgatgaagtcttcttcggaccctttggacataaagaaagatgtattgct

SEQ ID NO: 633 - DNA, 48 bp, Artificial Sequence
  Probe
cgtggaggtgtacaaagaagctcacttactggctttacacattgagag

SEQ ID NO: 634 - DNA, 43 bp, Artificial Sequence
  Probe
aaaaaggggatcttcactcggcagagacaaccaaaaagtgcag

SEQ ID NO: 635 - DNA, 47 bp, Artificial Sequence
  Probe
gattgccaatgaaaccaggtatccccactcagtagccaagtcacaat

SEQ ID NO: 636 - DNA, 50 bp, Artificial Sequence
  Probe
tggtcatctattctagcagggaacactaaaggtggaaataaaagattttc

SEQ ID NO: 637 - DNA, 41 bp, Artificial Sequence
  Probe
gggagccaggcattcatcccggtcacttttggttacaggac

SEQ ID NO: 638 - DNA, 41 bp, Artificial Sequence
  Probe
ctcgcttccccagccttctgaaagaaggaggtttaggggat

SEQ ID NO: 639 - DNA, 41 bp, Artificial Sequence
  Probe
caggatgggggcaggagagttagcaaaggtgacatcttctc

SEQ ID NO: 640 - DNA, 44 bp, Artificial Sequence
  Probe
caatccgagttcccggatgagggaacattctgcagtataaaggg

SEQ ID NO: 641 - DNA, 42 bp, Artificial Sequence
  Probe
agtttgaatcgcggtgcgacgaaggagtaggtggtgggatct

SEQ ID NO: 642 - DNA, 50 bp, Artificial Sequence
  Probe
gcctggattccttgttatctcaggactctaaatactctaacagctgtcca

SEQ ID NO: 643 - DNA, 46 bp, Artificial Sequence
  Probe
tgtttggtgggatggtggagtatgggaaatacagcaatgacctcta

SEQ ID NO: 644 - DNA, 43 bp, Artificial Sequence
  Probe
accccgggagtcacatactgccgtggtctacaccgaaaaagac

SEQ ID NO: 645 - DNA, 42 bp, Artificial Sequence
  Probe
atggcctgggagaccatcctgatggatacactggaggacaac

SEQ ID NO: 646 - DNA, 47 bp, Artificial Sequence
  Probe
tgtccagtattcgatggcctgtttgagttctgtcagttgtctactgg

SEQ ID NO: 647 - DNA, 47 bp, Artificial Sequence
  Probe
gaccgggtcatgactgtgtcctttcataagtatggagagtacttccc

SEQ ID NO: 648 - DNA, 45 bp, Artificial Sequence
  Probe
agatgttccagcctagtgcggtggtcttacagtgtggctcagact

SEQ ID NO: 649 - DNA, 47 bp, Artificial Sequence
  Probe
catgaagcctcatagaatccgcatgacccataacttgctgttaaatt

SEQ ID NO: 650 - DNA, 46 bp, Artificial Sequence
  Probe
gctggagctgtgaagttaaaccgacaacagactgatatggctgtta

SEQ ID NO: 651 - DNA, 45 bp, Artificial Sequence
  Probe
tattggtgctggaaaaggcaaatactatgctgtcaattttccaat

SEQ ID NO: 652 - DNA, 47 bp, Artificial Sequence
  Probe
agaaatcctctaaacagtcccggaaatctccaggagatgaagatgac

SEQ ID NO: 653 - DNA, 47 bp, Artificial Sequence
  Probe
cttgcagaaaaccagtgaagggacctaactaccataatgaatgctgc

SEQ ID NO: 654 - DNA, 49 bp, Artificial Sequence
  Probe
tgcgcagacttatacatgtctaggatccttttatcaaggcagttatgat

SEQ ID NO: 655 - DNA, 46 bp, Artificial Sequence
  Probe
tctcgagatgcagccagatctcggcgaagtaaagaatctgaagttt

SEQ ID NO: 656 - DNA, 48 bp, Artificial Sequence
  Probe
tgaagatgacatgaaagcacagatgaattgcttttatttgaaagcctt

SEQ ID NO: 657 - DNA, 48 bp, Artificial Sequence
  Probe
gaacaaaacacacagcgaagcttttttctcagaatgaagtgtacccta

SEQ ID NO: 658 - DNA, 48 bp, Artificial Sequence
  Probe
cccattcctagcagacaagctgagcaccgttgtaaccagagaactatt

SEQ ID NO: 659 - DNA, 46 bp, Artificial Sequence
  Probe
gcacaggtgtgagtggattgcttatggctatgagataggttgatct

SEQ ID NO: 660 - DNA, 47 bp, Artificial Sequence
  Probe
tggtgtatgctgtgctttcctcagcagtatggctctgacatctctta

SEQ ID NO: 661 - DNA, 38 bp, Artificial Sequence
  Probe
ccttggcctccaagcaggaaaaggacggcactgagaag

SEQ ID NO: 662 - DNA, 39 bp, Artificial Sequence
  Probe
aggagcccagcgaagtgccaacacctaagagacctcggg

SEQ ID NO: 663 - DNA, 38 bp, Artificial Sequence
  Probe
gcgtccccactcccttggtggtggggacattgctctct

SEQ ID NO: 664 - DNA, 46 bp, Artificial Sequence
  Probe
ggccttccgtccctgagtatctgagcgtttaaagtactgagcagta

SEQ ID NO: 665 - DNA, 47 bp, Artificial Sequence
  Probe
ctgtgaagaagccctgttctcgttgccctaattcatcttttaatcat

SEQ ID NO: 666 - DNA, 47 bp, Artificial Sequence
  Probe
gcgtggaagtgttcctgtctcaatagctccaagctgttaaagatatt

SEQ ID NO: 667 - DNA, 47 bp, Artificial Sequence
  Probe
ttttcgatcccaagaaggaatcaacctttgaagagagaagttactgg

SEQ ID NO: 668 - DNA, 48 bp, Artificial Sequence
  Probe
gacttgatctttggcctaaatgcgttattaagaacagcagatttgcag

SEQ ID NO: 669 - DNA, 46 bp, Artificial Sequence
  Probe
tgaatggacggactgctaccagggaagattttctaaaccctgatgt

SEQ ID NO: 670 - DNA, 42 bp, Artificial Sequence
  Probe
ggtcattgatggggagacgtgcctgttggacatcctggatac

SEQ ID NO: 671 - DNA, 45 bp, Artificial Sequence
  Probe
gagggcttcctgtgtgtgtttgccatcaacaacaccaagtctttt

SEQ ID NO: 672 - DNA, 43 bp, Artificial Sequence
  Probe
gctgaccatccagctgatccagaaccattttgtggacgaatac

SEQ ID NO: 673 - DNA, 46 bp, Artificial Sequence
  Probe
attcctgcgtcctttacaagcgccaagtctgtattcagcagtaagg

SEQ ID NO: 674 - DNA, 50 bp, Artificial Sequence
  Probe
tgttgtgggaaatgacacatacagaataaacaataaatacgatgaaacgt

SEQ ID NO: 675 - DNA, 48 bp, Artificial Sequence
  Probe
gcggtcagagtttgtaattggacaggaggtggcctataacttacttgt

SEQ ID NO: 676 - DNA, 46 bp, Artificial Sequence
  Probe
gggagcggactcttggagctattgtaagacaaaagaatcacccaat

SEQ ID NO: 677 - DNA, 46 bp, Artificial Sequence
  Probe
tattggccagaaactccctccattttcttatgcttatacggaactg

SEQ ID NO: 678 - DNA, 46 bp, Artificial Sequence
  Probe
tgtttgcccaccttcggagttatcataggtcagaaatctatgatgg

SEQ ID NO: 679 - DNA, 44 bp, Artificial Sequence
  Probe
gcacagacagattgacctattggggtgtttcgcgagtgtgagag

SEQ ID NO: 680 - DNA, 40 bp, Artificial Sequence
  Probe
aacgtctgattggcgatgccgccaagaaccagctcacctc

SEQ ID NO: 681 - DNA, 46 bp, Artificial Sequence
  Probe
acccatgcagttgttactgtaccagcctattttaatgatgcccaac

SEQ ID NO: 682 - DNA, 43 bp, Artificial Sequence
  Probe
attctgtttcagccagtcgccaagaatcatgaaagtcgccagt

SEQ ID NO: 683 - DNA, 44 bp, Artificial Sequence
  Probe
aggagagggcgctcctctctgcacacctactagtcaccagagac

SEQ ID NO: 684 - DNA, 45 bp, Artificial Sequence
  Probe
ttttaaaaaatggtcacgtttggtgcttctcagatttctgaggaa

SEQ ID NO: 685 - DNA, 49 bp, Artificial Sequence
  Probe
ggcattttgaagaattggaaagaggagagtgacagaaaaataatgcaga

SEQ ID NO: 686 - DNA, 51 bp, Artificial Sequence
  Probe
gcaacaaaaagaaacgagatgacttcgaaaagctgactaattattcggtaa

SEQ ID NO: 687 - DNA, 44 bp, Artificial Sequence
  Probe
tgaatgtccaacgcaaagcaatacatgaactcatccaagtgatg

SEQ ID NO: 688 - DNA, 46 bp, Artificial Sequence
  Probe
tcagagcagattagagcctgcgcaatggaataaagtcctcaaaatt

SEQ ID NO: 689 - DNA, 47 bp, Artificial Sequence
  Probe
acgcaagtagagggagtgcaggaaacaagaactacaggatgtaggaa

SEQ ID NO: 690 - DNA, 45 bp, Artificial Sequence
  Probe
caccgcaggatcctttgctctgcacgagttacctgttaaactttg

SEQ ID NO: 691 - DNA, 46 bp, Artificial Sequence
  Probe
ttgagaaagggaatttcatcccaaataaaaggaatgaagtctggct

SEQ ID NO: 692 - DNA, 40 bp, Artificial Sequence
  Probe
gccaggcatcgacatccgcaacgactatcagcagctgaag

SEQ ID NO: 693 - DNA, 44 bp, Artificial Sequence
  Probe
ctgtggactggtccctgatcctggatgcggtgtccaataactac

SEQ ID NO: 694 - DNA, 42 bp, Artificial Sequence
  Probe
ggagcaggttgcagacaatggcgatgaccactcagaaggagg

SEQ ID NO: 695 - DNA, 44 bp, Artificial Sequence
  Probe
atccccaactgtgacaagcatggcctgtacaacctcaaacagtg

SEQ ID NO: 696 - DNA, 41 bp, Artificial Sequence
  Probe
gggaccccgagtgtcatctcttctacaatgagcagcaggag

SEQ ID NO: 697 - DNA, 46 bp, Artificial Sequence
  Probe
acagccagcgctacaaagttgactacgagtctcagagcacagatac

SEQ ID NO: 698 - DNA, 46 bp, Artificial Sequence
  Probe
cgggagacagaatatggtccctgccgtagagaaatggaagacacac

SEQ ID NO: 699 - DNA, 43 bp, Artificial Sequence
  Probe
gctgagtcccaggggtgtacacattcccaactgtgacaagaag

SEQ ID NO: 700 - DNA, 40 bp, Artificial Sequence
  Probe
catccaggaaagcctgcagccctctgacaaggacgagggt

SEQ ID NO: 701 - DNA, 39 bp, Artificial Sequence
  Probe
catgaccgcaggtgcctgcagaagcacttcgccaaaatt

SEQ ID NO: 702 - DNA, 41 bp, Artificial Sequence
  Probe
acggcaacttccaccccaagcagtgtcacccagctctggat

SEQ ID NO: 703 - DNA, 45 bp, Artificial Sequence
  Probe
tctctttggaaacttctgcaggggaaaagagctaggaaagagctg

SEQ ID NO: 704 - DNA, 53 bp, Artificial Sequence
  Probe
gcggggtgtattttagattttaagcaaaaattttaaagataaatccatttttc

SEQ ID NO: 705 - DNA, 42 bp, Artificial Sequence
  Probe
ctgcttcccccaacctgttgcaaggctttaattcttgcaact

SEQ ID NO: 706 - DNA, 42 bp, Artificial Sequence
  Probe
ccttccatagtgacgccccccaaggacatctggaatgtcact

SEQ ID NO: 707 - DNA, 47 bp, Artificial Sequence
  Probe
tctcctctaagtaaggaagatgctggagaatatgagtgccatgcatc

SEQ ID NO: 708 - DNA, 48 bp, Artificial Sequence
  Probe
tgaaggtgccgagctataaacctccagaatattattagtctgcatggt

SEQ ID NO: 709 - DNA, 45 bp, Artificial Sequence
  Probe
gttacctgggttgccaagccttgtctgagatgatccagttttacc

SEQ ID NO: 710 - DNA, 49 bp, Artificial Sequence
  Probe
aaggcatctacaaagccatgagtgagtttgacatcttcatcaactacat

SEQ ID NO: 711 - DNA, 45 bp, Artificial Sequence
  Probe
ctctgggatagctgacccagccccttgagaaaccttattgtacct

SEQ ID NO: 712 - DNA, 42 bp, Artificial Sequence
  Probe
actggggtcccggattcttgggtctccaagaagtctgtccac

SEQ ID NO: 713 - DNA, 46 bp, Artificial Sequence
  Probe
ggaaagggaagcctgggtttttgtacaaaaatgtgagaaacctttg

SEQ ID NO: 714 - DNA, 44 bp, Artificial Sequence
  Probe
tggaaggttccacaagtcaccctgtgatcaacagtacccgtatg

SEQ ID NO: 715 - DNA, 48 bp, Artificial Sequence
  Probe
tgtcaccgagaagctgatgtagagagagacacagaaggagacagaaag

SEQ ID NO: 716 - DNA, 46 bp, Artificial Sequence
  Probe
ctgtgccacaaaaatcctcccttgaagaaccggatttttataaaac

SEQ ID NO: 717 - DNA, 47 bp, Artificial Sequence
  Probe
ttcatgctttcagaattcgggcagtgactattgatagagtgatgagc

SEQ ID NO: 718 - DNA, 48 bp, Artificial Sequence
  Probe
tgcaccccggaccatatttattataagtatgtataaagatagccagcc

SEQ ID NO: 719 - DNA, 50 bp, Artificial Sequence
  Probe
tgcaatttgaatcttcatcatacgaaggatactttctagcttgtgaaaaa

SEQ ID NO: 720 - DNA, 50 bp, Artificial Sequence
  Probe
aaaaaagaggatgaattgggggatagatctataatgttcactgttcaaaa

SEQ ID NO: 721 - DNA, 47 bp, Artificial Sequence
  Probe
aagaccaggcttctctctggtccttggtagagggctactttactgta

SEQ ID NO: 722 - DNA, 46 bp, Artificial Sequence
  Probe
tcctgaagctccatcccctctataggaaatgtgttgacaatattca

SEQ ID NO: 723 - DNA, 47 bp, Artificial Sequence
  Probe
aggagcttgtcaccccaaactctgaggtgatttatgccttaatcaag

SEQ ID NO: 724 - DNA, 48 bp, Artificial Sequence
  Probe
tggaaaagcgatttgtcttcaacaagatagaaatcaataacaagctgg

SEQ ID NO: 725 - DNA, 47 bp, Artificial Sequence
  Probe
tcaccatgcaatttgtgtcttcctaaagagagctgtacccagagagt

SEQ ID NO: 726 - DNA, 45 bp, Artificial Sequence
  Probe
aatccctagggctggcagaaagggaacagaaaggtttttgagtac

SEQ ID NO: 727 - DNA, 48 bp, Artificial Sequence
  Probe
tcctgtggtctccagatttcaggcctaagatgaaagcctctagtcttg

SEQ ID NO: 728 - DNA, 46 bp, Artificial Sequence
  Probe
cctgcgccatttgctaagactctatctggacagggtatttaaaaac

SEQ ID NO: 729 - DNA, 45 bp, Artificial Sequence
  Probe
cattgtggggaggaagcaatgaagaaatacagccagattctgagt

SEQ ID NO: 730 - DNA, 46 bp, Artificial Sequence
  Probe
gcctggtgaaaatcatcactggtcttttggagtttgaggtatacct

SEQ ID NO: 731 - DNA, 47 bp, Artificial Sequence
  Probe
gaacaagccagagctgtgcagatgagtacaaaagtcctgatccagtt

SEQ ID NO: 732 - DNA, 47 bp, Artificial Sequence
  Probe
tctggtcagaaacctgtccactgggcacagaacttatgttgttctct

SEQ ID NO: 733 - DNA, 48 bp, Artificial Sequence
  Probe
gcagttttgccaaggagtgctaaagaacttagatgtcagtgcataaag

SEQ ID NO: 734 - DNA, 47 bp, Artificial Sequence
  Probe
tccaagaatcagtgaagatgccagtgaaacttcaagcaaatctactt

SEQ ID NO: 735 - DNA, 47 bp, Artificial Sequence
  Probe
gccaagggccaagagaatatccgaactttaatttcaggaattgaatg

SEQ ID NO: 736 - DNA, 48 bp, Artificial Sequence
  Probe
tgaagaagttcgacaggtgggatcctataaaaaggggacaatgactac

SEQ ID NO: 737 - DNA, 46 bp, Artificial Sequence
  Probe
gctgaccaacgaaactggctttgaaatcagttcttctgatgctaca

SEQ ID NO: 738 - DNA, 42 bp, Artificial Sequence
  Probe
ggctgcaggactgttcctgccaggttcagtgggtatcactga

SEQ ID NO: 739 - DNA, 42 bp, Artificial Sequence
  Probe
cactatgcctgtttttggggccaagatcaagtggcagaggac

SEQ ID NO: 740 - DNA, 46 bp, Artificial Sequence
  Probe
aagatgggccagaatctcaaccgtattccatacaaggacacattct

SEQ ID NO: 741 - DNA, 47 bp, Artificial Sequence
  Probe
gaaccctgaacaaacactctggcattgacttcaaacagcttaacttc

SEQ ID NO: 742 - DNA, 46 bp, Artificial Sequence
  Probe
gggtcttgttggaagctgctgtacgaaattgtgatggctttttaat

SEQ ID NO: 743 - DNA, 46 bp, Artificial Sequence
  Probe
ggattttgctgctatgagggaggcagtgaaaactcttggaggtgat

SEQ ID NO: 744 - DNA, 46 bp, Artificial Sequence
  Probe
caggcaagtaggagtggctggaaagtttgttgagttttttggaagt

SEQ ID NO: 745 - DNA, 44 bp, Artificial Sequence
  Probe
cactcggatgcgcatgagaccctggctagagatgcagattaatt

SEQ ID NO: 746 - DNA, 44 bp, Artificial Sequence
  Probe
caacaaacgtggatgggaaggggtacctactcaatgaacctgga

SEQ ID NO: 747 - DNA, 45 bp, Artificial Sequence
  Probe
attgggctgagtctacagcgtgtcttcacagatctgaagaacatg

SEQ ID NO: 748 - DNA, 46 bp, Artificial Sequence
  Probe
ttatgccaaggatgatccattggaatttaagtcccatcagtggttt

SEQ ID NO: 749 - DNA, 44 bp, Artificial Sequence
  Probe
cctgtgccccattgtaccattggagaactgagatgaaacaggag

SEQ ID NO: 750 - DNA, 47 bp, Artificial Sequence
  Probe
cagcttatttcggatcaagtggcagaaatcgtatctaaatacgaccc

SEQ ID NO: 751 - DNA, 46 bp, Artificial Sequence
  Probe
gctttcccgaatctcagaatgcctgttaaaagatcactgaagttgg

SEQ ID NO: 752 - DNA, 47 bp, Artificial Sequence
  Probe
cttcctcacaaagcatcacgtcatcttgacagctatgaattccttaa

SEQ ID NO: 753 - DNA, 46 bp, Artificial Sequence
  Probe
cactcaccatgagcaccaacttctgcatctgcctgatcatatttaa

SEQ ID NO: 754 - DNA, 44 bp, Artificial Sequence
  Probe
tgttttccagtcgtgcatgctccaatcggcggagtatattagag

SEQ ID NO: 755 - DNA, 41 bp, Artificial Sequence
  Probe
gccgccccagagatgacttctttggacactatgcctgtgac

SEQ ID NO: 756 - DNA, 43 bp, Artificial Sequence
  Probe
gtgccagtatggctggcaaggcctgtactgtgataagtgcatc

SEQ ID NO: 757 - DNA, 45 bp, Artificial Sequence
  Probe
agtgcagcgatggcctcttctgtaagacactcacaattccaaaag

SEQ ID NO: 758 - DNA, 49 bp, Artificial Sequence
  Probe
tgcttctgttagtgaccaacatggagtcgtgtacattactgagaacaaa

SEQ ID NO: 759 - DNA, 46 bp, Artificial Sequence
  Probe
atgatcagctatgctggcatggtcttctgtgaagcaaaaattaatg

SEQ ID NO: 760 - DNA, 46 bp, Artificial Sequence
  Probe
gggacaggcatccttcttcaacctaactgtgaaggagatggtaaag

SEQ ID NO: 761 - DNA, 45 bp, Artificial Sequence
  Probe
tgatctgaagcccttgctctccaatgaggtaatctggctagacag

SEQ ID NO: 762 - DNA, 47 bp, Artificial Sequence
  Probe
gctgtccacttccttgaagaggagtgtctacatcgaaagtcggatag

SEQ ID NO: 763 - DNA, 46 bp, Artificial Sequence
  Probe
agtatttggcactcacaccacccagaaggaactctttgatgttgtg

SEQ ID NO: 764 - DNA, 45 bp, Artificial Sequence
  Probe
catatggtgtgacgggaagtggaaaaactcacacaatgactggtt

SEQ ID NO: 765 - DNA, 50 bp, Artificial Sequence
  Probe
ccacaatctaaattgcttcgtgaagataagaaccataacatgtatgttgc

SEQ ID NO: 766 - DNA, 46 bp, Artificial Sequence
  Probe
tgatgtggctgcaataaacccagaactcttacagcttcttccctta

SEQ ID NO: 767 - DNA, 46 bp, Artificial Sequence
  Probe
caaactgggaatttgcccgaatgattaaagaatttcgggctacttt

SEQ ID NO: 768 - DNA, 44 bp, Artificial Sequence
  Probe
cacagcaaggccactggtacagacaatctttgaaggtggaaaag

SEQ ID NO: 769 - DNA, 48 bp, Artificial Sequence
  Probe
ttttgagatcctggatgaaacgaatgagaataagcagaatgaatggat

SEQ ID NO: 770 - DNA, 46 bp, Artificial Sequence
  Probe
caagcttttccttgttgaccgctccttgtatgggaaagaagacaac

SEQ ID NO: 771 - DNA, 46 bp, Artificial Sequence
  Probe
agctgtgcctgttgtgtctgtgtccaaagcaagctatcttcttagg

SEQ ID NO: 772 - DNA, 46 bp, Artificial Sequence
  Probe
cgcctctccatgcaggagttaagatcccaggatgtaaataaacaag

SEQ ID NO: 773 - DNA, 48 bp, Artificial Sequence
  Probe
accaaagagaaaccaacctttggaaagttgagtataaacaaaccgaca

SEQ ID NO: 774 - DNA, 47 bp, Artificial Sequence
  Probe
gcaatttggagtctcattcagccattcttgaccagaaattaaatggt

SEQ ID NO: 775 - DNA, 48 bp, Artificial Sequence
  Probe
tgtcatctttagcatgtggctacttacgtaatcttacctggacacttt

SEQ ID NO: 776 - DNA, 52 bp, Artificial Sequence
  Probe
tgagaagtatttctctgtagaggaagaggaagatcaaaacgttgtaccagaa

SEQ ID NO: 777 - DNA, 42 bp, Artificial Sequence
  Probe
ccgcttcgcagctttctccctttgtctcataaccatgtccac

SEQ ID NO: 778 - DNA, 45 bp, Artificial Sequence
  Probe
tacatgaggactggggagggctttctttgtgtatttgccataaat

SEQ ID NO: 779 - DNA, 47 bp, Artificial Sequence
  Probe
ttcctctaagtgccagtattcccagagttttggtttttgaactagca

SEQ ID NO: 780 - DNA, 45 bp, Artificial Sequence
  Probe
gcagacccagtatgaaatggggattattatagcaaccattttggg

SEQ ID NO: 781 - DNA, 47 bp, Artificial Sequence
  Probe
ccagcgtgaggtttgtttctaccacttattccggagtaaccagataa

SEQ ID NO: 782 - DNA, 46 bp, Artificial Sequence
  Probe
gctctagttctcccccagcatcactaacaaatatgcttggcaagac

SEQ ID NO: 783 - DNA, 43 bp, Artificial Sequence
  Probe
cagtgaccaccacccacatgacatttcaaagcacctccttaag

SEQ ID NO: 784 - DNA, 44 bp, Artificial Sequence
  Probe
ccaagcaagcttctatctgcacctgctctcaatcctgctctcac

SEQ ID NO: 785 - DNA, 45 bp, Artificial Sequence
  Probe
ccgtagcacctctgttaccacgacttctagtgcctctgttaccac

SEQ ID NO: 786 - DNA, 41 bp, Artificial Sequence
  Probe
gtcgccgcacttctgatgtccgtaggccttaaatctgcctg

SEQ ID NO: 787 - DNA, 40 bp, Artificial Sequence
  Probe
gaccacccgtcaggtgcgtaccattgtggaagaggtccag

SEQ ID NO: 788 - DNA, 37 bp, Artificial Sequence
  Probe
aggcagggagcagccgccccatctgccccacagtctc

SEQ ID NO: 789 - DNA, 42 bp, Artificial Sequence
  Probe
agtgagctggtgcagagtggcaagagtgagatctcggagctc

SEQ ID NO: 790 - DNA, 40 bp, Artificial Sequence
  Probe
gtatccgtgtcctccgcccgctttgtgtcctcgtcctcct

SEQ ID NO: 791 - DNA, 38 bp, Artificial Sequence
  Probe
ggccaagtgggaggccaggtcagtgtggaggtggattc

SEQ ID NO: 792 - DNA, 39 bp, Artificial Sequence
  Probe
cacacggagcagctccagatgagcaggtccgaggttact

SEQ ID NO: 793 - DNA, 43 bp, Artificial Sequence
  Probe
cctcggtggaggtcttgccggaggtagcagtggaagctactac

SEQ ID NO: 794 - DNA, 47 bp, Artificial Sequence
  Probe
ctaggcagttgctcaagccatgttttatccttttctggagagtagtc

SEQ ID NO: 795 - DNA, 42 bp, Artificial Sequence
  Probe
attcccagcccctggtctcccgtgccgcagttctatattctg

SEQ ID NO: 796 - DNA, 46 bp, Artificial Sequence
  Probe
tcaatacctgttccactgagctcctgttgcttaccatcaagtcaac

SEQ ID NO: 797 - DNA, 47 bp, Artificial Sequence
  Probe
gcactcagacatgcgaatgtcctttttagttcccgtattattacagg

SEQ ID NO: 798 - DNA, 44 bp, Artificial Sequence
  Probe
gcagtgtccctgaatggcaagtgatgtaccttctgatgcagtct

SEQ ID NO: 799 - DNA, 41 bp, Artificial Sequence
  Probe
gctggacgagggatggtgtccacttcaaacccaaggaagag

SEQ ID NO: 800 - DNA, 42 bp, Artificial Sequence
  Probe
cttcaccatcacgggcaacaacagcaactttgctcagaggtt

SEQ ID NO: 801 - DNA, 41 bp, Artificial Sequence
  Probe
gtgacgatgggccagaacggcaacctctactttgccaatgt

SEQ ID NO: 802 - DNA, 47 bp, Artificial Sequence
  Probe
caggcagtgtatctttgatcgggaacttcacagacaaactggtaatg

SEQ ID NO: 803 - DNA, 43 bp, Artificial Sequence
  Probe
cactgatggcattcactgcgagaagtgcaagaatggcttttac

SEQ ID NO: 804 - DNA, 45 bp, Artificial Sequence
  Probe
caagcaataattggagcccccagctgagttactttgagtatcgaa

SEQ ID NO: 805 - DNA, 42 bp, Artificial Sequence
  Probe
accatcctgctcggcgtctggtatctgatcatcaatgctgtg

SEQ ID NO: 806 - DNA, 46 bp, Artificial Sequence
  Probe
tttgccctgaacatgttggttgcaatcactgtgcttatttatccaa

SEQ ID NO: 807 - DNA, 46 bp, Artificial Sequence
  Probe
agctgtgtttggaactgctaccgatacatcaatggtaggaactcct

SEQ ID NO: 808 - DNA, 48 bp, Artificial Sequence
  Probe
tggttccaagtccaatatggcaactctaaaggatcagctgatttataa

SEQ ID NO: 809 - DNA, 42 bp, Artificial Sequence
  Probe
cacctctgacgcaccactgccaatgctgtacgtactgcattt

SEQ ID NO: 810 - DNA, 46 bp, Artificial Sequence
  Probe
tcaaaggctacacatcctgggctattggactctctgtagcagattt

SEQ ID NO: 811 - DNA, 39 bp, Artificial Sequence
  Probe
ggggatgcccgcaagacccttgactcagtagccaaggag

SEQ ID NO: 812 - DNA, 42 bp, Artificial Sequence
  Probe
gaggcagccctaggtgaggccaagaagcaacttcaggatgag

SEQ ID NO: 813 - DNA, 41 bp, Artificial Sequence
  Probe
caagcgccgtcatgagacccgactggtggagattgacaatg

SEQ ID NO: 814 - DNA, 42 bp, Artificial Sequence
  Probe
cctcacgtgatttgagccccgtttttattttctgtgagccac

SEQ ID NO: 815 - DNA, 44 bp, Artificial Sequence
  Probe
actacatccaggcgtccacgtacgtgcagaagatgtccatgtac

SEQ ID NO: 816 - DNA, 43 bp, Artificial Sequence
  Probe
cagcatacagggcagatgtcagagattatgatcacagggtgct

SEQ ID NO: 817 - DNA, 42 bp, Artificial Sequence
  Probe
gcacagtatgacagctggccccattaccccgagtacttccag

SEQ ID NO: 818 - DNA, 43 bp, Artificial Sequence
  Probe
ctacggcaagggagaagggcccatctggttagacaatctccac

SEQ ID NO: 819 - DNA, 47 bp, Artificial Sequence
  Probe
cctgggttcaaatttgacaattcgttgatcaaccagatagagaacct

SEQ ID NO: 820 - DNA, 44 bp, Artificial Sequence
  Probe
ccgtgttgaccggtttggttgaagttggagaagtatccaatagg

SEQ ID NO: 821 - DNA, 46 bp, Artificial Sequence
  Probe
ggttgacatgttgggagtgctggctagctataatttgacagttcgc

SEQ ID NO: 822 - DNA, 47 bp, Artificial Sequence
  Probe
catgctgggaagttgctgtctgtgttaaagcatatgcctcagaagta

SEQ ID NO: 823 - DNA, 48 bp, Artificial Sequence
  Probe
tcatcagataacatgctccaatggtcagtgtatcccaagtgaatacag

SEQ ID NO: 824 - DNA, 46 bp, Artificial Sequence
  Probe
gcttacttgtgacaatggggcctgctataacaccagtcagaagtgt

SEQ ID NO: 825 - DNA, 47 bp, Artificial Sequence
  Probe
acaatgagttttcatgtggcaatggagagtgtatccctcgtgcttat

SEQ ID NO: 826 - DNA, 43 bp, Artificial Sequence
  Probe
ttccatgtgcctctcctcagctcccagaagatggtgtatccag

SEQ ID NO: 827 - DNA, 45 bp, Artificial Sequence
  Probe
gcatcccccacctagtcctcagccctagtactgtcttctttggag

SEQ ID NO: 828 - DNA, 45 bp, Artificial Sequence
  Probe
ctctcctttggccattccaacagctcaagtcttccctgatcaagt

SEQ ID NO: 829 - DNA, 46 bp, Artificial Sequence
  Probe
gctgtgagaaggggaacaccaccactctcattagtgagaatggtca

SEQ ID NO: 830 - DNA, 47 bp, Artificial Sequence
  Probe
caagggcttcctgtccagaagacccagaccatacattccacatactc

SEQ ID NO: 831 - DNA, 45 bp, Artificial Sequence
  Probe
ccaaatgatggaatgcctaccgggttataagcgggttaacaacac

SEQ ID NO: 832 - DNA, 41 bp, Artificial Sequence
  Probe
cacgtgtgcaccagctccagcaactgcaagcattctgtggt

SEQ ID NO: 833 - DNA, 45 bp, Artificial Sequence
  Probe
aacacagtggagcctctgagggggaatctggtgaagaaggactgt

SEQ ID NO: 834 - DNA, 50 bp, Artificial Sequence
  Probe
cactccttctgttttgttgccgtttatttttgtactcaaatctctacatg

SEQ ID NO: 835 - DNA, 47 bp, Artificial Sequence
  Probe
gaaagctatccaggatgaaatccgttcagtgatcagacagatcacag

SEQ ID NO: 836 - DNA, 47 bp, Artificial Sequence
  Probe
accaattctgaggaagtccgccttcgttcatttactactacaatcca

SEQ ID NO: 837 - DNA, 51 bp, Artificial Sequence
  Probe
tggttttcctgaaatcaggtcatctatagttgatatgttttatttcattgg

SEQ ID NO: 838 - DNA, 45 bp, Artificial Sequence
  Probe
ggttgcctcctccaatgttcctctacctctactacaaggatgggt

SEQ ID NO: 839 - DNA, 52 bp, Artificial Sequence
  Probe
ggcagtcgtatgttagtttcacttgtctactttatatgtctgatcaatttgg

SEQ ID NO: 840 - DNA, 51 bp, Artificial Sequence
  Probe
tgcattttcttgaactgatcattgaaaacttataaacctaacagaaaagcc

SEQ ID NO: 841 - DNA, 46 bp, Artificial Sequence
  Probe
ccttggagaaattggacgaggagcttatggttctgtcaacaaaatg

SEQ ID NO: 842 - DNA, 48 bp, Artificial Sequence
  Probe
ttcggtcaacagtggatgaaaaagaacaaaaacaacttcttatggatt

SEQ ID NO: 843 - DNA, 44 bp, Artificial Sequence
  Probe
ctgaaagaatagacccaagcgcatcacgacaaggatatgatgtc

SEQ ID NO: 844 - DNA, 47 bp, Artificial Sequence
  Probe
aatgctgactccaaagctctggacttattggacaaaatgttgacatt

SEQ ID NO: 845 - DNA, 47 bp, Artificial Sequence
  Probe
aagtagaacaggctctggcccacccatatctggagcagtattacgac

SEQ ID NO: 846 - DNA, 47 bp, Artificial Sequence
  Probe
gacatggaattggatgacttgcctaaggaaaagctcaaagaactaat

SEQ ID NO: 847 - DNA, 44 bp, Artificial Sequence
  Probe
cacaaaaacggggttacgtgtggcagtgaagaagctctccagac

SEQ ID NO: 848 - DNA, 46 bp, Artificial Sequence
  Probe
gggggcagatctgaacaacattgtgaaatgtcagaagcttacagat

SEQ ID NO: 849 - DNA, 45 bp, Artificial Sequence
  Probe
cataatggccgagctgttgactggaagaacattgtttcctggtac

SEQ ID NO: 850 - DNA, 43 bp, Artificial Sequence
  Probe
ctcccgtcctcgcctctgtcgactatcaggtgaactttgaacc

SEQ ID NO: 851 - DNA, 43 bp, Artificial Sequence
  Probe
cgatgacaaaaaagccaagggggctgatggtaaaacgaagatc

SEQ ID NO: 852 - DNA, 43 bp, Artificial Sequence
  Probe
ccagttgacctgagcaaggtgacctccaagtgtggctcattag

SEQ ID NO: 853 - DNA, 47 bp, Artificial Sequence
  Probe
accctgaccttatgagtggatgaagatacctcagttgtctgactttg

SEQ ID NO: 854 - DNA, 47 bp, Artificial Sequence
  Probe
tcgtcaatagctgtgagcgtcagcattaaatattctcccaaggagtg

SEQ ID NO: 855 - DNA, 45 bp, Artificial Sequence
  Probe
cactttccctgtaggtcccgcgatagggacaaatacggctattag

SEQ ID NO: 856 - DNA, 45 bp, Artificial Sequence
  Probe
aggacgagttgtaccggcagtcgctggagattatctctcggtacc

SEQ ID NO: 857 - DNA, 44 bp, Artificial Sequence
  Probe
atgggtttgtggagttcttccatgtagaggacctagaaggtggc

SEQ ID NO: 858 - DNA, 48 bp, Artificial Sequence
  Probe
gtgttgctggagtaggagctggtttggcatatctaataagatagcctt

SEQ ID NO: 859 - DNA, 41 bp, Artificial Sequence
  Probe
cctatgaggccgagggactggctctggatgatgaggacgta

SEQ ID NO: 860 - DNA, 45 bp, Artificial Sequence
  Probe
acgaggagatgatcgagagcatcgagaacctggaggatctcaaag

SEQ ID NO: 861 - DNA, 41 bp, Artificial Sequence
  Probe
gaaccgtgagagcctggtggtgaactatgaggacttggcag

SEQ ID NO: 862 - DNA, 46 bp, Artificial Sequence
  Probe
tttcagagcagcgatggagaaattaaatacttgcaattagcagagg

SEQ ID NO: 863 - DNA, 47 bp, Artificial Sequence
  Probe
tgagcttcctcgagggagtatcccccgcagtttagaagtaattttaa

SEQ ID NO: 864 - DNA, 45 bp, Artificial Sequence
  Probe
tgtggaatcagctcaagctggtgacaagtgtgactttacagggac

SEQ ID NO: 865 - DNA, 47 bp, Artificial Sequence
  Probe
caaatgtgcaataccaacatgtctgtacctactgatggtgctgtaac

SEQ ID NO: 866 - DNA, 47 bp, Artificial Sequence
  Probe
ttagaccaaagccattgcttttgaagttattaaagtctgttggtgca

SEQ ID NO: 867 - DNA, 51 bp, Artificial Sequence
  Probe
tcttggccagtatattatgactaaacgattatatgatgagaagcaacaaca

SEQ ID NO: 868 - DNA, 46 bp, Artificial Sequence
  Probe
cggagattgaggccttgaagaacctgagacatcagcatatatgtca

SEQ ID NO: 869 - DNA, 46 bp, Artificial Sequence
  Probe
cagacatgctgtgggagtctggcttatgcagcacctgagttaatac

SEQ ID NO: 870 - DNA, 46 bp, Artificial Sequence
  Probe
tggacccaaagaaacggatttctatgaaaaatctattgaaccatcc

SEQ ID NO: 871 - DNA, 43 bp, Artificial Sequence
  Probe
agccactgggcatggagaatgggaacattgccaactcacagat

SEQ ID NO: 872 - DNA, 48 bp, Artificial Sequence
  Probe
gcctacagccttaatggacacgaattcgatttcatccatgatgttaat

SEQ ID NO: 873 - DNA, 44 bp, Artificial Sequence
  Probe
gtaactggaacaaaaacgcggtgcatgtcaacctgtttgagacc

SEQ ID NO: 874 - DNA, 48 bp, Artificial Sequence
  Probe
cgcaagatggctgtcctctctaaggaatatggttttgtgcttctaact

SEQ ID NO: 875 - DNA, 42 bp, Artificial Sequence
  Probe
agcacggaccctgaaaatgggcacatcttcaactgcattcag

SEQ ID NO: 876 - DNA, 45 bp, Artificial Sequence
  Probe
gcctggattgttggacgagttctttatgcttatggctattacacg

SEQ ID NO: 877 - DNA, 46 bp, Artificial Sequence
  Probe
catccgtatccagcttcctgttgtgtcaaaacaacattgcaaaatt

SEQ ID NO: 878 - DNA, 48 bp, Artificial Sequence
  Probe
ttcagttccacaaatccaacacaagtaaatgggtctgttattgatgag

SEQ ID NO: 879 - DNA, 48 bp, Artificial Sequence
  Probe
tgagaaagctcaagattccaaggcctattcaaaaatcactgaaggaaa

SEQ ID NO: 880 - DNA, 46 bp, Artificial Sequence
  Probe
gcaagcctattgacgtgttcgactttcctgataattctgatgtctc

SEQ ID NO: 881 - DNA, 48 bp, Artificial Sequence
  Probe
tcaggcccattagtgatgactctgaaagcattgaagaaagtgatacaa

SEQ ID NO: 882 - DNA, 48 bp, Artificial Sequence
  Probe
cagccatcgccacattttatgttaatgttaaagaacaattcatcaaaa

SEQ ID NO: 883 - DNA, 46 bp, Artificial Sequence
  Probe
gcataagccatgtggctcatgttactattacaacgaaaacagctga

SEQ ID NO: 884 - DNA, 48 bp, Artificial Sequence
  Probe
catagccacgaggagaaaagctttaaaaaatccaagtgaagaatatgg

SEQ ID NO: 885 - DNA, 49 bp, Artificial Sequence
  Probe
tggatgtgaggataaaaccctagccttcaaaatgaatggttacatatcc

SEQ ID NO: 886 - DNA, 48 bp, Artificial Sequence
  Probe
ggtaatggtgccgataatgtccaatactgtggctactgtaaataccat

SEQ ID NO: 887 - DNA, 46 bp, Artificial Sequence
  Probe
gtctccccaggatttcctgagctttacagactcagatctgcgtaat

SEQ ID NO: 888 - DNA, 47 bp, Artificial Sequence
  Probe
ccaacagtcatcagcaaccaaagatgtacataaaggagagtctggaa

SEQ ID NO: 889 - DNA, 45 bp, Artificial Sequence
  Probe
tcgtgaagatcggctcactggagtggtactatgagcatgtgaaag

SEQ ID NO: 890 - DNA, 46 bp, Artificial Sequence
  Probe
gaagagagaagtggagacagcgaccagacagatgaggatggagaac

SEQ ID NO: 891 - DNA, 45 bp, Artificial Sequence
  Probe
gtccacgacttcgacttcgagggagactcagatgactccactcag

SEQ ID NO: 892 - DNA, 45 bp, Artificial Sequence
  Probe
aacctgaagaatgatgggaggcaagttgaaaagcggagaaatagt

SEQ ID NO: 893 - DNA, 48 bp, Artificial Sequence
  Probe
cattcaccaaggtctctgagggtcaagcagacatcatgatatcttttg

SEQ ID NO: 894 - DNA, 47 bp, Artificial Sequence
  Probe
gctcatgaactcggccattctcttggactctcccattctactgatat

SEQ ID NO: 895 - DNA, 44 bp, Artificial Sequence
  Probe
aaggtatggagcgatgtgacgccactcacctttactgaggtgca

SEQ ID NO: 896 - DNA, 44 bp, Artificial Sequence
  Probe
actcaccgagaaggggatgtccacttcgactatgatgagacctg

SEQ ID NO: 897 - DNA, 43 bp, Artificial Sequence
  Probe
ccctgatgtccgccttctacacctttcgctacccactgagtct

SEQ ID NO: 898 - DNA, 42 bp, Artificial Sequence
  Probe
cccaaggagagctgcaacctgtttgtgctgaaggacacacta

SEQ ID NO: 899 - DNA, 43 bp, Artificial Sequence
  Probe
gccccagacaggtgatcttgaccagaataccatcgagaccatg

SEQ ID NO: 900 - DNA, 41 bp, Artificial Sequence
  Probe
ctgcggcaacccagatgtggccaactacaacttcttccctc

SEQ ID NO: 901 - DNA, 47 bp, Artificial Sequence
  Probe
aggcaagacagcaaggcatagagacaacatagagctaagtaaagcca

SEQ ID NO: 902 - DNA, 46 bp, Artificial Sequence
  Probe
tgactcgagtcacactcaagggaacttgagcgtgaatctgtatctt

SEQ ID NO: 903 - DNA, 46 bp, Artificial Sequence
  Probe
caaatgggctgctgcttagcttgcaccttgtcacatagagtgatct

SEQ ID NO: 904 - DNA, 47 bp, Artificial Sequence
  Probe
agccaaactcaaggagatgcaaaaattctttggcctacctataactg

SEQ ID NO: 905 - DNA, 46 bp, Artificial Sequence
  Probe
tggacttccaaagtggtcacctacaggatcgtatcatatactcgag

SEQ ID NO: 906 - DNA, 44 bp, Artificial Sequence
  Probe
catgtggggcaaagagatccccctgcatttcaggaaagttgtat

SEQ ID NO: 907 - DNA, 43 bp, Artificial Sequence
  Probe
ccacccttgtgctcttccctggagacctgagaaccaatctcac

SEQ ID NO: 908 - DNA, 43 bp, Artificial Sequence
  Probe
ggcagctggcagaggaatacctgtaccgctatggttacactcg

SEQ ID NO: 909 - DNA, 46 bp, Artificial Sequence
  Probe
tcaagtggcaccaccacaacatcacctattggatccaaaactactc

SEQ ID NO: 910 - DNA, 44 bp, Artificial Sequence
  Probe
attcaagtcctggctccgcctcttccatcaggaccactattaag

SEQ ID NO: 911 - DNA, 42 bp, Artificial Sequence
  Probe
agggtgcccctctgtcaacacccttggctcctgtgtttagag

SEQ ID NO: 912 - DNA, 43 bp, Artificial Sequence
  Probe
aggaccttttctgctgggacaagacactgtactgccctctgct

SEQ ID NO: 913 - DNA, 48 bp, Artificial Sequence
  Probe
tcctggcaatctctctcagtttgaagacattctctttggtaacaatga

SEQ ID NO: 914 - DNA, 44 bp, Artificial Sequence
  Probe
tggccagagacaggttggagttgggtatgtggattccatacaga

SEQ ID NO: 915 - DNA, 50 bp, Artificial Sequence
  Probe
tcactgtctgcggtaatcaagtttttagaactcttatcagatgattccaa

SEQ ID NO: 916 - DNA, 47 bp, Artificial Sequence
  Probe
cgagaaagggaaatcagtccgtgttcatgtacagttttttgatgaca

SEQ ID NO: 917 - DNA, 46 bp, Artificial Sequence
  Probe
aaaatcaaaggaagcccagaagggaggtcatttttacagtgcaaag

SEQ ID NO: 918 - DNA, 45 bp, Artificial Sequence
  Probe
tctgagagtgacattggtggctctgatgtggaatttaagccagac

SEQ ID NO: 919 - DNA, 43 bp, Artificial Sequence
  Probe
ggggttttctgggcctctccaatattaagttcaggccaggatc

SEQ ID NO: 920 - DNA, 46 bp, Artificial Sequence
  Probe
atcaatgtccacgacgtggagacacagttcaatcagtataaaacgg

SEQ ID NO: 921 - DNA, 45 bp, Artificial Sequence
  Probe
aaggtttctgcaggtaatggtggcagcagcctctcttacacaaac

SEQ ID NO: 922 - DNA, 47 bp, Artificial Sequence
  Probe
ccagcccactgttaacaacgactattcctattaccacatttctgaag

SEQ ID NO: 923 - DNA, 47 bp, Artificial Sequence
  Probe
agaccctgagaaggaaaagcgaataaaggaattagaattgctcctaa

SEQ ID NO: 924 - DNA, 47 bp, Artificial Sequence
  Probe
accagggcaccattctggataatgttaagaacctcttagaatttgca

SEQ ID NO: 925 - DNA, 44 bp, Artificial Sequence
  Probe
agcaatgccagtacaggtggctgagagttttgaatccagacctt

SEQ ID NO: 926 - DNA, 42 bp, Artificial Sequence
  Probe
gctggcacaaccacctcaaccctgaggtgaagaagtcttgct

SEQ ID NO: 927 - DNA, 47 bp, Artificial Sequence
  Probe
gacaatgctgtgaagaatcactggaactctaccatcaaaaggaaggt

SEQ ID NO: 928 - DNA, 48 bp, Artificial Sequence
  Probe
gctgagtataaaagccggttttcggggctttatctaactcgctgtagt

SEQ ID NO: 929 - DNA, 39 bp, Artificial Sequence
  Probe
gcgacgatgcccctcaacgttagcttcaccaacaggaac

SEQ ID NO: 930 - DNA, 43 bp, Artificial Sequence
  Probe
cgagctgctgggaggagacatggtgaaccagagtttcatctgc

SEQ ID NO: 931 - DNA, 47 bp, Artificial Sequence
  Probe
ggcagtagttcagatggaaccgaagattccgatttttctacagatct

SEQ ID NO: 932 - DNA, 46 bp, Artificial Sequence
  Probe
tgcagtcttttggcactgaggagcctgcttactctaccagaagagt

SEQ ID NO: 933 - DNA, 46 bp, Artificial Sequence
  Probe
gagagcacagagccgggataagcagatagaagaaaggatgctgtct

SEQ ID NO: 934 - DNA, 46 bp, Artificial Sequence
  Probe
caagccaggaagaagcagcaatctgtcttctggattaaaactgaag

SEQ ID NO: 935 - DNA, 48 bp, Artificial Sequence
  Probe
tgtcatccagctcaccagttatcaactgacgacctatcatgtatcttc

SEQ ID NO: 936 - DNA, 46 bp, Artificial Sequence
  Probe
cctcatagaccttggatgtgggaggattgcattcagtctagttcct

SEQ ID NO: 937 - DNA, 46 bp, Artificial Sequence
  Probe
ttgctggatggtggactcagagaccaataaaaataaactgcttgaa

SEQ ID NO: 938 - DNA, 47 bp, Artificial Sequence
  Probe
tcctggacaaatgagacccaaagacaaaaaagccatacatttaattg

SEQ ID NO: 939 - DNA, 46 bp, Artificial Sequence
  Probe
ttgtatgatctgtgtggcacgccgcattactacaggagaaagaaca

SEQ ID NO: 940 - DNA, 49 bp, Artificial Sequence
  Probe
aagcatttggaagtaacaggacctctttctagctctcagaaaagtctga

SEQ ID NO: 941 - DNA, 47 bp, Artificial Sequence
  Probe
gatgatggattgcaagtgcaaagagtaagacaaaactccagcacata

SEQ ID NO: 942 - DNA, 44 bp, Artificial Sequence
  Probe
ctgctgtgtgtggcttctggatgggacaactgtagaggcagttc

SEQ ID NO: 943 - DNA, 44 bp, Artificial Sequence
  Probe
gtgacagcagggacatgtctcgggagatgcaggatgtagacctc

SEQ ID NO: 944 - DNA, 49 bp, Artificial Sequence
  Probe
tgcgcctaactcggtattaatccaaagcttattttgtaagagtgagctc

SEQ ID NO: 945 - DNA, 46 bp, Artificial Sequence
  Probe
ggagaagctgatccagtttccggaaacaaaatccttttctcatttg

SEQ ID NO: 946 - DNA, 37 bp, Artificial Sequence
  Probe
cttctcccggtgccccgcgtctgtccatcctcagtgg

SEQ ID NO: 947 - DNA, 40 bp, Artificial Sequence
  Probe
aggatggagggctgcatgggggaggagtcgtttcagatgt

SEQ ID NO: 948 - DNA, 38 bp, Artificial Sequence
  Probe
cgggtcaaggcgctggaggagcagaatgagctgctcag

SEQ ID NO: 949 - DNA, 47 bp, Artificial Sequence
  Probe
cagctcctttaccacctcttccagccctaccatttattctacctcag

SEQ ID NO: 950 - DNA, 45 bp, Artificial Sequence
  Probe
cagcatccatcaacaccgaagaggcacacagtcttgtacatctca

SEQ ID NO: 951 - DNA, 46 bp, Artificial Sequence
  Probe
gcagtatgtggatggaggattccccctccaacttcagtaacatgag

SEQ ID NO: 952 - DNA, 45 bp, Artificial Sequence
  Probe
ggacaaggtcaaaccatcatgcaagtacctgtttctggaacacag

SEQ ID NO: 953 - DNA, 44 bp, Artificial Sequence
  Probe
acacaaccagcagtgggcaagggactgtcactgtgacactacca

SEQ ID NO: 954 - DNA, 43 bp, Artificial Sequence
  Probe
gctggctctgtgcctgctatccaaagaatccctctacctggag

SEQ ID NO: 955 - DNA, 38 bp, Artificial Sequence
  Probe
gccaaggaggcatgccccacaggcctgtacacacacag

SEQ ID NO: 956 - DNA, 39 bp, Artificial Sequence
  Probe
gtggcccagccttgtggagccaaccagaccgtgtgtgag

SEQ ID NO: 957 - DNA, 42 bp, Artificial Sequence
  Probe
agcacccaggagcctgaggcacctccagaacaagacctcata

SEQ ID NO: 958 - DNA, 43 bp, Artificial Sequence
  Probe
cgagccctgctatgtttcagcctcagaaatcaaatttgacagc

SEQ ID NO: 959 - DNA, 46 bp, Artificial Sequence
  Probe
tcgggagaaaaaggaggaatccgaactgaagatatcttccagtcct

SEQ ID NO: 960 - DNA, 43 bp, Artificial Sequence
  Probe
ctgagggagcagagaggtggatcctgtaggctaaaaggcttcc

SEQ ID NO: 961 - DNA, 40 bp, Artificial Sequence
  Probe
caccatgcggcagaaggcggtatcgcttttcttgtgctac

SEQ ID NO: 962 - DNA, 41 bp, Artificial Sequence
  Probe
gtggcagcagcgtcgtcataggtaatattggtgccctgatg

SEQ ID NO: 963 - DNA, 45 bp, Artificial Sequence
  Probe
cgatgcccagaatccagaactttgtctatcactctccccaacaac

SEQ ID NO: 964 - DNA, 45 bp, Artificial Sequence
  Probe
gagagctgaggattcaggcgaataccactgcgtatatcactttgt

SEQ ID NO: 965 - DNA, 46 bp, Artificial Sequence
  Probe
tacctctggccgcttcttcatcatcaacaaggaaaattacactgag

SEQ ID NO: 966 - DNA, 47 bp, Artificial Sequence
  Probe
tcaagtgagcaacaccacaatgactgtctaaagcatgccttatttag

SEQ ID NO: 967 - DNA, 42 bp, Artificial Sequence
  Probe
cgaggtcgaattcctcgccgagaaggagctggttaccattat

SEQ ID NO: 968 - DNA, 45 bp, Artificial Sequence
  Probe
aaactccgcacgaacctccagcctctggagagtactcagtctcag

SEQ ID NO: 969 - DNA, 42 bp, Artificial Sequence
  Probe
cttgctgggggatgtgagcgctcaggatgtgatgaggtactc

SEQ ID NO: 970 - DNA, 45 bp, Artificial Sequence
  Probe
ccaggtcctaacggagcctatgtgtaagtccactactggtgcaag

SEQ ID NO: 971 - DNA, 46 bp, Artificial Sequence
  Probe
tggatgagactgttgctgagttcatcaagaggaccatcttgaaaat

SEQ ID NO: 972 - DNA, 46 bp, Artificial Sequence
  Probe
gacaacaatcctgaaggcctgggattttttgtctgaaaatcaactg

SEQ ID NO: 973 - DNA, 46 bp, Artificial Sequence
  Probe
caccgtaactttcaagcgctcctgttgttgtcgttgttttaaactt

SEQ ID NO: 974 - DNA, 45 bp, Artificial Sequence
  Probe
gcagcatcgattccggtgatagagtttgtatcactcaacatcagg

SEQ ID NO: 975 - DNA, 46 bp, Artificial Sequence
  Probe
tgccagcattaccttttgcgtagttaaacagacgtgtatccagtct

SEQ ID NO: 976 - DNA, 47 bp, Artificial Sequence
  Probe
caggccaatcggctttctagctagagggtttaactcctatttaaaaa

SEQ ID NO: 977 - DNA, 47 bp, Artificial Sequence
  Probe
tgtattttttctctggtggcattcctttaggaatgctgtgtgtctgt

SEQ ID NO: 978 - DNA, 48 bp, Artificial Sequence
  Probe
tcctccttaaccacttatctcccatatgagagtgtgaaaaataggaac

SEQ ID NO: 979 - DNA, 45 bp, Artificial Sequence
  Probe
aggagatcggcttgtggtttcaccctgaggaactggtagattaca

SEQ ID NO: 980 - DNA, 46 bp, Artificial Sequence
  Probe
ggagggaagctcttggagctgtgagttctccctgtacagtgttacc

SEQ ID NO: 981 - DNA, 47 bp, Artificial Sequence
  Probe
cctcccagcataggattcattgagttggttacttcatattgttgcat

SEQ ID NO: 982 - DNA, 45 bp, Artificial Sequence
  Probe
tttgaagggagcacctgtgagaggaatattgatgactgccctaac

SEQ ID NO: 983 - DNA, 48 bp, Artificial Sequence
  Probe
tttcaaaggtgtgcattgtgaattagaaataaatgaatgtcagagcaa

SEQ ID NO: 984 - DNA, 43 bp, Artificial Sequence
  Probe
gtacatgggcgccatctgcagtgaccagattgatgaatgttac

SEQ ID NO: 985 - DNA, 43 bp, Artificial Sequence
  Probe
agcttcttgtgcacttgcctccctggcttcactggtgagagat

SEQ ID NO: 986 - DNA, 41 bp, Artificial Sequence
  Probe
caggtgagcagtgccagcttcgggacttctgttcagccaac

SEQ ID NO: 987 - DNA, 42 bp, Artificial Sequence
  Probe
ttaatggaggggtgtgtctggccacatacccccagatccagt

SEQ ID NO: 988 - DNA, 45 bp, Artificial Sequence
  Probe
aagaatgcccagcttctggcttttgaaaatgatgattgtcatctg

SEQ ID NO: 989 - DNA, 47 bp, Artificial Sequence
  Probe
cctcgagggtggagaccaaataatagacatgcttatgtaggtattgc

SEQ ID NO: 990 - DNA, 46 bp, Artificial Sequence
  Probe
gctgtggcttcttctttgcctttcctgatctaccaagtaatgactg

SEQ ID NO: 991 - DNA, 48 bp, Artificial Sequence
  Probe
cgcactgacaatccagctaatccagaaccactttgtagatgaatatga

SEQ ID NO: 992 - DNA, 45 bp, Artificial Sequence
  Probe
ccaatacatgaggacaggcgaaggcttcctctgtgtatttgccat

SEQ ID NO: 993 - DNA, 45 bp, Artificial Sequence
  Probe
ctggtcctgacttcctggaggagaagtattcctgttgctgtcttc

SEQ ID NO: 994 - DNA, 46 bp, Artificial Sequence
  Probe
gaaagccccgggtaccttacatctcctggttatcctcattcttatc

SEQ ID NO: 995 - DNA, 46 bp, Artificial Sequence
  Probe
attcaggctccggacccataccagagaattatgatcaacttcaacc

SEQ ID NO: 996 - DNA, 48 bp, Artificial Sequence
  Probe
tcaagagaggtcctgaatgttcccagaactacacaacacctagtggag

SEQ ID NO: 997 - DNA, 44 bp, Artificial Sequence
  Probe
gcttgccctgcaaattgtgtctgcagcaagactgagatcaattg

SEQ ID NO: 998 - DNA, 44 bp, Artificial Sequence
  Probe
cctttgccaagaacccccatttgcgttatataaacctgtcaagt

SEQ ID NO: 999 - DNA, 44 bp, Artificial Sequence
  Probe
tcttcgggaattgcagttggagcagaactttttcaactgcagct

SEQ ID NO: 1000 - DNA, 46 bp, Artificial Sequence
  Probe
tcatcccctctctagaggagctggactccctcaagtacagtgacct

SEQ ID NO: 1001 - DNA, 46 bp, Artificial Sequence
  Probe
tcatgaaaagcaggaaagccaggatctcagagctactgcaaaagtt

SEQ ID NO: 1002 - DNA, 49 bp, Artificial Sequence
  Probe
cacagatgagtcatccaaacctggaaaaaataaaagaactgcaatcact

SEQ ID NO: 1003 - DNA, 48 bp, Artificial Sequence
  Probe
agaattcaagagacttgggcggtcaaataaaactcagagaaattccaa

SEQ ID NO: 1004 - DNA, 46 bp, Artificial Sequence
  Probe
aggaaagtgttcacgtcacccaaagaaagacacattattcaatgga

SEQ ID NO: 1005 - DNA, 46 bp, Artificial Sequence
  Probe
tagccaatggcagtctcctcctgttgtcgttatcttgaaggatatg

SEQ ID NO: 1006 - DNA, 45 bp, Artificial Sequence
  Probe
tgagtccagtcttccccagacacagcaagtggatcttgacttatc

SEQ ID NO: 1007 - DNA, 48 bp, Artificial Sequence
  Probe
tggagaaggtagaggagatgccacataaaccacagaaagatgaagatc

SEQ ID NO: 1008 - DNA, 46 bp, Artificial Sequence
  Probe
cattagaccagccacagtgcctgattggtatagccttatgtgcttt

SEQ ID NO: 1009 - DNA, 47 bp, Artificial Sequence
  Probe
tccttttccaccagtgctcatcgccataccaagttttatacagatcc

SEQ ID NO: 1010 - DNA, 46 bp, Artificial Sequence
  Probe
aactcatgccaatgcagcagatcgcaaattgaaatatggatatttg

SEQ ID NO: 1011 - DNA, 48 bp, Artificial Sequence
  Probe
tgtgtttcagactttatgcagccatataaactgttctctaggcatgct

SEQ ID NO: 1012 - DNA, 47 bp, Artificial Sequence
  Probe
agtctttggctcatccaggcttttttacttcaattggtcagatgact

SEQ ID NO: 1013 - DNA, 46 bp, Artificial Sequence
  Probe
tgagttgggcaaagtggcctatacagaagcagattattaccatacg

SEQ ID NO: 1014 - DNA, 46 bp, Artificial Sequence
  Probe
caagccctaaggcaactggatgaaggcgagatttctaccatagata

SEQ ID NO: 1015 - DNA, 46 bp, Artificial Sequence
  Probe
tgaattcaagcactctgagccaagaggtgagcgatttagtagagat

SEQ ID NO: 1016 - DNA, 46 bp, Artificial Sequence
  Probe
caaggcagaggggattctccttctagtaaaggcagcactgaaaaat

SEQ ID NO: 1017 - DNA, 47 bp, Artificial Sequence
  Probe
aaataccgagctttgaggtgcaaaattgagcatgttgaacagaatac

SEQ ID NO: 1018 - DNA, 46 bp, Artificial Sequence
  Probe
gggtgagacctgaccagtcagatggtagttgagggtgacttttcct

SEQ ID NO: 1019 - DNA, 46 bp, Artificial Sequence
  Probe
caaatttgaacttcattttggggggtattttggtactgtgatgggg

SEQ ID NO: 1020 - DNA, 44 bp, Artificial Sequence
  Probe
acaaccagaggctggcattgaggctaacctccaacacagtgcat

SEQ ID NO: 1021 - DNA, 47 bp, Artificial Sequence
  Probe
aaatactaaaatgcgccggcaatgaagatatcattacactaagggcc

SEQ ID NO: 1022 - DNA, 43 bp, Artificial Sequence
  Probe
gatgccttctggtgaatttgcacgtatatgccgagatctcagc

SEQ ID NO: 1023 - DNA, 45 bp, Artificial Sequence
  Probe
ttcctgtgcaaaagacggagtgaaattttctgcaagtggagaact

SEQ ID NO: 1024 - DNA, 42 bp, Artificial Sequence
  Probe
cacgtcctcggatgaggtgcagtctccagtgagagtgcgtat

SEQ ID NO: 1025 - DNA, 45 bp, Artificial Sequence
  Probe
ccactgaggacatcaacaagcgcctatcactaccagctgacatcc

SEQ ID NO: 1026 - DNA, 44 bp, Artificial Sequence
  Probe
gatctccgcagaggatgccatgaaacatccattcttcctcagtc

SEQ ID NO: 1027 - DNA, 35 bp, Artificial Sequence
  Probe
gctgacgccgagccatggcggacgaggagcttgag

SEQ ID NO: 1028 - DNA, 48 bp, Artificial Sequence
  Probe
aatggactctgatgaagatgacgattattgaactacaagtgctcacag

SEQ ID NO: 1029 - DNA, 54 bp, Artificial Sequence
  Probe
cggaacaagtctaggacagaagttaagatctgattatttactttgtttattgtc

SEQ ID NO: 1030 - DNA, 44 bp, Artificial Sequence
  Probe
cggagttcttcttggggctgatgtccgcaaatatgcagaattac

SEQ ID NO: 1031 - DNA, 36 bp, Artificial Sequence
  Probe
agccagcgcctcgggacgcgatgaggaccttggctt

SEQ ID NO: 1032 - DNA, 43 bp, Artificial Sequence
  Probe
ggacctccagcgactcctggagatagactccgtagggagtgag

SEQ ID NO: 1033 - DNA, 44 bp, Artificial Sequence
  Probe
gatgctgagtgaccactcgatccgctcctttgatgatctccaac

SEQ ID NO: 1034 - DNA, 46 bp, Artificial Sequence
  Probe
gtgagaaagatcgagattgtgcggaagaagccaatctttaagaagg

SEQ ID NO: 1035 - DNA, 47 bp, Artificial Sequence
  Probe
ggagagtgtgtgggcagggttatttaatatggtatttgctgtattgc

SEQ ID NO: 1036 - DNA, 48 bp, Artificial Sequence
  Probe
aggaatgactcatcttgaagcccagaataagattaagggttgtacagg

SEQ ID NO: 1037 - DNA, 47 bp, Artificial Sequence
  Probe
cccaccaagaaaacacattgtggagcgctatacagagttttatcatg

SEQ ID NO: 1038 - DNA, 44 bp, Artificial Sequence
  Probe
gaagactggcgtccaaggactggaacaactcagtctcgctcttt

SEQ ID NO: 1039 - DNA, 44 bp, Artificial Sequence
  Probe
gactccaggaaccagcgaagaccgctataagtctggcttgacaa

SEQ ID NO: 1040 - DNA, 47 bp, Artificial Sequence
  Probe
accatgtgtctccgtctgaccattcttgttattgttaaaatgcagag

SEQ ID NO: 1041 - DNA, 46 bp, Artificial Sequence
  Probe
gagtccttggatccagtgctacgtcagtaaatagcaccagcatttt

SEQ ID NO: 1042 - DNA, 40 bp, Artificial Sequence
  Probe
agcagaactgctctgggggcgctctgaatcacttccgctc

SEQ ID NO: 1043 - DNA, 45 bp, Artificial Sequence
  Probe
ctggacctgtcgggacgactgtaagtatgagtgtatgtgggtcac

SEQ ID NO: 1044 - DNA, 46 bp, Artificial Sequence
  Probe
ggaagatgacagcctgtacctgctgaaggaatcagaggacaagttc

SEQ ID NO: 1045 - DNA, 51 bp, Artificial Sequence
  Probe
gggctaaggagaagaggaagataaggttaaaagttgttaatgaccaaacat

SEQ ID NO: 1046 - DNA, 49 bp, Artificial Sequence
  Probe
cctgaatcattcattttagctaaggcttcatgttgactcgatatgtcat

SEQ ID NO: 1047 - DNA, 50 bp, Artificial Sequence
  Probe
ccagagtagactggattgaaagatggactgggtctaatttatcatgactg

SEQ ID NO: 1048 - DNA, 44 bp, Artificial Sequence
  Probe
atctccaccagaggaaggctgggaggagcagatgtgtgtcaaac

SEQ ID NO: 1049 - DNA, 40 bp, Artificial Sequence
  Probe
ttgtcgtcacgcagctgggctatgacacacgtgtgaccat

SEQ ID NO: 1050 - DNA, 47 bp, Artificial Sequence
  Probe
gaaactttggaaccaaaatctctgccagagctatggagtggatcact

SEQ ID NO: 1051 - DNA, 48 bp, Artificial Sequence
  Probe
gcagtggagagatgggacaattagataaatgtccattctttatcaagg

SEQ ID NO: 1052 - DNA, 44 bp, Artificial Sequence
  Probe
tcccattcaagattcccactccccagaggtgaccactttcaact

SEQ ID NO: 1053 - DNA, 47 bp, Artificial Sequence
  Probe
tcataccatggaggaaggctctgttccacatatatttccacttcttc

SEQ ID NO: 1054 - DNA, 47 bp, Artificial Sequence
  Probe
gcagcaggagaaacttgaaagcattcacttttatggaactcataagg

SEQ ID NO: 1055 - DNA, 46 bp, Artificial Sequence
  Probe
tgaggttccatcccaaagaacctgctattgagagtagcattcagaa

SEQ ID NO: 1056 - DNA, 45 bp, Artificial Sequence
  Probe
ggcgttgttagaaagctgtctggccagtccacagctgtcactaat

SEQ ID NO: 1057 - DNA, 44 bp, Artificial Sequence
  Probe
gtggggcatccacttgatgcccccaagaatcctagtagaatgtt

SEQ ID NO: 1058 - DNA, 47 bp, Artificial Sequence
  Probe
tttagaatgcctccgtgaggctacattaataaccataaagcatgaac

SEQ ID NO: 1059 - DNA, 47 bp, Artificial Sequence
  Probe
ctttgtgaccttcggctttttcaaccctttttaaaagtaattgaacc

SEQ ID NO: 1060 - DNA, 48 bp, Artificial Sequence
  Probe
ccaagagcggtacagcaaagaatacatagaaaagtttaaacgtgaagg

SEQ ID NO: 1061 - DNA, 47 bp, Artificial Sequence
  Probe
gacttgaagaagcaggcagctgagtatcgagaaattgacaaacgtat

SEQ ID NO: 1062 - DNA, 48 bp, Artificial Sequence
  Probe
gccacaaccacatacaacacaaagagaaaaagaaatgcaaaaatctct

SEQ ID NO: 1063 - DNA, 39 bp, Artificial Sequence
  Probe
gagtgaagtcagccgcggccctgcctgggaggaacttac

SEQ ID NO: 1064 - DNA, 40 bp, Artificial Sequence
  Probe
cctacttccgccacgcagaacctggattctccctcaagag

SEQ ID NO: 1065 - DNA, 39 bp, Artificial Sequence
  Probe
gtgtcattccggggcgaggcctcagagactctgcagagc

SEQ ID NO: 1066 - DNA, 45 bp, Artificial Sequence
  Probe
ggaaatgggtttcaaaccatggcctctttaacataggaggcagtg

SEQ ID NO: 1067 - DNA, 44 bp, Artificial Sequence
  Probe
ctgaatttctccgccccagagcagccattaagcttatatgaatg

SEQ ID NO: 1068 - DNA, 47 bp, Artificial Sequence
  Probe
agtggtggcctcacggaagtatattcataagtggatttcttatgggt

SEQ ID NO: 1069 - DNA, 43 bp, Artificial Sequence
  Probe
taaggaggccggagctgtggggagctcagagctgagatcctac

SEQ ID NO: 1070 - DNA, 45 bp, Artificial Sequence
  Probe
tggtgctacgtctttaaggcggggaagtacagctcagagttctgc

SEQ ID NO: 1071 - DNA, 44 bp, Artificial Sequence
  Probe
tattcggagcggctgaaggaggctcatgtcagactgtacccatc

SEQ ID NO: 1072 - DNA, 47 bp, Artificial Sequence
  Probe
aatggaggaacatgtgtgtccaacaagtacttctccaacattcactg

SEQ ID NO: 1073 - DNA, 47 bp, Artificial Sequence
  Probe
aagaaattcggagggcagcactgtgaaatagataagtcaaaaacctg

SEQ ID NO: 1074 - DNA, 47 bp, Artificial Sequence
  Probe
gggagatgaagtttgaggtggaaaacctcatcctacacaaggactac

SEQ ID NO: 1075 - DNA, 44 bp, Artificial Sequence
  Probe
ctggtggagaaaagctgtacccactcagagaagaccaacaggac

SEQ ID NO: 1076 - DNA, 43 bp, Artificial Sequence
  Probe
caccagccttaccgaggttgtgtgtgggttagacttgtgcaac

SEQ ID NO: 1077 - DNA, 44 bp, Artificial Sequence
  Probe
ctcgaatgcatttcctgtggctcatcagacatgagctgtgagag

SEQ ID NO: 1078 - DNA, 48 bp, Artificial Sequence
  Probe
caaaccaccttttgagacttcttgcctaaaagagacctacctccggat

SEQ ID NO: 1079 - DNA, 44 bp, Artificial Sequence
  Probe
tgccagtacctgcaccgaaaccgagttattcatcgagacctcaa

SEQ ID NO: 1080 - DNA, 46 bp, Artificial Sequence
  Probe
gctcttcaatgactcaacacgcctcatcctctacaatgatggtgac

SEQ ID NO: 1081 - DNA, 44 bp, Artificial Sequence
  Probe
cgctagcaggaagctgctctgttaaaagcgaaaatgaaacaatt

SEQ ID NO: 1082 - DNA, 47 bp, Artificial Sequence
  Probe
gggtatcaaggctgttgatgcacctgtaatggcaatgaagtactaca

SEQ ID NO: 1083 - DNA, 48 bp, Artificial Sequence
  Probe
aattacaacaagaacggctgctgataattttagcacccagtatgtttt

SEQ ID NO: 1084 - DNA, 46 bp, Artificial Sequence
  Probe
gccaaaatggtccaggtcttacatgcatactgtatcatttcagcag

SEQ ID NO: 1085 - DNA, 43 bp, Artificial Sequence
  Probe
cctgtggtatgcacaggtggaagccccagcataaaggaaaata

SEQ ID NO: 1086 - DNA, 46 bp, Artificial Sequence
  Probe
ctccagataaaaggcaaattttgctacaagaggaaaagcttttgtt

SEQ ID NO: 1087 - DNA, 46 bp, Artificial Sequence
  Probe
tgcaggagaatgcaagcctacagttcctgactacgaaatagacaag

SEQ ID NO: 1088 - DNA, 48 bp, Artificial Sequence
  Probe
tggggacttcctaaagcagttctggaaaaataccacagttttggtgta

SEQ ID NO: 1089 - DNA, 47 bp, Artificial Sequence
  Probe
aatggtctgatcaatcgcctcatagaggaaaataagatggatctgtt

SEQ ID NO: 1090 - DNA, 44 bp, Artificial Sequence
  Probe
gctgcttccctgatgggctagcccattctgacttgatgtgtaca

SEQ ID NO: 1091 - DNA, 43 bp, Artificial Sequence
  Probe
gcgtccttctacctggcagggaagttacactgcttcacaccac

SEQ ID NO: 1092 - DNA, 47 bp, Artificial Sequence
  Probe
aaatggtgaaaatgggcagatgaatagcaataagtggacctttgtta

SEQ ID NO: 1093 - DNA, 46 bp, Artificial Sequence
  Probe
tgagttctctcctggaacggctccatgcaaaatttaaccaaaatag

SEQ ID NO: 1094 - DNA, 46 bp, Artificial Sequence
  Probe
gcaactaatgctggtcccttggataagattcttcatggaagtgttg

SEQ ID NO: 1095 - DNA, 47 bp, Artificial Sequence
  Probe
ttcttcttgaaatttccccagccaatcccagtatctagagcatttgt

SEQ ID NO: 1096 - DNA, 49 bp, Artificial Sequence
  Probe
aattctctgttccttttgcaaacaattttaatgatggtgttaaagctgt

SEQ ID NO: 1097 - DNA, 48 bp, Artificial Sequence
  Probe
agagccctagggtgctctgaatctgtacatgttcttgtcataaaatgc

SEQ ID NO: 1098 - DNA, 47 bp, Artificial Sequence
  Probe
taaagcacacttttccccgaccgtatacttaaaatgacaaagccatt

SEQ ID NO: 1099 - DNA, 42 bp, Artificial Sequence
  Probe
tgccaaggtgctggagctggacaacgtcaagagtgagatcat

SEQ ID NO: 1100 - DNA, 45 bp, Artificial Sequence
  Probe
accaagacagacctggtccctgccttccagaacctgatgaaagac

SEQ ID NO: 1101 - DNA, 44 bp, Artificial Sequence
  Probe
cctctcagctgactgtcgggagaatgtgatcatgtcccagatct

SEQ ID NO: 1102 - DNA, 44 bp, Artificial Sequence
  Probe
aaacgttcctcctgctgctggcacttaaggttcgctatcctgat

SEQ ID NO: 1103 - DNA, 43 bp, Artificial Sequence
  Probe
gagagtcgccagatcacgcaggtctatggcttctacgatgagt

SEQ ID NO: 1104 - DNA, 41 bp, Artificial Sequence
  Probe
gtggcccagttcaacgcagccaatgacattgacatgatctg

SEQ ID NO: 1105 - DNA, 46 bp, Artificial Sequence
  Probe
gttcctcaaggaaggtgcctgtgatgaattgttctcctacctcatt

SEQ ID NO: 1106 - DNA, 46 bp, Artificial Sequence
  Probe
atcctgaaaatggtgcagctggactctattgaagatttggaagtga

SEQ ID NO: 1107 - DNA, 47 bp, Artificial Sequence
  Probe
gcgaaattttctccttacctgggccagatgattaatctgcgtagact

SEQ ID NO: 1108 - DNA, 47 bp, Artificial Sequence
  Probe
ttgctgaagaggaaagcctgaaggaaagactcatcaaaagcatatcc

SEQ ID NO: 1109 - DNA, 45 bp, Artificial Sequence
  Probe
tattgacagtgcctcagtgcccagcttagaagagctgaaccagtt

SEQ ID NO: 1110 - DNA, 43 bp, Artificial Sequence
  Probe
gaagcagtgtgtgaggggctgcgtactcaaatccgagagctct

SEQ ID NO: 1111 - DNA, 48 bp, Artificial Sequence
  Probe
gggaaggaacagctgtgatcgatggagaatttaaggagctgaagttaa

SEQ ID NO: 1112 - DNA, 46 bp, Artificial Sequence
  Probe
gaagacaaggaggacttgggccaataaggattccacttctttcaga

SEQ ID NO: 1113 - DNA, 47 bp, Artificial Sequence
  Probe
cagatccagctggaaagctgaagtatttcgataaactgaattgagaa

SEQ ID NO: 1114 - DNA, 51 bp, Artificial Sequence
  Probe
tgagctcctaggattattgggtgaagttcatcctagtgagatgataaataa

SEQ ID NO: 1115 - DNA, 47 bp, Artificial Sequence
  Probe
catgcatctcagtttagcacctgccttctggacaactacgtgtctct

SEQ ID NO: 1116 - DNA, 47 bp, Artificial Sequence
  Probe
cttgttaaagtggtgtgcccacacaaatgtagaattgaaaaaagctg

SEQ ID NO: 1117 - DNA, 46 bp, Artificial Sequence
  Probe
tgtttccttgcaagggaggactcgaaacagcctggagttagatatc

SEQ ID NO: 1118 - DNA, 47 bp, Artificial Sequence
  Probe
tgatggggaggagggattaaaagagtcaggaagaagacagagctaat

SEQ ID NO: 1119 - DNA, 46 bp, Artificial Sequence
  Probe
acatgtctgctgtcatcagccctgttccttaaaagttctagctgct

SEQ ID NO: 1120 - DNA, 44 bp, Artificial Sequence
  Probe
aagacaccaccggaagcaaggaaggtgctgtgtaatcattaagg

SEQ ID NO: 1121 - DNA, 48 bp, Artificial Sequence
  Probe
ccctgaaggctttcaagtgaaaactttaaattggaatcctaaccttat

SEQ ID NO: 1122 - DNA, 47 bp, Artificial Sequence
  Probe
ggcgaaaaattgctaccgagaaggatttcttggaagctgtaaataag

SEQ ID NO: 1123 - DNA, 45 bp, Artificial Sequence
  Probe
gcctctcaaatttctgcgtccacactatggcaaactgaaggaaat

SEQ ID NO: 1124 - DNA, 43 bp, Artificial Sequence
  Probe
tgtgtgaattacgtgcctgagcctgagaactcagccctactgc

SEQ ID NO: 1125 - DNA, 47 bp, Artificial Sequence
  Probe
agattggcattgatgctcaatgacatggagttggtagaagacatctt

SEQ ID NO: 1126 - DNA, 45 bp, Artificial Sequence
  Probe
cgtgttgttggtgtgcttttggggtcatggcaaaagaaagtactt

SEQ ID NO: 1127 - DNA, 49 bp, Artificial Sequence
  Probe
ccttttgatgaagatgacaaagacgattctgtatggtttttagaccatg

SEQ ID NO: 1128 - DNA, 45 bp, Artificial Sequence
  Probe
aagccgaaggacctagggctgcctacagaagcgtacatttcagtg

SEQ ID NO: 1129 - DNA, 46 bp, Artificial Sequence
  Probe
catgtgatcacctgggagaggattatcagccactttgatatttttg

SEQ ID NO: 1130 - DNA, 46 bp, Artificial Sequence
  Probe
ggccttgctgatccgtagttacggtctctgctggacaatcagtatt

SEQ ID NO: 1131 - DNA, 47 bp, Artificial Sequence
  Probe
cgatggtttgaccccaaatcttcttttcagagagtagctggagtgta

SEQ ID NO: 1132 - DNA, 44 bp, Artificial Sequence
  Probe
gctcccagacatgacagccatcatcaaagagatcgttagcagaa

SEQ ID NO: 1133 - DNA, 52 bp, Artificial Sequence
  Probe
ggatggattcgacttagacttgacctatatttatccaaacattattgctatg

SEQ ID NO: 1134 - DNA, 47 bp, Artificial Sequence
  Probe
cctgcagaaagacttgaaggcgtatacaggaacaatattgatgatgt

SEQ ID NO: 1135 - DNA, 49 bp, Artificial Sequence
  Probe
tgtgaataacattcccttccttcgaaatgcaattatgagttatgtcttg

SEQ ID NO: 1136 - DNA, 48 bp, Artificial Sequence
  Probe
tcacatttgattgacagtccaccaacttacaatgctgactatggctac

SEQ ID NO: 1137 - DNA, 44 bp, Artificial Sequence
  Probe
cattctttgcccagcacttcacgcatcagtttttcaagacagat

SEQ ID NO: 1138 - DNA, 48 bp, Artificial Sequence
  Probe
ggaaaatccaaagtggagagaggggaagaaagagaccagtgagtcatc

SEQ ID NO: 1139 - DNA, 45 bp, Artificial Sequence
  Probe
ctggagctgagtgcaagcaaaccatgaagacccagagatgtaaga

SEQ ID NO: 1140 - DNA, 48 bp, Artificial Sequence
  Probe
gaaaaaggaaggcaagaaacaggagaagatgctggattaaaagatgtc

SEQ ID NO: 1141 - DNA, 41 bp, Artificial Sequence
  Probe
cagtccccagctcgccagcgtttttcgttggaatatacgtt

SEQ ID NO: 1142 - DNA, 47 bp, Artificial Sequence
  Probe
ctccagttgaaaaagaaggaatccacgttctaaaaaagaaggggagc

SEQ ID NO: 1143 - DNA, 49 bp, Artificial Sequence
  Probe
cagtagaaggaaatgtaaacgaaggctgacttgattgtgccatttagag

SEQ ID NO: 1144 - DNA, 45 bp, Artificial Sequence
  Probe
aatccataggtgccatcgtggttgagacaagtgcaaaaaatgcta

SEQ ID NO: 1145 - DNA, 45 bp, Artificial Sequence
  Probe
ggacccccatgaaaatggaaacaatggaacaatcaaagttgagaa

SEQ ID NO: 1146 - DNA, 48 bp, Artificial Sequence
  Probe
tgtgctacctatcccaaattcccagtaactacttcagtgtcattgcct

SEQ ID NO: 1147 - DNA, 45 bp, Artificial Sequence
  Probe
cattgagaccagtgcgaagactggctacaacgtgaagcagctttt

SEQ ID NO: 1148 - DNA, 47 bp, Artificial Sequence
  Probe
ttggttgaacacatcagcctctgaaaaggtagctctgactcttgtct

SEQ ID NO: 1149 - DNA, 44 bp, Artificial Sequence
  Probe
aaaagccttgaagggggttgagggtacaggcaaccttgtgttct

SEQ ID NO: 1150 - DNA, 48 bp, Artificial Sequence
  Probe
cgggaagacatcactcatgaaccagtatgtgaataagaaattcagcaa

SEQ ID NO: 1151 - DNA, 45 bp, Artificial Sequence
  Probe
acaggcctggtgctacagcaaaaacaacattccctactttgagac

SEQ ID NO: 1152 - DNA, 47 bp, Artificial Sequence
  Probe
aaacggaggtggagctgtacaacgaatttcctgaacctatcaaactg

SEQ ID NO: 1153 - DNA, 47 bp, Artificial Sequence
  Probe
cactgaactttgcaaagaccttcgtctttgagaagacggtagcttct

SEQ ID NO: 1154 - DNA, 47 bp, Artificial Sequence
  Probe
agcacgtgttcccgacataacattgtactgtaatggagtgagcgtag

SEQ ID NO: 1155 - DNA, 47 bp, Artificial Sequence
  Probe
gctctttggatcagtctttgtgatttcatagcgagttttctgaccag

SEQ ID NO: 1156 - DNA, 49 bp, Artificial Sequence
  Probe
tggactaaataatacatggggggaaataaacaagtattcatgagggtga

SEQ ID NO: 1157 - DNA, 45 bp, Artificial Sequence
  Probe
tggcgaaggactttgaggatttccgtaaaaagtggcagaggactg

SEQ ID NO: 1158 - DNA, 47 bp, Artificial Sequence
  Probe
tgttccatgtggaaagcggataaaatttggcaaattatctctgaagt

SEQ ID NO: 1159 - DNA, 49 bp, Artificial Sequence
  Probe
gggataagaagctaaccaaagcccatgtgttcgagtgtaatttagagag

SEQ ID NO: 1160 - DNA, 46 bp, Artificial Sequence
  Probe
gaggaaaatcgggaagcagcttataatgccattactttacctgaag

SEQ ID NO: 1161 - DNA, 47 bp, Artificial Sequence
  Probe
tgattttggaatggatgatcgtgagataatgagagaaggcagtgctt

SEQ ID NO: 1162 - DNA, 48 bp, Artificial Sequence
  Probe
agcaagtgaactcatcccttgtttataaatagcatttggaaaccacta

SEQ ID NO: 1163 - DNA, 47 bp, Artificial Sequence
  Probe
ttttgtacatttgagccatgtcacacaaactgatgatgacaggtcag

SEQ ID NO: 1164 - DNA, 47 bp, Artificial Sequence
  Probe
cacctagggaagcacttgctcaaaatctgtgacctgtcagaataaaa

SEQ ID NO: 1165 - DNA, 46 bp, Artificial Sequence
  Probe
gcagttgaccaagcaggtggtgcacagattgtaattgaccatttaa

SEQ ID NO: 1166 - DNA, 47 bp, Artificial Sequence
  Probe
tcgcttcaagctcagcttatcaatatgggtgttattcctaccttagt

SEQ ID NO: 1167 - DNA, 48 bp, Artificial Sequence
  Probe
gctggttgaagcaggcctagtagagtgtctactagagattgttcagca

SEQ ID NO: 1168 - DNA, 41 bp, Artificial Sequence
  Probe
catgccgcctctcatccaggaaatgttggagaactcagagg

SEQ ID NO: 1169 - DNA, 44 bp, Artificial Sequence
  Probe
tgttcatcaagacacccctctgcccagctcaccacatcttcatc

SEQ ID NO: 1170 - DNA, 38 bp, Artificial Sequence
  Probe
cttcccctggagcccgtgggtgcacctgttactgttgg

SEQ ID NO: 1171 - DNA, 47 bp, Artificial Sequence
  Probe
gcgaaggagatggttggtcagaagatgaagtacagtattgtgagcag

SEQ ID NO: 1172 - DNA, 45 bp, Artificial Sequence
  Probe
aaaagcaacagcctgaagcagccacaaaatcctgtgttagaagca

SEQ ID NO: 1173 - DNA, 48 bp, Artificial Sequence
  Probe
tctctcgctggcaaaagtatgatctaattgaaacaagactgaaggatc

SEQ ID NO: 1174 - DNA, 45 bp, Artificial Sequence
  Probe
cggtttttctcaggggacgttgaaattatttttgtaacgggagtc

SEQ ID NO: 1175 - DNA, 51 bp, Artificial Sequence
  Probe
tgagtttgaagaaacagaagaacctgattttactgcattatgtcagaaatt

SEQ ID NO: 1176 - DNA, 48 bp, Artificial Sequence
  Probe
aagaaaaaggaactgtggggaatctgtatctttattgcacgagttgac

SEQ ID NO: 1177 - DNA, 39 bp, Artificial Sequence
  Probe
cccctgggtccccatgatgagagaatgggttctgctcat

SEQ ID NO: 1178 - DNA, 39 bp, Artificial Sequence
  Probe
cctgaacgatcctcgcctggtcatctcctatgagcccag

SEQ ID NO: 1179 - DNA, 41 bp, Artificial Sequence
  Probe
ctacctgcacccagggaacaccatcctgcacgtggacacta

SEQ ID NO: 1180 - DNA, 47 bp, Artificial Sequence
  Probe
cacgaacagcagcctaaggaactactttgtgaaatttaaagttggag

SEQ ID NO: 1181 - DNA, 45 bp, Artificial Sequence
  Probe
tggctgcagctttatgccaaattatattgcagactgaacagacgt

SEQ ID NO: 1182 - DNA, 46 bp, Artificial Sequence
  Probe
agccacacagcgtgtaacctgaagtcatctagattatggggaaact

SEQ ID NO: 1183 - DNA, 46 bp, Artificial Sequence
  Probe
accaagcaaccatcgatgatgaagttgtttccatggagatactaga

SEQ ID NO: 1184 - DNA, 47 bp, Artificial Sequence
  Probe
cgaggaagttttgaggaagtgctgccacttaagaacatcctagatga

SEQ ID NO: 1185 - DNA, 44 bp, Artificial Sequence
  Probe
gacttggaccactccaggcaggttagcacagaagaaggagagaa

SEQ ID NO: 1186 - DNA, 47 bp, Artificial Sequence
  Probe
agttgctttccaggaagaagtggttgcagtgctgaaaaaatctttag

SEQ ID NO: 1187 - DNA, 47 bp, Artificial Sequence
  Probe
ctcttgttttacggaccacctggaactggaaaaacatccactatttt

SEQ ID NO: 1188 - DNA, 47 bp, Artificial Sequence
  Probe
ccgtgtccgccttttaagattgtgattctggatgaagcagattctat

SEQ ID NO: 1189 - DNA, 45 bp, Artificial Sequence
  Probe
ttaaaacacaagcgaaccgaggaagaggaagaagatttgcctgat

SEQ ID NO: 1190 - DNA, 42 bp, Artificial Sequence
  Probe
cccaaaaagccgggactggcagctttaagaagcaaaggaatt

SEQ ID NO: 1191 - DNA, 48 bp, Artificial Sequence
  Probe
gccgggtttatcattgctttgttatttgtaaggactgaaatgtacaaa

SEQ ID NO: 1192 - DNA, 43 bp, Artificial Sequence
  Probe
gtgggagggtcatgacgcagcgagtttcagtcgtgacttttct

SEQ ID NO: 1193 - DNA, 44 bp, Artificial Sequence
  Probe
actgctgtggatgtttttcgaaggataattttggaggcagaaaa

SEQ ID NO: 1194 - DNA, 47 bp, Artificial Sequence
  Probe
tgattctgctgcaaagcctgaggacactgggaatatattctacctga

SEQ ID NO: 1195 - DNA, 41 bp, Artificial Sequence
  Probe
ccaccgcagtctggttggagctgttgtcttgtatgctcagc

SEQ ID NO: 1196 - DNA, 39 bp, Artificial Sequence
  Probe
gctcccagaacggctgcatcaactgctgcaaggtgctat

SEQ ID NO: 1197 - DNA, 41 bp, Artificial Sequence
  Probe
actgagtgccaagggtcccctgagcatgcttttctgaagag

SEQ ID NO: 1198 - DNA, 46 bp, Artificial Sequence
  Probe
aaaaagcccagctttcctccatgttagatgtgacttggaaaatgag

SEQ ID NO: 1199 - DNA, 46 bp, Artificial Sequence
  Probe
gatcggagcacagtgctacttggaatgttcagctctgactcagaaa

SEQ ID NO: 1200 - DNA, 45 bp, Artificial Sequence
  Probe
aatcctcaccattttccaccccaagaaaaagaagaaacgctgttc

SEQ ID NO: 1201 - DNA, 37 bp, Artificial Sequence
  Probe
ctcggggtgccctccaatgcttcagtcaacgcgtcct

SEQ ID NO: 1202 - DNA, 39 bp, Artificial Sequence
  Probe
cggggcttccagtgcgacctactgctcttctccaccaac

SEQ ID NO: 1203 - DNA, 39 bp, Artificial Sequence
  Probe
gtggcctgcttcatgaccctggtcatcgtggtgtggagc

SEQ ID NO: 1204 - DNA, 45 bp, Artificial Sequence
  Probe
acccaacacctagccagactcggctagcaactcagctgactgaag

SEQ ID NO: 1205 - DNA, 50 bp, Artificial Sequence
  Probe
tcctatgagactaattgagccagggtctcttatctgacttcaagtgaacc

SEQ ID NO: 1206 - DNA, 45 bp, Artificial Sequence
  Probe
agcccaaagagccagggattaggaattaagatcgtgcacaaaagt

SEQ ID NO: 1207 - DNA, 46 bp, Artificial Sequence
  Probe
tgtctcaggctgtgcagacaaacggaactcaaccattaagcaaaac

SEQ ID NO: 1208 - DNA, 45 bp, Artificial Sequence
  Probe
caacgaacacctcaggaggcaataacagatggcttagaaattgtg

SEQ ID NO: 1209 - DNA, 45 bp, Artificial Sequence
  Probe
gtgcagactgcatcatcacagcccttagaagtggcaacaaagaat

SEQ ID NO: 1210 - DNA, 42 bp, Artificial Sequence
  Probe
gcgaagcaaacctgtcggagtcaattatttctctcgacttcg

SEQ ID NO: 1211 - DNA, 41 bp, Artificial Sequence
  Probe
gcagtcggaggagagcgcccagactctgaactcagcagaaa

SEQ ID NO: 1212 - DNA, 44 bp, Artificial Sequence
  Probe
cgattagggcgcagaactttggaagctgctacttacttggaatg

SEQ ID NO: 1213 - DNA, 43 bp, Artificial Sequence
  Probe
tggctttgacagagagcctttgcactcagaacatccaagcaag

SEQ ID NO: 1214 - DNA, 42 bp, Artificial Sequence
  Probe
ccaggccagcggtacagtccaaataacggcttatcctaccag

SEQ ID NO: 1215 - DNA, 41 bp, Artificial Sequence
  Probe
atatggccattgcccaccactacagggactcctatcgacac

SEQ ID NO: 1216 - DNA, 38 bp, Artificial Sequence
  Probe
cccgaggctcactcagcaccacaagccacttcagcagc

SEQ ID NO: 1217 - DNA, 40 bp, Artificial Sequence
  Probe
ctggaggcggggaccctaacaaccttcaagaccagtgatg

SEQ ID NO: 1218 - DNA, 43 bp, Artificial Sequence
  Probe
ccagatcctggccgtctcatcccatacttctgtggggaatcag

SEQ ID NO: 1219 - DNA, 44 bp, Artificial Sequence
  Probe
atgccatctcaaatggaacacgccatggaaaccatgatgtttac

SEQ ID NO: 1220 - DNA, 42 bp, Artificial Sequence
  Probe
tgagcagttcgctcctccctgataagagttgtccaaagggtc

SEQ ID NO: 1221 - DNA, 51 bp, Artificial Sequence
  Probe
tctcatttgacaagcagagaaagaaaagttaaataccagataagcttttga

SEQ ID NO: 1222 - DNA, 45 bp, Artificial Sequence
  Probe
gacagatgaagctgctttccagaagctgatgagcaacttggacag

SEQ ID NO: 1223 - DNA, 41 bp, Artificial Sequence
  Probe
tcctgcatcgccatgatgtgtaacgaattctttgaaggctt

SEQ ID NO: 1224 - DNA, 46 bp, Artificial Sequence
  Probe
tcagacacgtgcttgatgctgagcaagttcaataaagattcttgga

SEQ ID NO: 1225 - DNA, 41 bp, Artificial Sequence
  Probe
gcatccccgtgaaccacctcatagagggctcccagaagtgt

SEQ ID NO: 1226 - DNA, 37 bp, Artificial Sequence
  Probe
ctgaaggccctgctgggggccctgacagtgtttggct

SEQ ID NO: 1227 - DNA, 40 bp, Artificial Sequence
  Probe
ccgagactggagcatctacacctgaggacaagacgctgcc

SEQ ID NO: 1228 - DNA, 41 bp, Artificial Sequence
  Probe
ccatggcacccggagagaagatcaaagccaaaatcaagaag

SEQ ID NO: 1229 - DNA, 41 bp, Artificial Sequence
  Probe
ctcccaccggattccgctgctgatctttgatcaggatgaga

SEQ ID NO: 1230 - DNA, 42 bp, Artificial Sequence
  Probe
aagcggaaagtcggcggtagcatcattcacaaggcttcaaat

SEQ ID NO: 1231 - DNA, 42 bp, Artificial Sequence
  Probe
agagcctggtttgcctccagtgcagcctgtcttcatcactgt

SEQ ID NO: 1232 - DNA, 42 bp, Artificial Sequence
  Probe
cgctacgtccaggacttccacccaagactgttgggtctgacc

SEQ ID NO: 1233 - DNA, 44 bp, Artificial Sequence
  Probe
ccatctacctgctcaaccctgacggcctcttcacggattactac

SEQ ID NO: 1234 - DNA, 46 bp, Artificial Sequence
  Probe
tggaaatgagctcaatggaggctgtgtccatgactgtttgaatatt

SEQ ID NO: 1235 - DNA, 44 bp, Artificial Sequence
  Probe
caacaatggaggctgtgaccgcacctgtaaggatacttcgacag

SEQ ID NO: 1236 - DNA, 46 bp, Artificial Sequence
  Probe
tgtcaccaccatcaggacaagtgtaacctttaagctaaatgaaggc

SEQ ID NO: 1237 - DNA, 46 bp, Artificial Sequence
  Probe
gcctttctgaaggcaagactgggattggatcacttcttaaacttcc

SEQ ID NO: 1238 - DNA, 48 bp, Artificial Sequence
  Probe
tgggtacttgtgatcacactacgggaatctctgtggtatatacctggg

SEQ ID NO: 1239 - DNA, 45 bp, Artificial Sequence
  Probe
gggaggatggggaaaagagctgagagtttatgctgaaatggattt

SEQ ID NO: 1240 - DNA, 46 bp, Artificial Sequence
  Probe
gtgcttttggtgaggaaggtgaaggtgattatctggatgactggac

SEQ ID NO: 1241 - DNA, 45 bp, Artificial Sequence
  Probe
gagagatggtgaggtgcggttcaaacactcttccactgaggtact

SEQ ID NO: 1242 - DNA, 47 bp, Artificial Sequence
  Probe
gtcactctcccagacttgcgtgggtcagttctttctgagtagaggac

SEQ ID NO: 1243 - DNA, 41 bp, Artificial Sequence
  Probe
gaaacacaggcactgaggccccagattatctggccactgtg

SEQ ID NO: 1244 - DNA, 44 bp, Artificial Sequence
  Probe
tgacttctggtaccagcctcgacacaatgtcatgatcagcactg

SEQ ID NO: 1245 - DNA, 43 bp, Artificial Sequence
  Probe
atcctgctctccctggacgaccgcttcctctacttcagcaact

SEQ ID NO: 1246 - DNA, 45 bp, Artificial Sequence
  Probe
ccacttcttcaacttcctgctcaacacaaccgactaccgaatctt

SEQ ID NO: 1247 - DNA, 46 bp, Artificial Sequence
  Probe
gctcattcctgacagtgcggagcgcaatgatgataagctttacttc

SEQ ID NO: 1248 - DNA, 44 bp, Artificial Sequence
  Probe
ccgtgtgtgtctactccatggctgatattcgcatggtcttcaac

SEQ ID NO: 1249 - DNA, 45 bp, Artificial Sequence
  Probe
aacgtggacttcgctttcagcctgtacaagcagttagtcctgaag

SEQ ID NO: 1250 - DNA, 47 bp, Artificial Sequence
  Probe
ctgactttcaggactcagctgcagctaagaagctcatcaacgactac

SEQ ID NO: 1251 - DNA, 44 bp, Artificial Sequence
  Probe
tcaaggaccttgactcgcagacaatgatggtcctggtgaattac

SEQ ID NO: 1252 - DNA, 46 bp, Artificial Sequence
  Probe
gcttcgggcatggttgataacatgaccaaacttgtgctagtaaatg

SEQ ID NO: 1253 - DNA, 47 bp, Artificial Sequence
  Probe
gtcagcttgcccaggttcaaactggaagagagttacactctcaactc

SEQ ID NO: 1254 - DNA, 47 bp, Artificial Sequence
  Probe
caaggctgatctgtctggcatgtcaggagccagagatatttttatat

SEQ ID NO: 1255 - DNA, 46 bp, Artificial Sequence
  Probe
ggaggatctttgtgtggcaaacacactctttgccctcaatttattc

SEQ ID NO: 1256 - DNA, 45 bp, Artificial Sequence
  Probe
agtgggagccaatgcagttacccccatgactccagagaactttac

SEQ ID NO: 1257 - DNA, 45 bp, Artificial Sequence
  Probe
cagcgcacacctgtacagatgatgtacttgcgtgaaaagctaaac

SEQ ID NO: 1258 - DNA, 43 bp, Artificial Sequence
  Probe
cggagcacggtcaagcaagtggacttttcagaggtggagagag

SEQ ID NO: 1259 - DNA, 42 bp, Artificial Sequence
  Probe
agttcaccacgcccgatggccattactacgacatcctggaac

SEQ ID NO: 1260 - DNA, 45 bp, Artificial Sequence
  Probe
tgaaaaagaggtgcctctctctgccctcaccaacattctgagtgc

SEQ ID NO: 1261 - DNA, 47 bp, Artificial Sequence
  Probe
gcgaacagaatccatcattcaccgggctctctactatgacttgatca

SEQ ID NO: 1262 - DNA, 46 bp, Artificial Sequence
  Probe
gcataaaatccagctttgtggcacctctggaaaagtcatatgggac

SEQ ID NO: 1263 - DNA, 46 bp, Artificial Sequence
  Probe
ccagaaagacttccctcgaggatttctacttggatgaagagaggac

SEQ ID NO: 1264 - DNA, 46 bp, Artificial Sequence
  Probe
gttcttcggcttctactggcccgagatgcttaagtgtgacaagttc

SEQ ID NO: 1265 - DNA, 47 bp, Artificial Sequence
  Probe
tgtgacaacgagttgaaatctgaggccatcattgaacatctctgtgc

SEQ ID NO: 1266 - DNA, 43 bp, Artificial Sequence
  Probe
ggcccatcaagaagaaggacctgaagaagcttgtgctgtacct

SEQ ID NO: 1267 - DNA, 42 bp, Artificial Sequence
  Probe
caggaatacctgaggcgggtccagatcgaagcagctcaatgt

SEQ ID NO: 1268 - DNA, 48 bp, Artificial Sequence
  Probe
gctcaaattgacccaaagaagttgaaaaggaagcaaagtgtgaatatt

SEQ ID NO: 1269 - DNA, 45 bp, Artificial Sequence
  Probe
attggcttgtcttgaaaagcctttgttacctgaggctcattcact

SEQ ID NO: 1270 - DNA, 41 bp, Artificial Sequence
  Probe
ttcccaccagtgcttgagcctcgatggtttgcccactatga

SEQ ID NO: 1271 - DNA, 39 bp, Artificial Sequence
  Probe
aggtctcaggggatggggagccactcagaggccagctct

SEQ ID NO: 1272 - DNA, 44 bp, Artificial Sequence
  Probe
cacgcagacctgggtgctggctactaccgcaaatacttctatgg

SEQ ID NO: 1273 - DNA, 45 bp, Artificial Sequence
  Probe
gagatagccatggaggacagccccactatggttagagtggacagc

SEQ ID NO: 1274 - DNA, 43 bp, Artificial Sequence
  Probe
gctacaatgccaccctggtgggagtactcatggctgtcttttc

SEQ ID NO: 1275 - DNA, 46 bp, Artificial Sequence
  Probe
actcagtctttcagccccatttgagaacatctactttggactctgg

SEQ ID NO: 1276 - DNA, 39 bp, Artificial Sequence
  Probe
gccgtgctcatgggcttctcgaaactgggcaagtccttt

SEQ ID NO: 1277 - DNA, 41 bp, Artificial Sequence
  Probe
aacaaggacctgtggcccctgctgctgagcatcatcttcat

SEQ ID NO: 1278 - DNA, 44 bp, Artificial Sequence
  Probe
agctgacgtgacccatgacctgcaggagatgaaggaagagagtc

SEQ ID NO: 1279 - DNA, 44 bp, Artificial Sequence
  Probe
ccctttcaggctccaccctttgcggagattataaatagtcatga

SEQ ID NO: 1280 - DNA, 45 bp, Artificial Sequence
  Probe
tttggatccttcctgaggacgtggagaaaactttctgctgagaag

SEQ ID NO: 1281 - DNA, 46 bp, Artificial Sequence
  Probe
ttggctgaaaaagctgtttctggaatcacccctagatctttcttga

SEQ ID NO: 1282 - DNA, 47 bp, Artificial Sequence
  Probe
gctggcgtctacttgtcagatggagctgaaattaaagaaaaaggatt

SEQ ID NO: 1283 - DNA, 47 bp, Artificial Sequence
  Probe
tgcaagtgttggtggcctctacacttctgttgtggttaagtacacag

SEQ ID NO: 1284 - DNA, 48 bp, Artificial Sequence
  Probe
ccaacaaggagaaacagcttcaaaggagagagttattggtgtgtgatt

SEQ ID NO: 1285 - DNA, 47 bp, Artificial Sequence
  Probe
tgttgacttggcaatttccacacggcaatatcatctacaacagcttt

SEQ ID NO: 1286 - DNA, 46 bp, Artificial Sequence
  Probe
cagaccacgagcatcactctgaccataatcatgctgcttctggtaa

SEQ ID NO: 1287 - DNA, 46 bp, Artificial Sequence
  Probe
acaaatagcctgggttggtggttttatagccatttccatcatcagt

SEQ ID NO: 1288 - DNA, 43 bp, Artificial Sequence
  Probe
gaggcgtgtgcctgagtgggctctactgccttgttccatatta

SEQ ID NO: 1289 - DNA, 48 bp, Artificial Sequence
  Probe
ttagcaccattgaaagaggagcattccaggatcttaaagaactagaga

SEQ ID NO: 1290 - DNA, 44 bp, Artificial Sequence
  Probe
caatcccaaggaaagctttccgtggggcagttgacataaaaaat

SEQ ID NO: 1291 - DNA, 42 bp, Artificial Sequence
  Probe
aggccactgtctgcagctcccgtgaagatgtccactccagac

SEQ ID NO: 1292 - DNA, 40 bp, Artificial Sequence
  Probe
catgtcggacgacccgcgctacaaccagatgaaaggaatg

SEQ ID NO: 1293 - DNA, 43 bp, Artificial Sequence
  Probe
accagctgcaccagctcagagctcagatcatggcctacaagat

SEQ ID NO: 1294 - DNA, 41 bp, Artificial Sequence
  Probe
cagggtggcagagctgacctccctgtcagatgaggacagtg

SEQ ID NO: 1295 - DNA, 43 bp, Artificial Sequence
  Probe
acttctggccacatcagccccacaggactttgatgaagaccat

SEQ ID NO: 1296 - DNA, 44 bp, Artificial Sequence
  Probe
acaaggaaccctcaggccaccctccacgaggtgtgactaactat

SEQ ID NO: 1297 - DNA, 44 bp, Artificial Sequence
  Probe
agacccccatgccattgaagctgaaaagtttcagtgcaatttat

SEQ ID NO: 1298 - DNA, 47 bp, Artificial Sequence
  Probe
aataccagtgcaaaaactgctccaaaaccttctccagaatgtctctc

SEQ ID NO: 1299 - DNA, 47 bp, Artificial Sequence
  Probe
gctgtgtagcacactgagtgacgcaatcaatgtttactcgaacagaa

SEQ ID NO: 1300 - DNA, 41 bp, Artificial Sequence
  Probe
tagagggctacaggccagcgtggatgacctgaagagcgctc

SEQ ID NO: 1301 - DNA, 41 bp, Artificial Sequence
  Probe
cagcacaaccctgcacacccaccatggatgtcttcaagaag

SEQ ID NO: 1302 - DNA, 42 bp, Artificial Sequence
  Probe
cccccaacaggagggtgtggcatccaaagagaaagaggaagt

SEQ ID NO: 1303 - DNA, 46 bp, Artificial Sequence
  Probe
caggactccattgactcgaacgactctgatgatgtagatgacactg

SEQ ID NO: 1304 - DNA, 46 bp, Artificial Sequence
  Probe
gaccagagtgctgaaacccacagccacaagcagtccagattatata

SEQ ID NO: 1305 - DNA, 46 bp, Artificial Sequence
  Probe
gcaatgagcattccgatgtgattgatagtcaggaactttccaaagt

SEQ ID NO: 1306 - DNA, 39 bp, Artificial Sequence
  Probe
cagcgaaacgggaggcctctaaatctttaggttggggct

SEQ ID NO: 1307 - DNA, 50 bp, Artificial Sequence
  Probe
actgctttctacgccctatacaacttggcttcacatacttttacactaac

SEQ ID NO: 1308 - DNA, 46 bp, Artificial Sequence
  Probe
ttttctgggcattgccactttcacctatttttataagaagttcggg

SEQ ID NO: 1309 - DNA, 47 bp, Artificial Sequence
  Probe
ttgagacggaatattcccggaatctagagaagttagcagaaaggttc

SEQ ID NO: 1310 - DNA, 47 bp, Artificial Sequence
  Probe
cttggctaccatgcaagtctgaacagagccctaagaacatatctgtc

SEQ ID NO: 1311 - DNA, 46 bp, Artificial Sequence
  Probe
gaaacctccagacatgagggcttagacattattgagaatgcagttg

SEQ ID NO: 1312 - DNA, 46 bp, Artificial Sequence
  Probe
atattcactgctgtggcaaggcctgtagagagtttcgaagttagga

SEQ ID NO: 1313 - DNA, 44 bp, Artificial Sequence
  Probe
tatgtgtttcctgaccgccccaaggatgaggtcttctccaagta

SEQ ID NO: 1314 - DNA, 47 bp, Artificial Sequence
  Probe
cctctcatgaatgtttgaatcccacgcttctctttggaaacaatatg

SEQ ID NO: 1315 - DNA, 48 bp, Artificial Sequence
  Probe
gagatggagataacttccccggatttagcttttttgtctttgtttttg

SEQ ID NO: 1316 - DNA, 47 bp, Artificial Sequence
  Probe
agggcagttgctcagaccaaatactgtatctagtgcttctgctccta

SEQ ID NO: 1317 - DNA, 45 bp, Artificial Sequence
  Probe
aatctcactgaattccaaacggcggaaagaggaaactttcccaac

SEQ ID NO: 1318 - DNA, 39 bp, Artificial Sequence
  Probe
gtgggcctgaggtccccggaggatgacctagcactgaaa

SEQ ID NO: 1319 - DNA, 39 bp, Artificial Sequence
  Probe
gaagttgaccctgaccgggccgtctcccagttctgaggc

SEQ ID NO: 1320 - DNA, 42 bp, Artificial Sequence
  Probe
aaattttggagaagggaagtcggaacacaaggaaggaccgct

SEQ ID NO: 1321 - DNA, 44 bp, Artificial Sequence
  Probe
tgagatcgaggacatccagcaggagatcactgtcctcagtcagt

SEQ ID NO: 1322 - DNA, 47 bp, Artificial Sequence
  Probe
tcctgaagcacaagttcatcacacgctacaccaagaagacctccttc

SEQ ID NO: 1323 - DNA, 41 bp, Artificial Sequence
  Probe
agtcagaggggcatggcgaggagtccagctctgaggactct

SEQ ID NO: 1324 - DNA, 45 bp, Artificial Sequence
  Probe
atgagctggattcccacaccatggtgaagactagtgtgggagagt

SEQ ID NO: 1325 - DNA, 45 bp, Artificial Sequence
  Probe
gatgagtgaaggggcccagaccatgattgaacataatagcacgat

SEQ ID NO: 1326 - DNA, 47 bp, Artificial Sequence
  Probe
catgcatgaacccttccctatgtccaaaaacgtttttcctgataact

SEQ ID NO: 1327 - DNA, 40 bp, Artificial Sequence
  Probe
ggacccggaagcggaaagggcatctttgaggtcgatactt

SEQ ID NO: 1328 - DNA, 48 bp, Artificial Sequence
  Probe
tctggacaaagacgcttattatcggcgagtgaagagactgtacagcaa

SEQ ID NO: 1329 - DNA, 43 bp, Artificial Sequence
  Probe
accatcgctgtaaaggaggatggggagctcaacctaatgaaga

SEQ ID NO: 1330 - DNA, 45 bp, Artificial Sequence
  Probe
cccacagtctggagtccaaagccgaaagaattgcaaggtacaaag

SEQ ID NO: 1331 - DNA, 42 bp, Artificial Sequence
  Probe
ctgatgctgtcgagaagcggggaggaaaaagtgacaaacagg

SEQ ID NO: 1332 - DNA, 45 bp, Artificial Sequence
  Probe
ctaagcttggccgaaaagttggccttgtttaacaaattgtcccag

SEQ ID NO: 1333 - DNA, 45 bp, Artificial Sequence
  Probe
acggaggaagtccacggattccgtccccatctctaagtctacact

SEQ ID NO: 1334 - DNA, 46 bp, Artificial Sequence
  Probe
acgggttccagcagtgcttctagtacccttaagcgaactaaaaaac

SEQ ID NO: 1335 - DNA, 43 bp, Artificial Sequence
  Probe
gtgaaggagacgcaacaggagccagatgaagagagccttgtcc

SEQ ID NO: 1336 - DNA, 47 bp, Artificial Sequence
  Probe
tgtgaaaactacaagctggccgtaaactgctttgtgaataataatcg

SEQ ID NO: 1337 - DNA, 45 bp, Artificial Sequence
  Probe
gccaaatgtttggtgatgaaggcagaaatgaatggctcaaaactt

SEQ ID NO: 1338 - DNA, 44 bp, Artificial Sequence
  Probe
gtgtgaacactgctggggtcagaagaacagacaaggacactgaa

SEQ ID NO: 1339 - DNA, 47 bp, Artificial Sequence
  Probe
tccctacctgtcaggactggtgttaggatgagataatgtttgtgaac

SEQ ID NO: 1340 - DNA, 47 bp, Artificial Sequence
  Probe
cgtgtgctactgtgagaactggaacaaagaagagagggagtgagaga

SEQ ID NO: 1341 - DNA, 46 bp, Artificial Sequence
  Probe
acagtcgcgagccacactttgcaatgaaactctttagactttctgc

SEQ ID NO: 1342 - DNA, 41 bp, Artificial Sequence
  Probe
cttcctatggcatgagccgcgaagtgcagtccaaaatcgag

SEQ ID NO: 1343 - DNA, 44 bp, Artificial Sequence
  Probe
atggcgtgattctgagcaagctggtgaacagcctgtaccctgat

SEQ ID NO: 1344 - DNA, 46 bp, Artificial Sequence
  Probe
tggtttatgaagaaagcgcaggagcataagagggaattcacagaga

SEQ ID NO: 1345 - DNA, 44 bp, Artificial Sequence
  Probe
tgtgatcttcgtggtggaaagctaaattttaaaaccaccccaat

SEQ ID NO: 1346 - DNA, 45 bp, Artificial Sequence
  Probe
aggttgtaaacgttctggcagtgtgtaacatgccatttgaaatcc

SEQ ID NO: 1347 - DNA, 48 bp, Artificial Sequence
  Probe
cgaacctgaacttcatcctgctgtgtgctatcggataaaatctctaag

SEQ ID NO: 1348 - DNA, 44 bp, Artificial Sequence
  Probe
tcctccgatgtccactttccatcgtagtggtacaaaccattaca

SEQ ID NO: 1349 - DNA, 48 bp, Artificial Sequence
  Probe
ggtctagaaatggaggacaggcctcatcgtctcctaattatgaaggac

SEQ ID NO: 1350 - DNA, 46 bp, Artificial Sequence
  Probe
gcaaagccgaattgaagatcgtttagaaagactggatgatgctatt

SEQ ID NO: 1351 - DNA, 48 bp, Artificial Sequence
  Probe
ggaacaccagatgcattttcacaattactcacctgtccatattgtgat

SEQ ID NO: 1352 - DNA, 45 bp, Artificial Sequence
  Probe
gtgaatgggcgaccaagaacaggactcaagacatctcagtgttct

SEQ ID NO: 1353 - DNA, 46 bp, Artificial Sequence
  Probe
acacgaccacagatacggcaaaagatagagaataaaccccttcaag

SEQ ID NO: 1354 - DNA, 53 bp, Artificial Sequence
  Probe
tgccttaaaataatgaatacaatttccaaaatggtctctaacatttccttaca

SEQ ID NO: 1355 - DNA, 49 bp, Artificial Sequence
  Probe
aaagaaagtcagccatatctccattgtgcctaagtccagtgtttctttt

SEQ ID NO: 1356 - DNA, 47 bp, Artificial Sequence
  Probe
ttctggggaaaacgaatttctcattttcttcttaaattgccattttc

SEQ ID NO: 1357 - DNA, 46 bp, Artificial Sequence
  Probe
caagttggagggctcagcatttctctaagggactagacctttcaac

SEQ ID NO: 1358 - DNA, 44 bp, Artificial Sequence
  Probe
ggatctggccgtgaagctcacctctggagactctgaatctcatc

SEQ ID NO: 1359 - DNA, 48 bp, Artificial Sequence
  Probe
gctctactgagcttgctgtgctctactctggtctcagaagtaaacatg

SEQ ID NO: 1360 - DNA, 37 bp, Artificial Sequence
  Probe
ccttcaccaccagcgtgcgcagctacctgcccaacac

SEQ ID NO: 1361 - DNA, 37 bp, Artificial Sequence
  Probe
gtctgggatgcgaacgggcctggaaccatagcgtcag

SEQ ID NO: 1362 - DNA, 40 bp, Artificial Sequence
  Probe
gcgtggaccgagtgaccgtggtttctgtgtggtgtcacct

SEQ ID NO: 1363 - DNA, 39 bp, Artificial Sequence
  Probe
gccgaatatcagccgccaccctactttccccctccctac

SEQ ID NO: 1364 - DNA, 43 bp, Artificial Sequence
  Probe
gaccaagaaccctctgaacctcccctgtcagaaggagctggtg

SEQ ID NO: 1365 - DNA, 46 bp, Artificial Sequence
  Probe
tcagtccctggaagattgtcgctcctcagctctacgtctaaataca

SEQ ID NO: 1366 - DNA, 47 bp, Artificial Sequence
  Probe
ccctctttgcaacatttcaggaaaacagagaaagaagtgataggagg

SEQ ID NO: 1367 - DNA, 43 bp, Artificial Sequence
  Probe
agccattctccagcagacagccgagtacatcttctccctggag

SEQ ID NO: 1368 - DNA, 41 bp, Artificial Sequence
  Probe
caccatgggcccctcctcggtcatcaactctgtttccacat

SEQ ID NO: 1369 - DNA, 42 bp, Artificial Sequence
  Probe
cagagaggaggcaatggccaccatggagaacaaggtgatctg

SEQ ID NO: 1370 - DNA, 43 bp, Artificial Sequence
  Probe
ttgtggttttcctggtgtcacgccctcccagtgtgcaaataag

SEQ ID NO: 1371 - DNA, 43 bp, Artificial Sequence
  Probe
gttcgtggggtcccctggtgcttctatcctaataccatcgacg

SEQ ID NO: 1372 - DNA, 41 bp, Artificial Sequence
  Probe
gacctctcccctttgggagagaaaaactgtctgggagcttg

SEQ ID NO: 1373 - DNA, 43 bp, Artificial Sequence
  Probe
ctgctttgactccaggatccctggagtgccttggtgtttcaag

SEQ ID NO: 1374 - DNA, 41 bp, Artificial Sequence
  Probe
ccctttgctcccggcaagcgcttctgctgaaagttcatatc

SEQ ID NO: 1375 - DNA, 45 bp, Artificial Sequence
  Probe
cagatacggagttgccaccactgaaacttatgcattcattttgtg

SEQ ID NO: 1376 - DNA, 48 bp, Artificial Sequence
  Probe
tgctttttggaagaagatcctggaatatgtcgaggttatattaccagg

SEQ ID NO: 1377 - DNA, 44 bp, Artificial Sequence
  Probe
gtccgaatggtttccaggtggataattatggaacccagctcaat

SEQ ID NO: 1378 - DNA, 49 bp, Artificial Sequence
  Probe
tggctacttgggctattgtaaaggggtagaaccaaaaactgagtgtgag

SEQ ID NO: 1379 - DNA, 47 bp, Artificial Sequence
  Probe
aattcatatgtccctcgtgaggctggatctcaaaaagatgaaaatct

SEQ ID NO: 1380 - DNA, 46 bp, Artificial Sequence
  Probe
aactcagcaaagtctggcgtgatcaacattttgttaagattcaggt

SEQ ID NO: 1381 - DNA, 45 bp, Artificial Sequence
  Probe
agtttggccaggtggactgtggcagatcaataaagaaaggcttct

SEQ ID NO: 1382 - DNA, 46 bp, Artificial Sequence
  Probe
gcggaccacgatttcaagacttgttaaaaaagaactgcaaagagac

SEQ ID NO: 1383 - DNA, 47 bp, Artificial Sequence
  Probe
tgcctactggggaagaaagtgaaggaggggaaactgtttaatatcac

SEQ ID NO: 1384 - DNA, 45 bp, Artificial Sequence
  Probe
ccacagatcccctattcaagaccacccaccttctggtaccagatc

SEQ ID NO: 1385 - DNA, 41 bp, Artificial Sequence
  Probe
ccgcgggactatccacctgcaagactatcgacatggagctg

SEQ ID NO: 1386 - DNA, 52 bp, Artificial Sequence
  Probe
caagttcaagcagagtacacacagcatatatatgttcttcaacacatcagag

SEQ ID NO: 1387 - DNA, 42 bp, Artificial Sequence
  Probe
gctgaactttgccacggtcagcctctctctgtccacttgcac

SEQ ID NO: 1388 - DNA, 46 bp, Artificial Sequence
  Probe
caggaaaacaccgagtcggaatactatgccaaagaaatccataaat

SEQ ID NO: 1389 - DNA, 44 bp, Artificial Sequence
  Probe
gatgagcacattgccaaacagcgctatatcggtggcaagaatct

SEQ ID NO: 1390 - DNA, 43 bp, Artificial Sequence
  Probe
gtctggcggagacaacagcgtgtttgacatctttgaactcacc

SEQ ID NO: 1391 - DNA, 43 bp, Artificial Sequence
  Probe
cgtccaaggaaagcagcacgtggtgtctgtggaagaagctctc

SEQ ID NO: 1392 - DNA, 42 bp, Artificial Sequence
  Probe
gcaggaagacagggcccagctgtacatcgactgtgaaaagat

SEQ ID NO: 1393 - DNA, 45 bp, Artificial Sequence
  Probe
tgatttccaccttcaagctgcagactaaaagttcagccaccatct

SEQ ID NO: 1394 - DNA, 43 bp, Artificial Sequence
  Probe
cctgaagaacgatgggaaggtgcatttggtggttttcaacaac

SEQ ID NO: 1395 - DNA, 39 bp, Artificial Sequence
  Probe
agcaatttgcagcgaggggccggctccctagagctctac

SEQ ID NO: 1396 - DNA, 47 bp, Artificial Sequence
  Probe
tgactaccaatgggcaatcaacatgaagaaattctttcctaaaggag

SEQ ID NO: 1397 - DNA, 45 bp, Artificial Sequence
  Probe
attggaccatcccccaatcctctcatcttgtcctacctgaagtat

SEQ ID NO: 1398 - DNA, 43 bp, Artificial Sequence
  Probe
cctgtgtgtccaggcattgctggacatcatggacatgttttgt

SEQ ID NO: 1399 - DNA, 42 bp, Artificial Sequence
  Probe
caggctgaggcccctgatctctacacctacttcaccatgctc

SEQ ID NO: 1400 - DNA, 45 bp, Artificial Sequence
  Probe
tgagcaccaattcctggattccagtcactggctcacctttagaat

SEQ ID NO: 1401 - DNA, 45 bp, Artificial Sequence
  Probe
gagtgtaggtgttggcacgtgaccaaaattcacatccctcctcat

SEQ ID NO: 1402 - DNA, 43 bp, Artificial Sequence
  Probe
cttctgcactgatggtgggtggatgagtaatgcatccaggaag

SEQ ID NO: 1403 - DNA, 47 bp, Artificial Sequence
  Probe
aaccagaccaccttataccagcgttatgagatcaagatgaccaagat

SEQ ID NO: 1404 - DNA, 46 bp, Artificial Sequence
  Probe
ttctcattgctggaaaactgcaggatggactcttgcacatcactac

SEQ ID NO: 1405 - DNA, 41 bp, Artificial Sequence
  Probe
acccgcaacaggcgttttgcaatgcagatgtagtgatcagg

SEQ ID NO: 1406 - DNA, 44 bp, Artificial Sequence
  Probe
ctgagcaccacccagaagaagagcctgaaccacaggtaccagat

SEQ ID NO: 1407 - DNA, 45 bp, Artificial Sequence
  Probe
tggtccagctctgacatcccttcctggaaacagcatgaataaaac

SEQ ID NO: 1408 - DNA, 42 bp, Artificial Sequence
  Probe
ggcttgccccagagctgatccttgtctttgtccacttctcag

SEQ ID NO: 1409 - DNA, 45 bp, Artificial Sequence
  Probe
taacccagcatcctgaaccgtgtttgttgaatgaatacagaaccc

SEQ ID NO: 1410 - DNA, 44 bp, Artificial Sequence
  Probe
tctgtgcctgctctctccagagaaactggaggggtagcagttag

SEQ ID NO: 1411 - DNA, 44 bp, Artificial Sequence
  Probe
ctccttccaggcttccctctgcatcttactgagtatgcaggtcg

SEQ ID NO: 1412 - DNA, 46 bp, Artificial Sequence
  Probe
cgccttttgactcttccctctgtggtgtgaaactagaagccaacag

SEQ ID NO: 1413 - DNA, 47 bp, Artificial Sequence
  Probe
ttgactggtcaggtcctcagtgatggaaaagtcttcatccatctgtg

SEQ ID NO: 1414 - DNA, 42 bp, Artificial Sequence
  Probe
cttactgcgggacggccttggagagtactcgggttcgtgaac

SEQ ID NO: 1415 - DNA, 44 bp, Artificial Sequence
  Probe
agttgatgagacgcgtccgtcgcttccagattgctcagtacaag

SEQ ID NO: 1416 - DNA, 42 bp, Artificial Sequence
  Probe
agtaccactccgtgtgtcggctctgctacttcaagaaggcct

SEQ ID NO: 1417 - DNA, 48 bp, Artificial Sequence
  Probe
ggagctaaagcctcaacaaataacgaaagctctaatcacagttttgga

SEQ ID NO: 1418 - DNA, 47 bp, Artificial Sequence
  Probe
ggcatttataagacgctgtttggcatatcgaaaagaagatcgatttg

SEQ ID NO: 1419 - DNA, 47 bp, Artificial Sequence
  Probe
cctacacccccttcttcaagcataattacttactgactttcctccaa

SEQ ID NO: 1420 - DNA, 41 bp, Artificial Sequence
  Probe
ctcacaggccccgcagaggctgtccttctacagctggtatg

SEQ ID NO: 1421 - DNA, 40 bp, Artificial Sequence
  Probe
gcttggctcccacctgtgcctacgtcttccagcctgaact

SEQ ID NO: 1422 - DNA, 41 bp, Artificial Sequence
  Probe
cagccccttctgcagagcagccaaaaccagagcttcaatgc

SEQ ID NO: 1423 - DNA, 46 bp, Artificial Sequence
  Probe
ggtcaccaccagctattggaccttactatgaaaaccatggatacca

SEQ ID NO: 1424 - DNA, 47 bp, Artificial Sequence
  Probe
cggaccaaacttcatccttcagatgtactcatctcagaggaagtcct

SEQ ID NO: 1425 - DNA, 46 bp, Artificial Sequence
  Probe
aatagtggatgacagcggatccaccagctttatgaaactgaacaca

SEQ ID NO: 1426 - DNA, 43 bp, Artificial Sequence
  Probe
gccatcagagggcctgtacctcatctactcccaggtcctcttc

SEQ ID NO: 1427 - DNA, 42 bp, Artificial Sequence
  Probe
tcgactttgccgagtctgggcaggtctactttgggatcattg

SEQ ID NO: 1428 - DNA, 45 bp, Artificial Sequence
  Probe
cctccttcagacaccctcaacctcttctggctcaaaaagagaatt

SEQ ID NO: 1429 - DNA, 46 bp, Artificial Sequence
  Probe
ggaggattgcgttgacgagactcttatttattgtcaccaacctgtg

SEQ ID NO: 1430 - DNA, 46 bp, Artificial Sequence
  Probe
ctttaagggctgaaacccacgggcctgagagactataagagcgttc

SEQ ID NO: 1431 - DNA, 45 bp, Artificial Sequence
  Probe
gctgggagagagacttgccaagcagaagattgaggaccacttgtt

SEQ ID NO: 1432 - DNA, 42 bp, Artificial Sequence
  Probe
gcacgcgcacaaactacggggacgatttctgattgatttttg

SEQ ID NO: 1433 - DNA, 50 bp, Artificial Sequence
  Probe
gcttgcctctccctatcactaccttatcatcatagtggttttagtcatca

SEQ ID NO: 1434 - DNA, 44 bp, Artificial Sequence
  Probe
tacttgacccatgccccaacaaactctactatccaatatggggc

SEQ ID NO: 1435 - DNA, 47 bp, Artificial Sequence
  Probe
tgatcttcacagtgctcctgcagtctctctgtgtggctgtaacttac

SEQ ID NO: 1436 - DNA, 48 bp, Artificial Sequence
  Probe
tcccctagtgagagaaagaggtcctcagagagtagcagctcacataac

SEQ ID NO: 1437 - DNA, 47 bp, Artificial Sequence
  Probe
tggtgaactggtcatccatgaaaaagggttttactacatctattccc

SEQ ID NO: 1438 - DNA, 47 bp, Artificial Sequence
  Probe
tcagaagatggcactcactgcatttatagaattttgagactccatga

SEQ ID NO: 1439 - DNA, 48 bp, Artificial Sequence
  Probe
gcaccaagtattggtcagggaattctgaattccatttttattccataa

SEQ ID NO: 1440 - DNA, 48 bp, Artificial Sequence
  Probe
gatgcaacatactttggggcttttaaagttcgagatatagattgagcc

SEQ ID NO: 1441 - DNA, 44 bp, Artificial Sequence
  Probe
ggaaacaggaagtcctgcttgccaatttcagcacagggagtagt

SEQ ID NO: 1442 - DNA, 45 bp, Artificial Sequence
  Probe
gcagccctgtccttcctagagggactggaacctaattctcctgag

SEQ ID NO: 1443 - DNA, 43 bp, Artificial Sequence
  Probe
cacgacggagtgccaggagcactaacagtacccttagcttgct

SEQ ID NO: 1444 - DNA, 46 bp, Artificial Sequence
  Probe
tgtgagacaaactcccacacagcactttaaaaatcagttcccagct

SEQ ID NO: 1445 - DNA, 45 bp, Artificial Sequence
  Probe
ggccttcaccaagaaccgaatgaactataccaacaaattcctgct

SEQ ID NO: 1446 - DNA, 46 bp, Artificial Sequence
  Probe
gggacaagctaatggtgaacgtcagtgacatctctttggtggatta

SEQ ID NO: 1447 - DNA, 47 bp, Artificial Sequence
  Probe
aacacaaagatcgagaacaccggcacaaagaacacaagaaggagaag

SEQ ID NO: 1448 - DNA, 47 bp, Artificial Sequence
  Probe
gctatcctgaaggcatcaagtggaaattcctagaacataaaggtcca

SEQ ID NO: 1449 - DNA, 46 bp, Artificial Sequence
  Probe
gtcatgaagctgagccccaaagcagaggaagtagctacgttctttg

SEQ ID NO: 1450 - DNA, 47 bp, Artificial Sequence
  Probe
ctcaagcccttcaatggagaagattatacatgtatcacctttcagcc

SEQ ID NO: 1451 - DNA, 48 bp, Artificial Sequence
  Probe
tggcattttacagccttcctgaatttgaagagtggaagagttctactc

SEQ ID NO: 1452 - DNA, 48 bp, Artificial Sequence
  Probe
tctagaacccatgttgaatggcaccgagaagacacctcctctcataac

SEQ ID NO: 1453 - DNA, 47 bp, Artificial Sequence
  Probe
gtgctcaagactggcgctaaaagttttgagcttctcaaaagtctaga

SEQ ID NO: 1454 - DNA, 43 bp, Artificial Sequence
  Probe
ctggcccctgtcatcttctgtcccttcccagaaaacctaccag

SEQ ID NO: 1455 - DNA, 44 bp, Artificial Sequence
  Probe
ccgagtggaaggaaatttgcgtgtggagtatttggatgacagaa

SEQ ID NO: 1456 - DNA, 42 bp, Artificial Sequence
  Probe
acctatcctgaaccccagcaagcctgaaacagctcagccaag

SEQ ID NO: 1457 - DNA, 45 bp, Artificial Sequence
  Probe
agtccggggacgacaagaactncaactacttcagcatggactcta

SEQ ID NO: 1458 - DNA, 40 bp, Artificial Sequence
  Probe
atcggcaacaagcagaaggcggtcaagtcctgcctggtgt

SEQ ID NO: 1459 - DNA, 47 bp, Artificial Sequence
  Probe
ggaaaaacatccctgtgtaaagcgttagcccagaaattgacaattag

SEQ ID NO: 1460 - DNA, 48 bp, Artificial Sequence
  Probe
ggcaagctggtaaccaagatgtttcagaagattcaggatttgattgat

SEQ ID NO: 1461 - DNA, 48 bp, Artificial Sequence
  Probe
cattccaatgttgtgattctgaccacttctaacatcaccgagaagatc

SEQ ID NO: 1462 - DNA, 45 bp, Artificial Sequence
  Probe
gggacgacgtgacagctgtctttaaagagaacctcaattctgacc

SEQ ID NO: 1463 - DNA, 46 bp, Artificial Sequence
  Probe
gagccacatgacaagcacctcttggacaggattaacgaatatgtgg

SEQ ID NO: 1464 - DNA, 47 bp, Artificial Sequence
  Probe
tcaagcacctcttttgccttctttactaaaatgtctcaagatggaca

SEQ ID NO: 1465 - DNA, 45 bp, Artificial Sequence
  Probe
acctcatgcagcttggcagatatctgagaaatggtttaattcatg

SEQ ID NO: 1466 - DNA, 45 bp, Artificial Sequence
  Probe
cccccaggaggaacttgaaaggagggtaaaaagactaaaatgagg

SEQ ID NO: 1467 - DNA, 48 bp, Artificial Sequence
  Probe
gacaaaatggtgacaggtagctgggacctaggctatcttaccatgaag

SEQ ID NO: 1468 - DNA, 45 bp, Artificial Sequence
  Probe
ctgacgttgctggtagtgcctgccatcaagaaagattatggttcc

SEQ ID NO: 1469 - DNA, 44 bp, Artificial Sequence
  Probe
tcaagtgctgtggcttcaccaactatacggattttgaggactca

SEQ ID NO: 1470 - DNA, 48 bp, Artificial Sequence
  Probe
gccatgattgtgtccatgtatctgtactgcaatctacaataagtccac

SEQ ID NO: 1471 - DNA, 44 bp, Artificial Sequence
  Probe
gtggtcattgcagtgggcatcttcttgttcctgattgctttagt

SEQ ID NO: 1472 - DNA, 46 bp, Artificial Sequence
  Probe
acaatacggcaagtgctcgaaatgacatccagagaaatctaaactg

SEQ ID NO: 1473 - DNA, 47 bp, Artificial Sequence
  Probe
tttgagatttgttggtggcattggcctgttcttcagttttacagaga

SEQ ID NO: 1474 - DNA, 46 bp, Artificial Sequence
  Probe
gggaagcactacaagggtcctgaagtcagttgttgcatcaaatact

SEQ ID NO: 1475 - DNA, 45 bp, Artificial Sequence
  Probe
ttttcttcctggagctcactgccggagttctagcatttgttttca

SEQ ID NO: 1476 - DNA, 48 bp, Artificial Sequence
  Probe
ttttggagctgatgattggaacctaaatatttacttcaattgcacaga

SEQ ID NO: 1477 - DNA, 38 bp, Artificial Sequence
  Probe
tcccccaggacagggaccctcatctgccttactggttg

SEQ ID NO: 1478 - DNA, 47 bp, Artificial Sequence
  Probe
agatcagggacctcacgcatctctttctcatatacatggactctctg

SEQ ID NO: 1479 - DNA, 42 bp, Artificial Sequence
  Probe
tcttcgagagaacctgtcgccagtatgacaagctgcgtaagc

SEQ ID NO: 1480 - DNA, 45 bp, Artificial Sequence
  Probe
gggccggagacctagatgtcattgtttccagagaaggagaaaatg

SEQ ID NO: 1481 - DNA, 44 bp, Artificial Sequence
  Probe
attcaaagaaacagggcgtggggcgcacttttaaaagagaaagc

SEQ ID NO: 1482 - DNA, 44 bp, Artificial Sequence
  Probe
tgaggacccatggtaaaatgcaaatagatccggtgtctaaatgc

SEQ ID NO: 1483 - DNA, 48 bp, Artificial Sequence
  Probe
cctcctcagatccgatttctcactccaatttatcatccaaacattgat

SEQ ID NO: 1484 - DNA, 47 bp, Artificial Sequence
  Probe
cttggagaccatccctcaacatcgcaactgtgttgacctctattcag

SEQ ID NO: 1485 - DNA, 46 bp, Artificial Sequence
  Probe
aggggacttgtcctggttcatcttagttaatgtgttctttgccaag

SEQ ID NO: 1486 - DNA, 43 bp, Artificial Sequence
  Probe
agtcagagcctcccctgctgcgtacaagcaagcgtaccatcta

SEQ ID NO: 1487 - DNA, 44 bp, Artificial Sequence
  Probe
ttcaacttcgaccacccagatgcctttgacttcgacctcatcat

SEQ ID NO: 1488 - DNA, 44 bp, Artificial Sequence
  Probe
ctgttggagctcctggacatgaagatctttgtggacacagactc

SEQ ID NO: 1489 - DNA, 41 bp, Artificial Sequence
  Probe
accaaggtggaggagctgaggcggaagatccaggagctgtt

SEQ ID NO: 1490 - DNA, 41 bp, Artificial Sequence
  Probe
tcttcgactacgaggtccgcctgaatgacaccatccagctc

SEQ ID NO: 1491 - DNA, 41 bp, Artificial Sequence
  Probe
aggacctggaggtgggccaggtggtcatgctcaactacaac

SEQ ID NO: 1492 - DNA, 37 bp, Artificial Sequence
  Probe
ggccctgcaaacagctcccgattagggggtgcttttg

SEQ ID NO: 1493 - DNA, 42 bp, Artificial Sequence
  Probe
cgggaggcggctctgtaccagacggactatactgagagccta

SEQ ID NO: 1494 - DNA, 41 bp, Artificial Sequence
  Probe
cacctgggcagcttcaaggtggacaactggaagcagaacct

SEQ ID NO: 1495 - DNA, 47 bp, Artificial Sequence
  Probe
cccatttgacaggctggagatagacttactgaaaggagatcatctca

SEQ ID NO: 1496 - DNA, 47 bp, Artificial Sequence
  Probe
gaggatgcagacaggaagtccctggaaaccaagagtttggaagtaac

SEQ ID NO: 1497 - DNA, 47 bp, Artificial Sequence
  Probe
ggaaaagttcttgtttgccgagctaaattacacattgatgaaatgga

SEQ ID NO: 1498 - DNA, 38 bp, Artificial Sequence
  Probe
actcaccggccagggcgctcggtgctggaatttgatat

SEQ ID NO: 1499 - DNA, 44 bp, Artificial Sequence
  Probe
gggagattgctctacttccccaaatcactgtggattttggaaac

SEQ ID NO: 1500 - DNA, 41 bp, Artificial Sequence
  Probe
agcagcgaaagcgacaggggcaaagtgagtgacctgctttt

SEQ ID NO: 1501 - DNA, 41 bp, Artificial Sequence
  Probe
aggaaggcagcggcagctccactcagccagtacccagatac

SEQ ID NO: 1502 - DNA, 41 bp, Artificial Sequence
  Probe
gcaatgcctctttgcggctgaaaaacgtgcaactcacagat

SEQ ID NO: 1503 - DNA, 44 bp, Artificial Sequence
  Probe
agcatgccggaagtgaatgtggactataatgccagctcagagac

SEQ ID NO: 1504 - DNA, 41 bp, Artificial Sequence
  Probe
ggggactccacagcccctgggctacataacagcaagacagt

SEQ ID NO: 1505 - DNA, 46 bp, Artificial Sequence
  Probe
ctatgcctccaaagggctgtatctagaaactgaggctgggtactac

SEQ ID NO: 1506 - DNA, 47 bp, Artificial Sequence
  Probe
gggctgtgtggcaactttaacatctttgctgaagatgactttatgac

SEQ ID NO: 1507 - DNA, 45 bp, Artificial Sequence
  Probe
tgaacgtagcctcctccacgaacctgcttacagactccaagagtc

SEQ ID NO: 1508 - DNA, 40 bp, Artificial Sequence
  Probe
ctgttgagccgcaaacagcggcgtctgatacgccaaaatc

SEQ ID NO: 1509 - DNA, 41 bp, Artificial Sequence
  Probe
aaaccgccctccccccacgacctcgtctacttcgagaaatc

SEQ ID NO: 1510 - DNA, 46 bp, Artificial Sequence
  Probe
agcagcggaaatgtcctgaatggatgaatgtgcagaataaaagatg

SEQ ID NO: 1511 - DNA, 46 bp, Artificial Sequence
  Probe
ggtgggatttgacatggagtggccaccattatacaatagagggaaa

SEQ ID NO: 1512 - DNA, 47 bp, Artificial Sequence
  Probe
ccccagggattaaaaatgttgcttgaaaataaagcagttaaaaaggc

SEQ ID NO: 1513 - DNA, 44 bp, Artificial Sequence
  Probe
gttgggcattctggacaacttggacccagtcatgttcttcaaat

SEQ ID NO: 1514 - DNA, 50 bp, Artificial Sequence
  Probe
ttgaccacatatataccaagcccctagtcttagagataccctctgagaca

SEQ ID NO: 1515 - DNA, 44 bp, Artificial Sequence
  Probe
aggaagcacctctcagcccctcagagaatgatcaccctgaattc

SEQ ID NO: 1516 - DNA, 47 bp, Artificial Sequence
  Probe
tcatccatgctgtcccacaaatagttttttgtttacgatttatgaca

SEQ ID NO: 1517 - DNA, 47 bp, Artificial Sequence
  Probe
tacattgtggcttcaaaagggccagtgtaaaactgcttccatgtcta

SEQ ID NO: 1518 - DNA, 45 bp, Artificial Sequence
  Probe
acatactggtttgtcctggcggggaataaaagggatcattggttc

SEQ ID NO: 1519 - DNA, 46 bp, Artificial Sequence
  Probe
gtaggggcggggggaagtttaggagttgaggaaagaagattaaaga

SEQ ID NO: 1520 - DNA, 44 bp, Artificial Sequence
  Probe
gcctttgggactctgaaggctgaagaattgatgaattgcaagtt

SEQ ID NO: 1521 - DNA, 49 bp, Artificial Sequence
  Probe
cctgaagagtgacaccattgattttgaaactactgaagaaacccaagac

SEQ ID NO: 1522 - DNA, 44 bp, Artificial Sequence
  Probe
cgggatccagaaacatgtcgaccacacttctgtccgccttctac

SEQ ID NO: 1523 - DNA, 43 bp, Artificial Sequence
  Probe
atccctggccaacctcaacctgaacaacatgctggacaagaag

SEQ ID NO: 1524 - DNA, 42 bp, Artificial Sequence
  Probe
acaaggagaacaaattccgggaccgctcgtttagcgagaacg

SEQ ID NO: 1525 - DNA, 48 bp, Artificial Sequence
  Probe
cagtgacaccatcactgagcttcctaaaagttcgaagaagttagagga

SEQ ID NO: 1526 - DNA, 45 bp, Artificial Sequence
  Probe
actccagaaattgcccaacggaactttgagattatatgcaatcga

SEQ ID NO: 1527 - DNA, 46 bp, Artificial Sequence
  Probe
gacaggaaacatgccaactcaatccctcttaatgtacatggatggg

SEQ ID NO: 1528 - DNA, 46 bp, Artificial Sequence
  Probe
gccatttggatcacacgatgttttttcaagattttagaccctttct

SEQ ID NO: 1529 - DNA, 46 bp, Artificial Sequence
  Probe
ccccagctgacaaggaaaagatcacatctcttccaacagtgacagt

SEQ ID NO: 1530 - DNA, 49 bp, Artificial Sequence
  Probe
tgggtttagagtgtccagtatgcaaagaagattacacagttgaagagga

SEQ ID NO: 1531 - DNA, 43 bp, Artificial Sequence
  Probe
cttcgtgaaacccactccttgctattaaaggaaatgttgtgga

SEQ ID NO: 1532 - DNA, 41 bp, Artificial Sequence
  Probe
gaagacattgccggtgacctggccccagactaacacaaggc

SEQ ID NO: 1533 - DNA, 43 bp, Artificial Sequence
  Probe
agaggtggccgaggtgaagccaaagccagagacagaagctaag

SEQ ID NO: 1534 - DNA, 46 bp, Artificial Sequence
  Probe
gccgaagctataaacagcgaagctctttagaggaacataaagagcg

SEQ ID NO: 1535 - DNA, 49 bp, Artificial Sequence
  Probe
gggcacactgtacccagtcattaaagaagaaactaatcacagtgaaatg

SEQ ID NO: 1536 - DNA, 41 bp, Artificial Sequence
  Probe
cctacgacagcagcgccagctacgagaaggagaacgaaatg